(19) United States
(12) Patent Application Publication
(10) Pub. No.: US 2026/0050145 A1
(43) Pub. Date: Feb. 19, 2026

(54) VARIABLE MAGNIFICATION OPTICAL SYSTEM AND IMAGING APPARATUS

(71) Applicant: FUJIFILM Corporation, Tokyo (JP)

(72) Inventor: Masato KONDO, Saitama-shi (JP)

(73) Assignee: FUJIFILM Corporation, Tokyo (JP)

(21) Appl. No.: 19/358,396

(22) Filed: Oct. 14, 2025

Related U.S. Application Data
(63) Continuation of application No. PCT/JP2024/010312, filed on Mar. 15, 2024.

(30) Foreign Application Priority Data
Apr. 19, 2023 (JP) 2023-068813

(51) Int. Cl. G02B 13/00; G02B 15/14; G02B 27/64

(52) U.S. Cl. CPC G02B 13/009; G02B 13/0045; G02B 13/006; G02B 15/1465; G02B 27/646

(57) ABSTRACT

A variable magnification optical system consists of, in order from an object side to an image side, a first lens group having negative refractive power, an intermediate group consisting of a plurality of lens groups, and a final lens group having refractive power. During magnification change, a spacing between the first lens group and the intermediate group changes, a spacing between the intermediate group and the final lens group changes, and spacings between all adjacent lens groups in the intermediate group change. A focusing group that moves along an optical axis during focusing is disposed on the image side with respect to the first lens group. The variable magnification optical system satisfies predetermined conditional expressions.

### CROSS-REFERENCE TO RELATED APPLICATIONS

This application is a continuation application of International Application No. PCT/JP2024/010312, filed on Mar. 15, 2024, which claims priority from Japanese Patent Application No. 2023-068813, filed on Apr. 19, 2023. The entire disclosure of each of the above applications is incorporated herein by reference.

### BACKGROUND

### Technical Field

The technology of the present disclosure relates to a variable magnification optical system and an imaging apparatus.

### Related Art

In the related art, as variable magnification optical systems usable in imaging apparatuses such as digital cameras, zoom lenses disclosed in JP2021-162822A and JP2019-105696A are known.

### SUMMARY

There is a demand for a variable magnification optical system that is compact in configuration and maintains good optical performance throughout an entire magnification change range. The level of this demand is increasing year by year.

The present disclosure provides a variable magnification optical system that is compact in configuration and maintains good optical performance throughout an entire magnification change range, as well as an imaging apparatus comprising the variable magnification optical system.

A first aspect of the present disclosure relates to a variable magnification optical system consisting of, in order from an object side to an image side, a first lens group having negative refractive power, an intermediate group consisting of a plurality of lens groups, and a final lens group having refractive power, in which, during magnification change, a spacing between the first lens group and the intermediate group changes, a spacing between the intermediate group and the final lens group changes, and spacings between all adjacent lens groups in the intermediate group change, a focusing group that moves along an optical axis during focusing is disposed on the image side with respect to the first lens group, and Conditional Expressions (1), (2), and (3) represented by 2<TLw/(fw×tan ωw)<6.5 (1), 0.15<Bfw/(fw×tan ωw)<1.5 (2), and 0.1<Dsum/(TLw−Bfw)<0.8 (3) are satisfied.

The symbols in Conditional Expressions (1), (2), and (3) are defined as follows. A sum of a distance on the optical axis from a surface closest to the object side of the first lens group to a lens surface closest to the image side of the final lens group and a back focus in terms of an air-equivalent distance of an entire system in a state in which an infinite distance object is in focus at a wide angle end is denoted by TLw. A focal length of the entire system in a state in which the infinite distance object is in focus at the wide angle end is denoted by fw. A maximum half angle of view in a state in which the infinite distance object is in focus at the wide angle end is denoted by ωw. A back focus in terms of the air-equivalent distance of the entire system in a state in which the infinite distance object is in focus at the wide angle end is denoted by Bfw. A total sum of thicknesses of all lens groups on the optical axis is denoted by Dsum.

A second aspect of the present disclosure relates to the variable magnification optical system according to the first aspect, in which Conditional Expression (1-1) represented by 2.6<TLw/(fw×tan ωw)<5.5 (1-1) is satisfied.

A third aspect of the present disclosure relates to the variable magnification optical system according to the second aspect, in which Conditional Expression (1-2) represented by 2.8<TLw/(fw×tan ωw)<5 (1-2) is satisfied.

A fourth aspect of the present disclosure relates to the variable magnification optical system according to the third aspect, in which Conditional Expression (1-3) represented by 3.1<TLw/(fw×tan ωw)<4.5 (1-3) is satisfied.

A fifth aspect of the present disclosure relates to the variable magnification optical system according to the fourth aspect, in which Conditional Expression (1-4) represented by 3.2<TLw/(fw×tan ωw)<4.25 (1-4) is satisfied.

A sixth aspect of the present disclosure relates to the variable magnification optical system according to the first aspect, in which Conditional Expression (2-1) represented by 0.2<Bfw/(fw×tan ωw)<1.25 (2-1) is satisfied.

A seventh aspect of the present disclosure relates to the variable magnification optical system according to the sixth aspect, in which Conditional Expression (2-2) represented by 0.25<Bfw/(fw×tan ωw)<1.1 (2-2) is satisfied.

An eighth aspect of the present disclosure relates to the variable magnification optical system according to the seventh aspect, in which Conditional Expression (2-3) represented by 0.35<Bfw/(fw×tan ωw)<1 (2-3) is satisfied.

A ninth aspect of the present disclosure relates to the variable magnification optical system according to the first aspect, in which Conditional Expression (3-1) represented by 0.15<Dsum/(TLw−Bfw)<0.6 (3-1) is satisfied.

A tenth aspect of the present disclosure relates to the variable magnification optical system according to the ninth aspect, in which Conditional Expression (3-2) represented by 0.21<Dsum/(TLw−Bfw)<0.54 (3-2) is satisfied.

An eleventh aspect of the present disclosure relates to the variable magnification optical system according to the first aspect, in which in a case in which an open F-number in a state in which the infinite distance object is in focus at the wide angle end is denoted by FNow, Conditional Expression (4) represented by 2.3<FNow/tan ωw<7 (4) is satisfied.

A twelfth aspect of the present disclosure relates to the variable magnification optical system according to the first aspect, in which in a case in which a focal length of the entire system in a state in which the infinite distance object is in focus at a telephoto end is denoted by ft, Conditional Expression (5) represented by 0.45<(fw×TLw)/ft²<3 (5) is satisfied.

A thirteenth aspect of the present disclosure relates to the variable magnification optical system according to the twelfth aspect, in which Conditional Expression (5-1) represented by 0.58<(fw×TLw)/ft²<2.2 (5-1) is satisfied.

A fourteenth aspect of the present disclosure relates to the variable magnification optical system according to the thirteenth aspect, in which Conditional Expression (5-2) represented by 0.73<(fw×TLw)/ft²<1.4 (5-2) is satisfied.

A fifteenth aspect of the present disclosure relates to the variable magnification optical system according to the fourteenth aspect, in which Conditional Expression (5-3) represented by 0.75<(fw×TLw)/ft²<1.35 (5-3) is satisfied.

A sixteenth aspect of the present disclosure relates to the variable magnification optical system according to the first aspect, in which in a case in which a focal length of the entire system in a state in which the infinite distance object is in focus at a telephoto end is denoted by ft, and a focal length of the first lens group is denoted by f1, Conditional Expression (6) represented by −10<ft/f1<−0.4 (6) is satisfied.

A seventeenth aspect of the present disclosure relates to the variable magnification optical system according to the sixteenth aspect, in which Conditional Expression (6-1) represented by −7<ft/f1<−0.9 (6-1) is satisfied.

An eighteenth aspect of the present disclosure relates to the variable magnification optical system according to the third aspect, in which Conditional Expression (2-3) represented by 0.35<Bfw/(fw×tan ωw)<1 (2-3) is satisfied.

A nineteenth aspect of the present disclosure relates to the variable magnification optical system according to the eighteenth aspect, in which Conditional Expression (3-2) represented by 0.21<Dsum/(TLw−Bfw)<0.54 (3-2) is satisfied.

A twentieth aspect of the present disclosure relates to the variable magnification optical system according to the ninth aspect, in which in a case in which an open F-number in a state in which the infinite distance object is in focus at the wide angle end is denoted by FNow, Conditional Expression (4-1) represented by 2.9<FNow/tan ωw<6 (4-1) is satisfied.

A twenty-first aspect of the present disclosure relates to the variable magnification optical system according to the twentieth aspect, in which in a case in which a focal length of the entire system in a state in which the infinite distance object is in focus at a telephoto end is denoted by ft, Conditional Expression (5-3) represented by 0.75<(fw×TLw)/ft²<1.35 (5-3) is satisfied.

A twenty-second aspect of the present disclosure relates to the variable magnification optical system according to the twenty-first aspect, in which in a case in which the focal length of the entire system in a state in which the infinite distance object is in focus at the telephoto end is denoted by ft, and a focal length of the first lens group is denoted by f1, Conditional Expression (6-2) represented by −5<ft/f1<−1.1 (6-2) is satisfied.

A twenty-third aspect of the present disclosure relates to the variable magnification optical system according to the twenty-second aspect, in which the intermediate group includes an anti-vibration group that moves in a direction intersecting the optical axis during image shake correction, and in a case in which a focal length of the anti-vibration group is denoted by fois, Conditional Expression (7) represented by 0.3<ft/|fois|<4 (7) is satisfied.

A twenty-fourth aspect of the present disclosure relates to the variable magnification optical system according to the twenty-third aspect, in which the anti-vibration group is disposed closest to the object side in a lens group that is located closest to the object side in the intermediate group.

A twenty-fifth aspect of the present disclosure relates to the variable magnification optical system according to the fourth aspect, in which Conditional Expression (2-2) represented by 0.25<Bfw/(fw×tan ωw)<1.1 (2-2) is satisfied.

A twenty-sixth aspect of the present disclosure relates to the variable magnification optical system according to the twenty-fifth aspect, in which Conditional Expression (3-2) represented by 0.21<Dsum/(TLw−Bfw)<0.54 (3-2) is satisfied.

A twenty-seventh aspect of the present disclosure relates to the variable magnification optical system according to the twenty-sixth aspect, in which in a case in which an open F-number in a state in which the infinite distance object is in focus at the wide angle end is denoted by FNow, Conditional Expression (4-1) represented by 2.9<FNow/tan ωw<6 (4-1) is satisfied.

A twenty-eighth aspect of the present disclosure relates to the variable magnification optical system according to the twenty-seventh aspect, in which in a case in which a focal length of the entire system in a state in which the infinite distance object is in focus at a telephoto end is denoted by ft, Conditional Expression (5-2) represented by 0.73<(fw×TLw)/ft²<1.4 (5-2) is satisfied.

A twenty-ninth aspect of the present disclosure relates to the variable magnification optical system according to the twenty-eighth aspect, in which in a case in which a focal length of the first lens group is denoted by f1, Conditional Expression (6-2) represented by −5<ft/f1<−1.1 (6-2) is satisfied.

A thirtieth aspect of the present disclosure relates to the variable magnification optical system according to the first aspect, in which the intermediate group includes, in order from the object side to the image side, at least a first intermediate lens group having positive refractive power, a second intermediate lens group having refractive power, and a third intermediate lens group having refractive power.

A thirty-first aspect of the present disclosure relates to the variable magnification optical system according to the thirtieth aspect, in which Conditional Expression (1-2) represented by 2.8<TLw/(fw×tan ωw)<5 (1-2) is satisfied.

A thirty-second aspect of the present disclosure relates to the variable magnification optical system according to the thirty-first aspect, in which Conditional Expression (2-1A) represented by 0.18<Bfw/(fw×tan ωw)<1.25 (2-1A) is satisfied.

A thirty-third aspect of the present disclosure relates to the variable magnification optical system according to the thirty-second aspect, in which in a case in which a focal length of the entire system in a state in which the infinite distance object is in focus at a telephoto end is denoted by ft, Conditional Expression (5-1A) represented by 0.63<(fw×TLw)/ft²<1.85 (5-1A) is satisfied.

A thirty-fourth aspect of the present disclosure relates to the variable magnification optical system according to the thirty-third aspect, in which in a case in which a focal length of the first lens group is denoted by f1, Conditional Expression (6-1) represented by −7<ft/f1<−0.9 (6-1) is satisfied.

A thirty-fifth aspect of the present disclosure relates to the variable magnification optical system according to the first aspect, in which in a case in which a focal length of the first lens group is denoted by f1, Conditional Expression (8) represented by −3.5<fw/f1<−0.2 (8) is satisfied.

A thirty-sixth aspect of the present disclosure relates to the variable magnification optical system according to the first aspect, in which in a case in which a focal length of the entire system in a state in which the infinite distance object is in focus at a telephoto end is denoted by ft, and a focal length of the intermediate group in a state in which the infinite distance object is in focus at the wide angle end is denoted by fMw, Conditional Expression (9) represented by 0.2<ft/fMw<7.5 (9) is satisfied.

A thirty-seventh aspect of the present disclosure relates to the variable magnification optical system according to the first aspect, in which in a case in which a focal length of the entire system in a state in which the infinite distance object is in focus at a telephoto end is denoted by ft, and a focal length of a lens group located closest to the image side in the intermediate group is denoted by fme, Conditional Expression (10) represented by −16<ft/fme<−0.15 (10) is satisfied.

A thirty-eighth aspect of the present disclosure relates to the variable magnification optical system according to the first aspect, in which in a case in which a focal length of the entire system in a state in which the infinite distance object is in focus at a telephoto end is denoted by ft, and a focal length of the final lens group is denoted by fE, Conditional Expression (11) represented by −2<ft/fE<2.5 (11) is satisfied.

A thirty-ninth aspect of the present disclosure relates to the variable magnification optical system according to the first aspect, in which in a case in which a focal length of the first lens group is denoted by f1, and a focal length of a lens group located closest to the object side in the intermediate group is denoted by fm1, Conditional Expression (12) represented by −5<f1/fm1<−0.05 (12) is satisfied.

A fortieth aspect of the present disclosure relates to the variable magnification optical system according to the first aspect, in which a lens group located closest to the object side in the intermediate group has positive refractive power, and in a case in which a focal length of the lens group located closest to the object side in the intermediate group is denoted by fm1, and a focal length of a lens group located closest to the image side in the intermediate group is denoted by fme, Conditional Expression (13) represented by −15<fm1/fme<−0.05 (13) is satisfied.

A forty-first aspect of the present disclosure relates to the variable magnification optical system according to the first aspect, in which in a case in which an open F-number in a state in which the infinite distance object is in focus at a telephoto end is denoted by FNot, and a focal length of the entire system in a state in which the infinite distance object is in focus at the telephoto end is denoted by ft, Conditional Expression (14) represented by 1.5<FNot/(ft/fw)<7 (14) is satisfied.

A forty-second aspect of the present disclosure relates to the variable magnification optical system according to the first aspect, in which in a case in which a focal length of the entire system in a state in which the infinite distance object is in focus at a telephoto end is denoted by ft, and a maximum half angle of view in a state in which the infinite distance object is in focus at the telephoto end is denoted by ωt, Conditional Expression (15) represented by 0.4<fw/(ft×tan ωt)<2.7 (15) is satisfied.

A forty-third aspect of the present disclosure relates to the variable magnification optical system according to the first aspect, in which a lens group located closest to the image side in the intermediate group has negative refractive power, and in a case in which a focal length of the lens group located closest to the image side in the intermediate group is denoted by fme, and a focal length of the final lens group is denoted by fE, Conditional Expression (16) represented by −9<fme/fE<−0.05 (16) is satisfied.

A forty-fourth aspect of the present disclosure relates to the variable magnification optical system according to the third aspect, in which Conditional Expression (2-2) represented by 0.25<Bfw/(fw×tan ωw)<1.1 (2-2) is satisfied.

A forty-fifth aspect of the present disclosure relates to the variable magnification optical system according to the forty-fourth aspect, in which in a case in which a focal length of the entire system in a state in which the infinite distance object is in focus at a telephoto end is denoted by ft, Conditional Expression (5-1) represented by 0.58<(fw×TLw)/ft²<2.2 (5-1) is satisfied.

A forty-sixth aspect of the present disclosure relates to the variable magnification optical system according to the forty-fifth aspect, in which in a case in which a focal length of a lens group located closest to the image side in the intermediate group is denoted by fme, Conditional Expression (10-1) represented by −10<ft/fme<−1.5 (10-1) is satisfied.

A forty-seventh aspect of the present disclosure relates to the variable magnification optical system according to the forty-sixth aspect, in which in a case in which a focal length of the final lens group is denoted by fE, Conditional Expression (11-1) represented by 0.1<ft/fE<0.7 (11-1) is satisfied.

A forty-eighth aspect of the present disclosure relates to the variable magnification optical system according to the forty-seventh aspect, in which Conditional Expression (16-1) represented by −3<fme/fE<−0.35 (16-1) is satisfied.

A forty-ninth aspect of the present disclosure relates to the variable magnification optical system according to the first aspect, in which in a case in which a focal length of the first lens group is denoted by f1, and a focal length of the intermediate group in a state in which the infinite distance object is in focus at the wide angle end is denoted by fMw, Conditional Expression (17) represented by 0.2<(−f1)/fMw<5 (17) is satisfied.

A fiftieth aspect of the present disclosure relates to the variable magnification optical system according to the first aspect, in which in a case in which a focal length of the first lens group is denoted by f1, and a focal length of the entire system in a state in which the infinite distance object is in focus at a telephoto end is denoted by ft, Conditional Expression (18) represented by 0.3<(−f1)/(fw×ft)^{1/2}<2 (18) is satisfied.

A fifty-first aspect of the present disclosure relates to the variable magnification optical system according to the first aspect, in which in a case in which a focal length of the intermediate group in a state in which the infinite distance object is in focus at the wide angle end is denoted by fMw, and a focal length of the entire system in a state in which the infinite distance object is in focus at a telephoto end is denoted by ft, Conditional Expression (19) represented by 0.15<fMw/(fw×ft)^{1/2}<2 (19) is satisfied.

A fifty-second aspect of the present disclosure relates to the variable magnification optical system according to the first aspect, in which in a case in which a focal length of the first lens group is denoted by f1, a focal length of the entire system in a state in which the infinite distance object is in focus at a telephoto end is denoted by ft, and an open F-number in a state in which the infinite distance object is in focus at the telephoto end is denoted by FNot, Conditional Expression (20) represented by 1<(−f1)/(ft/FNot)<12 (20) is satisfied.

A fifty-third aspect of the present disclosure relates to the variable magnification optical system according to the first aspect, in which Conditional Expression (21) represented by 2.5<TLw/fw<7 (21) is satisfied.

A fifty-fourth aspect of the present disclosure relates to the variable magnification optical system according to the first aspect, in which in a case in which a focal length of the entire system in a state in which the infinite distance object is in focus at a telephoto end is denoted by ft, and a focal length of the focusing group is denoted by ffoc, Conditional Expression (22) represented by 0.3<ft/|ffoc|<6 (22) is satisfied.

A fifty-fifth aspect of the present disclosure relates to the variable magnification optical system according to the first aspect, in which in a case in which a focal length of the focusing group is denoted by ffoc, Conditional Expression (23) represented by 0.15<fw/|ffoc|<3.2 (23) is satisfied.

A fifty-sixth aspect of the present disclosure relates to the variable magnification optical system according to the first aspect, in which the focusing group consists of one lens, and in a case in which an Abbe number, based on a d line, of the lens constituting the focusing group is denoted by vdfoc, Conditional Expression (24) represented by 20<vdfoc<75 (24) is satisfied.

A fifty-seventh aspect of the present disclosure relates to the variable magnification optical system according to the first aspect, in which the intermediate group includes an aperture stop, and in a case in which a distance on the optical axis from a surface closest to the object side of the first lens group to the aperture stop in a state in which the infinite distance object is in focus at the wide angle end is denoted by DDLISTw, Conditional Expression (25) represented by 0.18<DDLISTw/TLw<0.8 (25) is satisfied.

A fifty-eighth aspect of the present disclosure relates to the variable magnification optical system according to the first aspect, in which in a case in which a spacing on the optical axis between the first lens group and the intermediate group in a state in which the infinite distance object is in focus at the wide angle end is denoted by DDG1Mw, and a spacing on the optical axis between the first lens group and the intermediate group in a state in which the infinite distance object is in focus at a telephoto end is denoted by DDG1Mt, Conditional Expression (26) represented by 0.07<|DDG1Mw−DDG1Mt|/TLw<0.4 (26) is satisfied.

A fifty-ninth aspect of the present disclosure relates to the variable magnification optical system according to the first aspect, in which in a case in which a paraxial curvature radius of an object-side surface of a negative lens closest to the object side among negative lenses included in the first lens group is denoted by R1nf, and a paraxial curvature radius of an image-side surface of the negative lens closest to the object side among the negative lenses included in the first lens group is denoted by R1nr, Conditional Expression (27) represented by 0.4<(R1nf+R1nr)/(R1nf−R1nr)<5 (27) is satisfied.

A sixtieth aspect of the present disclosure relates to the variable magnification optical system according to the first aspect, in which in a case in which a total sum of thicknesses of all lenses included in the first lens group on the optical axis is denoted by d1sum, a focal length of the entire system in a state in which the infinite distance object is in focus at a telephoto end is denoted by ft, and an open F-number in a state in which the infinite distance object is in focus at the telephoto end is denoted by FNot, Conditional Expression (28) represented by 0.15<d1sum/(ft/FNot)<4 (28) is satisfied.

A sixty-first aspect of the present disclosure relates to the variable magnification optical system according to the first aspect, in which the variable magnification optical system includes an aperture stop, and in a case in which a focal length of the first lens group is denoted by f1, and a composite focal length from a lens closest to the object side of the first lens group to the aperture stop in a state in which the infinite distance object is in focus at the wide angle end is denoted by fL1STw, Conditional Expression (29) represented by −3<f1/fL1STw<−0.1 (29) is satisfied.

A sixty-second aspect of the present disclosure relates to the variable magnification optical system according to the first aspect, in which the variable magnification optical system includes an aperture stop, and in a case in which a composite focal length from a lens closest to the object side of the first lens group to the aperture stop in a state in which the infinite distance object is in focus at the wide angle end is denoted by fL1STw, Conditional Expression (30) represented by 0.1<fw/fL1STw<3.2 (30) is satisfied.

A sixty-third aspect of the present disclosure relates to the variable magnification optical system according to the first aspect, in which in a case in which a refractive index, at a d line, of a negative lens closest to the object side among negative lenses included in the first lens group is denoted by N1n, Conditional Expression (31) represented by 1.55<N1n<2 (31) is satisfied.

A sixty-fourth aspect of the present disclosure relates to the variable magnification optical system according to the first aspect, in which in a case in which an open F-number in a state in which the infinite distance object is in focus at the wide angle end is denoted by FNow, Conditional Expression (32) represented by 1<(Dsum/TLw)×FNow<2.5 (32) is satisfied.

A sixty-fifth aspect of the present disclosure relates to the variable magnification optical system according to the first aspect, in which in a case in which a thickness of the focusing group on the optical axis is denoted by Dfoc, Conditional Expression (33) represented by 0.01<Dfoc/(fw×tan ωw)<0.25 (33) is satisfied.

A sixty-sixth aspect of the present disclosure relates to the variable magnification optical system according to the first aspect, in which in a case in which a sum of thicknesses of all lenses included in the first lens group on the optical axis is denoted by d1sum, and a focal length of the first lens group is denoted by f1, Conditional Expression (34) represented by 0.045<d1sum/|f1|<0.5 (34) is satisfied.

A sixty-seventh aspect of the present disclosure relates to the variable magnification optical system according to the first aspect, in which the final lens group remains stationary with respect to an image plane during magnification change.

A sixty-eighth aspect of the present disclosure relates to the variable magnification optical system according to the first aspect, in which the final lens group consists of one positive lens.

A sixty-ninth aspect of the present disclosure relates to the variable magnification optical system according to the first aspect, in which the number of lenses included in the variable magnification optical system is equal to or greater than 7 and equal to or less than 11.

A seventieth aspect of the present disclosure relates to the variable magnification optical system according to the sixty-ninth aspect, in which the number of lenses included in the variable magnification optical system is equal to or greater than 7 and equal to or less than 9.

A seventy-first aspect of the present disclosure relates to the variable magnification optical system according to the first aspect, in which the first lens group consists of three uncemented single lenses.

A seventy-second aspect of the present disclosure relates to the variable magnification optical system according to the first aspect, in which the first lens group consists of two lenses.

A seventy-third aspect of the present disclosure relates to the variable magnification optical system according to the first aspect, in which the focusing group consists of two lenses.

A seventy-fourth aspect of the present disclosure relates to the variable magnification optical system according to the first aspect, in which the focusing group consists of one lens.

A seventy-fifth aspect of the present disclosure relates to an imaging apparatus comprising: the variable magnification optical system according to any one of the first to seventy-fourth aspects.

It should be noted that, in the present specification, the expressions “consists of” and “consisting of” indicate that a lens substantially not having refractive power, an optical element other than a lens, such as a stop, a filter, and a cover glass, a mechanism part such as a lens flange, a lens barrel, an imaging element, and a camera shake correction mechanism may be included in addition to the shown constituents.

In the present specification, the expressions “ . . . group having positive refractive power” and “ . . . group has positive refractive power” mean that the entire group has positive refractive power. Similarly, the expressions “ . . . group having negative refractive power” and “ . . . group has negative refractive power” mean that the entire group has negative refractive power. The expressions “first lens group”, “lens group”, “final lens group”, “focusing group”, and “anti-vibration group” in the present specification are not limited to a configuration consisting of a plurality of lenses, and may be a configuration consisting of only one lens.

The expression “single lens” means one uncemented lens. It should be noted that a compound aspherical lens (a lens functioning as one aspherical lens as a whole, in which a lens (for example, a spherical lens) and a film of an aspherical shape formed on the lens are configured to be integrated with each other) is not regarded as a cemented lens but is regarded as one lens. Unless otherwise specified, a curvature radius, a sign of refractive power, and a surface shape related to a lens including an aspherical surface in a paraxial region are used. A sign of a paraxial curvature radius of a surface having a convex shape facing the object side is defined as positive, and a sign of a paraxial curvature radius of a surface having a convex shape facing the image side is defined as negative.

The expression “entire system” in the present specification means the variable magnification optical system. The expression “back focus in terms of an air-equivalent distance of the entire system” means an air-equivalent distance on the optical axis from a lens surface closest to the image side of the entire system to the image plane. The expression “focal length” used in the conditional expressions means a paraxial focal length. Unless otherwise specified, the expression “distance on the optical axis” used in the conditional expressions means a geometrical distance. Unless otherwise specified, values used in the conditional expressions are values based on the d line in a state in which the infinite distance object is in focus.

According to the present disclosure, it is possible to provide the variable magnification optical system that is compact in configuration and maintains good optical performance throughout the entire magnification change range, as well as the imaging apparatus comprising the variable magnification optical system.

### BRIEF DESCRIPTION OF THE DRAWINGS

FIG. 1 is a diagram showing a cross-sectional view of a configuration and a movement locus of a variable magnification optical system according to one embodiment, which corresponds to a variable magnification optical system according to Example 1.

FIG. 2 is a diagram showing symbols of conditional expressions.

FIG. 3 is each aberration diagram of the variable magnification optical system according to Example 1.

FIG. 4 is a diagram showing a cross-sectional view of a configuration and a movement locus of a variable magnification optical system according to Example 2.

FIG. 5 is each aberration diagram of the variable magnification optical system according to Example 2.

FIG. 6 is a diagram showing a cross-sectional view of a configuration and a movement locus of a variable magnification optical system according to Example 3.

FIG. 7 is each aberration diagram of the variable magnification optical system according to Example 3.

FIG. 8 is a diagram showing a cross-sectional view of a configuration and a movement locus of a variable magnification optical system according to Example 4.

FIG. 9 is each aberration diagram of the variable magnification optical system according to Example 4.

FIG. 10 is a diagram showing a cross-sectional view of a configuration and a movement locus of a variable magnification optical system according to Example 5.

FIG. 11 is each aberration diagram of the variable magnification optical system according to Example 5.

FIG. 12 is a diagram showing a cross-sectional view of a configuration and a movement locus of a variable magnification optical system according to Example 6.

FIG. 13 is each aberration diagram of the variable magnification optical system according to Example 6.

FIG. 14 is a diagram showing a cross-sectional view of a configuration and a movement locus of a variable magnification optical system according to Example 7.

FIG. 15 is each aberration diagram of the variable magnification optical system according to Example 7.

FIG. 16 is a diagram showing a cross-sectional view of a configuration and a movement locus of a variable magnification optical system according to Example 8.

FIG. 17 is each aberration diagram of the variable magnification optical system according to Example 8.

FIG. 18 is a diagram showing a cross-sectional view of a configuration and a movement locus of a variable magnification optical system according to Example 9.

FIG. 19 is each aberration diagram of the variable magnification optical system according to Example 9.

FIG. 20 is a diagram showing a cross-sectional view of a configuration and a movement locus of a variable magnification optical system according to Example 10.

FIG. 21 is each aberration diagram of the variable magnification optical system according to Example 10.

FIG. 22 is a diagram showing a cross-sectional view of a configuration and a movement locus of a variable magnification optical system according to Example 11.

FIG. 23 is each aberration diagram of the variable magnification optical system according to Example 11.

FIG. 24 is a diagram showing a cross-sectional view of a configuration and a movement locus of a variable magnification optical system according to Example 12.

FIG. 25 is each aberration diagram of the variable magnification optical system according to Example 12.

FIG. 26 is a diagram showing a cross-sectional view of a configuration and a movement locus of a variable magnification optical system according to Example 13.

FIG. 27 is each aberration diagram of the variable magnification optical system according to Example 13.

FIG. 28 is a diagram showing a cross-sectional view of a configuration and a movement locus of a variable magnification optical system according to Example 14.

FIG. 29 is each aberration diagram of the variable magnification optical system according to Example 14.

FIG. 30 is a diagram showing a cross-sectional view of a configuration and a movement locus of a variable magnification optical system according to Example 15.

FIG. 31 is each aberration diagram of the variable magnification optical system according to Example 15.

FIG. 32 is a diagram showing a cross-sectional view of a configuration and a movement locus of a variable magnification optical system according to Example 16.

FIG. 33 is each aberration diagram of the variable magnification optical system according to Example 16.

FIG. 34 is a diagram showing a cross-sectional view of a configuration and a movement locus of a variable magnification optical system according to Example 17.

FIG. 35 is each aberration diagram of the variable magnification optical system according to Example 17.

FIG. 36 is a diagram showing a cross-sectional view of a configuration and a movement locus of a variable magnification optical system according to Example 18.

FIG. 37 is each aberration diagram of the variable magnification optical system according to Example 18.

FIG. 38 is a diagram showing a cross-sectional view of a configuration and a movement locus of a variable magnification optical system according to Example 19.

FIG. 39 is each aberration diagram of the variable magnification optical system according to Example 19.

FIG. 40 is a diagram showing a cross-sectional view of a configuration and a movement locus of a variable magnification optical system according to Example 20.

FIG. 41 is each aberration diagram of the variable magnification optical system according to Example 20.

FIG. 42 is a diagram showing a cross-sectional view of a configuration and a movement locus of a variable magnification optical system according to Example 21.

FIG. 43 is each aberration diagram of the variable magnification optical system according to Example 21.

FIG. 44 is a diagram showing a cross-sectional view of a configuration and a movement locus of a variable magnification optical system according to Example 22.

FIG. 45 is each aberration diagram of the variable magnification optical system according to Example 22.

FIG. 46 is a diagram showing a cross-sectional view of a configuration and a movement locus of a variable magnification optical system according to Example 23.

FIG. 47 is each aberration diagram of the variable magnification optical system according to Example 23.

FIG. 48 is a diagram showing a cross-sectional view of a configuration and a movement locus of a variable magnification optical system according to Example 24.

FIG. 49 is each aberration diagram of the variable magnification optical system according to Example 24.

FIG. 50 is a diagram showing a cross-sectional view of a configuration and a movement locus of a variable magnification optical system according to Example 25.

FIG. 51 is each aberration diagram of the variable magnification optical system according to Example 25.

FIG. 52 is a diagram showing a cross-sectional view of a configuration and a movement locus of a variable magnification optical system according to Example 26.

FIG. 53 is each aberration diagram of the variable magnification optical system according to Example 26.

FIG. 54 is a diagram showing a cross-sectional view of a configuration and a movement locus of a variable magnification optical system according to Example 27.

FIG. 55 is each aberration diagram of the variable magnification optical system according to Example 27.

FIG. 56 is a diagram showing a cross-sectional view of a configuration and a movement locus of a variable magnification optical system according to Example 28.

FIG. 57 is each aberration diagram of the variable magnification optical system according to Example 28.

FIG. 58 is a diagram showing a cross-sectional view of a configuration and a movement locus of a variable magnification optical system according to Example 29.

FIG. 59 is each aberration diagram of the variable magnification optical system according to Example 29.

FIG. 60 is a diagram showing a cross-sectional view of a configuration and a movement locus of a variable magnification optical system according to Example 30.

FIG. 61 is each aberration diagram of the variable magnification optical system according to Example 30.

FIG. 62 is a diagram showing a cross-sectional view of a configuration and a movement locus of a variable magnification optical system according to Example 31.

FIG. 63 is each aberration diagram of the variable magnification optical system according to Example 31.

FIG. 64 is a diagram showing a cross-sectional view of a configuration and a movement locus of a variable magnification optical system according to Example 32.

FIG. 65 is each aberration diagram of the variable magnification optical system according to Example 32.

FIG. 66 is a diagram showing a cross-sectional view of a configuration and a movement locus of a variable magnification optical system according to Example 33.

FIG. 67 is each aberration diagram of the variable magnification optical system according to Example 33.

FIG. 68 is a diagram showing a cross-sectional view of a configuration and a movement locus of a variable magnification optical system according to Example 34.

FIG. 69 is each aberration diagram of the variable magnification optical system according to Example 34.

FIG. 70 is a diagram showing a cross-sectional view of a configuration and a movement locus of a variable magnification optical system according to Example 35.

FIG. 71 is each aberration diagram of the variable magnification optical system according to Example 35.

FIG. 72 is a diagram showing a cross-sectional view of a configuration and a movement locus of a variable magnification optical system according to Example 36.

FIG. 73 is each aberration diagram of the variable magnification optical system according to Example 36.

FIG. 74 is a diagram showing a cross-sectional view of a configuration and a movement locus of a variable magnification optical system according to Example 37.

FIG. 75 is each aberration diagram of the variable magnification optical system according to Example 37.

FIG. 76 is a diagram showing a cross-sectional view of a configuration and a movement locus of a variable magnification optical system according to Example 38.

FIG. 77 is each aberration diagram of the variable magnification optical system according to Example 38.

FIG. 78 is a diagram showing a cross-sectional view of a configuration and a movement locus of a variable magnification optical system according to Example 39.

FIG. 79 is each aberration diagram of the variable magnification optical system according to Example 39.

FIG. 80 is a diagram showing a cross-sectional view of a configuration and a movement locus of a variable magnification optical system according to Example 40.

FIG. 81 is each aberration diagram of the variable magnification optical system according to Example 40.

FIG. 82 is a diagram showing a cross-sectional view of a configuration and a movement locus of a variable magnification optical system according to Example 41.

FIG. 83 is each aberration diagram of the variable magnification optical system according to Example 41.

FIG. 84 is a diagram showing a cross-sectional view of a configuration and a movement locus of a variable magnification optical system according to Example 42.

FIG. 85 is each aberration diagram of the variable magnification optical system according to Example 42.

FIG. 86 is a diagram showing a cross-sectional view of a configuration and a movement locus of a variable magnification optical system according to Example 43.

FIG. 87 is each aberration diagram of the variable magnification optical system according to Example 43.

FIG. 88 is a diagram showing a cross-sectional view of a configuration and a movement locus of a variable magnification optical system according to Example 44.

FIG. 89 is each aberration diagram of the variable magnification optical system according to Example 44.

FIG. 90 is a diagram showing a cross-sectional view of a configuration and a movement locus of a variable magnification optical system according to Example 45.

FIG. 91 is each aberration diagram of the variable magnification optical system according to Example 45.

FIG. 92 is a diagram showing a cross-sectional view of a configuration and a movement locus of a variable magnification optical system according to Example 46.

FIG. 93 is each aberration diagram of the variable magnification optical system according to Example 46.

FIG. 94 is a perspective view of a front surface side of an imaging apparatus according to one embodiment.

FIG. 95 is a perspective view of a rear surface side of the imaging apparatus according to one embodiment.

### DETAILED DESCRIPTION

Hereinafter, an embodiment of the present disclosure will be described with reference to the accompanying drawings.

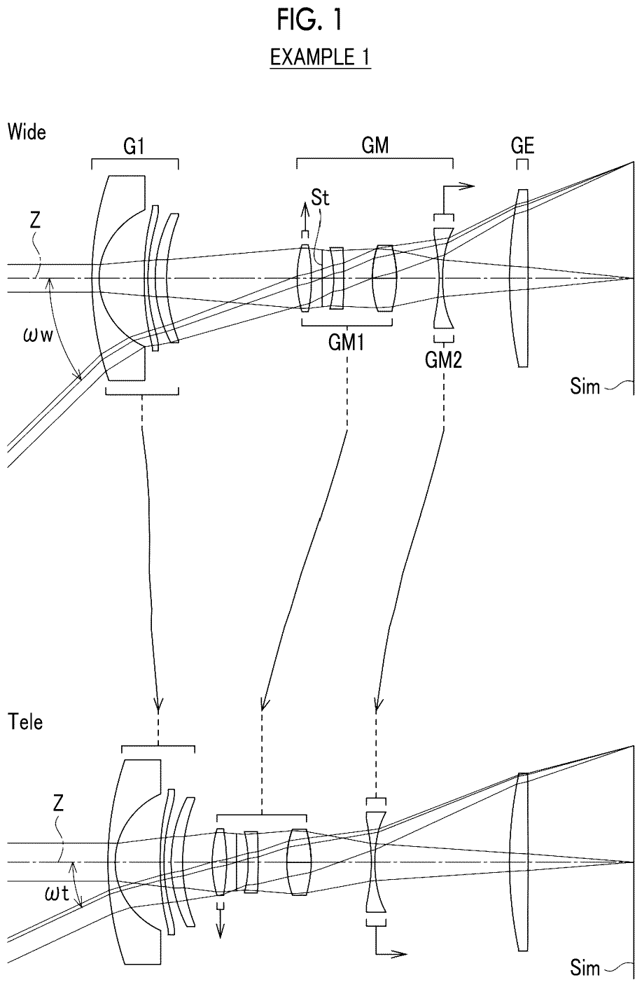

FIG. 1 shows a cross-sectional view of a configuration and a movement locus of a variable magnification optical system according to one embodiment of the present disclosure. FIG. 1 shows a wide angle end state in an upper part marked “Wide”, and a telephoto end state in a lower part marked “Tele”. The example shown in FIG. 1 corresponds to a variable magnification optical system according to Example 1 described later. FIG. 1 shows a state in which an infinite distance object is in focus, a left side is an object side, and a right side is an image side. FIG. 1 also shows an on-axis luminous flux and a luminous flux of a maximum half angle of view ow at the wide angle end and an on-axis luminous flux and a luminous flux of a maximum half angle of view ωt at the telephoto end.

A variable magnification optical system according to the present disclosure consists of, in order from an object side to an image side along an optical axis Z, a first lens group G1 having negative refractive power, an intermediate group GM consisting of a plurality of lens groups, and a final lens group GE having refractive power. During magnification change, a spacing between the first lens group G1 and the intermediate group GM changes, a spacing between the intermediate group GM and the final lens group GE changes, and spacings between all adjacent lens groups in the intermediate group GM change. With the above-described configuration, an advantage in suppressing various aberrations in the entire magnification change range is achieved.

In the present specification, groups of which a spacing relative to the adjacent group in an optical axis direction changes during magnification change are defined as one lens group. During magnification change, a spacing between adjacent lenses is not changed in one lens group. That is, the expression “lens group” means a portion that constitutes the variable magnification optical system and that includes at least one lens divided by an air spacing that is changed during magnification change. During magnification change, each lens group moves or remains stationary in lens group units. The expression “lens group” may include a constituent having no refractive power other than a lens, for example, an aperture stop St.

As an example, each group of the variable magnification optical system shown in FIG. 1 is configured as follows. The first lens group G1 consists of three lenses. The intermediate group GM consists of, in order from the object side to the image side, a first intermediate lens group GM1 and a second intermediate lens group GM2. The first intermediate lens group GM1 consists of, in order from the object side to the image side, one lens, an aperture stop St, and two lenses. The second intermediate lens group GM2 consists of one lens. The final lens group GE consists of one lens.

In the example of FIG. 1, during magnification change, the first lens group G1, the first intermediate lens group GM1, and the second intermediate lens group GM2 move along the optical axis Z while changing the spacings between the adjacent lens groups, and the final lens group GE remains stationary with respect to the image plane Sim. In FIG. 1, a schematic movement locus during magnification change from the wide angle end to the telephoto end is indicated by a solid line arrow for each group that moves during magnification change, between the diagram of Wide and the diagram of Tele.

In the variable magnification optical system according to the present disclosure, the first lens group G1 may consist of three uncemented single lenses. In this case, the increase in size of the first lens group G1 can be suppressed while various aberrations are suppressed.

It is preferable that a lens group located closest to the object side in the intermediate group GM has positive refractive power. In such a case, it is advantageous for reducing the size.

It is preferable that a lens group located closest to the image side in the intermediate group GM has negative refractive power. In such a case, it is advantageous for obtaining a large image circle.

The final lens group GE may remain stationary with respect to the image plane Sim during magnification change. In such a case, a variable magnification mechanism can be simplified.

The final lens group GE may consist of one positive lens. In such a case, it is advantageous for reducing the total length of the optical system.

The variable magnification optical system according to the present disclosure includes a focusing group that moves along the optical axis Z during focusing. Focusing is performed by moving the focusing group. In the variable magnification optical system according to the present disclosure, the focusing group is disposed closer to the image side than the first lens group G1. By disposing the lens groups in this way, it is advantageous for reducing the diameter of the focusing group. For example, the lens group located closest to the image side in the intermediate group GM may include the focusing group.

In the example of FIG. 1, the focusing group consists of the second intermediate lens group GM2. The parentheses and the rightward arrow attached to the second intermediate lens group GM2 in FIG. 1 indicate that the second intermediate lens group GM2 is the focusing group and moves to the image side during focusing from the infinite distance object to the short range object.

As in the example of FIG. 1, the focusing group may consist of one lens. In such a case, it is advantageous for increasing the speed of focusing.

In the variable magnification optical system according to the present disclosure, it is preferable that the intermediate group GM includes an anti-vibration group that moves in a direction intersecting the optical axis Z during image shake correction. The image shake correction is performed by moving the anti-vibration group. By disposing the anti-vibration group in the intermediate group GM, it is easy to reduce the diameter of the anti-vibration group.

The anti-vibration group may be disposed closest to the object side in the lens group located closest to the object side in the intermediate group GM. As described above, by moving only a part of the intermediate group instead of moving the entire intermediate group during image shake correction, a mechanism for the image shake correction can be simplified. Further, by disposing the anti-vibration group as described above, it is easy to suppress fluctuation in spherical aberration during image shake correction at the telephoto end.

In the example of FIG. 1, the anti-vibration group consists of one lens closest to the object side of the first intermediate lens group GM1. The parentheses and the vertical arrow attached to the lens closest to the object side of the first intermediate lens group GM1 in FIG. 1 indicate that the lens is the anti-vibration group.

In a case in which the variable magnification optical system according to the present disclosure includes the anti-vibration group and the focusing group, it is preferable that the focusing group is disposed closer to the image side than the anti-vibration group. In a case in which the mechanism for the image shake correction and a mechanism for the focusing are disposed not to interfere with each other, locating the anti-vibration group on the image side of the focusing group restricts the movement amount of the focusing group during focusing. Accordingly, by disposing the focusing group closer to the image side than the anti-vibration group, it is easy to ensure a space in which the focusing group moves during focusing.

The number of lenses included in the variable magnification optical system according to the present disclosure is preferably equal to or greater than 7 and equal to or less than 11. By setting the number of lenses included in the variable magnification optical system to equal to or greater than 7, it is advantageous for suppressing various aberrations, and by setting the number of lenses to equal to or less than 11, it is advantageous for shortening the total length of the optical system. In a case in which the number of lenses included in the variable magnification optical system is set to equal to or greater than 7 and equal to or less than 9, it is possible to further reduce the total length of the optical system while suppressing various aberrations.

Next, preferable configurations and available configurations related to the conditional expressions of the variable magnification optical system according to the present disclosure will be described. It should be noted that, in the following description related to the conditional expressions, duplicate descriptions of symbols will be partially omitted by using the same symbol for the same definition in order to avoid redundant description. Hereinafter, the expression “variable magnification optical system according to the present disclosure” will be simply referred to as the “variable magnification optical system” in order to avoid redundant description.

The variable magnification optical system preferably satisfies Conditional Expression (1). A sum of a distance on the optical axis from a surface closest to the object side of the first lens group G1 to a lens surface closest to the image side of the final lens group GE and a back focus in terms of the air-equivalent distance of the entire system in a state in which the infinite distance object is in focus at the wide angle end is denoted by TLw. A focal length of the entire system in a state in which the infinite distance object is in focus at the wide angle end is denoted by fw. A maximum half angle of view in a state in which the infinite distance object is in focus at the wide angle end is denoted by ωw. TLw denotes a total length in a state in which the infinite distance object is in focus at the wide angle end. In Conditional Expression (1), tan is a tangent, and the same applies to other conditional expressions. By preventing the corresponding value of Conditional Expression (1) from being equal to or less than the lower limit, it is advantageous for suppressing various aberrations, particularly at the wide angle end. By preventing the corresponding value of Conditional Expression (1) from being equal to or greater than the upper limit, it is advantageous for reducing the size of the entire optical system.

$$2 < TLw / ( fw \times tan ω w ) < 6.5 \qquad ( 1 )$$

In order to obtain better characteristics, it is preferable to set the lower limit of Conditional Expression (1) to any one of 2.3, 2.6, 2.8, 2.9, 3, 3.1, or 3.2 instead of 2. In addition, it is preferable to set the upper limit of Conditional Expression (1) to any one of 6, 5.5, 5, 4.8, 4.6, 4.5, or 4.25 instead of 6.5. For example, the variable magnification optical system more preferably satisfies Conditional Expression (1-1), more preferably satisfies Conditional Expression (1-2), still more preferably satisfies Conditional Expression (1-3), and still more preferably satisfies Conditional Expression (1-4).

$$2.6 < TLw / ( fw \times tan ω w ) < 5.5 \qquad ( 1 ‐ 1 )$$

$$2.8 < TLw / ( fw \times tan ω w ) < 5 \qquad ( 1 ‐ 2 )$$

$$3.1 < TLw / ( fw \times tan ω w ) < 4.5 \qquad ( 1 ‐ 3 )$$

$$3.2 < TLw / ( fw \times tan ω w ) < 4 \text{.25} \qquad ( 1 ‐ 4 )$$

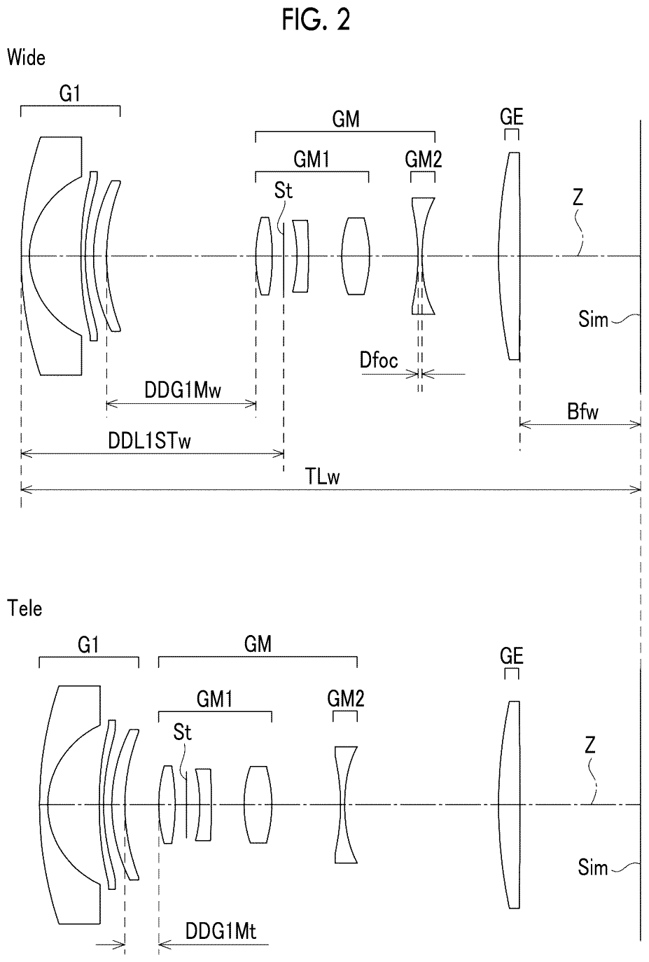

FIG. 2 shows a cross-sectional view of the variable magnification optical system of FIG. 1 and shows, as an example, the total length TLw in the variable magnification optical system. FIG. 2 shows a wide angle end state in an upper part marked “Wide”, and a telephoto end state in a lower part marked “Tele”.

The variable magnification optical system preferably satisfies Conditional Expression (2). Here, the back focus of the entire system in terms of the air-equivalent distance in a state in which the infinite distance object is in focus at the wide angle end is denoted by Bfw. As an example, FIG. 2 shows the back focus Bfw. By preventing the corresponding value of Conditional Expression (2) from being equal to or less than the lower limit, the back focus is not excessively shortened, and thus it is easy to attach the mount replacement mechanism. By preventing the corresponding value of Conditional Expression (2) from being equal to or greater than the upper limit, the back focus is not excessively increased, and thus it is easy to reduce the size.

$$0. 15 < Bfw / ( fw \times tan ω w ) < 1.5 \qquad ( 2 )$$

In order to obtain better characteristics, it is preferable to set the lower limit of Conditional Expression (2) to any one of 0.2, 0.25, 0.26, 0.3, 0.34, 0.35, 0.37, 0.4, 0.42, 0.43, or 0.45 instead of 0.15. In addition, it is preferable to set the upper limit of Conditional Expression (2) to any one of 1.25, 1.1, 1.05, 1, 0.95, 0.9, 0.85, 0.83, or 0.82 instead of 1.5. For example, the variable magnification optical system more preferably satisfies Conditional Expression (2-1), more preferably satisfies Conditional Expression (2-2), and still more preferably satisfies Conditional Expression (2-3).

$$0.2 < Bfw / ( fw \times tan ω w ) < 1.25 \qquad ( 2 ‐ 1 )$$

$$0.25 < Bfw / ( fw \times tan ω w ) < 1.1 \qquad ( 2 ‐ 2 )$$

$$0.35 < Bfw / ( fw \times tan ω w ) < 1 \qquad ( 2 ‐ 3 )$$

The variable magnification optical system preferably satisfies Conditional Expression (3). Here, a total sum of thicknesses of all lens groups on the optical axis is denoted by Dsum. In other words, Dsum is obtained by adding the thicknesses of the lens groups on the optical axis of each lens group for the entire system. The expression “thickness of the lens group on the optical axis” in the present specification means a distance on the optical axis from a surface closest to the object side of the lens group to a surface closest to the image side of the lens group. By preventing the corresponding value of Conditional Expression (3) from being equal to or less than the lower limit, the thickness of each lens in the variable magnification optical system is not excessively decreased, and thus it is advantageous for ensuring good optical performance. By preventing the corresponding value of Conditional Expression (3) from being equal to or greater than the upper limit, it is advantageous for suppressing the increase in weight of the entire variable magnification optical system.

$$0 \text{.1} < Dsum / ( TLw - Bfw ) < 0.8 \qquad ( 3 )$$

In order to obtain better characteristics, it is preferable to set the lower limit of Conditional Expression (3) to any one of 0.15, 0.2, 0.21, 0.22, or 0.23 instead of 0.1. In addition, it is preferable to set the upper limit of Conditional Expression (3) to any one of 0.6, 0.56, 0.54, 0.52, or 0.5 instead of 0.8. For example, the variable magnification optical system more preferably satisfies Conditional Expression (3-1), and still more preferably satisfies Conditional Expression (3-2).

$$0.15 < Dsum / ( TLw - Bfw ) < 0.6 \qquad ( 3 ‐ 1 )$$

$$0.21 < Dsum / ( TLw - Bfw ) < 0 \text{.54} \qquad ( 3 ‐ 2 )$$

The variable magnification optical system preferably satisfies Conditional Expression (4). Here, an open F-number in a state in which the infinite distance object is in focus at the wide angle end is denoted by FNow. By preventing the corresponding value of Conditional Expression (4) from being equal to or less than the lower limit, it is easy to suppress the increase in number of lenses and to suppress the increase in size of the optical system while obtaining good optical performance. By preventing the corresponding value of Conditional Expression (4) from being equal to or greater than the upper limit, it is easy to decrease the open F-number at the wide angle end while increasing the angle of view at the wide angle end.

$$2.3 < FNow / tan ω w < 7 \qquad ( 4 )$$

In order to obtain better characteristics, it is preferable to set the lower limit of Conditional Expression (4) to any one of 2.5, 2.7, 2.9, 3, or 3.1 instead of 2.3. In addition, it is preferable to set the upper limit of Conditional Expression (4) to any one of 6.6, 6.3, 6, 5.8, or 5.6 instead of 7. For example, the variable magnification optical system more preferably satisfies Conditional Expression (4-1).

$$2.9 < FNow / tan ω w < 6 \qquad ( 4 ‐ 1 )$$

The variable magnification optical system preferably satisfies Conditional Expression (5). Here, a focal length of the entire system in a state in which the infinite distance object is in focus at the telephoto end is denoted by ft. By preventing the corresponding value of Conditional Expression (5) from being equal to or less than the lower limit, it is advantageous for suppressing various aberrations in the entire magnification change range.

By preventing the corresponding value of Conditional Expression (5) from being equal to or greater than the upper limit, it is advantageous for reducing the size of the entire optical system or it is advantageous for obtaining a sufficient magnification change ratio as the variable magnification optical system.

$$0.45 < ( fw \times TLw ) / {ft}^{2} < 3 \qquad ( 5 )$$

In order to obtain better characteristics, it is preferable to set the lower limit of Conditional Expression (5) to any one of 0.58, 0.63, 0.66, 0.69, 0.71, 0.73, or 0.75 instead of 0.45. In addition, it is preferable to set the upper limit of Conditional Expression (5) to any one of 2.2, 1.85, 1.7, 1.55, 1.45, 1.4, or 1.35 instead of 3. For example, the variable magnification optical system more preferably satisfies Conditional Expression (5-1), more preferably satisfies Conditional Expression (5-2), and still more preferably satisfies Conditional Expression (5-3).

$$0.58 < ( fw \times TLw ) / {ft}^{2} < 2.2 \qquad ( 5 - 1 )$$

$$0.73 < ( fw \times TLw ) / {ft}^{2} < 1.4 \qquad ( 5 - 2 )$$

$$0.75 < ( fw \times TLw ) / {ft}^{2} < 1.35 \qquad ( 5 - 3 )$$

The variable magnification optical system preferably satisfies Conditional Expression (6). Here, a focal length of the first lens group G1 is denoted by f1. By preventing the corresponding value of Conditional Expression (6) from being equal to or less than the lower limit, the refractive power of the first lens group G1 is not excessively increased, and it is advantageous for suppressing fluctuation of the aberrations during magnification change. By preventing the corresponding value of Conditional Expression (6) from being equal to or greater than the upper limit, the refractive power of the first lens group G1 is not excessively decreased, and thus the movement amount of the first lens group G1 during magnification change can be suppressed.

$$- 10 < ft / f 1 < - 0.4 \qquad ( 6 )$$

In order to obtain better characteristics, it is preferable to set the lower limit of Conditional Expression (6) to any one of −9, −8, −7, −6, −5, −4, or −3 instead of −10. In addition, it is preferable to set the upper limit of Conditional Expression (6) to any one of −0.6, −0.8, −0.9, −1, −1.1, −1.2, or −1.3 instead of −0.4. For example, the variable magnification optical system more preferably satisfies Conditional Expression (6-1), and still more preferably satisfies Conditional Expression (6-2).

$$- 7 < ft / f 1 < - 0.9 \qquad ( 6 - 1 )$$

$$- 5 < ft / f 1 < - 1.1 \qquad ( 6 - 2 )$$

In a configuration in which the intermediate group GM includes the anti-vibration group, the variable magnification optical system preferably satisfies Conditional Expression (7). Here, a focal length of the anti-vibration group is denoted by fois. By preventing the corresponding value of Conditional Expression (7) from being equal to or less than the lower limit, the movement amount of the anti-vibration group during image shake correction can be suppressed, and thus it is advantageous for reducing the size of the entire variable magnification optical system and reduction in size of the vibration-proof unit. By preventing the corresponding value of Conditional Expression (7) from being equal to or greater than the upper limit, the refractive power of the anti-vibration group is not excessively increased, and thus it is advantageous for suppressing fluctuation in aberration during image shake correction.

$$0.3 < ft / \vert fois \vert < 4 \qquad ( 7 )$$

In order to obtain better characteristics, it is preferable to set the lower limit of Conditional Expression (7) to any one of 0.5, 0.7, or 0.8 instead of 0.3. In addition, it is preferable to set the upper limit of Conditional Expression (7) to any one of 3.5, 3, or 2.8 instead of 4.

The variable magnification optical system preferably satisfies Conditional Expression (8). By preventing the corresponding value of Conditional Expression (8) from being equal to or less than the lower limit, the refractive power of the first lens group G1 is not excessively increased, and it is advantageous for suppressing fluctuation of the aberrations during magnification change. By preventing the corresponding value of Conditional Expression (8) from being equal to or greater than the upper limit, the refractive power of the first lens group G1 is not excessively decreased, and thus the movement amount of the first lens group G1 during magnification change can be suppressed.

$$- 3.5 < fw / f 1 < - 0.2 \qquad ( 8 )$$

In order to obtain better characteristics, it is preferable to set the lower limit of Conditional Expression (8) to any one of −3, −2.5, −2, −1.8, −1.6, −1.4, or −1.2 instead of −3.5. In addition, it is preferable to set the upper limit of Conditional Expression (8) to any one of −0.3, −0.4, −0.47, −0.53, −0.61, −0.63, or −0.65 instead of −0.2.

The variable magnification optical system preferably satisfies Conditional Expression (9). Here, a focal length of the intermediate group GM in a state in which the infinite distance object is in focus at the wide angle end is denoted by fMw. By preventing the corresponding value of Conditional Expression (9) from being equal to or less than the lower limit, the positive refractive power of the intermediate group GM is not excessively decreased, and thus the movement amount of the intermediate group GM during magnification change can be suppressed. By preventing the corresponding value of Conditional Expression (9) from being equal to or greater than the upper limit, the positive refractive power of the intermediate group GM is not excessively increased, and thus it is advantageous for correcting the spherical aberration at the telephoto end.

$$0.2 < ft / fMw < 7.5 \qquad ( 9 )$$

In order to obtain better characteristics, it is preferable to set the lower limit of Conditional Expression (9) to any one of 0.5, 0.8, 1.1, 1.3, or 1.4 instead of 0.2. In addition, it is preferable to set the upper limit of Conditional Expression (9) to any one of 6.5, 5.5, 4.5, 3.5, or 2.7 instead of 7.5.

The variable magnification optical system preferably satisfies Conditional Expression (10). Here, a focal length of a lens group located closest to the image side in the intermediate group GM is denoted by fme. By preventing the corresponding value of Conditional Expression (10) from being equal to or less than the lower limit, the refractive power of the lens group located closest to the image side in the intermediate group GM is not excessively increased, and thus it is advantageous for suppressing fluctuation in aberrations during magnification change. By preventing the corresponding value of Conditional Expression (10) from being equal to or greater than the upper limit, the refractive power of the lens group located closest to the image side in the intermediate group GM is not excessively decreased, and thus the movement amount of the lens group located closest to the image side in the intermediate group GM during magnification change can be suppressed.

$$- 16 < ft / fme < - 0.15 \qquad ( 10 )$$

In order to obtain better characteristics, it is preferable to set the lower limit of Conditional Expression (10) to any one of −15, −14, −13, −12, −11, −10, −5, −4, or −3 instead of −16. In addition, it is preferable to set the upper limit of Conditional Expression (10) to any one of −0.3, −0.4, −0.8, −1.2, −1.4, −1.5, −1.6, −1.7, or −1.8 instead of −0.15. For example, the variable magnification optical system more preferably satisfies Conditional Expression (10-1).

$$- 10 < ft / fme < - 1.5 \qquad ( 10 - 1 )$$

The variable magnification optical system preferably satisfies Conditional Expression (11). Here, a focal length of the final lens group GE is denoted by fE. By preventing the corresponding value of Conditional Expression (11) from being equal to or less than the lower limit, the negative refractive power of the final lens group GE is not excessively increased, and thus it is advantageous for reducing the incidence angle of the off-axis principal ray on the image plane Sim. By preventing the corresponding value of Conditional Expression (11) from being equal to or greater than the upper limit, the positive refractive power of the final lens group GE is not excessively increased, and thus it is advantageous for correcting the field curvature.

$$- 2 < ft / fE < 2.5 \qquad ( 11 )$$

In order to obtain better characteristics, it is preferable to set the lower limit of Conditional Expression (11) to any one of −1.8, −1.6, −1.5, −1.4, −1.3, −1.2, −1.1, or −1 instead of −2. In addition, it is preferable to set the upper limit of Conditional Expression (11) to any one of 2, 1.5, 1.2, 1, 0.9, 0.8, 0.7, or 0.68 instead of 2.5.

In addition, the variable magnification optical system may satisfy Conditional Expression (11-1). By preventing the corresponding value of Conditional Expression (11-1) from being equal to or less than the lower limit, the positive refractive power of the final lens group GE is not excessively weakened, and thus it is advantageous for reducing the incidence angle of the off-axis principal ray on the image plane Sim. By preventing the corresponding value of Conditional Expression (11-1) from being equal to or greater than the upper limit, the positive refractive power of the final lens group GE is not excessively increased, and thus it is advantageous for correcting the field curvature.

$$0.1 < ft / fE < 0.7 \qquad ( 11 - 1 )$$

In order to obtain better characteristics, it is preferable to set the lower limit of Conditional Expression (11-1) to 0.11 instead of 0.1. Further, it is preferable to set the upper limit of Conditional Expression (11-1) to 0.68 instead of 0.7.

The variable magnification optical system preferably satisfies Conditional Expression (12). Here, a focal length of a lens group located closest to the object side in the intermediate group GM is denoted by fm1. By preventing the corresponding value of Conditional Expression (12) from being equal to or less than the lower limit, it is advantageous for correcting the spherical aberration on the telephoto side. By preventing the corresponding value of Conditional Expression (12) from being equal to or greater than the upper limit, the refractive power of the first lens group G1 is not excessively increased, and thus the refractive power of the lens group located closest to the object side in the intermediate group GM is not excessively decreased, and, as a result, it is advantageous for correcting the spherical aberration on the wide angle side. In addition, by preventing the corresponding value of Conditional Expression (12) from being equal to or greater than the upper limit, it is possible to increase the magnification change ratio without increasing the movement amount during magnification change of the lens group located closest to the object side in the intermediate group GM, and thus it is advantageous for reducing the total length of the optical system.

$$- 5 < f 1 / fm 1 < - 0.05 \qquad ( 12 )$$

In order to obtain better characteristics, it is preferable to set the lower limit of Conditional Expression (12) to any one of −4, −3, −2.5, −2.2, −1.9, or −1.8 instead of −5. In addition, it is preferable to set the upper limit of Conditional Expression (12) to any one of −0.1, −0.14, −0.18, −0.2, −0.22, or −0.23 instead of −0.05.

In a configuration in which the lens group located closest to the object side in the intermediate group GM has positive refractive power, the variable magnification optical system preferably satisfies Conditional Expression (13). By preventing the corresponding value of Conditional Expression (13) from being equal to or less than the lower limit, the negative refractive power of the lens group located closest to the image side in the intermediate group GM is not excessively increased with respect to the lens group located closest to the object side in the intermediate group GM, and thus it is advantageous for correcting the spherical aberration, particularly at the telephoto end. By preventing the corresponding value of Conditional Expression (13) from being equal to or greater than the upper limit, the negative refractive power of the lens group located closest to the image side in the intermediate group GM with respect to the lens group located closest to the object side in the intermediate group GM is not excessively decreased, and thus it is possible to suppress excessive correction of spherical aberration, particularly at the telephoto end.

$$- 15 < fm 1 / fme < - 0.05 \qquad ( 13 )$$

In order to obtain better characteristics, it is preferable to set the lower limit of Conditional Expression (13) to any one of −8, −4, −2.5, −1.5, −1.2, or −0.9 instead of −15. In addition, it is preferable to set the upper limit of Conditional Expression (13) to any one of −0.1, −0.15, −0.2, −0.25, −0.3, or −0.35 instead of −0.05.

The variable magnification optical system preferably satisfies Conditional Expression (14). An open F-number in a state in which the infinite distance object is in focus at the telephoto end is denoted by FNot. By preventing the corresponding value of Conditional Expression (14) from being equal to or less than the lower limit, it is advantageous for the size reduction in the entire optical system or it is advantageous for suppressing various aberrations particularly at the telephoto end. By preventing the corresponding value of Conditional Expression (14) from being equal to or greater than the upper limit, it is easy to obtain sufficient brightness at the telephoto end.

$$1.5 < FNot / ( ft / fw ) < 7 \qquad ( 14 )$$

In order to obtain better characteristics, it is preferable to set the lower limit of Conditional Expression (14) to any one of 2, 2.1, 2.2, 2.3, 2.4, or 2.5 instead of 1.5. In addition, it is preferable to set the upper limit of Conditional Expression (14) to any one of 6, 5.5, 5, 4.5, 4.2, or 3.9 instead of 7.

The variable magnification optical system preferably satisfies Conditional Expression (15). Here, a maximum half angle of view in a state in which the infinite distance object is in focus at the telephoto end is denoted by ωt. By preventing the corresponding value of Conditional Expression (15) from being equal to or less than the lower limit, it is advantageous for suppressing various aberrations. By preventing the corresponding value of Conditional Expression (15) from being equal to or greater than the upper limit, it is advantageous for increase in the angle of view at the wide angle end.

$$0.4 < fw / ( ft \times tan ω t ) < 2.7 \qquad ( 15 )$$

In order to obtain better characteristics, it is preferable to set the lower limit of Conditional Expression (15) to any one of 0.55, 0.7, or 0.8 instead of 0.4. In addition, it is preferable to set the upper limit of Conditional Expression (15) to any one of 2.2, 1.8, or 1.4 instead of 2.7.

In a configuration in which the lens group located closest to the image side in the intermediate group GM has negative refractive power, the variable magnification optical system preferably satisfies Conditional Expression (16). By preventing the corresponding value of Conditional Expression (16) from being equal to or less than the lower limit, the positive refractive power of the final lens group GE is not excessively increased, and thus it is advantageous for correcting the field curvature particularly at the wide angle end. By preventing the corresponding value of Conditional Expression (16) from being equal to or greater than the upper limit, the negative refractive power of the lens group located closest to the image side in the intermediate group GM is not excessively increased, and thus it is advantageous for correcting the astigmatism, particularly at the wide angle end.

$$- 9 < fme / fE < - 0.05 \qquad ( 16 )$$

In order to obtain better characteristics, it is preferable to set the lower limit of Conditional Expression (16) to any one of −7.5, −6, −4.5, −3, or −1.5 instead of −9. In addition, it is preferable to set the upper limit of Conditional Expression (16) to any one of −0.1, −0.15, −0.3, −0.35, or −0.4 instead of −0.05. For example, the variable magnification optical system more preferably satisfies Conditional Expression (16-1).

$$- 3 < fme / fE < - 0.35 \qquad ( 16 - 1 )$$

The variable magnification optical system preferably satisfies Conditional Expression (17). By preventing the corresponding value of Conditional Expression (17) from being equal to or less than the lower limit, the refractive power of the intermediate group GM including the lens group that moves during magnification change is not excessively decreased, and thus it is advantageous for suppressing the movement amount of the first lens group G1 during magnification change. By preventing the corresponding value of Conditional Expression (17) from being equal to or greater than the upper limit, the refractive power of the first lens group G1 is not excessively decreased, and thus it is advantageous for suppressing the distortion at the wide angle end.

$$0.2 < ( - f 1 ) / fMw < 5 \qquad ( 17 )$$

In order to obtain more favorable characteristics, it is preferable to set the lower limit of Conditional Expression (17) to any one of 0.4, 0.6, 0.8, or 0.9 instead of 0.2. In addition, it is preferable to set the upper limit of Conditional Expression (17) to any one of 4, 3, 2.5, or 2 instead of 5.

The variable magnification optical system preferably satisfies Conditional Expression (18). By preventing the corresponding value of Conditional Expression (18) from being equal to or less than the lower limit, the refractive power of the first lens group G1 is not excessively increased, and it is advantageous for suppressing fluctuation of the aberrations during magnification change. By preventing the corresponding value of Conditional Expression (18) from being equal to or greater than the upper limit, the refractive power of the first lens group G1 is not excessively decreased, and thus it is advantageous for suppressing the distortion at the wide angle end.

$$0.3 < ( - f 1 ) / {( fw \times ft )}^{1 / 2} < 2 \qquad ( 18 )$$

In order to obtain better characteristics, it is preferable to set the lower limit of Conditional Expression (18) to any one of 0.4, 0.5, 0.6, or 0.65 instead of 0.3. In addition, it is preferable to set the upper limit of Conditional Expression (18) to any one of 1.8, 1.6, 1.4, or 1.25 instead of 2.

The variable magnification optical system preferably satisfies Conditional Expression (19). By preventing the corresponding value of Conditional Expression (19) from being equal to or less than the lower limit, the refractive power of the intermediate group GM is not excessively increased, and thus the field curvature generated in the intermediate group GM can be reduced, and it is advantageous for correcting the aberrations during magnification change. By preventing the corresponding value of Conditional Expression (19) from being equal to or greater than the upper limit, the refractive power of the intermediate group GM is not excessively decreased, and thus the movement amount of the intermediate group GM during magnification change can be suppressed, and, as a result, it is advantageous for shortening the total length of the optical system.

$$0.15 < fMw / {( fw \times ft )}^{1 / 2} < 2 \qquad ( 19 )$$

In order to obtain better characteristics, it is preferable to set the lower limit of Conditional Expression (19) to 0.3, 0.4, 0.45, or 0.5 instead of 0.15. In addition, it is preferable to set the upper limit of Conditional Expression (19) to any one of 1.6, 1.2, 1.05, or 0.95 instead of 2.

The variable magnification optical system preferably satisfies Conditional Expression (20). By preventing the corresponding value of Conditional Expression (20) from being equal to or less than the lower limit, it is advantageous for improving performance. By preventing the corresponding value of Conditional Expression (20) from being equal to or greater than the upper limit, the refractive power of the first lens group G1 is not excessively decreased, and thus it is advantageous for suppressing the distortion at the wide angle end.

$$1 < ( - f 1 ) / ( ft / FNot ) < 12 \qquad ( 20 )$$

In order to obtain better characteristics, it is preferable to set the lower limit of Conditional Expression (20) to any one of 1.5, 2, 2.4, 2.7, or 2.9 instead of 1. In addition, it is preferable to set the upper limit of Conditional Expression (20) to any one of 10, 8, 7, 6.5, or 6 instead of 12.

The variable magnification optical system preferably satisfies Conditional Expression (21). By preventing the corresponding value of Conditional Expression (21) from being equal to or less than the lower limit, it is advantageous for suppressing various aberrations at the wide angle end. By preventing the corresponding value of Conditional Expression (21) from being equal to or greater than the upper limit, it is advantageous for reducing the total length of the optical system at the wide angle end.

$$2.5 < TLw / fw < 7 \qquad ( 21 )$$

In order to obtain better characteristics, it is preferable to set the lower limit of Conditional Expression (21) to any one of 2.8, 3.1, or 3.3 instead of 2.5. In addition, it is preferable to set the upper limit of Conditional Expression (21) to any one of 6, 5.3, or 4.8 instead of 7.

The variable magnification optical system preferably satisfies Conditional Expression (22). Here, a focal length of the focusing group is denoted by ffoc. By preventing the corresponding value of Conditional Expression (22) from being equal to or less than the lower limit, the refractive power of the focusing group is not excessively decreased, and thus the movement amount of the focusing group during focusing can be suppressed. By preventing the corresponding value of Conditional Expression (22) from being equal to or greater than the upper limit, the refractive power of the focusing group is not excessively increased, and thus it is advantageous for suppressing the fluctuation in aberrations during focusing.

$$0.3 < ft / \vert ffoc \vert < 6 \qquad ( 22 )$$

In order to obtain better characteristics, it is preferable to set the lower limit of Conditional Expression (22) to any one of 0.33, 0.36, 0.39, 0.42, 0.45, 0.48, or 0.5 instead of 0.3. In addition, it is preferable to set the upper limit of Conditional Expression (22) to any one of 5.2, 4.5, 3.8, 3.3, 3, 2.8, or 2.6 instead of 6.

The variable magnification optical system preferably satisfies Conditional Expression (23). By preventing the corresponding value of Conditional Expression (23) from being equal to or less than the lower limit, the refractive power of the focusing group is not excessively decreased, and thus the movement amount of the focusing group during focusing can be suppressed. By preventing the corresponding value of Conditional Expression (23) from being equal to or greater than the upper limit, the refractive power of the focusing group is not excessively increased, and thus it is advantageous for suppressing the fluctuation in aberrations during focusing.

$$0.15 < fw / \vert ffoc \vert < 32 \qquad ( 23 )$$

In order to obtain better characteristics, it is preferable to set the lower limit of Conditional Expression (23) to any one of 0.18, 0.2, 0.22, 0.23, 0.24, 0.25, or 0.26 instead of 0.15. In addition, it is preferable to set the upper limit of Conditional Expression (23) to any one of 2.7, 2.3, 2, 1.7, 1.5, 1.4, or 1.3 instead of 3.2.

In a configuration in which the focusing group consists of one lens, the variable magnification optical system preferably satisfies Conditional Expression (24). Here, an Abbe number, based on the d line, of the lens constituting the focusing group is denoted by vdfoc. By preventing the corresponding value of Conditional Expression (24) from being equal to or less than the lower limit, it is advantageous for suppressing the fluctuation in chromatic aberration during focusing. By preventing the corresponding value of Conditional Expression (24) from being equal to or greater than the upper limit, a material having high availability can be used, and thus it is advantageous for achieving the variable magnification optical system in which spherical aberration and astigmatism are suppressed.

$$20 < vdfoc < 75 \qquad ( 24 )$$

In order to obtain better characteristics, it is preferable to set the lower limit of Conditional Expression (24) to any one of 30, 40, 45, or 50 instead of 20. In addition, it is preferable to set the upper limit of Conditional Expression (24) to any one of 70, 65, 60, or 58 instead of 75.

In a configuration in which the intermediate group GM includes the aperture stop St, the variable magnification optical system preferably satisfies Conditional Expression (25). A distance on the optical axis from the surface closest to the object side of the first lens group G1 to the aperture stop St in a state in which the infinite distance object is in focus at the wide angle end is denoted by DDLISTw. As an example, FIG. 2 shows the distance DDL1STw. By preventing the corresponding value of Conditional Expression (25) from being equal to or less than the lower limit, the distance between the aperture stop St and the first lens group G1 is not excessively decreased, and thus the distance from the lens surface closest to the object side of the first lens group G1 to the entrance pupil position is not excessively decreased, and, as a result, it is easy to suppress the fluctuation in aberrations during magnification change. By preventing the corresponding value of Conditional Expression (25) from being equal to or greater than the upper limit, the distance between the aperture stop St and the first lens group G1 is not excessively increased, and thus the distance from the lens surface closest to the object side of the first lens group G1 to the entrance pupil position is not excessively increased. This can suppress the increase in diameter of the first lens group G1 and thus achieves an advantage in reduction in size.

$$0.18 < DDL 1 STw / TLw < 0.8 \qquad ( 25 )$$

In order to obtain better characteristics, it is preferable to set the lower limit of Conditional Expression (25) to any one of 0.25 or 0.3 instead of 0.18. In addition, it is preferable to set the upper limit of Conditional Expression (25) to any one of 0.7 or 0.6 instead of 0.8.

The variable magnification optical system preferably satisfies Conditional Expression (26). Here, a spacing on the optical axis between the first lens group G1 and the intermediate group GM in a state in which the infinite distance object is in focus at the wide angle end is denoted by DDG1Mw. A spacing on the optical axis between the first lens group G1 and the intermediate group GM in a state in which the infinite distance object is in focus at the telephoto end is denoted by DDG1Mt. For example, FIG. 2 shows the spacing DDG1Mw and the spacing DDG1Mt. By preventing the corresponding value of Conditional Expression (26) from being equal to or less than the lower limit, it is advantageous for ensuring an effective magnification change ratio. By preventing the corresponding value of Conditional Expression (26) from being equal to or greater than the upper limit, it is advantageous for suppressing the distortion during magnification change.

$$0.07 < \vert DDG 1 Mw - DDG 1 Mt \vert / TLw < 0.4 \qquad ( 26 )$$

In order to obtain better characteristics, it is preferable to set the lower limit of Conditional Expression (26) to any one of 0.1 or 0.12 instead of 0.07. In addition, it is preferable to set the upper limit of Conditional Expression (26) to any one of 0.3 or 0.25 instead of 0.4.

The variable magnification optical system preferably satisfies Conditional Expression (27). Here, a paraxial curvature radius of an object-side surface of the negative lens closest to the object side among the negative lenses included in the first lens group G1 is denoted by R1nf. A paraxial curvature radius of an image-side surface of the negative lens closest to the object side among the negative lenses included in the first lens group G1 is denoted by R1nr. By preventing the corresponding value of Conditional Expression (27) from being equal to or less than the lower limit, it is easy to effectively correct the astigmatism. By preventing the corresponding value of Conditional Expression (27) from being equal to or greater than the upper limit, it is easy to effectively correct the spherical aberration. Further, by preventing the corresponding value of Conditional Expression (27) from being equal to or greater than the upper limit, the refractive power of the lens is not excessively decreased, and thus it is easy to increase the angle of view at the wide angle end.

$$0.4 < ( R 1 nf + R 1 nr ) / ( R 1 nf - R 1 nr ) < 5 \qquad ( 27 )$$

In order to obtain better characteristics, it is preferable to set the lower limit of Conditional Expression (27) to any one of 0.6, 0.7, 0.8, 0.85, or 0.9 instead of 0.4. In addition, it is preferable to set the upper limit of Conditional Expression (27) to any one of 4.5, 4, 3.6, 3.2, or 3 instead of 5.

The variable magnification optical system preferably satisfies Conditional Expression (28). Here, a total sum of thicknesses of all lenses included in the first lens group G1 on the optical axis is denoted by d1sum. By preventing the corresponding value of Conditional Expression (28) from being equal to or less than the lower limit, it is easy to ensure the mechanical strength of the first lens group G1. By preventing the corresponding value of Conditional Expression (28) from being equal to or greater than the upper limit, it is advantageous for reducing the weight of the first lens group G1.

$$0.15 < d 1 sum / ( ft / FNot ) < 4 \qquad ( 28 )$$

In order to obtain better characteristics, it is preferable to set the lower limit of Conditional Expression (28) to 0.2, 0.25, 0.3, or 0.35 instead of 0.15. In addition, it is preferable to set the upper limit of Conditional Expression (28) to any one of 3, 2.4, 1.8, or 1.5, instead of 4.

In a configuration in which the variable magnification optical system includes the aperture stop St, the variable magnification optical system preferably satisfies Conditional Expression (29). Here, a composite focal length from a lens closest to the object side of the first lens group G1 to the aperture stop St in a state in which the infinite distance object is in focus at the wide angle end is denoted by fL1STw. By preventing the corresponding value of Conditional Expression (29) from being equal to or less than the lower limit, the positive refractive power of the partial optical system from the lens closest to the object side of the first lens group G1 to the aperture stop St at the wide angle end is not excessively increased, and thus it is advantageous for obtaining a wide angle of view at the wide angle end. By preventing the corresponding value of Conditional Expression (29) from being equal to or greater than the upper limit, the positive refractive power of the partial optical system from the lens closest to the object side of the first lens group G1 to the aperture stop St at the wide angle end is not excessively decreased, and thus it is advantageous for correcting the spherical aberration at the wide angle end.

$$- 3 < f 1 / fL 1 STw < - 0.1 \qquad ( 29 )$$

In order to obtain better characteristics, it is preferable to set the lower limit of Conditional Expression (29) to −2.5 instead of −3. Further, it is preferable to set the upper limit of Conditional Expression (29) to −0.2 instead of −0.1.

In a configuration in which the variable magnification optical system includes the aperture stop St, the variable magnification optical system preferably satisfies Conditional Expression (30). By preventing the corresponding value of Conditional Expression (30) from being equal to or less than the lower limit, the positive refractive power of the partial optical system from the lens closest to the object side of the first lens group G1 to the aperture stop St at the wide angle end is not excessively decreased, and thus it is advantageous for correcting the spherical aberration at the wide angle end. By preventing the corresponding value of Conditional Expression (30) from being equal to or greater than the upper limit, the positive refractive power of the partial optical system from the lens closest to the object side of the first lens group G1 to the aperture stop St at the wide angle end is not excessively increased, and thus it is advantageous for obtaining a wide angle of view at the wide angle end.

$$0.1 < fw / fL 1 STw < 3.2 \qquad ( 30 )$$

In order to obtain better characteristics, it is preferable to set the lower limit of Conditional Expression (30) to any one of 0.2 or 0.3 instead of 0.1. In addition, it is preferable to set the upper limit of Conditional Expression (30) to any one of 2.5 or 2 instead of 3.2.

The variable magnification optical system preferably satisfies Conditional Expression (31). Here, a refractive index, at the d line, of the negative lens closest to the object side among the negative lenses included in the first lens group G1 is denoted by N1n. By preventing the corresponding value of Conditional Expression (31) from being equal to or less than the lower limit, it is easy for the negative lens closest to the object side of the first lens group G1 to have a sufficient negative refractive power, and thus it is advantageous for favor of effectively correcting distortion. By preventing the corresponding value of Conditional Expression (31) from being equal to or greater than the upper limit, it is easy to configure the first lens group G1 without using a material having a large dispersion in the negative lens closest to the object side, and thus it is advantageous for effectively correcting the lateral chromatic aberration.

$$1.55 < N 1 n < 2 \qquad ( 31 )$$

In order to obtain better characteristics, it is preferable to set the lower limit of Conditional Expression (31) to any one of 1.58 or 1.6 instead of 1.55. In addition, it is preferable to set the upper limit of Conditional Expression (31) to any one of 1.93 or 1.88 instead of 2.

The variable magnification optical system preferably satisfies Conditional Expression (32). By preventing the corresponding value of Conditional Expression (32) from being equal to or less than the lower limit, the thickness of each lens group is not excessively decreased, and thus it is easy to achieve the increase in angle of view, and it is possible to suppress the fluctuation in aberrations during magnification change. By preventing the corresponding value of Conditional Expression (32) from being equal to or greater than the upper limit, the thickness of the variable magnification optical system is not excessively increased, and thus it is advantageous for shortening the total length of the lens in a case in which the lens is particularly retracted. By satisfying Conditional Expression (32), the thickness of each lens group can be reduced and, particularly in a case in which the variable magnification optical system is collapsed, the total length of the lenses in the collapsed state can be reduced while sufficiently correcting aberrations.

$$1 < ( D sum / TLw ) \times FNow < 2.5 \qquad ( 32 )$$

In order to obtain better characteristics, it is preferable to set the lower limit of Conditional Expression (32) to any one of 1.2 or 1.3 instead of 1. Further, it is preferable to set the upper limit of Conditional Expression (32) to 2.3 instead of 2.5.

The variable magnification optical system preferably satisfies Conditional Expression (33). Here, a thickness of the focusing group on the optical axis is denoted by Dfoc. The “thickness of the focusing group on the optical axis” is a distance on the optical axis from a surface closest to the object side of the focusing group to a surface closest to the image side of the focusing group. As an example, FIG. 2 shows the thickness Dfoc. By preventing the corresponding value of Conditional Expression (33) from being equal to or less than the lower limit, the thickness of the focusing group is not excessively decreased, and thus it is advantageous for ensuring the strength of the focusing group. By preventing the corresponding value of Conditional Expression (33) from being equal to or greater than the upper limit, the thickness of the focusing group is not excessively increased, and thus it is advantageous for achieving the increase in speed of focusing.

$$0.01 < D foc / ( fw \times tan ω w ) < 0.25 \qquad ( 33 )$$

In order to obtain better characteristics, it is preferable to set the lower limit of Conditional Expression (33) to any one of 0.015 or 0.02 instead of 0.01. In addition, it is preferable to set the upper limit of Conditional Expression (33) to any one of 0.15 or 0.1 instead of 0.25.

The variable magnification optical system preferably satisfies Conditional Expression (34). By preventing the corresponding value of Conditional Expression (34) from being equal to or less than the lower limit value, it is advantageous for ensuring the strength of the first lens group G1. By preventing the corresponding value of Conditional Expression (34) from being equal to or greater than the upper limit, it is advantageous for reducing the weight of the first lens group G1.

$$0.045 < d 1 sum / \vert f 1 \vert < 0.5 \qquad ( 34 )$$

In order to obtain better characteristics, it is preferable to set the lower limit of Conditional Expression (34) to any one of 0.065 or 0.08 instead of 0.045. In addition, it is preferable to set the upper limit of Conditional Expression (34) to any one of 0.4 or 0.35 instead of 0.5.

It should be noted that the example shown in FIG. 1 is merely an example, and various modifications can be made without departing from the gist of the technology of the present disclosure. For example, the number of lenses included in each lens group, the number of lenses included in the focusing group, the number of lenses included in the anti-vibration group, and the number of lens groups included in the intermediate group GM may be different from the numbers in the example of FIG. 1.

For example, the first lens group G1 may consist of two lenses. In such a case, it is advantageous for reducing the total length of the optical system. Alternatively, the first lens group G1 may consist of four lenses. In such a case, it is advantageous for suppressing various aberrations.

The focusing group may consist of two lenses. In such a case, an advantage of suppressing fluctuations of aberrations during focusing is achieved.

The intermediate group GM may include, in order from the object side to the image side, at least the first intermediate lens group GM1 having positive refractive power, the second intermediate lens group GM2 having refractive power, and the third intermediate lens group GM3 having refractive power. The first intermediate lens group GM1, the second intermediate lens group GM2, and the third intermediate lens group GM3 are lens groups in which a spacing between adjacent lens groups changes during magnification change. By dividing the intermediate group GM into three or more lens groups in this way, it is easy to suppress the fluctuation in various aberrations during magnification change.

In a configuration in which the intermediate group GM includes at least the first intermediate lens group GM1, the second intermediate lens group GM2, and the third intermediate lens group GM3, the variable magnification optical system preferably satisfies Conditional Expression (1-2). By preventing the corresponding value of Conditional Expression (1-2) from being equal to or less than the lower limit, it is advantageous for suppressing various aberrations, particularly at the wide angle end. By preventing the corresponding value of Conditional Expression (1-2) from being equal to or greater than the upper limit, it is advantageous for reducing the size of the entire optical system.

$$2.8 < TLw / ( fw \times tan ω w ) < 5 \qquad ( 1 - 2 )$$

In order to obtain more favorable characteristics, it is preferable to set the lower limit of Conditional Expression (1-2) to any one of 2.9, 3, 3.1, or 3.2 instead of 2.8. In addition, it is preferable to set the upper limit of Conditional Expression (1-2) to any one of 4.8, 4.6, 4.5, or 4.25 instead of 5.

In a configuration in which the intermediate group GM includes at least the first intermediate lens group GM1, the second intermediate lens group GM2, and the third intermediate lens group GM3, the variable magnification optical system preferably satisfies Conditional Expression (2-1A). By preventing the corresponding value of Conditional Expression (2-1A) from being equal to or less than the lower limit, the back focus is not excessively shortened, and thus it is easy to attach the mount replacement mechanism.

By preventing the corresponding value of Conditional Expression (2-1A) from being equal to or greater than the upper limit, the back focus is not excessively increased, and thus it is easy to reduce the size.

$$0.18 < Bfw / ( fw \times tan ω w ) < 1.25 \qquad ( 2 - 1 A )$$

In order to obtain better characteristics, it is preferable to set the lower limit of Conditional Expression (2-1A) to any one of 0.22, 0.26, 0.3, 0.34, 0.37, 0.4, or 0.42 instead of 0.18. In addition, it is preferable to set the upper limit of Conditional Expression (2-1A) to any one of 1.1, 1.05, 1, 0.95, 0.9, 0.85, or 0.83 instead of 1.25.

In a configuration in which the intermediate group GM includes at least the first intermediate lens group GM1, the second intermediate lens group GM2, and the third intermediate lens group GM3, the variable magnification optical system preferably satisfies Conditional Expression (5-1A). By preventing the corresponding value of Conditional Expression (5-1A) from being equal to or less than the lower limit, it is advantageous for suppressing various aberrations in the entire magnification change range. By preventing the corresponding value of Conditional Expression (5-1A) from being equal to or greater than the upper limit, it is advantageous for reducing the size of the entire optical system or it is advantageous for obtaining a sufficient magnification change ratio as the variable magnification optical system.

$$0.63 < ( f w \times T Lw ) / {ft}^{2} < 1.85 \qquad ( 5 - 1 A )$$

In order to obtain better characteristics, it is preferable to set the lower limit of Conditional Expression (5-1A) to any one of 0.66, 0.69, 0.71, 0.73, or 0.75 instead of 0.63. In addition, it is preferable to set the upper limit of Conditional Expression (5-1A) to any one of 1.7, 1.55, 1.45, 1.4, or 1.35 instead of 1.85.

In a configuration in which the intermediate group GM includes at least the first intermediate lens group GM1, the second intermediate lens group GM2, and the third intermediate lens group GM3, the variable magnification optical system preferably satisfies Conditional Expression (6-1). By preventing the corresponding value of Conditional Expression (6-1) from being equal to or less than the lower limit, the refractive power of the first lens group G1 is not excessively increased, and it is advantageous for suppressing fluctuation of the aberrations during magnification change. By preventing the corresponding value of Conditional Expression (6-1) from being equal to or greater than the upper limit, the refractive power of the first lens group G1 is not excessively decreased, and thus the movement amount of the first lens group G1 during magnification change can be suppressed.

$$- 7 < ft / fl < - 0.9 \qquad ( 6 - 1 )$$

In order to obtain better characteristics, it is preferable to set the lower limit of Conditional Expression (6-1) to any one of −6, −5, −4, or −3 instead of −7. In addition, it is preferable to set the upper limit of Conditional Expression (6-1) to any one of −1, −1.1, −1.2, or −1.3 instead of −0.9.

In a configuration in which the intermediate group GM includes at least the first intermediate lens group GM1, the second intermediate lens group GM2, and the third intermediate lens group GM3, the variable magnification optical system more preferably satisfies Conditional Expressions (1-2), (2-1A), (5-1A), and (6-1).

The final lens group GE may be configured to move along the optical axis Z during magnification change. In such a case, it is advantageous for suppressing fluctuations of aberrations during magnification change.

Although the example in which the variable magnification optical system is a zoom lens is shown in FIG. 1, the variable magnification optical system according to the present disclosure may be a zoom lens or a varifocal lens.

The preferred configurations and the available configurations described above can be combined in any manner without inconsistency, and it is preferable that the preferred configurations and available configurations described above are selectively adopted as appropriate in accordance with required specifications.

For example, a preferred aspect of the variable magnification optical system according to the present disclosure consists of, in order from the object side to the image side, the first lens group G1 having negative refractive power, the intermediate group GM consisting of a plurality of lens groups, and the final lens group GE having refractive power, in which during magnification change, the spacing between the first lens group G1 and the intermediate group GM changes, the spacing between the intermediate group GM and the final lens group GE changes, the spacings of all adjacent lens groups in the intermediate group GM change, and the focusing group that moves along the optical axis Z during focusing is disposed closer to the image side than the first lens group G1, and the variable magnification optical system satisfies Conditional Expressions (1), (2), and (3).

Next, examples of the variable magnification optical system according to the present disclosure will be described with reference to the accompanying drawings. It should be noted that reference numerals provided to the groups in the cross-sectional view of each example are independently used for each example in order to avoid complication of description and the drawings caused by an increasing number of digits of the reference numerals. Therefore, even in a case in which a common reference numeral is provided in the drawings of different examples, the common reference numeral does not always indicate a common configuration.

### Example 1

A configuration and a movement locus of the variable magnification optical system according to Example 1 are shown in FIG. 1, and its showing method and its configuration are described above, and thus the duplicate description will be partially omitted here. The variable magnification optical system according to Example 1 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power. The aperture stop St is disposed in the first intermediate lens group GM1.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

For the variable magnification optical system according to Example 1, basic lens data is shown in Table 1, specifications and variable surface spacings are shown in Table 2, and aspherical coefficients are shown in Table 3.

The table of the basic lens data is described as below. The column of Sn shows surface numbers in a case in which the number is increased by one toward the image side from the surface closest to the object side as a first surface. The column of R shows the curvature radius of each surface. The column of D shows the surface spacing on the optical axis between each surface and its adjacent surface on the image side. The column of Nd shows a refractive index at the d line for each constituent. The column of νd shows the Abbe number based on the d line for each constituent. A column of θgF shows a partial dispersion ratio between a g line and an F line for each constituent. The leftmost column of the row of the lens corresponding to the anti-vibration group is denoted by “Gois”, and the leftmost column of the row of the lens corresponding to the focusing group is denoted by “Gfoc”.

In a case in which refractive indexes of a certain lens with respect to the g line, the F line, and a C line are denoted by Ng, NF, and NC, respectively, and a partial dispersion ratio of the lens between the g line and the F line is denoted by θgF, θgF is defined as the following expression.

$$θ gF = ( N g - NF ) / ( NF - N C )$$

The expressions “d line”, “C line”, “F line”, and “g line” described in the present specification mean emission lines, in which a wavelength of the d line is 587.56 nanometers (nm), a wavelength of the C line is 656.27 nanometers (nm), a wavelength of the F line is 486.13 nanometers (nm), and a wavelength of the g line is 435.84 nanometers (nm).

In the table of the basic lens data, a sign of a curvature radius of a surface having a convex shape facing the object side is positive, and a sign of a curvature radius of a surface having a convex shape facing the image side is negative. In Table 1, the field of a surface number of the surface corresponding to the aperture stop St has the term of the surface number (St). A value in the lowermost field of the column of D in the table indicates a spacing between the surface closest to the image side in the table and the image plane Sim. The symbol DD[ ] is used for the variable surface spacings during magnification change, and the surface number on the object side of the spacing is provided inside [ ] and is described in the column of the surface spacings.

Table 2 shows a magnification change ratio Zr, a focal length f, a back focus Bf, an open F-number FNo., a maximum full angle of view 2ω, and variable surface spacings, based on the d line. In a case in which the variable magnification optical system is a zoom lens, the magnification change ratio is synonymous with a zoom magnification. In the field of 2ω, [°] indicates a degree unit. Table 2 shows the values of the wide angle end state, a middle focal length state, and the telephoto end state in the columns marked “Wide”, “Middle”, and “Tele”, respectively.

In the basic lens data, a surface number of an aspherical surface is marked with *, and a value of a paraxial curvature radius is shown in the field of the curvature radius of the aspherical surface. In Table 3, the column of Sn shows the surface numbers of the aspherical surfaces, and the columns of KA and Am show numerical values of the aspherical coefficients for each aspherical surface. Here, m of Am is an integer equal to or greater than 3, and varies depending on the surface. For example, m=4, 6, 8, 10, 12, 14, 16, 18 for the third surface according to Example 1. In Table 3, “E±n” (n: integer) of the numerical value of the aspherical coefficient means “×10^{±n}”. KA and Am are aspherical coefficients in an aspheric equation represented by the following equation.

$$Z d = C \times {h}^{2} / \{ 1 + {( 1 - KA \times {C}^{2} \times {h}^{2} )}^{1 / 2} \} + Σ A m \times {h}^{m}$$

Here,
Zd: aspherical surface depth (a length of a perpendicular line drawn from a point on the aspheric surface at height h to a plane perpendicular to the optical axis Z where the apex of the aspheric surface is in contact),
h: height (distance from optical axis Z to lens surface),
C: reciprocal of paraxial curvature radius, and
KA, Am: aspherical coefficients,
and Σ means the total sum with respect to m in aspherical surface equation.

In the data of each table, a degree unit is used for angles, and a millimeter unit is used for lengths, the optical system can also be proportionally enlarged or proportionally reduced to be used, and thus other appropriate units can also be used. Furthermore, numerical values rounded to predetermined digits are described in each table shown below.

TABLE 1
Example 1

| | Sn | R | D | Nd | νd | θgF |
|---|---|---|---|---|---|---|
| | 1 | 62.4987 | 1.2498 | 1.64000 | 60.08 | 0.53704 |
| | 2 | 14.0929 | 7.8763 | | | |
| | *3 | 68.8393 | 0.6730 | 1.53409 | 55.87 | 0.55858 |
| | *4 | 36.7644 | 1.2500 | | | |
| | 5 | 27.4519 | 2.0000 | 1.95906 | 17.47 | 0.65993 |
| | 6 | 33.0551 | DD[6] | | | |
| Gois | *7 | 23.0834 | 2.5000 | 1.53409 | 55.87 | 0.55858 |
| | *8 | −35.6492 | 1.7500 | | | |
| | 9(St) | ∞ | 2.0335 | | | |
| | 10 | −24.8444 | 1.7498 | 2.00330 | 28.27 | 0.59802 |
| | 11 | −122.2955 | 5.0002 | | | |
| | *12 | 20.2881 | 4.2500 | 1.49700 | 81.54 | 0.53748 |
| | *13 | −19.9902 | DD[13] | | | |
| Gfoc | *14 | −31.0590 | 0.6248 | 1.53409 | 55.87 | 0.55858 |
| | *15 | 32.6324 | DD[15] | | | |
| | 16 | 83.3311 | 3.2500 | 1.48749 | 70.32 | 0.52917 |
| | 17 | −1337.4491 | 18.4400 | | | |

TABLE 2
Example 1

| | Wide | Middle | Tele |
|---|---|---|---|
| Zr | 1.0 | 1.5 | 1.8 |
| f | 23.24 | 34.16 | 42.53 |
| Bf | 18.44 | 18.44 | 18.44 |
| FNo. | 4.51 | 5.47 | 6.00 |
| 2ω[°] | 92.2 | 65.6 | 53.2 |
| DD[6] | 22.81 | 11.37 | 5.17 |
| DD[13] | 7.41 | 8.60 | 10.42 |
| DD[15] | 11.69 | 20.28 | 23.52 |

TABLE 3
Example 1

| Sn | 3 | 4 | 7 | 8 |
|---|---|---|---|---|
| KA | 1.0000000E+00 | 1.0000000E+00 | 1.0000000E+00 | 1.0000000E+00 |
| A4 | 1.0880364E−05 | −6.1425152E−07 | −1.6971274E−05 | −1.5541579E−05 |
| A6 | 8.8280391E−08 | 5.8416781E−08 | 1.1629793E−07 | 2.0779732E−07 |
| A8 | −4.4586582E−10 | −8.8691238E−10 | −2.4617308E−09 | 3.4903922E−09 |
| A10 | −2.3410906E−12 | 8.3550591E−13 | 6.2329982E−11 | −2.2436792E−11 |
| A12 | 1.4020161E−14 | −1.3606424E−14 | 2.8483694E−12 | −1.7831421E−12 |
| A14 | 1.8487610E−17 | 1.3571686E−16 | −1.4654092E−14 | 1.4993370E−13 |
| A16 | −7.3715564E−21 | −6.7237719E−19 | −1.4339397E−15 | −2.7142348E−15 |
| A18 | −2.1572267E−21 | −3.9123025E−22 | 3.6004756E−17 | 3.4026209E−17 |

| Sn | 12 | 13 |
|---|---|---|
| KA | 1.0000000E+00 | 1.0000000E+00 |
| A4 | −1.1483128E−05 | 5.2607260E−05 |
| A6 | 4.2328298E−07 | 1.7419378E−07 |
| A8 | 1.0705463E−08 | 2.9782520E−08 |
| A10 | 5.2078596E−10 | −3.4146195E−10 |
| A12 | −1.9679684E−11 | 6.0148976E−12 |
| A14 | 3.8392857E−13 | −4.8046800E−14 |
| A16 | −1.8521114E−15 | 1.8286131E−15 |
| Sn | 14 | 15 |
| KA | 1.0000000E+00 | 1.0000000E+00 |
| A3 | 0.0000000E+00 | 0.0000000E+00 |
| A4 | 1.3898179E−04 | 1.8766568E−04 |
| A5 | −1.4978499E−05 | −1.8038304E−05 |
| A6 | −1.9441489E−06 | −7.4490455E−07 |
| A7 | 2.8277129E−07 | 1.1704216E−07 |
| A8 | 2.6018903E−08 | 1.9036655E−08 |
| A9 | −1.4079878E−09 | −3.3254940E−10 |
| A10 | −4.3984277E−10 | 3.8313537E−11 |
| A11 | 6.7029186E−12 | −3.8629131E−11 |
| A12 | 3.3262526E−12 | −2.3391108E−12 |
| A13 | −2.1115609E−13 | 1.6422683E−13 |
| A14 | 2.2900154E−14 | 6.0349284E−14 |
| A15 | −1.4814874E−15 | 5.6098163E−15 |
| A16 | 1.3283730E−15 | −6.4648179E−16 |
| A17 | −4.9288390E−17 | −6.5674316E−17 |
| A18 | −2.0455846E−17 | −1.7784605E−18 |
| A19 | −2.1565465E−19 | 9.1039889E−19 |
| A20 | 1.5407824E−19 | −3.1889741E−20 |

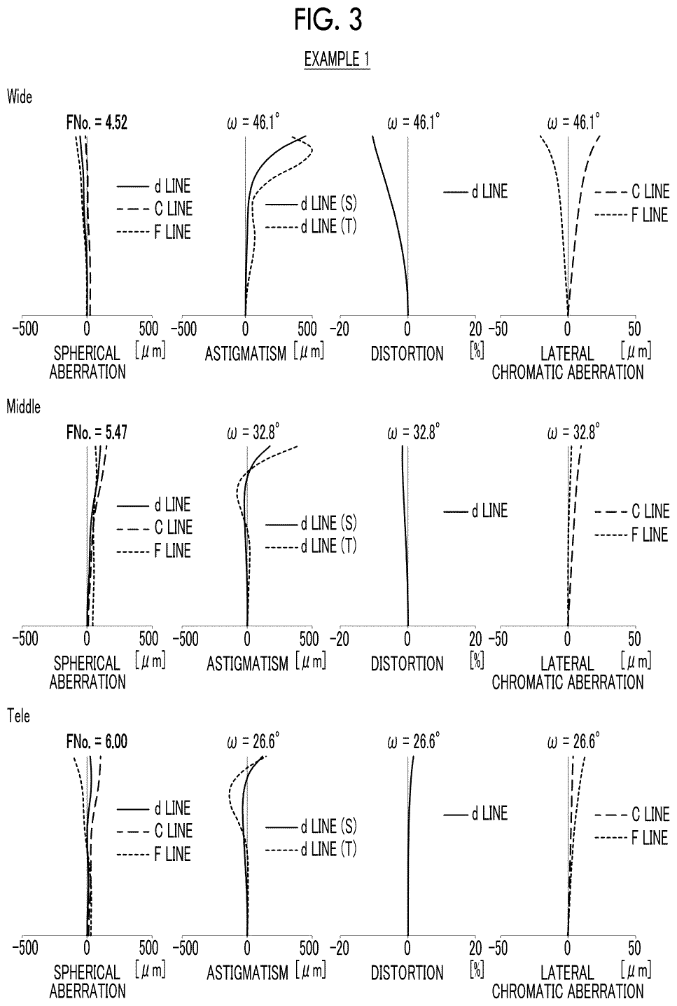

FIG. 3 shows each aberration diagram of the variable magnification optical system according to Example 1 in a state in which the infinite distance object is in focus. FIG. 3 shows, in order from the left side, spherical aberration, astigmatism, distortion, and lateral chromatic aberration. FIG. 3 shows aberrations in the wide angle end state in an upper part marked “Wide”, aberrations in the middle focal length state in a middle part marked “Middle”, and aberrations in the telephoto end state in a lower part marked “Tele”. In the spherical aberration diagram, the aberrations at the d line, the C line, and the F line are shown by a solid line, a long dashed line, and a short dashed line, respectively. In the astigmatism diagram, the aberration at the d line in a sagittal direction is shown by a solid line, and the aberration at the d line in a tangential direction is shown by a short dashed line. In the distortion diagram, the aberration at the d line is shown by a solid line. In the lateral chromatic aberration diagram, the aberrations at the C line and the F line are shown by a long dashed line and a short dashed line, respectively. In the spherical aberration diagram, a value of the open F-number is shown after FNo. =. In other aberration diagrams, a value of the maximum half angle of view is shown after ω=.

Symbols, meanings, description methods, and showing methods of each data related to Example 1 are basically the same in the following examples unless otherwise specified, and thus the duplicate description will be omitted below.

### Example 2

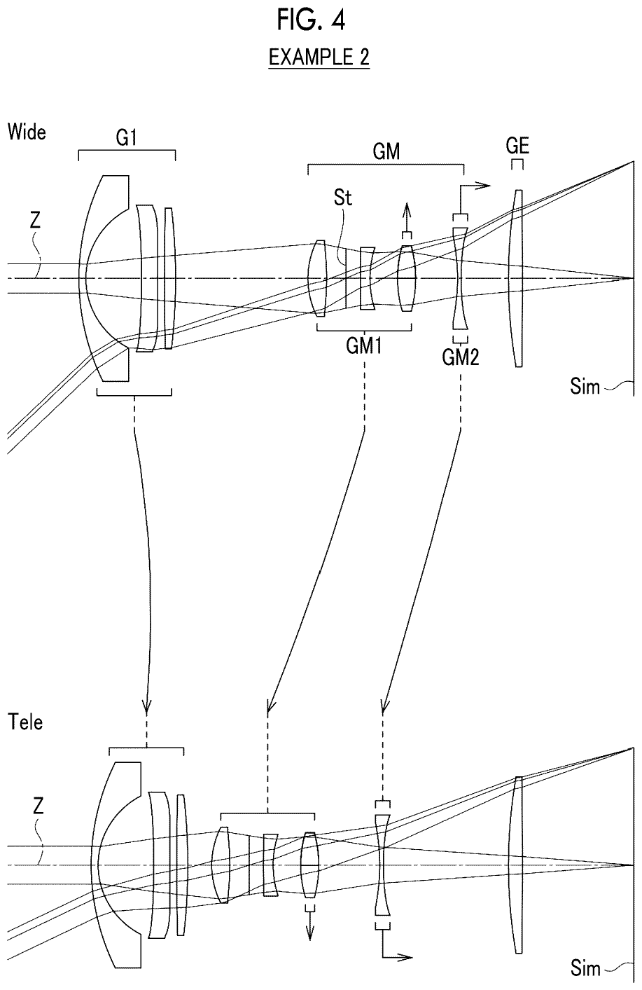

A configuration and a movement locus of a variable magnification optical system according to Example 2 are shown in FIG. 4. The variable magnification optical system according to Example 2 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the image side of the first intermediate lens group GM1.

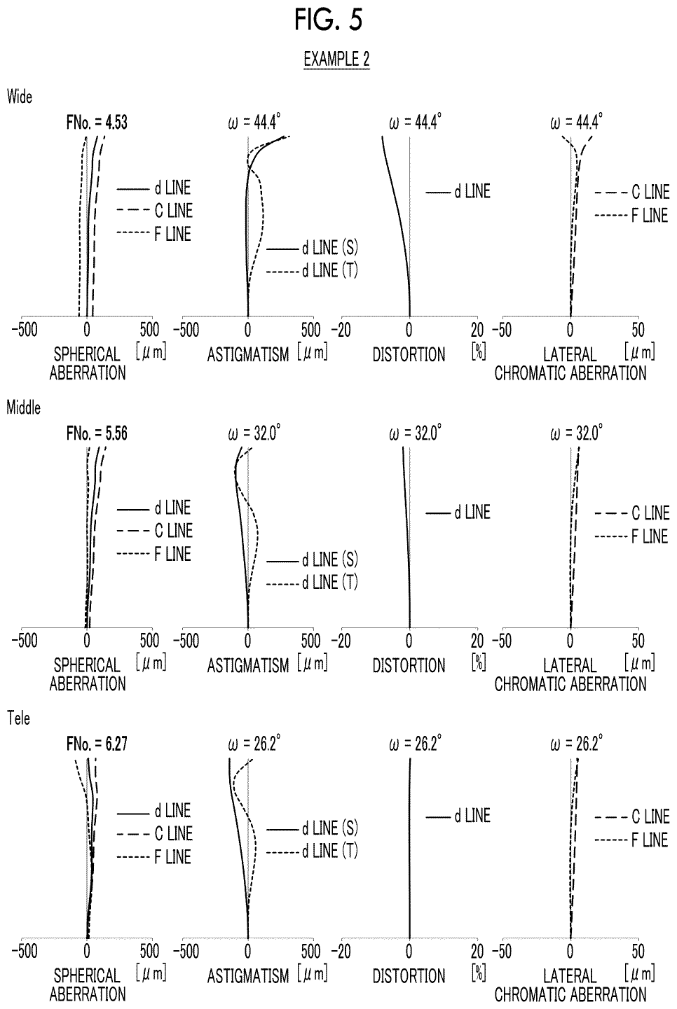

For the variable magnification optical system according to Example 2, basic lens data is shown in Table 4, specifications and variable surface spacings are shown in Table 5, aspherical coefficients are shown in Table 6, and each aberration diagram is shown in FIG. 5.

TABLE 4
Example 2

| | Sn | R | D | Nd | νd | θgF |
|---|---|---|---|---|---|---|
| | 1 | 43.8590 | 1.2498 | 1.89190 | 37.13 | 0.57813 |
| | 2 | 14.5171 | 10.0002 | | | |
| | *3 | −167.2094 | 2.8697 | 1.53409 | 55.87 | 0.55858 |
| | *4 | 225.7726 | 1.2500 | | | |
| | 5 | 508.2357 | 2.0000 | 1.95906 | 17.47 | 0.65993 |
| | 6 | −115.1874 | DD[6] | | | |
| | *7 | 15.6474 | 3.2502 | 1.53409 | 55.87 | 0.55858 |
| | *8 | −48.1905 | 3.5000 | | | |
| | 9(St) | ∞ | 2.5451 | | | |
| | 10 | 252.5353 | 1.7502 | 2.00330 | 28.27 | 0.59802 |
| | 11 | 18.5788 | 4.9592 | | | |
| Gois | *12 | 21.6874 | 3.2499 | 1.49700 | 81.54 | 0.53748 |
| | *13 | −21.8104 | DD[13] | | | |
| Gfoc | *14 | −32.2876 | 0.6532 | 1.53409 | 55.87 | 0.55858 |
| | *15 | 64.8749 | DD[15] | | | |
| | 16 | 98.0046 | 2.5067 | 1.48749 | 70.32 | 0.52917 |
| | 17 | −1357.6982 | 20.0000 | | | |

TABLE 5
Example 2

| | Wide | Middle | Tele |
|---|---|---|---|
| Zr | 1.0 | 1.5 | 1.8 |
| f | 24.03 | 35.31 | 43.97 |
| Bf | 20.00 | 20.00 | 20.00 |
| FNo. | 4.52 | 5.55 | 6.27 |
| 2ω[°] | 88.8 | 64.0 | 52.4 |
| DD[6] | 23.80 | 10.50 | 4.30 |
| DD[13] | 7.54 | 9.18 | 10.87 |
| DD[15] | 8.50 | 17.26 | 22.47 |

TABLE 6
Example 2

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −4.8960496E−06 | −2.4242382E−05 | −1.7036715E−05 | 2.8559977E−05 |
| A6 | 8.9236271E−09 | −1.3401740E−08 | 4.3444602E−08 | −1.0190407E−08 |
| A8 | −5.2567236E−11 | −4.6117309E−10 | −3.1744819E−10 | 5.1956066E−09 |
| A10 | −1.9928525E−12 | 1.4498084E−12 | 5.9722283E−11 | 1.1130786E−11 |
| A12 | 1.0976227E−14 | −1.3687346E−14 | 2.0422525E−12 | −1.9812402E−12 |
| A14 | 8.9702735E−18 | 1.2928815E−16 | −2.3948425E−14 | 1.3134235E−13 |
| A16 | 3.9990974E−20 | −6.5588916E−19 | −1.0567201E−15 | −3.4010844E−15 |
| A18 | −1.5748991E−21 | 4.8251573E−22 | 2.4087177E−17 | 4.0582819E−17 |

| Sn | 12 | 13 |
|---|---|---|
| KA | 1.0000000E+00 | 1.0000000E+00 |
| A4 | −3.6128465E−06 | 2.9599465E−05 |
| A6 | 1.7401490E−07 | −5.4649553E−08 |
| A8 | 3.8843685E−09 | 2.2733804E−08 |
| A10 | 3.5433706E−10 | −5.1126337E−10 |
| A12 | −1.4904370E−11 | 1.2631554E−11 |
| A14 | 3.8333741E−13 | −1.3001436E−13 |
| A16 | −2.1919725E−15 | 2.0921502E−15 |
| Sn | 14 | 15 |
| KA | 1.0000000E+00 | 1.0000000E+00 |
| A3 | 0.0000000E+00 | 0.0000000E+00 |
| A4 | 1.6765697E−04 | 1.8383155E−04 |
| A5 | −1.8899815E−05 | −1.9306958E−05 |
| A6 | −1.6967121E−06 | −9.0318919E−07 |
| A7 | 2.7493096E−07 | 1.2798745E−07 |
| A8 | 2.5134949E−08 | 1.9755453E−08 |
| A9 | −1.4424182E−09 | −3.1344817E−10 |
| A10 | −4.3903216E−10 | 3.8973982E−11 |
| A11 | 6.5456503E−12 | −3.8420905E−11 |
| A12 | 3.2873909E−12 | −2.2947534E−12 |
| A13 | −1.9067691E−13 | 1.7811272E−13 |
| A14 | 2.2002445E−14 | 5.9569717E−14 |
| A15 | −1.7423711E−15 | 5.4367658E−15 |
| A16 | 1.2657676E−15 | −6.7498044E−16 |
| A17 | −5.6482845E−17 | −7.0627172E−17 |
| A18 | −1.8225182E−17 | −1.5760079E−18 |
| A19 | −2.3988834E−19 | 9.3906467E−19 |
| A20 | 1.5488743E−19 | −2.5403171E−20 |

### Example 3

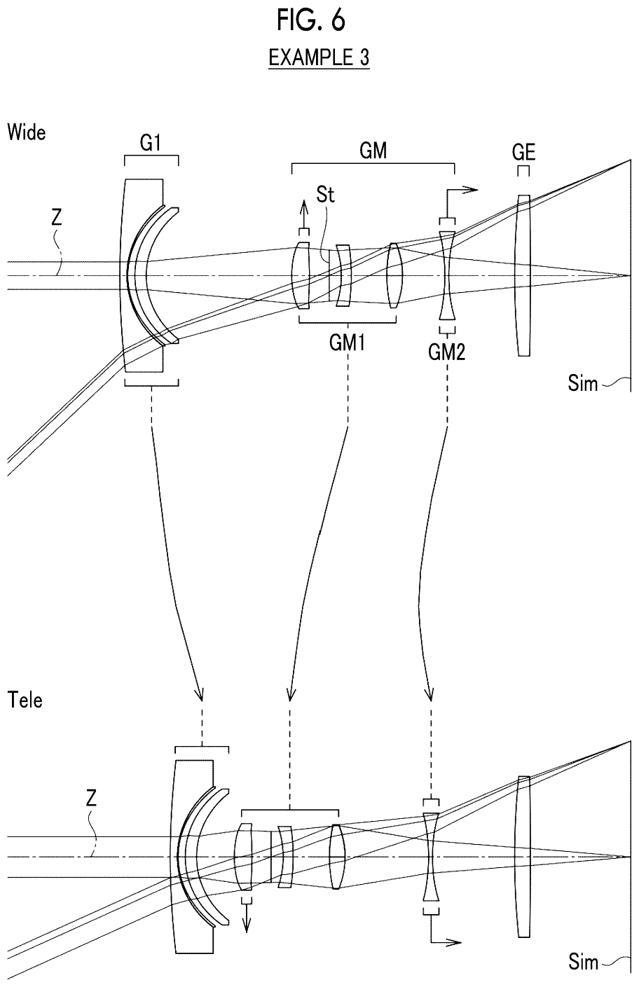

A configuration and a movement locus of a variable magnification optical system according to Example 3 are shown in FIG. 6. The variable magnification optical system according to Example 3 consists of, in order from the object side to the image side, the first lens group G1 having negative refractive power, the intermediate group GM, and the final lens group GE having positive refractive power. The lens closest to the object side of the first lens group G1 is a compound aspherical lens. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

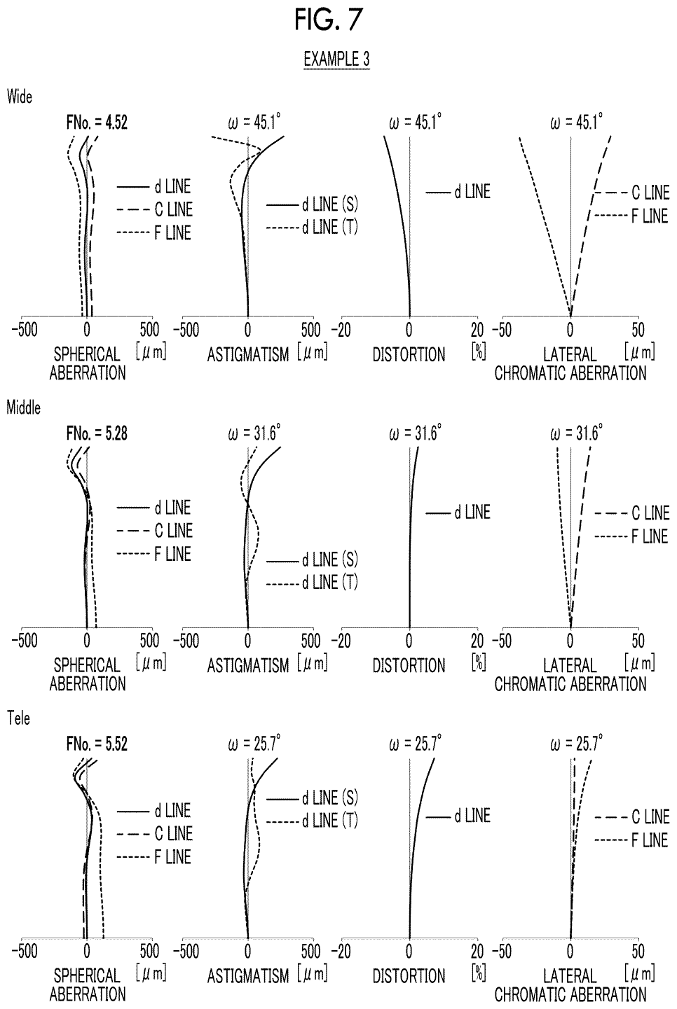

For the variable magnification optical system according to Example 3, basic lens data is shown in Table 7, specifications and variable surface spacings are shown in Table 8, aspherical coefficients are shown in Table 9, and each aberration diagram is shown in FIG. 7.

TABLE 7
Example 3

| | Sn | R | D | Nd | νd | θgF |
|---|---|---|---|---|---|---|
| | 1 | 163.3502 | 1.2498 | 1.64000 | 60.08 | 0.53704 |
| | 2 | 16.8111 | 0.1248 | 1.53409 | 55.87 | 0.55858 |
| | *3 | 14.9633 | 1.2498 | | | |
| | 4 | 15.6667 | 2.0000 | 1.95906 | 17.47 | 0.65993 |
| | 5 | 15.2985 | DD[5] | | | |
| Gois | *6 | 20.0558 | 3.0964 | 1.53409 | 55.87 | 0.55858 |
| | *7 | −53.0126 | 3.3658 | | | |
| | 8(St) | ∞ | 2.1121 | | | |
| | 9 | −18.4632 | 1.7499 | 2.00330 | 28.27 | 0.59802 |
| | 10 | −41.6983 | 6.2500 | | | |
| | *11 | 26.0798 | 2.7522 | 1.49700 | 81.54 | 0.53748 |
| | *12 | −16.3884 | DD[12] | | | |
| Gfoc | *13 | −33.1934 | 0.7120 | 1.53409 | 55.87 | 0.55858 |
| | *14 | 44.8194 | DD[14] | | | |
| | 15 | 156.5448 | 2.7501 | 1.48749 | 70.32 | 0.52917 |
| | 16 | −1118.3948 | 17.6500 | | | |

TABLE 8
Example 3

| | Wide | Middle | Tele |
|---|---|---|---|
| Zr | 1.0 | 1.5 | 1.8 |
| f | 23.33 | 34.29 | 42.00 |
| Bf | 17.65 | 17.65 | 17.65 |
| FNo. | 4.52 | 5.28 | 5.52 |
| 2ω[°] | 90.2 | 63.2 | 51.4 |
| DD[5] | 25.55 | 13.45 | 6.62 |
| DD[12] | 7.43 | 10.19 | 14.65 |
| DD[14] | 11.54 | 16.59 | 14.40 |

TABLE 9
Example 3

| Sn | 3 | 6 | 7 |
|---|---|---|---|
| KA | 1.0000000E+00 | 1.0000000E+00 | 1.0000000E+00 |
| A4 | −1.0393002E−05 | 8.4747958E−05 | 1.0248108E−04 |
| A6 | −1.1568394E−07 | 1.1189287E−06 | 1.9565759E−06 |
| A8 | 7.4078183E−10 | 2.7199317E−08 | 1.1722427E−09 |
| A10 | −4.5754821E−12 | 4.3137761E−10 | 8.6024188E−10 |
| A12 | −1.5244549E−14 | −3.4050668E−12 | 1.9217055E−11 |
| A14 | 1.7069676E−16 | −6.9884248E−15 | −1.6232737E−13 |
| A16 | −2.7007312E−19 | 1.8421363E−15 | −2.3197506E−14 |
| A18 | −1.2384030E−21 | 7.5019303E−17 | 7.1902326E−16 |

| Sn | 11 | 12 |
|---|---|---|
| KA | 1.0000000E+00 | 1.0000000E+00 |
| A4 | −3.8647922E−05 | 1.4789248E−05 |
| A6 | 6.4790975E−07 | 4.9117285E−07 |
| A8 | −3.2294572E−08 | −1.3052921E−08 |
| A10 | 7.2387789E−10 | −2.0761556E−10 |
| A12 | −7.8739639E−12 | 1.2731424E−11 |
| A14 | 1.0712742E−13 | −6.8746720E−14 |
| A16 | −4.0272962E−15 | −3.6695060E−15 |

| Sn | 13 | 14 |
|---|---|---|
| KA | 1.0000000E+00 | 1.0000000E+00 |
| A3 | 0.0000000E+00 | 0.0000000E+00 |
| A4 | 1.9571307E−04 | 2.4903208E−04 |
| A5 | −2.3706066E−05 | −2.3845742E−05 |
| A6 | −2.0428486E−06 | −1.0114543E−06 |
| A7 | 2.8553606E−07 | 1.0314357E−07 |
| A8 | 2.5266153E−08 | 1.9193584E−08 |
| A9 | −1.6492974E−09 | −2.6531312E−10 |
| A10 | −4.6900896E−10 | 4.9789907E−11 |
| A11 | 5.2130658E−12 | −3.7714667E−11 |
| A12 | 3.2131760E−12 | −2.3090990E−12 |
| A13 | −2.0196801E−13 | 1.6166214E−13 |
| A14 | 2.6163293E−14 | 5.9919267E−14 |
| A15 | −8.8856768E−16 | 5.4298318E−15 |
| A16 | 1.3524946E−15 | −6.5851299E−16 |
| A17 | −4.8513531E−17 | −6.6741092E−17 |
| A18 | −2.1391622E−17 | −1.8803616E−18 |
| A19 | −2.2014826E−19 | 9.4101482E−19 |
| A20 | 1.4756738E−19 | −3.0721371E−20 |

### Example 4

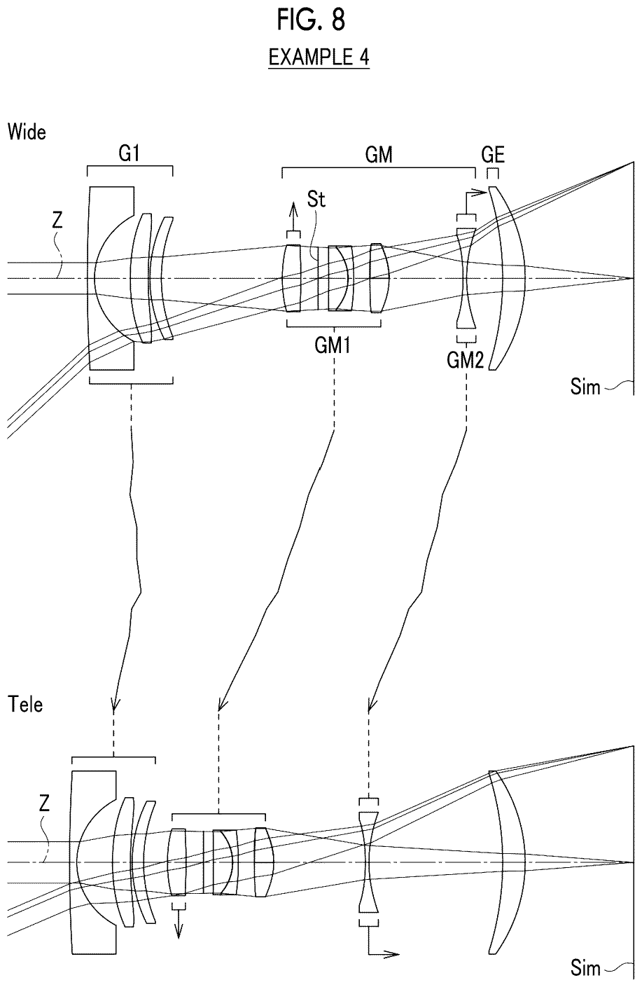

A configuration and a movement locus of a variable magnification optical system according to Example 4 are shown in FIG. 8. The variable magnification optical system according to Example 4 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

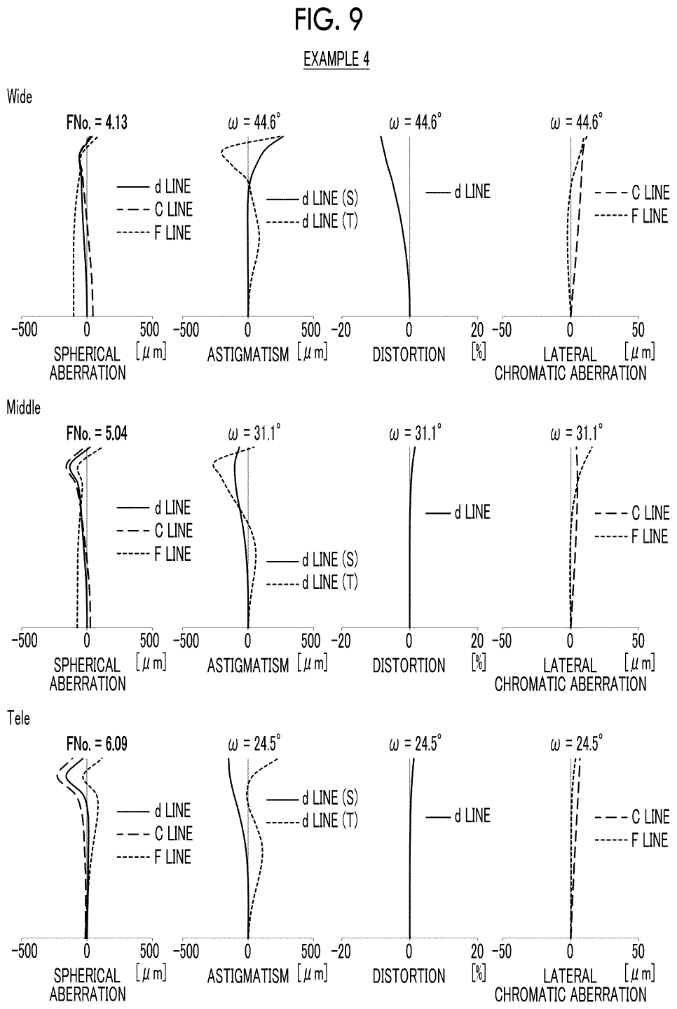

For the variable magnification optical system according to Example 4, basic lens data is shown in Table 10, specifications and variable surface spacings are shown in Table 11, aspherical coefficients are shown in Table 12, and each aberration diagram is shown in FIG. 9.

TABLE 10
Example 4

| | Sn | R | D | Nd | νd | θgF |
|---|---|---|---|---|---|---|
| | 1 | 314.1198 | 1.2501 | 1.64000 | 60.08 | 0.53704 |
| | 2 | 13.3893 | 6.2502 | | | |
| | *3 | 40.9300 | 3.1329 | 1.53409 | 55.87 | 0.55858 |
| | *4 | 67.9956 | 0.3000 | | | |
| | 5 | 26.5873 | 2.0000 | 1.95906 | 17.47 | 0.65993 |
| | 6 | 30.2378 | DD[6] | | | |
| Gois | *7 | 30.3578 | 3.2502 | 1.53409 | 55.87 | 0.55858 |
| | *8 | −61.1850 | 3.0163 | | | |
| | 9(St) | ∞ | 1.7498 | | | |
| | 10 | −277.5308 | 3.3649 | 1.52841 | 76.45 | 0.53954 |
| | 11 | −9.0285 | 0.9998 | 1.80400 | 46.53 | 0.55775 |
| | 12 | −45.1281 | 2.8251 | | | |
| | *13 | 393.6001 | 3.3502 | 1.49700 | 81.54 | 0.53748 |
| | *14 | −13.1499 | DD[14] | | | |
| Gfoc | *15 | −33.4645 | 0.6248 | 1.53409 | 55.87 | 0.55858 |
| | *16 | 27.4632 | DD[16] | | | |
| | 17 | −58.1389 | 3.9341 | 1.80400 | 46.53 | 0.55775 |
| | 18 | −30.6521 | 18.9600 | | | |

TABLE 11
Example 4

| | Wide | Middle | Tele |
|---|---|---|---|
| Zr | 1.0 | 1.5 | 2.0 |
| f | 24.02 | 35.31 | 46.84 |
| Bf | 18.96 | 18.96 | 18.96 |
| FNo. | 4.13 | 5.04 | 6.09 |
| 2ω[°] | 89.2 | 62.2 | 49.0 |
| DD [6] | 21.14 | 9.68 | 4.18 |
| DD[14] | 12.92 | 14.82 | 15.92 |
| DD[16] | 6.29 | 14.13 | 23.36 |

TABLE 12
Example 4

| Sn | 3 | 4 | 7 | 8 |
|---|---|---|---|---|
| KA | 1.0000000E+00 | 1.0000000E+00 | 1.0000000E+00 | 1.0000000E+00 |
| A4 | 1.4665329E−05 | −1.0102200E−05 | 4.9897088E−05 | 6.7574904E−05 |
| A6 | 9.1141679E−08 | 6.1296541E−08 | 7.9018313E−07 | 9.2461979E−07 |
| A8 | −1.0310694E−10 | −1.2960636E−09 | 6.8511478E−09 | 4.8414745E−09 |
| A10 | −6.1150255E−12 | −6.2247651E−13 | 7.2916247E−11 | 8.7459881E−11 |
| A12 | 1.6126611E−14 | −9.8705591E−15 | 1.2620806E−12 | 4.0565895E−13 |
| A14 | 1.3977277E−16 | 2.6183541E−16 | −5.1174029E−14 | 1.6305982E−13 |
| A16 | 3.4697781E−19 | 9.2758717E−20 | 6.6561996E−16 | −6.4116126E−15 |
| A18 | −5.1095311E−21 | −8.5075015E−21 | −4.8538463E−19 | 7.4841906E−17 |

| Sn | 13 | 14 |
|---|---|---|
| KA | 1.0000000E+00 | 1.0000000E+00 |
| A4 | 5.1050709E−05 | 7.0988550E−05 |
| A6 | 6.4126288E−07 | 4.0861756E−07 |
| A8 | 1.0646882E−08 | 2.3486406E−08 |
| A10 | 4.9067537E−10 | −2.0749708E−10 |
| A12 | −1.7580059E−11 | 7.9568934E−12 |
| A14 | 4.6129301E−13 | −9.2939915E−14 |
| A16 | −2.9242039E−15 | 2.4887054E−15 |
| Sn | 15 | 16 |
| KA | 1.0000000E+00 | 1.0000000E+00 |
| A3 | 0.0000000E+00 | 0.0000000E+00 |
| A4 | 1.4124509E−04 | 1.7163343E−04 |
| A5 | −2.5849766E−05 | −2.8863817E−05 |
| A6 | −1.6214168E−06 | −6.2229375E−07 |
| A7 | 2.6680680E−07 | 1.4917330E−07 |
| A8 | 2.2883175E−08 | 2.0861489E−08 |
| A9 | −1.2173722E−09 | −3.0142286E−10 |
| A10 | −3.6572236E−10 | 2.6768885E−11 |
| A11 | 1.2000603E−11 | −4.0236312E−11 |
| A12 | 2.9232227E−12 | −2.5113500E−12 |
| A13 | −4.0833769E−13 | 1.4893618E−13 |
| A14 | −1.3286789E−14 | 6.1567448E−14 |
| A15 | −6.3433206E−16 | 5.7325175E−15 |
| A16 | 2.5347983E−15 | −6.2312806E−16 |
| A17 | −2.0015961E−16 | −6.9858743E−17 |
| A18 | −2.1083348E−17 | −1.5196164E−18 |
| A19 | 2.7075166E−18 | 9.5440216E−19 |
| A20 | −6.7686093E−20 | −3.3825971E−20 |

### Example 5

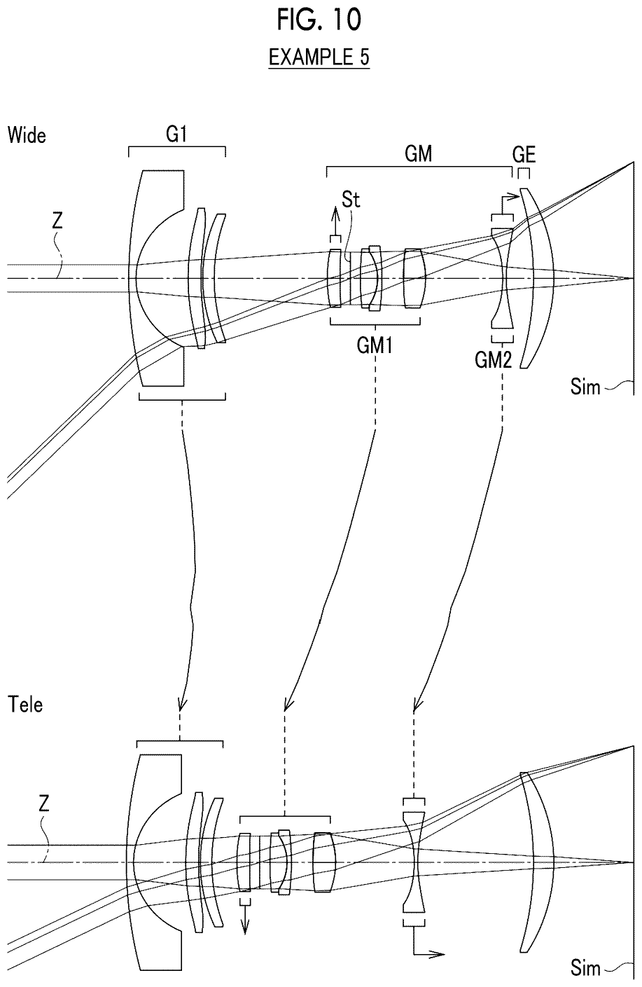

A configuration and a movement locus of a variable magnification optical system according to Example 5 are shown in FIG. 10. The variable magnification optical system according to Example 5 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

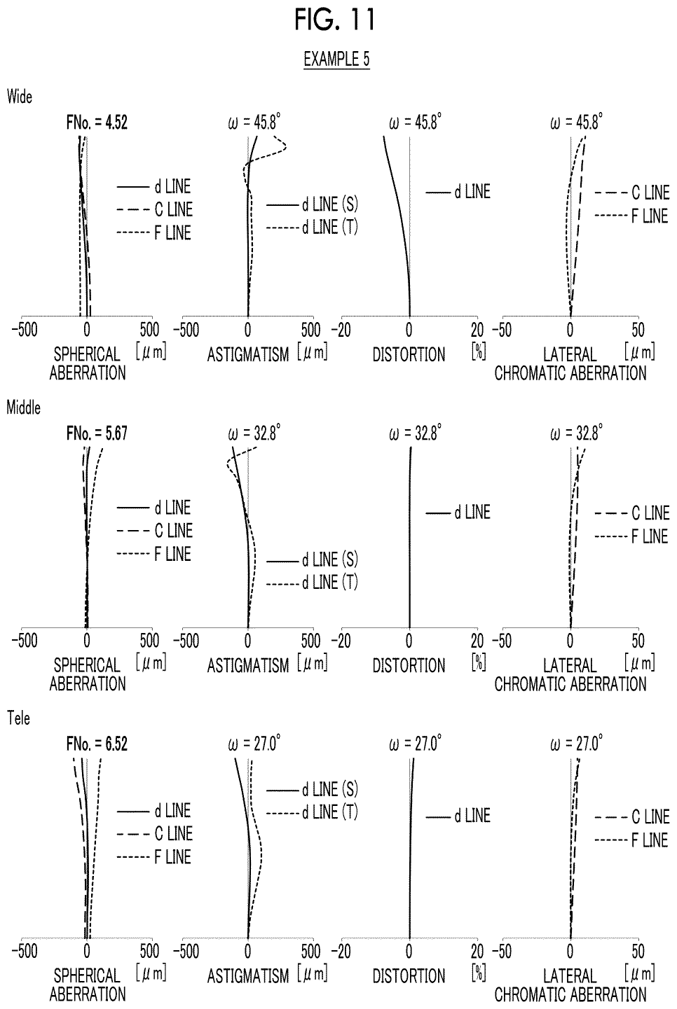

For the variable magnification optical system according to Example 5, basic lens data is shown in Table 13, specifications and variable surface spacings are shown in Table 14, aspherical coefficients are shown in Table 15, and each aberration diagram is shown in FIG. 11.

TABLE 13
Example 5

| | Sn | R | D | Nd | νd | θgF |
|---|---|---|---|---|---|---|
| | 1 | 83.3308 | 1.2498 | 1.64000 | 60.08 | 0.53704 |
| | 2 | 13.9748 | 9.0970 | | | |
| | *3 | 44.7495 | 2.2470 | 1.53409 | 55.87 | 0.55858 |
| | *4 | 50.6809 | 0.3000 | | | |
| | 5 | 29.5237 | 2.0000 | 1.95906 | 17.47 | 0.65993 |
| | 6 | 34.9050 | DD[6] | | | |
| Gois | *7 | 29.9271 | 2.2624 | 1.53409 | 55.87 | 0.55858 |
| | *8 | 834.3224 | 1.7498 | | | |
| | 9(St) | ∞ | 1.7498 | | | |
| | 10 | 56.1824 | 3.0047 | 1.52841 | 76.45 | 0.53954 |
| | 11 | −9.2482 | 0.7498 | 1.80400 | 46.53 | 0.55775 |
| | 12 | −51.0363 | 3.7773 | | | |
| | *13 | 69.3188 | 3.8492 | 1.49700 | 81.54 | 0.53748 |
| | *14 | −14.2935 | DD[14] | | | |
| Gfoc | *15 | −22.4783 | 0.6249 | 1.53409 | 55.87 | 0.55858 |
| | *16 | 26.7182 | DD[16] | | | |
| | 17 | −58.8073 | 3.5451 | 1.80400 | 46.53 | 0.55775 |
| | 18 | −32.2281 | 13.9300 | | | |

TABLE 14
Example 5

| | Wide | Middle | Tele |
|---|---|---|---|
| Zr | 1.0 | 1.5 | 1.8 |
| f | 22.80 | 33.51 | 41.95 |
| Bf | 13.93 | 13.93 | 13.93 |
| FNo. | 4.52 | 5.67 | 6.53 |
| 2ω[°] | 91.6 | 65.6 | 54.0 |
| DD[6] | 19.63 | 9.21 | 4.36 |
| DD[14] | 13.45 | 13.48 | 13.70 |
| DD[16] | 4.74 | 13.69 | 20.17 |
| DD[18] | 13.93 | 13.93 | 13.93 |

TABLE 15
Example 5

| Sn | 3 | 4 | 7 | 8 |
|---|---|---|---|---|
| KA | 1.0000000E+00 | 1.0000000E+00 | 1.0000000E+00 | 1.0000000E+00 |
| A4 | 1.8882748E−06 | −1.6775117E−05 | 4.8163690E−05 | 5.9318549E−05 |
| A6 | 1.8134848E−09 | −3.0455527E−08 | 6.5721885E−07 | 6.2962321E−07 |
| A8 | −7.3994882E−11 | −6.8740913E−10 | 4.4293836E−09 | 4.6984813E−10 |
| A10 | −2.4876193E−12 | 1.0964207E−12 | 1.5758255E−11 | −8.6325416E−11 |
| A12 | 9.7394207E−15 | −1.0747856E−14 | −4.1832861E−12 | −2.4384052E−12 |
| A14 | 1.8672898E−17 | 1.4088090E−16 | −1.1929431E−13 | 1.7289708E−13 |
| A16 | 1.1023894E−19 | −6.8593689E−19 | 1.0016779E−14 | −5.9579007E−15 |
| A18 | −2.0447114E−21 | −2.3140229E−22 | −1.4137017E−16 | 9.7508333E−17 |

| Sn | 13 | 14 |
|---|---|---|
| KA | 1.0000000E+00 | 1.0000000E+00 |
| A4 | 9.1780101E−05 | 1.1408805E−04 |
| A6 | 5.8507751E−07 | 3.5065477E−07 |
| A8 | 4.9352625E−09 | 2.4330433E−08 |
| A10 | 5.3941361E−10 | −2.9199651E−10 |
| A12 | −1.7639067E−11 | 8.1113359E−12 |
| A14 | 3.7512067E−13 | −8.1307960E−14 |
| A16 | −2.8016813E−15 | 1.1007918E−15 |
| Sn | 15 | 16 |
| KA | 1.0000000E+00 | 1.0000000E+00 |
| A3 | 0.0000000E+00 | 0.0000000E+00 |
| A4 | 6.5559759E−06 | 3.5785754E−05 |
| A5 | −1.6732753E−05 | −2.0858596E−05 |
| A6 | −2.1189320E−06 | −4.4371637E−07 |
| A7 | 2.5188056E−07 | 1.4092445E−07 |
| A8 | 2.4287320E−08 | 2.0291240E−08 |
| A9 | −1.1770062E−09 | −3.3995295E−10 |
| A10 | −3.9140843E−10 | 2.7449041E−11 |
| A11 | 9.9631185E−12 | −4.0155151E−11 |
| A12 | 3.0311102E−12 | −2.4955723E−12 |
| A13 | −3.1496007E−13 | 1.4886089E−13 |
| A14 | 5.3994657E−15 | 6.0062801E−14 |
| A15 | −2.5769981E−15 | 5.7063626E−15 |
| A16 | 1.5041213E−15 | −6.4941847E−16 |
| A17 | −3.1420081E−17 | −6.4612439E−17 |
| A18 | −2.3225323E−17 | −1.4773721E−18 |
| A19 | 3.6534687E−19 | 9.3776158E−19 |
| A20 | 1.2917330E−19 | −3.4171804E−20 |

### Example 6

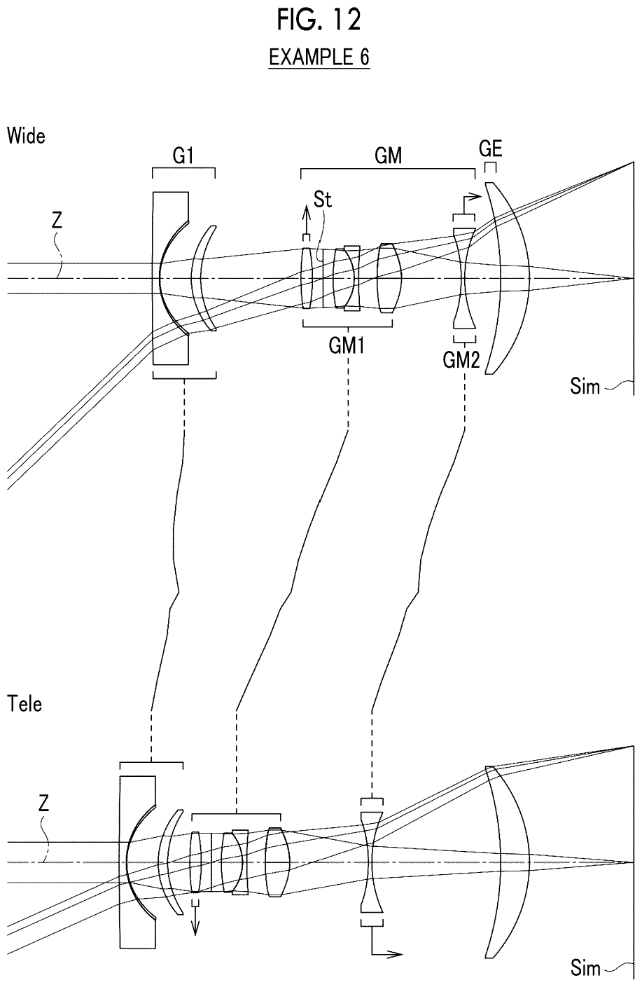

A configuration and a movement locus of a variable magnification optical system according to Example 6 are shown in FIG. 12. The variable magnification optical system according to Example 6 consists of, in order from the object side to the image side, the first lens group G1 having negative refractive power, the intermediate group GM, and the final lens group GE having positive refractive power. The lens closest to the object side of the first lens group G1 is a compound aspherical lens. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

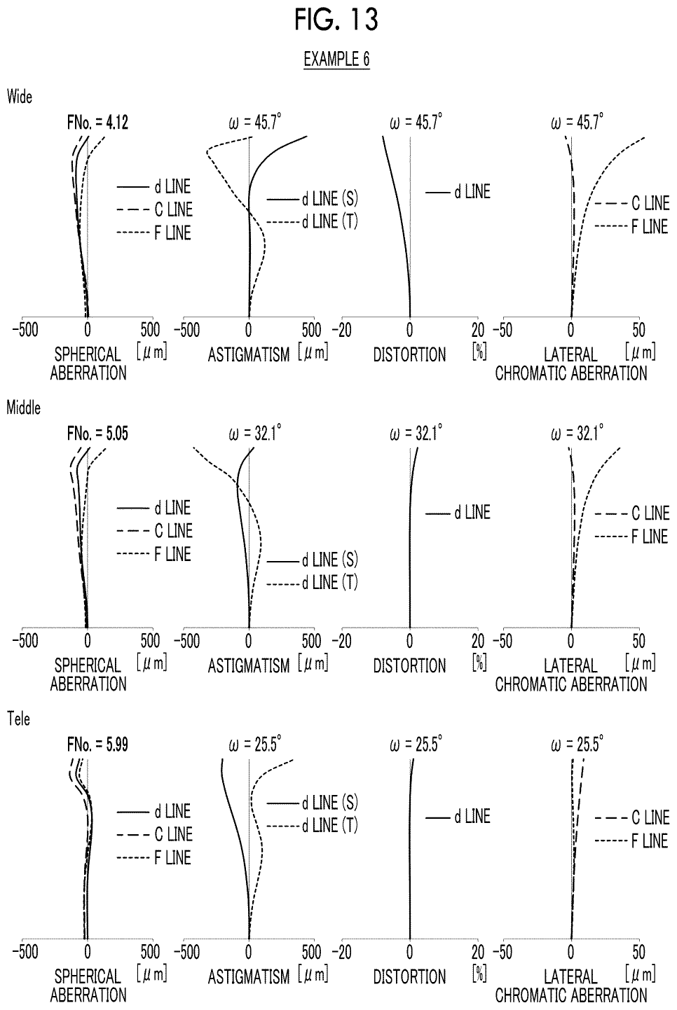

For the variable magnification optical system according to Example 6, basic lens data is shown in Table 16, specifications and variable surface spacings are shown in Table 17, aspherical coefficients are shown in Table 18, and each aberration diagram is shown in FIG. 13.

TABLE 16
Example 6

| | Sn | R | D | Nd | νd | θgF |
|---|---|---|---|---|---|---|
| | 1 | 719.5063 | 1.2498 | 1.64000 | 60.08 | 0.53704 |
| | 2 | 13.8651 | 0.0752 | 1.53409 | 55.87 | 0.55858 |
| | *3 | 12.1312 | 5.5002 | | | |
| | 4 | 15.5034 | 1.6404 | 1.95906 | 17.47 | 0.65993 |
| | 5 | 17.8118 | DD[5] | | | |
| Gois | *6 | 46.2835 | 1.9998 | 1.53409 | 55.87 | 0.55858 |
| | *7 | −30.8476 | 1.7498 | | | |
| | 8(St) | ∞ | 1.7498 | | | |
| | 9 | 30.9530 | 3.6994 | 1.52841 | 76.45 | 0.53954 |
| | 10 | −9.0036 | 0.7498 | 1.80400 | 46.53 | 0.55775 |
| | 11 | 73.4542 | 3.2255 | | | |
| | *12 | 39.0434 | 4.2502 | 1.49700 | 81.54 | 0.53748 |
| | *13 | −12.0802 | DD[13] | | | |
| Gfoc | *14 | −25.7002 | 0.6243 | 1.53409 | 55.87 | 0.55858 |
| | *15 | 26.5044 | DD[15] | | | |
| | 16 | −58.1383 | 5.0225 | 1.80400 | 46.53 | 0.55775 |
| | 17 | −28.0083 | 18.1800 | | | |

TABLE 17
Example 6

| | Wide | Middle | Tele |
|---|---|---|---|
| Zr | 1.0 | 1.5 | 2.0 |
| f | 23.00 | 33.80 | 44.85 |
| Bf | 18.18 | 18.18 | 18.18 |
| FNo. | 4.12 | 5.05 | 5.99 |
| 2ω[°] | 91.4 | 64.2 | 51.0 |
| DD[5] | 17.49 | 8.60 | 3.87 |
| DD[13] | 10.42 | 12.16 | 13.62 |
| DD[15] | 6.26 | 14.37 | 22.45 |

TABLE 18
Example 6

| Sn | 6 | 7 |
|---|---|---|
| KA | 1.0000000E+00 | 1.0000000E+00 |
| A4 | 4.7825062E−06 | −1.1251669E−06 |
| A6 | 7.2839867E−07 | 1.0213724E−06 |
| A8 | 1.2786576E−08 | −8.0183028E−10 |
| A10 | −1.4897245E−10 | 3.7483573E−10 |
| A12 | 2.0499124E−11 | −6.2158422E−12 |
| A14 | −2.4626100E−13 | 4.8261776E−13 |
| A16 | −6.7803651E−15 | −1.2284329E−14 |
| A18 | 1.9233465E−16 | 1.5921389E−16 |

| Sn | 3 | 12 | 13 |
|---|---|---|---|
| KA | 1.0000000E+00 | 1.0000000E+00 | 1.0000000E+00 |
| A4 | −1.8124853E−05 | 2.4267535E−05 | 7.4282888E−05 |
| A6 | −8.2384244E−08 | 7.9750465E−07 | 6.2398584E−07 |
| A8 | −3.0352167E−09 | 1.5291702E−08 | 1.7877234E−08 |
| A10 | 4.2203975E−11 | 3.4156663E−10 | 8.6937537E−11 |
| A12 | −4.6322032E−13 | −1.4232483E−11 | 6.9325114E−12 |
| A14 | 2.6951654E−15 | 5.0564471E−13 | −1.9829140E−13 |
| A16 | −1.0945499E−17 | −3.4344549E−15 | 5.3208647E−15 |

| Sn | 14 | 15 |
|---|---|---|
| KA | 1.0000000E+00 | 1.0000000E+00 |
| A3 | 0.0000000E+00 | 0.0000000E+00 |
| A4 | 1.6114539E−04 | 2.1164452E−04 |
| A5 | −2.5994654E−05 | −2.9282027E−05 |
| A6 | −1.6886165E−06 | −6.4607275E−07 |
| A7 | 2.8438614E−07 | 1.6404847E−07 |
| A8 | 2.5317449E−08 | 2.1113683E−08 |
| A9 | −1.5026184E−09 | −5.1076429E−10 |
| A10 | −4.0511331E−10 | 1.7732319E−12 |
| A11 | 1.2888391E−11 | −4.0318290E−11 |
| A12 | 2.6666782E−12 | −3.2639082E−12 |
| A13 | −2.8540933E−13 | 3.1146035E−13 |
| A14 | 2.3146207E−15 | 6.5323792E−14 |
| A15 | −6.6800695E−15 | 5.8651749E−15 |
| A16 | 2.0834199E−15 | −8.7114574E−16 |
| A17 | −9.4744280E−17 | −7.4555711E−17 |
| A18 | −1.6080843E−17 | 9.0606353E−19 |
| A19 | 3.7307035E−18 | 1.1388662E−18 |
| A20 | −2.6873431E−19 | −5.9826913E−20 |

### Example 7

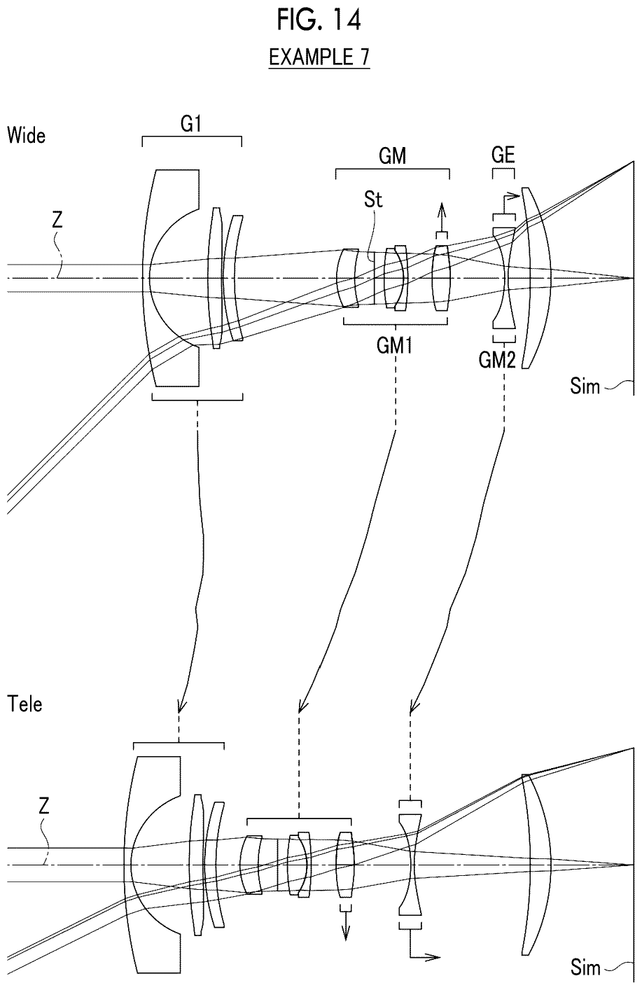

A configuration and a movement locus of a variable magnification optical system according to Example 7 are shown in FIG. 14. The variable magnification optical system according to Example 7 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the image side of the first intermediate lens group GM1.

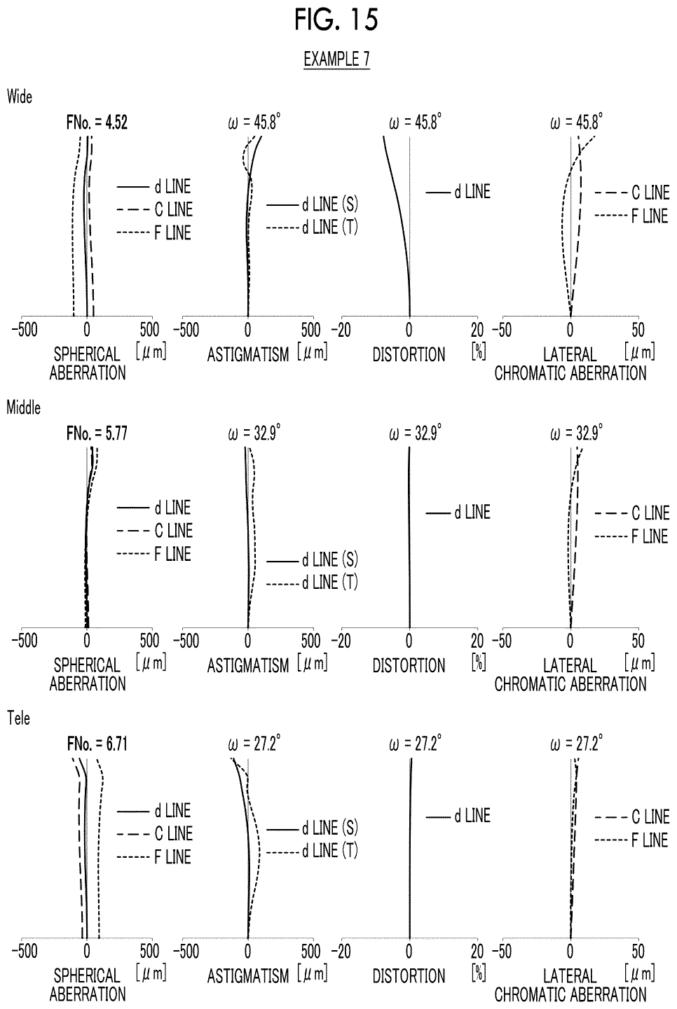

For the variable magnification optical system according to Example 7, basic lens data is shown in Table 19, specifications and variable surface spacings are shown in Table 20, aspherical coefficients are shown in Table 21, and each aberration diagram is shown in FIG. 15.

TABLE 19
Example 7

| | Sn | R | D | Nd | νd | θgF |
|---|---|---|---|---|---|---|
| | 1 | 83.3308 | 1.2498 | 1.64000 | 60.08 | 0.53704 |
| | 2 | 13.6650 | 10.4507 | | | |
| | *3 | 92.2529 | 2.4802 | 1.53409 | 55.87 | 0.55858 |
| | *4 | 194.9703 | 0.3000 | | | |
| | 5 | 38.3515 | 2.0000 | 1.95906 | 17.47 | 0.65993 |
| | 6 | 42.4186 | DD[6] | | | |
| | *7 | 12.4590 | 3.2502 | 1.53409 | 55.87 | 0.55858 |
| | *8 | 21.1748 | 3.5002 | | | |
| | 9(St) | ∞ | 1.7498 | | | |
| | 10 | 32.0136 | 3.5008 | 1.52841 | 76.45 | 0.53954 |
| | 11 | −9.3896 | 0.7498 | 1.80400 | 46.53 | 0.55775 |
| | 12 | −45.8760 | 4.3752 | | | |
| Gois | *13 | 34.3708 | 3.2502 | 1.49700 | 81.54 | 0.53748 |
| | *14 | −23.5806 | DD[14] | | | |
| Gfoc | *15 | −21.0854 | 0.6249 | 1.53409 | 55.87 | 0.55858 |
| | *16 | 25.2117 | DD[16] | | | |
| | 17 | −87.8747 | 3.6996 | 1.80400 | 46.53 | 0.55775 |
| | 18 | −36.4384 | 14.8200 | | | |

TABLE 20
Example 7

| | Wide | Middle | Tele |
|---|---|---|---|
| Zr | 1.0 | 1.5 | 1.8 |
| f | 22.80 | 33.51 | 41.95 |
| Bf | 14.82 | 14.82 | 14.82 |
| FNo. | 4.52 | 5.77 | 6.71 |
| 2ω[°] | 91.6 | 65.8 | 54.4 |
| DD[6] | 18.21 | 8.71 | 4.33 |
| DD[14] | 9.74 | 9.89 | 10.12 |
| DD[16] | 3.99 | 13.66 | 20.81 |

TABLE 21
Example 7

| Sn | 3 | 4 | 7 | 8 |
|---|---|---|---|---|
| KA | 1.0000000E+00 | 1.0000000E+00 | 1.0000000E+00 | 1.0000000E+00 |
| A4 | 1.3012797E−05 | −9.7402546E−06 | 3.5143782E−05 | 7.0203634E−05 |
| A6 | −1.6365831E−08 | −5.0938087E−08 | 4.4245827E−07 | 5.3448773E−07 |
| A8 | −4.5542314E−11 | −6.7107504E−10 | 4.5481370E−09 | 1.7175679E−10 |
| A10 | −2.5530129E−12 | 1.0837211E−12 | 1.4926519E−11 | −8.6849170E−11 |
| A12 | 9.6177918E−15 | −1.0814503E−14 | −4.3944474E−12 | −2.0215472E−12 |
| A14 | 1.8219937E−17 | 1.4069906E−16 | −1.0337186E−13 | 1.8712488E−13 |
| A16 | 1.1041481E−19 | −6.8964837E−19 | 1.0424716E−14 | −4.8732398E−15 |
| A18 | −2.0255839E−21 | −2.6493455E−22 | −1.5115575E−16 | 4.7721287E−17 |

| Sn | 13 | 14 |
|---|---|---|
| KA | 1.0000000E+00 | 1.0000000E+00 |
| A4 | 1.2696371E−04 | 1.5692009E−04 |
| A6 | 5.2882702E−07 | 2.4392112E−07 |
| A8 | 4.6108074E−09 | 2.4395838E−08 |
| A10 | 5.3365178E−10 | −2.9154833E−10 |
| A12 | −1.7659617E−11 | 8.1376278E−12 |
| A14 | 3.6693754E−13 | −9.1014781E−14 |
| A16 | −2.5480993E−15 | 1.2331765E−15 |
| Sn | 15 | 16 |
| KA | 1.0000000E+00 | 1.0000000E+00 |
| A3 | 0.0000000E+00 | 0.0000000E+00 |
| A4 | 1.9226977E−05 | 3.3157719E−05 |
| A5 | −1.7320196E−05 | −2.1029168E−05 |
| A6 | −2.2200314E−06 | −4.1102407E−07 |
| A7 | 2.5005673E−07 | 1.4185875E−07 |
| A8 | 2.4398643E−08 | 2.0268733E−08 |
| A9 | −1.1738470E−09 | −3.4247196E−10 |
| A10 | −3.9274003E−10 | 2.7099230E−11 |
| A11 | 9.7282287E−12 | −4.0205883E−11 |
| A12 | 2.9911933E−12 | −2.5014495E−12 |
| A13 | −3.2489469E−13 | 1.4820829E−13 |
| A14 | 5.7884304E−15 | 6.0047230E−14 |
| A15 | −2.8218550E−15 | 5.7150825E−15 |
| A16 | 1.4960081E−15 | −6.4990398E−16 |
| A17 | −3.0346560E−17 | −6.4448195E−17 |
| A18 | −2.2232008E−17 | −1.4561752E−18 |
| A19 | 4.0227893E−19 | 9.3579663E−19 |
| A20 | 1.1262576E−19 | −3.4341275E−20 |

### Example 8

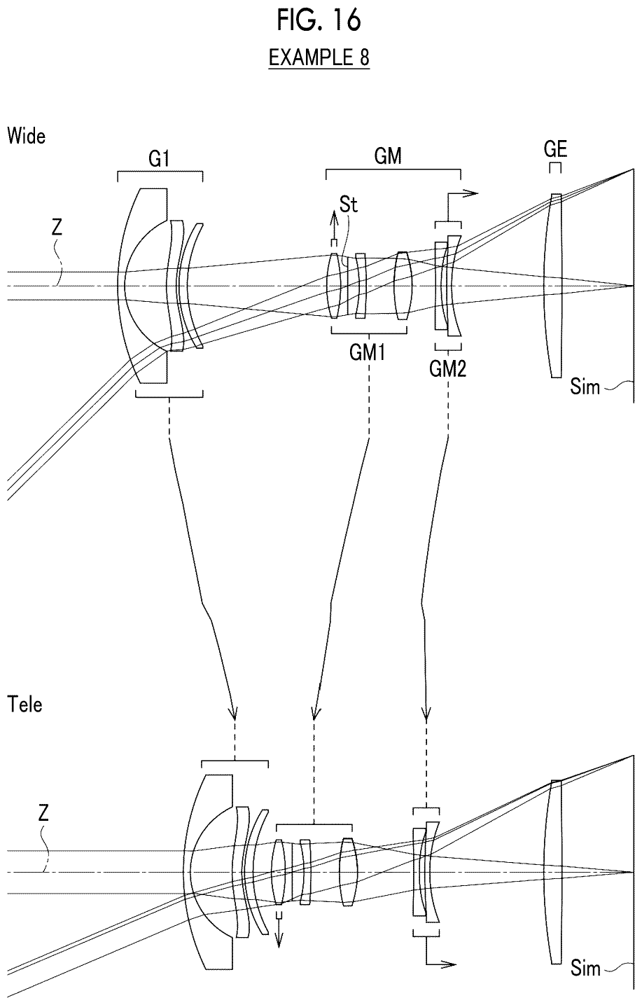

A configuration and a movement locus of a variable magnification optical system according to Example 8 are shown in FIG. 16. The variable magnification optical system according to Example 8 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

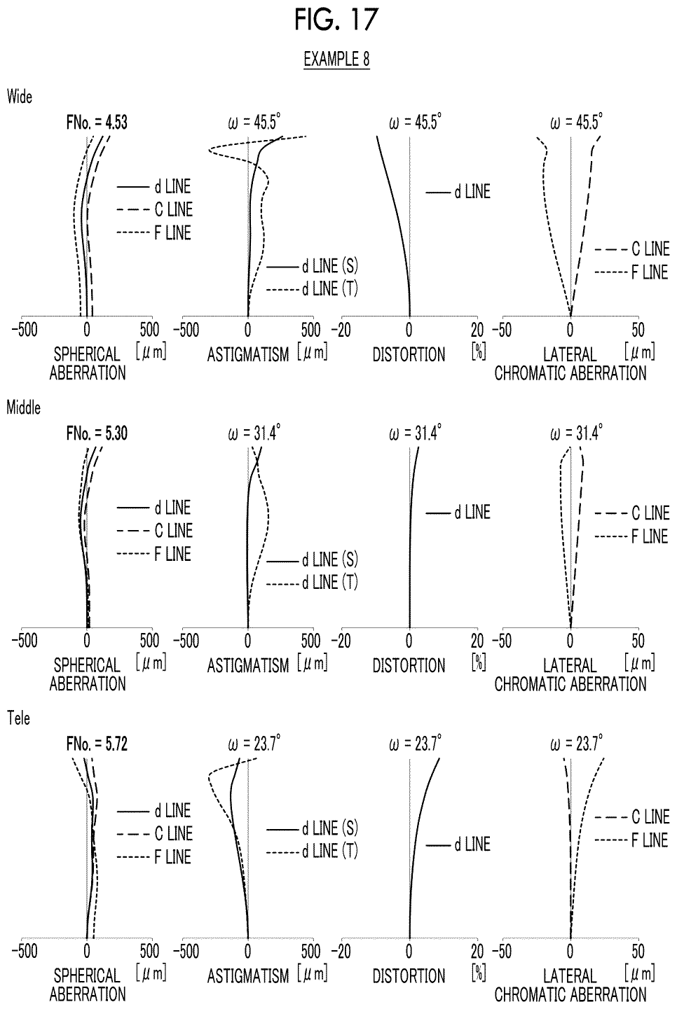

For the variable magnification optical system according to Example 8, basic lens data is shown in Table 22, specifications and variable surface spacings are shown in Table 23, aspherical coefficients are shown in Table 24, and each aberration diagram is shown in FIG. 17.

TABLE 22
Example 8

| | Sn | R | D | Nd | νd | θgF |
|---|---|---|---|---|---|---|
| | 1 | 42.0177 | 1.2500 | 1.64000 | 60.08 | 0.53704 |
| | 2 | 13.4552 | 7.5001 | | | |
| | *3 | 23.8220 | 1.7498 | 1.53409 | 55.87 | 0.55858 |
| | *4 | 18.5166 | 0.5000 | | | |
| | 5 | 22.3801 | 1.4998 | 1.95906 | 17.47 | 0.65993 |
| | 6 | 23.7055 | DD[6] | | | |
| Gois | *7 | 20.7904 | 2.4998 | 1.53409 | 55.87 | 0.55858 |
| | *8 | −25.5494 | 1.2498 | | | |
| | 9(St) | ∞ | 2.0938 | | | |
| | 10 | −23.2201 | 1.2498 | 2.00330 | 28.27 | 0.59802 |
| | 11 | −80.3997 | 5.0002 | | | |
| | *12 | 27.0339 | 3.2545 | 1.49700 | 81.54 | 0.53748 |
| | *13 | −18.3355 | DD[13] | | | |
| Gfoc | *14 | −125.0056 | 1.0002 | 1.53409 | 55.87 | 0.55858 |
| | *15 | 31.3256 | 1.0000 | | | |
| | 16 | 109.5629 | 0.8752 | 1.51680 | 64.20 | 0.53430 |
| | 17 | 25.6854 | DD[17] | | | |
| | 18 | 98.7151 | 3.2498 | 1.48749 | 70.32 | 0.52917 |
| | 19 | −1146.3926 | 12.8900 | | | |

TABLE 23
Example 8

| | Wide | Middle | Tele |
|---|---|---|---|
| Zr | 1.0 | 1.5 | 1.9 |
| f | 23.53 | 34.58 | 45.41 |
| Bf | 12.89 | 12.89 | 12.89 |
| FNo. | 4.53 | 5.29 | 5.71 |
| 2ω[°] | 91.0 | 62.8 | 47.4 |
| DD[6] | 24.92 | 12.11 | 3.31 |
| DD[13] | 4.20 | 6.28 | 10.10 |
| DD[17] | 16.55 | 21.35 | 20.48 |

TABLE 24
Example 8

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −1.4183670E−04 | −1.7679613E−04 | −1.0214615E−05 | 1.4725904E−05 |
| A6 | 2.1774733E−07 | 2.3423597E−07 | −3.8222846E−08 | −1.8935535E−07 |
| A8 | −7.6245494E−11 | −6.7715580E−10 | −4.8890500E−09 | 1.3560466E−08 |
| A10 | −3.7114393E−12 | 2.9894477E−12 | 2.8542060E−10 | −2.4730984E−10 |
| A12 | 1.1500739E−14 | −1.8466326E−14 | −1.0867001E−11 | −9.7895762E−12 |
| A14 | 4.5059815E−17 | 5.7388315E−17 | 1.4765524E−13 | 2.9269630E−13 |
| A16 | 1.2622778E−19 | −9.5981599E−19 | 2.3908434E−15 | 3.6324611E−15 |
| A18 | −4.6889694E−21 | 2.2595247E−21 | −4.9217685E−17 | −1.0842487E−16 |

| Sn | 12 | 13 |
|---|---|---|
| KA | 1.0000000E+00 | 1.0000000E+00 |
| A4 | −9.8850237E−06 | 4.9986335E−05 |
| A6 | −4.6578906E−08 | −4.9636701E−07 |
| A8 | 9.4879665E−09 | 4.2232170E−08 |
| A10 | 5.8358569E−10 | −6.8647716E−10 |
| A12 | −2.5068954E−11 | 3.0171178E−12 |
| A14 | 5.1066187E−13 | 1.5994751E−13 |
| A16 | −2.6434326E−15 | −4.1952596E−16 |
| Sn | 14 | 15 |
| KA | 1.0000000E+00 | 1.0000000E+00 |
| A3 | 0.0000000E+00 | 0.0000000E+00 |
| A4 | 1.6735690E−04 | 2.0935058E−04 |
| A5 | −2.1547658E−05 | −1.9920044E−05 |
| A6 | −1.2076243E−06 | −7.7591965E−07 |
| A7 | 2.6315290E−07 | 1.2071327E−07 |
| A8 | 2.3111656E−08 | 1.9539455E−08 |
| A9 | −1.7020495E−09 | −3.1895538E−10 |
| A10 | −4.9511786E−10 | 3.5110881E−11 |
| A11 | 4.9610682E−12 | −3.9272734E−11 |
| A12 | 3.9257225E−12 | −2.4074711E−12 |
| A13 | 2.5061598E−14 | 1.5989261E−13 |
| A14 | 5.2496704E−14 | 6.0272298E−14 |
| A15 | 1.1724017E−15 | 5.6224995E−15 |
| A16 | 2.9350402E−16 | −6.4756590E−16 |
| A17 | −2.8930028E−16 | −6.5900234E−17 |
| A18 | 9.9970989E−18 | −1.6472299E−18 |
| A19 | −1.3228401E−18 | 9.5374312E−19 |
| A20 | 2.8334955E−19 | −3.0712043E−20 |

### Example 9

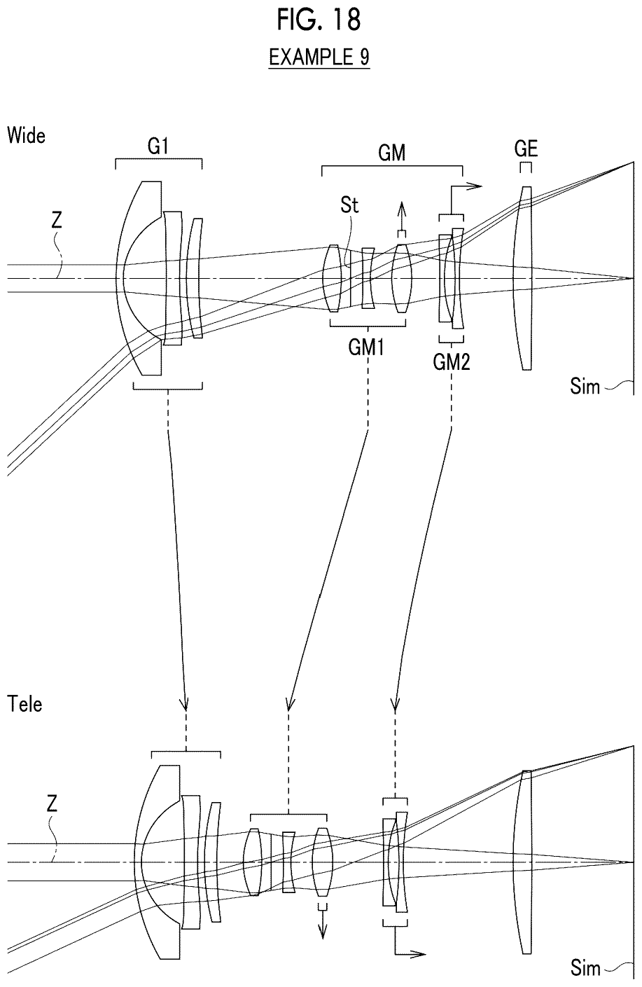

A configuration and a movement locus of a variable magnification optical system according to Example 9 are shown in FIG. 18. The variable magnification optical system according to Example 9 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the image side of the first intermediate lens group GM1.

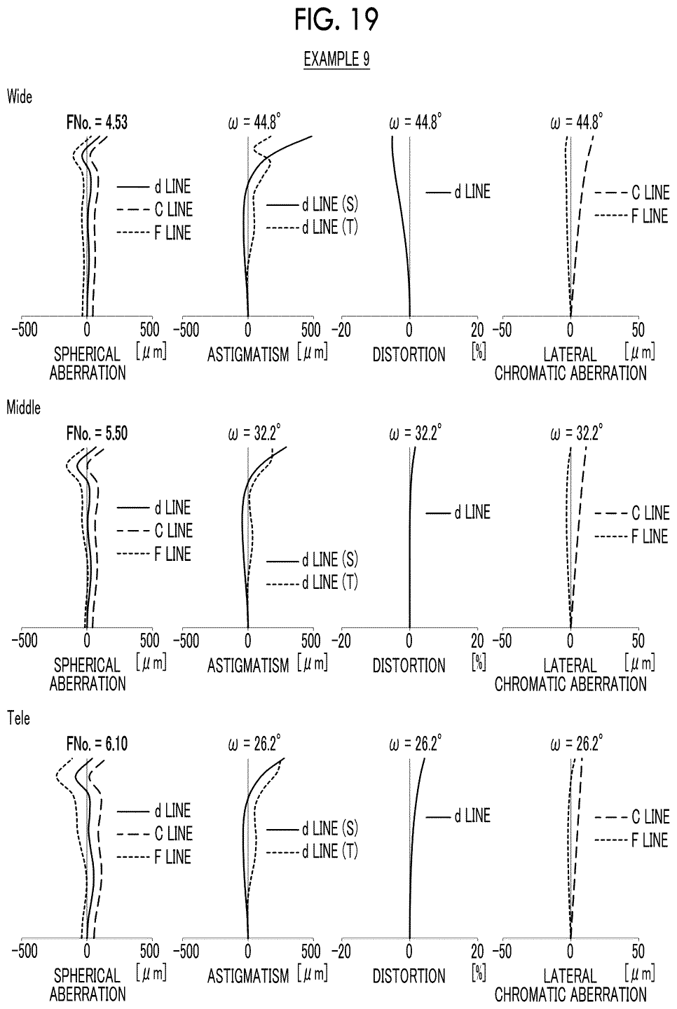

For the variable magnification optical system according to Example 9, basic lens data is shown in Table 25, specifications and variable surface spacings are shown in Table 26, aspherical coefficients are shown in Table 27, and each aberration diagram is shown in FIG. 19.

TABLE 25
Example 9

| | Sn | R | D | Nd | νd | θgF |
|---|---|---|---|---|---|---|
| | 1 | 37.8788 | 1.2500 | 1.77535 | 50.30 | 0.55004 |
| | 2 | 13.0921 | 7.5000 | | | |
| | *3 | −283.7904 | 2.3195 | 1.53409 | 55.87 | 0.55858 |
| | *4 | 68.1471 | 1.2000 | | | |
| | 5 | 46.9785 | 2.1639 | 1.95906 | 17.47 | 0.65993 |
| | 6 | 90.8283 | DD[6] | | | |
| | *7 | 14.5091 | 3.2269 | 1.53409 | 55.87 | 0.55858 |
| | *8 | −31.0109 | 1.6281 | | | |
| | 9(St) | ∞ | 2.1434 | | | |
| | 10 | −134.2472 | 1.3311 | 2.00330 | 28.27 | 0.59802 |
| | 11 | 22.0954 | 3.7363 | | | |
| Gois | *12 | 18.3789 | 3.4823 | 1.48749 | 70.32 | 0.52917 |
| | *13 | −18.0167 | DD[13] | | | |
| Gfoc | *14 | −122.0238 | 0.8106 | 1.53409 | 55.87 | 0.55858 |
| | *15 | 30.1593 | 1.8695 | | | |
| | 16 | −62.2586 | 0.7500 | 1.48749 | 70.32 | 0.52917 |
| | 17 | 59.5338 | DD[17] | | | |
| | 18 | 84.2607 | 3.2500 | 1.83481 | 42.74 | 0.56490 |
| | 19 | −1320.3680 | 17.8200 | | | |

TABLE 26
Example 9

| | Wide | Middle | Tele |
|---|---|---|---|
| Zr | 1.0 | 1.5 | 1.8 |
| f | 22.99 | 33.80 | 42.08 |
| Bf | 17.82 | 17.82 | 17.82 |
| FNo. | 4.53 | 5.50 | 6.09 |
| 2ω[°] | 89.6 | 64.4 | 52.4 |
| DD[6] | 21.58 | 10.43 | 4.62 |
| DD[13] | 4.91 | 6.79 | 8.89 |
| DD[17] | 9.38 | 16.49 | 19.19 |

TABLE 27
Example 9

| Sn | 3 | 4 | 7 | 8 |
|---|---|---|---|---|
| KA | 1.0000000E+00 | 1.0000000E+00 | 1.0000000E+00 | 1.0000000E+00 |
| A4 | 1.2122640E−05 | −1.0145117E−05 | −3.9997674E−05 | 2.4143030E−05 |
| A6 | −8.1694174E−08 | −9.0367010E−08 | −3.7824110E−07 | −7.8274680E−07 |
| A8 | 4.8683535E−10 | −7.7455076E−10 | −1.5115664E−08 | 1.2764856E−08 |
| A10 | −6.2146788E−12 | 2.6301297E−12 | 2.3457660E−10 | −2.3074603E−10 |
| A12 | 1.2837781E−14 | −1.5479242E−14 | −5.9213503E−12 | −1.5376083E−11 |
| A14 | 9.2713924E−17 | 5.5373655E−17 | 2.7819632E−13 | 2.0614567E−13 |
| A16 | 2.6299784E−19 | −1.1279242E−18 | −1.3166678E−14 | 2.7956870E−15 |
| A18 | −8.0299248E−21 | 2.0030726E−21 | 1.1929053E−16 | −8.4897132E−17 |

| Sn | 12 | 13 |
|---|---|---|
| KA | 1.0000000E+00 | 1.0000000E+00 |
| A4 | −3.2623800E−05 | 4.3813391E−05 |
| A6 | 3.2308686E−08 | −5.7147872E−07 |
| A8 | 2.9542480E−09 | 4.1394814E−08 |
| A10 | 5.1753868E−10 | −6.8138719E−10 |
| A12 | −2.5999433E−11 | 1.2513930E−12 |
| A14 | 4.9667508E−13 | 7.7116323E−14 |
| A16 | −1.9432616E−15 | 1.1643642E−15 |
| Sn | 14 | 15 |
| KA | 1.0000000E+00 | 1.0000000E+00 |
| A3 | 0.0000000E+00 | 0.0000000E+00 |
| A4 | 1.6107968E−04 | 2.0935058E−04 |
| A5 | −2.2651524E−05 | −1.9920044E−05 |
| A6 | −9.2047526E−07 | −7.7591965E−07 |
| A7 | 2.4376475E−07 | 1.2071327E−07 |
| A8 | 1.8607460E−08 | 1.9539455E−08 |
| A9 | −2.0415683E−09 | −3.1895538E−10 |
| A10 | −4.7645071E−10 | 3.5110881E−11 |
| A11 | 1.5450684E−11 | −3.9272734E−11 |
| A12 | 5.6184504E−12 | −2.4074711E−12 |
| A13 | 1.9234832E−13 | 1.5989261E−13 |
| A14 | 4.7474601E−14 | 6.0272298E−14 |
| A15 | −4.8132656E−15 | 5.6224995E−15 |
| A16 | −1.3103661E−15 | −6.4756590E−16 |
| A17 | −2.3338764E−16 | −6.5900234E−17 |
| A18 | 4.6093387E−17 | −1.6472299E−18 |
| A19 | −3.1512716E−18 | 9.5374312E−19 |
| A20 | 2.4965928E−19 | −3.0712043E−20 |

### Example 10

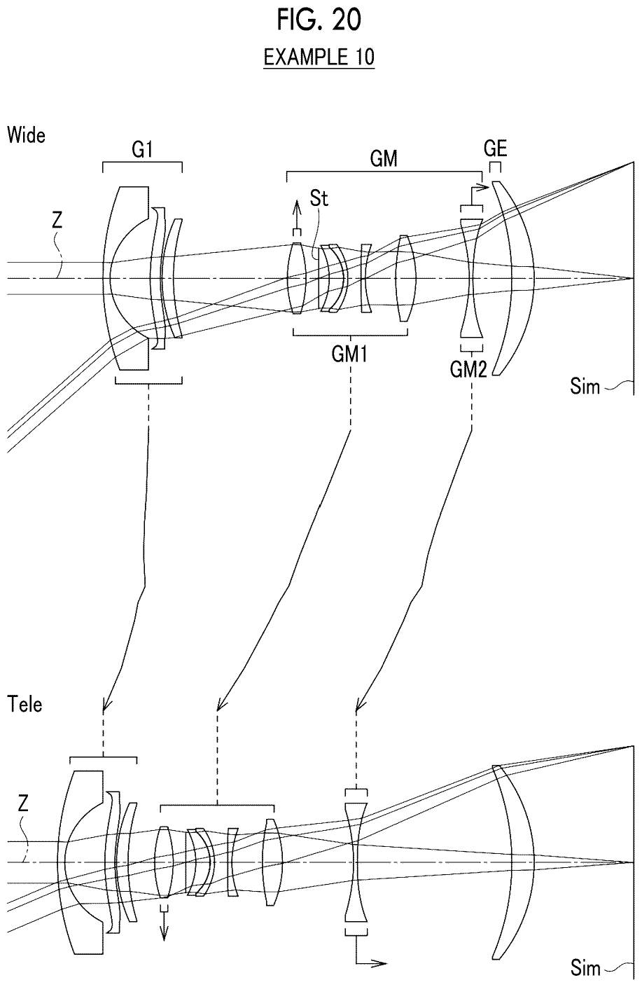

A configuration and a movement locus of a variable magnification optical system according to Example 10 are shown in FIG. 20. The variable magnification optical system according to Example 10 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

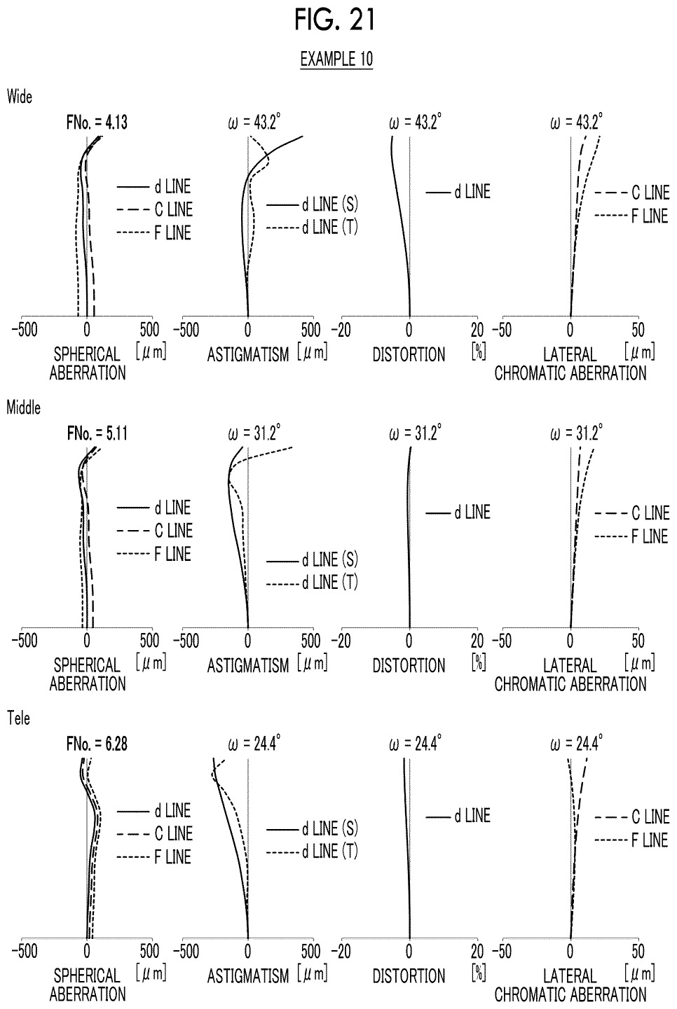

For the variable magnification optical system according to Example 10, basic lens data is shown in Table 28, specifications and variable surface spacings are shown in Table 29, aspherical coefficients are shown in Table 30, and each aberration diagram is shown in FIG. 21.

TABLE 28
Example 10

| | Sn | R | D | Nd | νd | θgF |
|---|---|---|---|---|---|---|
| | 1 | 50.5056 | 1.2498 | 1.77535 | 50.30 | 0.55004 |
| | 2 | 12.5660 | 7.0175 | | | |
| | *3 | 36.1260 | 1.7560 | 1.53409 | 55.87 | 0.55858 |
| | *4 | 31.6223 | 0.3000 | | | |
| | 5 | 28.0977 | 2.0000 | 1.95906 | 17.47 | 0.65993 |
| | 6 | 39.0098 | DD[6] | | | |
| Gois | *7 | 21.3569 | 3.2481 | 1.53409 | 55.87 | 0.55858 |
| | *8 | −21.6194 | 2.2062 | | | |
| | 9(St) | ∞ | 1.7498 | | | |
| | 10 | −13.3811 | 2.5099 | 1.52841 | 76.45 | 0.53954 |
| | 11 | −7.9610 | 0.7498 | 1.80400 | 46.53 | 0.55775 |
| | 12 | −11.1979 | 2.3058 | | | |
| | 13 | 213.7263 | 0.7499 | 1.84666 | 23.78 | 0.62054 |
| | 14 | 18.8286 | 5.3215 | | | |
| | 15 | 36.5631 | 3.5186 | 1.54072 | 47.23 | 0.56511 |
| | 16 | −21.2267 | DD[16] | | | |
| Gfoc | *17 | −26.9548 | 0.6471 | 1.53409 | 55.87 | 0.55858 |
| | *18 | 69.6639 | DD[18] | | | |
| | 19 | −47.1690 | 3.9001 | 1.80400 | 46.53 | 0.55775 |
| | 20 | −29.6412 | 17.3900 | | | |

TABLE 29
Example 10

| | Wide | Middle | Tele |
|---|---|---|---|
| Zr | 1.0 | 1.5 | 2.0 |
| f | 24.28 | 35.69 | 48.56 |
| Bf | 17.39 | 17.39 | 17.39 |
| FNo. | 4.13 | 5.11 | 6.28 |
| 2ω[°] | 86.4 | 62.4 | 48.8 |
| DD[6] | 19.92 | 9.80 | 4.63 |
| DD[16] | 9.33 | 11.31 | 12.32 |
| DD[18] | 6.79 | 15.53 | 27.01 |

TABLE 30
Example 10

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −4.1394107E−05 | −7.2337465E−05 | −1.9770008E−05 | 4.1623653E−05 |
| A6 | 2.3417825E−07 | 2.7255251E−07 | 3.6538257E−07 | 8.0954811E−08 |
| A8 | −3.9703667E−10 | −3.5005353E−09 | −2.7179510E−08 | −5.3862588E−09 |
| A10 | −1.8386507E−11 | 9.3758873E−12 | 8.3377191E−10 | −8.9582261E−11 |
| A12 | 5.7831229E−14 | −5.3062093E−14 | −3.9158992E−12 | 4.8241525E−12 |
| A14 | 5.2768077E−16 | 3.3160306E−16 | −2.2911677E−13 | 2.0909598E−13 |
| A16 | 2.2550996E−18 | 4.3666382E−18 | 3.4835746E−15 | −9.5694789E−15 |
| A18 | −3.4893536E−20 | −4.2100211E−20 | −1.3973711E−17 | 9.0095463E−17 |

| Sn | 17 | 18 |
|---|---|---|
| KA | 1.0000000E+00 | 1.0000000E+00 |
| A3 | 0.0000000E+00 | 0.0000000E+00 |
| A4 | 2.3268555E−04 | 2.5006431E−04 |
| A5 | −2.4358211E−05 | −2.3152208E−05 |
| A6 | −1.5411551E−06 | −1.6843864E−06 |
| A7 | 1.7446557E−07 | 1.4395860E−07 |
| A8 | 1.9823030E−08 | 2.6674995E−08 |
| A9 | 1.2976333E−10 | −2.9271934E−10 |
| A10 | −2.3812462E−10 | 4.9330821E−11 |
| A11 | 9.7270056E−12 | −4.1116720E−11 |
| A12 | 1.3019107E−12 | −3.0902772E−12 |
| A13 | −5.7456701E−13 | 1.5333626E−13 |
| A14 | −2.1455782E−16 | 6.2421374E−14 |
| A15 | −2.1769737E−15 | 5.3513960E−15 |
| A16 | 1.6293623E−15 | −6.5143226E−16 |
| A17 | 4.6077466E−18 | −6.0710387E−17 |
| A18 | −1.3553505E−17 | −1.1826634E−18 |
| A19 | −3.5097989E−19 | 9.7755918E−19 |
| A20 | 6.6013894E−20 | −4.1221601E−20 |

### Example 11

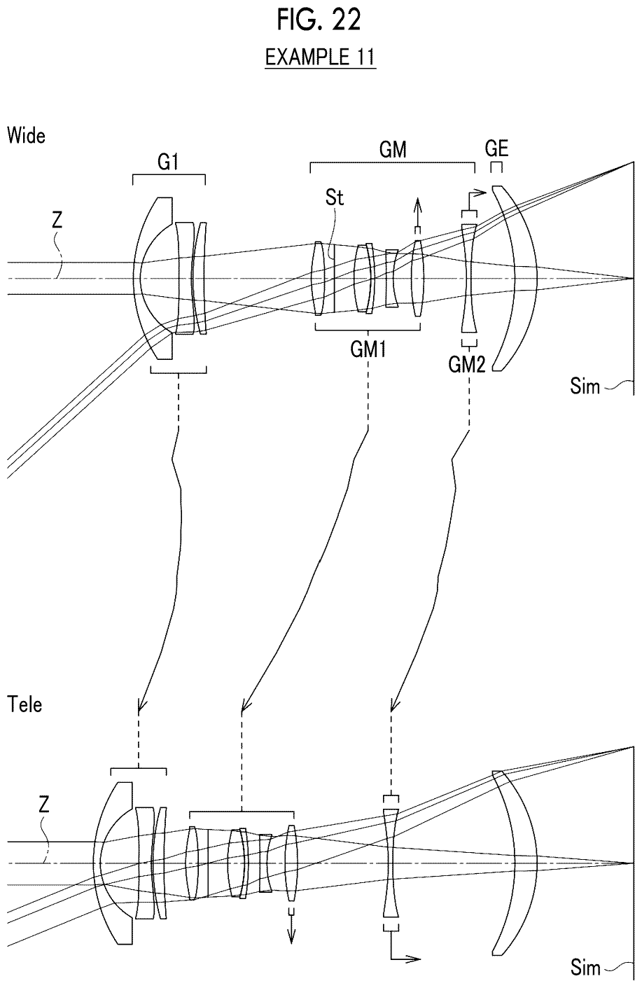

A configuration and a movement locus of a variable magnification optical system according to Example 11 are shown in FIG. 22. The variable magnification optical system according to Example 11 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the image side of the first intermediate lens group GM1.

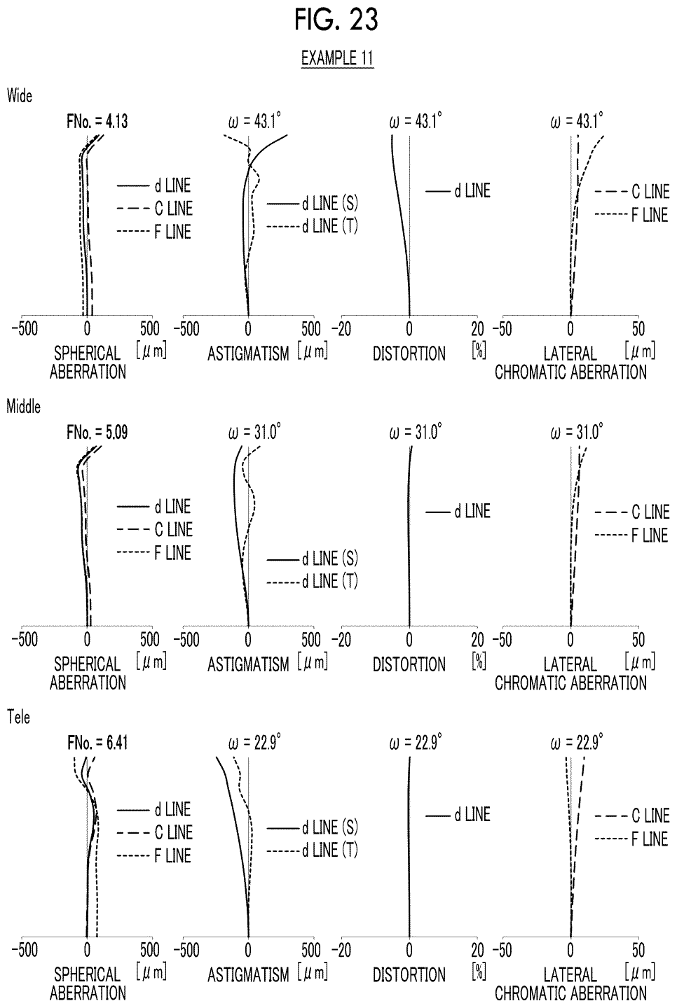

For the variable magnification optical system according to Example 11, basic lens data is shown in Table 31, specifications and variable surface spacings are shown in Table 32, aspherical coefficients are shown in Table 33, and each aberration diagram is shown in FIG. 23.

TABLE 31
Example 11

| | Sn | R | D | Nd | νd | θgF |
|---|---|---|---|---|---|---|
| | 1 | 27.8183 | 1.2498 | 1.89190 | 37.13 | 0.57813 |
| | 2 | 11.7476 | 6.9344 | | | |
| | *3 | 348.7114 | 2.2498 | 1.53409 | 55.87 | 0.55858 |
| | *4 | 33.9060 | 0.3000 | | | |
| | 5 | 40.3120 | 1.9749 | 1.95906 | 17.47 | 0.65993 |
| | 6 | 131.4985 | DD[6] | | | |
| | *7 | 23.4275 | 2.2780 | 1.53409 | 55.87 | 0.55858 |
| | *8 | −48.6860 | 1.7500 | | | |
| | 9(St) | ∞ | 3.5252 | | | |
| | 10 | 24.8734 | 3.0352 | 1.52841 | 76.45 | 0.53954 |
| | 11 | −24.2952 | 0.7025 | 1.80400 | 46.53 | 0.55775 |
| | 12 | −41.0854 | 2.0752 | | | |
| | 13 | −425.8217 | 1.2500 | 1.84666 | 23.78 | 0.62054 |
| | 14 | 15.5811 | 3.2502 | | | |
| Gois | 15 | 33.1540 | 2.2752 | 1.63852 | 34.39 | 0.58800 |
| | 16 | −38.5467 | DD[16] | | | |
| Gfoc | *17 | −45.2804 | 0.8176 | 1.53409 | 55.87 | 0.55858 |
| | *18 | 76.0491 | DD[18] | | | |
| | 19 | −35.1642 | 4.0002 | 1.83664 | 44.97 | 0.55713 |
| | 20 | −26.1625 | 17.3800 | | | |

TABLE 32
Example 11

| | Wide | Middle | Tele |
|---|---|---|---|
| Zr | 1.0 | 1.5 | 2.1 |
| f | 24.36 | 35.80 | 51.15 |
| Bf | 17.38 | 17.38 | 17.38 |
| FNo. | 4.13 | 5.08 | 6.40 |
| 2ω[°] | 86.2 | 62.0 | 45.8 |
| DD[6] | 19.32 | 9.78 | 3.89 |
| DD[16] | 7.65 | 11.91 | 16.21 |
| DD[18] | 7.91 | 13.48 | 21.96 |

TABLE 33
Example 11

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −1.0125571E−04 | −1.3668821E−04 | −5.5654780E−05 | −3.1369257E−05 |
| A6 | 5.4571426E−07 | 7.0038857E−07 | −8.7536994E−08 | −2.3635596E−07 |
| A8 | 9.9402777E−10 | −4.3846791E−09 | −2.1409670E−08 | −5.4269527E−09 |
| A10 | −5.9895476E−11 | −5.2548521E−12 | 3.5877615E−11 | −5.9702760E−10 |
| A12 | 2.0577424E−13 | 1.0897636E−15 | −2.2229505E−12 | 2.0263210E−12 |
| A14 | 2.1728080E−15 | 1.5021650E−15 | −8.3949840E−14 | 3.6902967E−13 |
| A16 | −9.5838713E−18 | −1.0600410E−17 | 4.4441905E−15 | −9.0173822E−15 |
| A18 | −5.2505859E−20 | 2.0530182E−21 | −8.7326997E−17 | 3.5278989E−17 |

| Sn | 17 | 18 |
|---|---|---|
| KA | 1.0000000E+00 | 1.0000000E+00 |
| A3 | 0.0000000E+00 | 0.0000000E+00 |
| A4 | 9.2402768E−06 | 3.2399819E−05 |
| A5 | 2.5106184E−06 | 4.1495425E−06 |
| A6 | −6.6827279E−07 | −1.1402454E−06 |
| A7 | 2.6200282E−08 | 7.8727425E−08 |
| A8 | 1.6949128E−08 | 1.4142276E−08 |
| A9 | −4.6240535E−12 | −7.0146878E−10 |
| A10 | −2.2553833E−10 | 4.9927757E−11 |
| A11 | 1.1269014E−12 | −3.5561428E−11 |
| A12 | 6.9234638E−13 | −2.0932476E−12 |
| A13 | −5.1332707E−13 | 1.7249331E−13 |
| A14 | 1.2211039E−14 | 5.9052183E−14 |
| A15 | 3.5566078E−16 | 5.3327290E−15 |
| A16 | 1.7201926E−15 | −7.0889666E−16 |
| A17 | 3.1075467E−18 | −6.1955160E−17 |
| A18 | −1.9406425E−17 | −9.8613698E−19 |
| A19 | −5.7774976E−19 | 9.6015830E−19 |
| A20 | 1.1283742E−19 | −3.8630155E−20 |

### Example 12

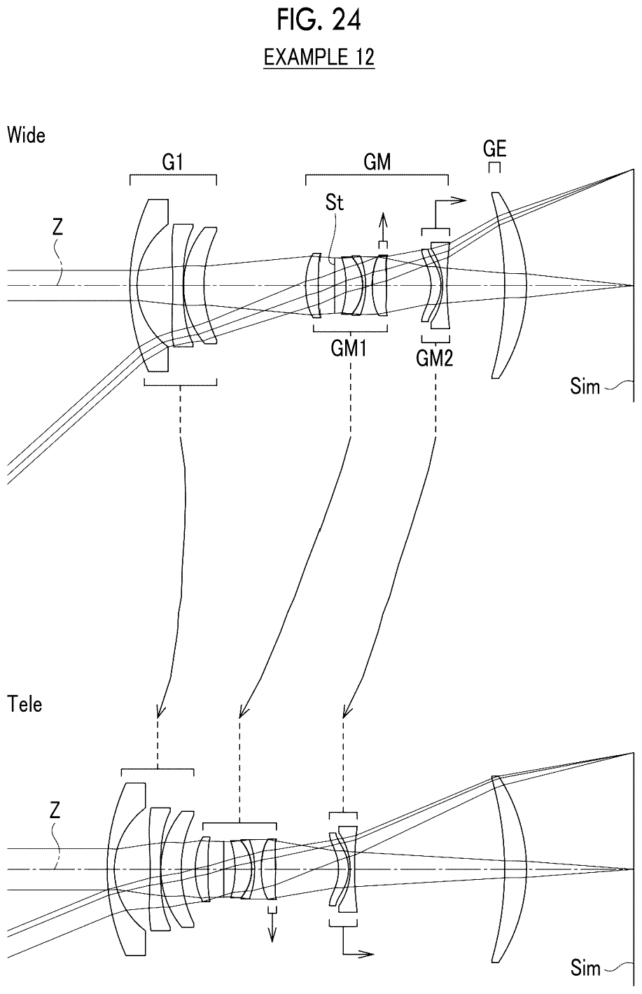

A configuration and a movement locus of a variable magnification optical system according to Example 12 are shown in FIG. 24. The variable magnification optical system according to Example 12 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the image side of the first intermediate lens group GM1.

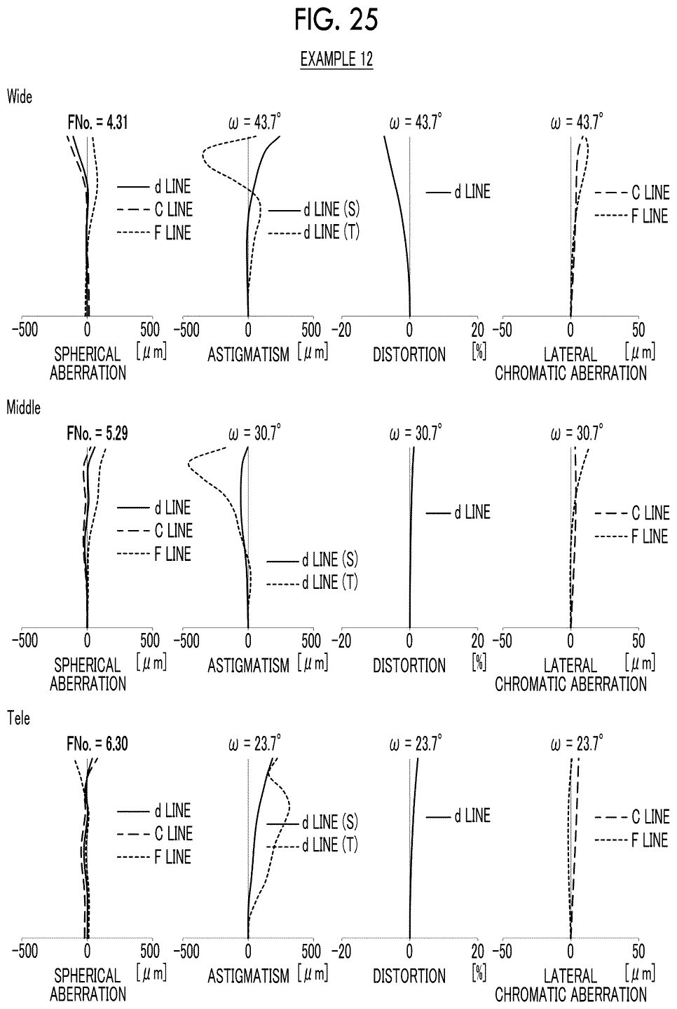

For the variable magnification optical system according to Example 12, basic lens data is shown in Table 34, specifications and variable surface spacings are shown in Table 35, aspherical coefficients are shown in Table 36, and each aberration diagram is shown in FIG. 25.

TABLE 34
Example 12

| | Sn | R | D | Nd | νd | θgF |
|---|---|---|---|---|---|---|
| | 1 | 40.7920 | 1.2498 | 1.90525 | 35.04 | 0.58486 |
| | 2 | 14.7059 | 6.2498 | | | |
| | *3 | −71.2096 | 1.8264 | 1.53409 | 55.87 | 0.55858 |
| | *4 | 92.8933 | 0.0500 | | | |
| | 5 | 17.5826 | 3.5582 | 1.95906 | 17.47 | 0.65993 |
| | 6 | 24.0093 | DD[6] | | | |
| | *7 | 17.4579 | 2.2198 | 1.53409 | 55.87 | 0.55858 |
| | *8 | 205.3834 | 2.7502 | | | |
| | 9(St) | ∞ | 2.0002 | | | |
| | 10 | −18.2248 | 2.8994 | 1.52841 | 76.45 | 0.53954 |
| | 11 | −8.4052 | 0.5248 | 1.70444 | 31.60 | 0.59493 |
| | 12 | −16.3314 | 1.1485 | | | |
| Gois | *13 | 19.4449 | 2.5000 | 1.49700 | 81.54 | 0.53748 |
| | *14 | −50.1780 | DD[14] | | | |
| Gfoc | *15 | −9.2055 | 1.7452 | 1.53409 | 55.87 | 0.55858 |
| | *16 | −7.4447 | 0.2971 | | | |
| | 17 | −12.5742 | 0.7500 | 1.51680 | 64.20 | 0.53430 |
| | 18 | 69.1858 | DD[18] | | | |
| | 19 | −64.9883 | 3.8258 | 1.80400 | 46.53 | 0.55775 |
| | 20 | −33.1125 | 18.7400 | | | |

TABLE 35
Example 12

| | Wide | Middle | Tele |
|---|---|---|---|
| Zr | 1.0 | 1.5 | 2.0 |
| f | 24.46 | 35.95 | 48.18 |
| Bf | 18.74 | 18.74 | 18.74 |
| FNo. | 4.31 | 5.29 | 6.30 |
| 2ω[°] | 87.4 | 61.4 | 47.4 |
| DD[6] | 17.78 | 7.93 | 2.46 |
| DD[14] | 7.76 | 9.38 | 10.91 |
| DD[18] | 10.07 | 18.13 | 26.22 |

TABLE 36
Example 12

| Sn | 3 | 4 | 7 | 8 |
|---|---|---|---|---|
| KA | 1.0000000E+00 | 1.0000000E+00 | 1.0000000E+00 | 1.0000000E+00 |
| A4 | 1.0531154E−04 | 1.1337945E−04 | 1.2892094E−04 | 1.5895758E−04 |
| A6 | −6.4345460E−07 | −5.3420743E−07 | 9.1267240E−07 | 9.7221856E−07 |
| A8 | 3.2043681E−09 | 2.0143588E−09 | 2.9351409E−08 | 2.2954681E−08 |
| A10 | 1.6603548E−13 | 8.6786730E−12 | 2.3196434E−10 | 2.9534815E−10 |
| A12 | −6.6015019E−14 | −7.8980190E−14 | 2.5156118E−12 | −4.3726010E−12 |
| A14 | 3.4384557E−17 | −5.5840758E−17 | −2.5274154E−13 | 8.7495849E−14 |
| A16 | 2.1909504E−18 | 2.2150102E−18 | 3.6337274E−15 | −1.9056251E−15 |
| A18 | −7.4673444E−21 | −7.2670053E−21 | 7.1052804E−17 | 1.3627450E−16 |

| Sn | 13 | 14 |
|---|---|---|
| KA | 1.0000000E+00 | 1.0000000E+00 |
| A4 | 2.0723320E−04 | 2.3564533E−04 |
| A6 | 2.5571427E−06 | 2.1317935E−06 |
| A8 | 1.2839438E−08 | 1.3963667E−07 |
| A10 | 3.8851345E−09 | −2.2397388E−09 |
| A12 | −9.1604710E−11 | 1.4541973E−10 |
| A14 | 2.1971463E−13 | −5.4417503E−12 |
| A16 | 3.0219437E−14 | 1.0903928E−13 |
| Sn | 15 | 16 |
| KA | 1.0000000E+00 | 1.0000000E+00 |
| A3 | 0.0000000E+00 | 0.0000000E+00 |
| A4 | 1.8925977E−04 | 3.2954753E−04 |
| A5 | −1.3182817E−06 | 9.2858956E−06 |
| A6 | 4.1537255E−06 | 1.2230006E−06 |
| A7 | 4.2456080E−07 | 7.2517864E−07 |
| A8 | 4.1122401E−08 | 7.0264160E−08 |
| A9 | 3.2277734E−09 | 9.5420217E−09 |
| A10 | 1.0028715E−09 | −2.7682362E−10 |
| A11 | 1.4440343E−10 | −9.0055787E−11 |
| A12 | 1.9495983E−11 | 4.6634440E−12 |
| A13 | −3.1814620E−12 | 2.3677849E−12 |
| A14 | −8.5717331E−13 | 4.2883449E−13 |
| A15 | −1.1850186E−13 | 7.0875503E−14 |
| A16 | −1.0226080E−14 | 1.8784456E−15 |
| A17 | −1.4272505E−16 | −2.3236691E−15 |
| A18 | 9.1487455E−16 | −2.7742268E−16 |
| A19 | 5.8775120E−17 | −6.9689702E−17 |
| A20 | −1.4500073E−17 | 1.5639822E−17 |

### Example 13

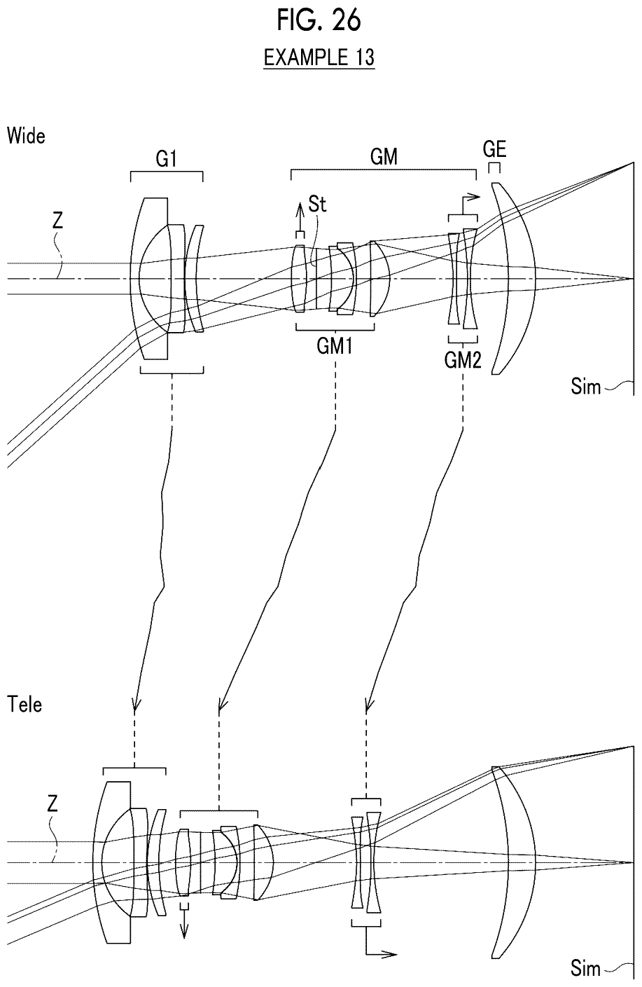

A configuration and a movement locus of a variable magnification optical system according to Example 13 are shown in FIG. 26. The variable magnification optical system according to Example 13 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

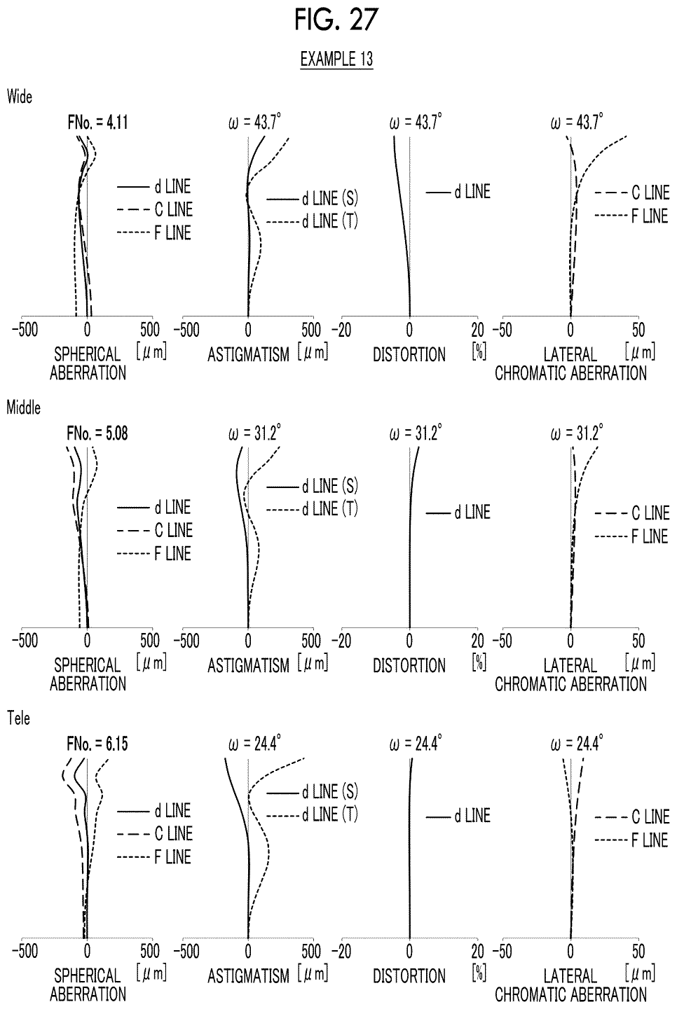

For the variable magnification optical system according to Example 13, basic lens data is shown in Table 37, specifications and variable surface spacings are shown in Table 38, aspherical coefficients are shown in Table 39, and each aberration diagram is shown in FIG. 27.

TABLE 37
Example 13

| | Sn | R | D | Nd | νd | θgF |
|---|---|---|---|---|---|---|
| | 1 | 46.6292 | 1.5502 | 1.77535 | 50.30 | 0.55004 |
| | 2 | 12.5000 | 5.6248 | | | |
| | *3 | −452.5321 | 2.2500 | 1.53409 | 55.87 | 0.55858 |
| | *4 | 81.7816 | 0.1000 | | | |
| | 5 | 26.3706 | 2.0000 | 1.95906 | 17.47 | 0.65993 |
| | 6 | 37.1555 | DD[6] | | | |
| Gois | *7 | 36.1521 | 2.6454 | 1.53409 | 55.87 | 0.55858 |
| | *8 | −26.6845 | 1.7498 | | | |
| | 9(St) | ∞ | 2.5124 | | | |
| | 10 | −39.0087 | 3.8373 | 1.52841 | 76.45 | 0.53954 |
| | 11 | −7.0787 | 0.5249 | 1.80400 | 46.53 | 0.55775 |
| | 12 | −33.0458 | 2.4724 | | | |
| | *13 | 4211.3681 | 3.3502 | 1.49700 | 81.54 | 0.53748 |
| | *14 | −9.8529 | DD[14] | | | |
| Gfoc | *15 | −25.0722 | 0.6248 | 1.53409 | 55.87 | 0.55858 |
| | *16 | −108.2275 | 1.8773 | | | |
| | 17 | −54.8537 | 0.4998 | 1.56377 | 55.89 | 0.55140 |
| | 18 | 36.0160 | DD[18] | | | |
| | 19 | −52.8007 | 4.7502 | 1.80400 | 46.53 | 0.55775 |
| | 20 | −27.9130 | 17.1400 | | | |

TABLE 38
Example 13

| | Wide | Middle | Tele |
|---|---|---|---|
| Zr | 1.0 | 1.5 | 2.0 |
| f | 23.72 | 34.87 | 47.45 |
| Bf | 17.14 | 17.14 | 17.14 |
| FNo. | 4.11 | 5.08 | 6.15 |
| 2ω[°] | 87.4 | 62.4 | 48.8 |
| DD[6] | 16.65 | 8.03 | 2.92 |
| DD[14] | 11.07 | 12.78 | 14.47 |
| DD[18] | 6.67 | 14.89 | 23.52 |

TABLE 39
Example 13

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −4.2962270E−05 | −5.6621035E−05 | 5.3165391E−05 | 7.6151175E−05 |
| A6 | −7.1560627E−08 | −1.1032714E−07 | 1.8661294E−06 | 1.9462761E−06 |
| A8 | 2.0836764E−11 | −2.6959622E−10 | 1.5555281E−08 | 1.3998791E−08 |
| A10 | −1.0282912E−11 | 1.3646272E−12 | 2.2046401E−10 | 2.2927973E−10 |
| A12 | 2.6425410E−14 | −1.7382825E−14 | 3.0144932E−12 | 7.3354288E−12 |
| A14 | 3.7646347E−16 | 7.9105401E−17 | 8.7369721E−14 | 2.3805125E−13 |
| A16 | 2.9023203E−19 | −7.7142019E−19 | 4.8812298E−15 | −6.2814927E−15 |
| A18 | −3.3150299E−20 | −3.8511053E−21 | −3.4558545E−17 | 2.0614786E−16 |

| Sn | 13 | 14 |
|---|---|---|
| KA | 1.0000000E+00 | 1.0000000E+00 |
| A4 | −2.0809037E−05 | 5.6797501E−05 |
| A6 | −4.4399339E−07 | −7.8832262E−08 |
| A8 | 6.8926442E−09 | 1.4493077E−08 |
| A10 | 2.4238211E−10 | −2.7649609E−10 |
| A12 | −2.1718959E−11 | 6.0007289E−12 |
| A14 | 4.5519439E−13 | −1.6477607E−13 |
| A16 | −2.5212213E−15 | 2.3374776E−15 |
| Sn | 15 | 16 |
| KA | 1.0000000E+00 | 1.0000000E+00 |
| A3 | 0.0000000E+00 | 0.0000000E+00 |
| A4 | 3.8189410E−04 | 4.2236871E−04 |
| A5 | −3.6598467E−05 | −3.5169152E−05 |
| A6 | −1.7238236E−06 | −1.3439179E−06 |
| A7 | 2.5631993E−07 | 1.2801414E−07 |
| A8 | 2.1041796E−08 | 2.1711433E−08 |
| A9 | −1.3652500E−09 | −9.1733246E−11 |
| A10 | −3.6433004E−10 | 5.0822636E−11 |
| A11 | 1.3979413E−11 | −3.8340452E−11 |
| A12 | 3.1853489E−12 | −2.4002020E−12 |
| A13 | −2.9089052E−13 | 1.4277559E−13 |
| A14 | 2.6881363E−15 | 5.9022021E−14 |
| A15 | −2.5665991E−16 | 5.0580076E−15 |
| A16 | 2.1228874E−15 | −4.5725672E−16 |
| A17 | −1.7674549E−16 | −5.4543479E−17 |
| A18 | −2.1147865E−17 | −2.0169695E−18 |
| A19 | 2.0180819E−18 | 4.0723873E−19 |
| A20 | −2.0839651E−20 | −4.3829374E−21 |

### Example 14

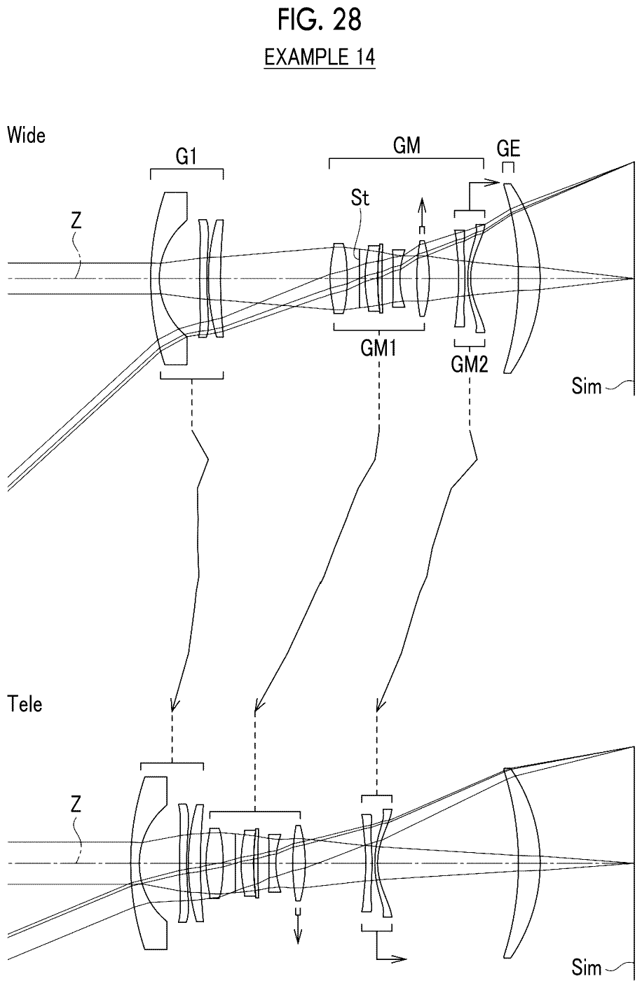

A configuration and a movement locus of a variable magnification optical system according to Example 14 are shown in FIG. 28. The variable magnification optical system according to Example 14 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the image side of the first intermediate lens group GM1.

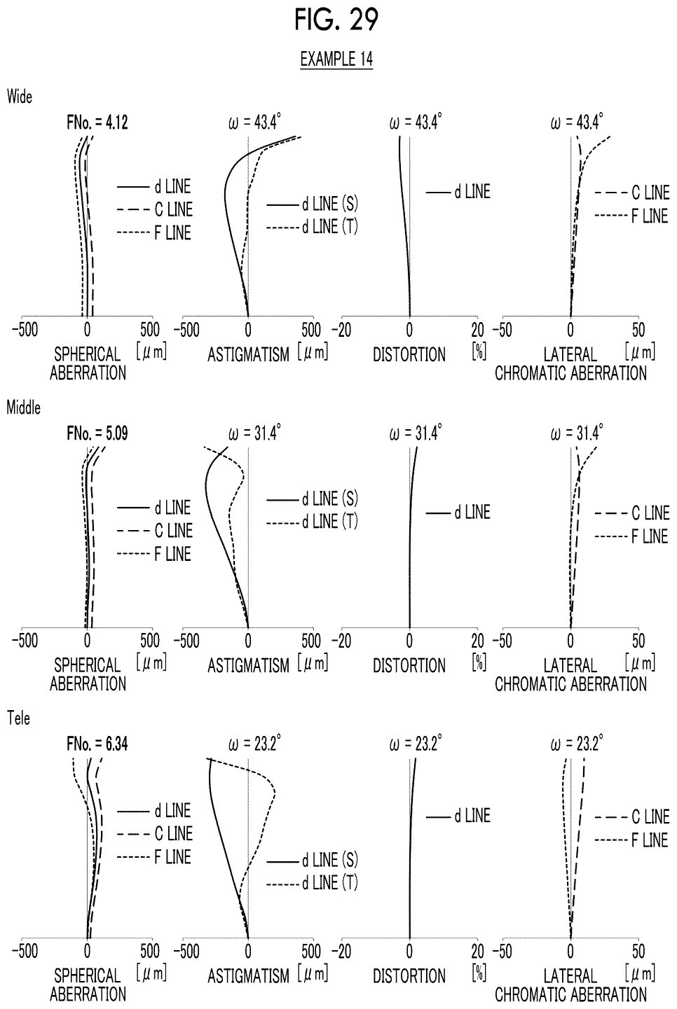

For the variable magnification optical system according to Example 14, basic lens data is shown in Table 40, specifications and variable surface spacings are shown in Table 41, aspherical coefficients are shown in Table 42, and each aberration diagram is shown in FIG. 29.

TABLE 40
Example 14

| | Sn | R | D | Nd | νd | θgF |
|---|---|---|---|---|---|---|
| | 1 | 51.6988 | 1.5501 | 1.89190 | 37.13 | 0.57813 |
| | 2 | 14.2287 | 7.2502 | | | |
| | *3 | 138.1195 | 1.2727 | 1.53409 | 55.87 | 0.55858 |
| | *4 | 61.6948 | 0.3000 | | | |
| | 5 | 40.6602 | 2.1743 | 1.95906 | 17.47 | 0.65993 |
| | 6 | 110.9236 | DD[6] | | | |
| | *7 | 22.2382 | 3.0766 | 1.53409 | 55.87 | 0.55858 |
| | *8 | −39.8014 | 2.1786 | | | |
| | 9(St) | ∞ | 1.0501 | | | |
| | 10 | 26.1336 | 2.2599 | 1.52841 | 76.45 | 0.53954 |
| | 11 | 49.2390 | 0.7500 | 1.80400 | 46.53 | 0.55775 |
| | 12 | 140.6575 | 2.0000 | | | |
| | 13 | −232.0353 | 1.2502 | 1.84666 | 23.78 | 0.62054 |
| | 14 | 16.2829 | 3.0252 | | | |
| Gois | 15 | 42.6474 | 2.2502 | 1.61772 | 49.81 | 0.56035 |
| | 16 | −27.6315 | DD[16] | | | |
| Gfoc | *17 | −64.8248 | 1.1382 | 1.53409 | 55.87 | 0.55858 |
| | *18 | −52.9241 | 0.5002 | | | |
| | *19 | 19.9292 | 0.5000 | 1.53409 | 55.87 | 0.55858 |
| | *20 | 11.9002 | DD[20] | | | |
| | 21 | −58.1387 | 3.8998 | 1.80400 | 46.53 | 0.55775 |
| | 22 | −31.7416 | 16.9100 | | | |

TABLE 41
Example 14

| | Wide | Middle | Tele |
|---|---|---|---|
| Zr | 1.0 | 1.5 | 2.1 |
| f | 23.60 | 34.68 | 49.56 |
| Bf | 16.91 | 16.91 | 16.91 |
| FNo. | 4.11 | 5.08 | 6.34 |
| 2ω[°] | 86.8 | 62.8 | 46.4 |
| DD[6] | 19.59 | 8.43 | 1.00 |
| DD[16] | 5.27 | 7.49 | 10.76 |
| DD[20] | 8.61 | 16.33 | 25.32 |

TABLE 42
Example 14

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −2.4261794E−05 | −4.6358298E−05 | −6.4407103E−05 | −4.5172802E−05 |
| A6 | −7.9911303E−09 | −2.5721955E−08 | −8.1504778E−07 | −9.4287145E−07 |
| A8 | −9.6819119E−10 | −1.5839302E−09 | −2.0576729E−08 | −8.6300135E−09 |
| A10 | 4.4765895E−12 | 3.3395189E−12 | 7.3183451E−11 | −3.3997270E−10 |
| A12 | −6.0081457E−14 | 5.7582785E−16 | −1.9480423E−13 | 3.2599918E−12 |
| A14 | −1.7536627E−16 | −5.9073020E−17 | −4.0934675E−14 | 2.8284041E−13 |
| A16 | 4.9841184E−18 | −3.1789688E−18 | −1.4983748E−15 | −1.1405414E−14 |
| A18 | −3.4961216E−20 | 9.2107391E−21 | 1.1717565E−17 | 1.0676980E−16 |

| Sn | 17 | 20 |
|---|---|---|
| KA | 1.0000000E+00 | 1.0000000E+00 |
| A3 | 0.0000000E+00 | 0.0000000E+00 |
| A4 | −4.5502693E−04 | −2.4352898E−04 |
| A5 | 6.5041854E−05 | 1.0969022E−05 |
| A6 | 8.1511287E−07 | −1.6527148E−06 |
| A7 | 1.0778251E−08 | −3.5213963E−08 |
| A8 | 5.1374991E−09 | 1.0673913E−08 |
| A9 | −2.2018802E−09 | −6.4473143E−11 |
| A10 | −4.5067276E−10 | 1.5144773E−10 |
| A11 | −9.6151163E−12 | −2.7858049E−11 |
| A12 | 1.7004760E−12 | −2.0287269E−12 |
| A13 | −1.9099559E−13 | 7.9784134E−14 |
| A14 | 2.5563025E−14 | 4.6620883E−14 |
| A15 | 1.7151629E−16 | 4.1782628E−15 |
| A16 | 1.6710127E−15 | −7.5258502E−16 |
| A17 | −1.4924099E−17 | −5.4205275E−17 |
| A18 | −2.0777622E−17 | 8.3838454E−19 |
| A19 | −1.1091820E−18 | 1.1241407E−18 |
| A20 | 1.8273051E−19 | −6.0117463E−20 |
| Sn | 18 | 19 |
| KA | 1.0000000E+00 | 1.0000000E+00 |
| A3 | 0.0000000E+00 | 0.0000000E+00 |
| A4 | −1.4115709E−04 | 1.0156474E−04 |
| A5 | 4.3738451E−05 | −1.0993227E−05 |
| A6 | 7.6231197E−07 | −1.5456025E−06 |
| A7 | −1.8433875E−08 | −2.5518898E−09 |
| A8 | −7.9388500E−09 | 5.2357858E−09 |
| A9 | −1.5979711E−09 | 4.5698540E−10 |
| A10 | −1.9020861E−10 | 4.2384697E−11 |
| A11 | −1.1384702E−11 | 2.9766960E−13 |
| A12 | 2.2195012E−12 | −1.1563140E−12 |

### Example 15

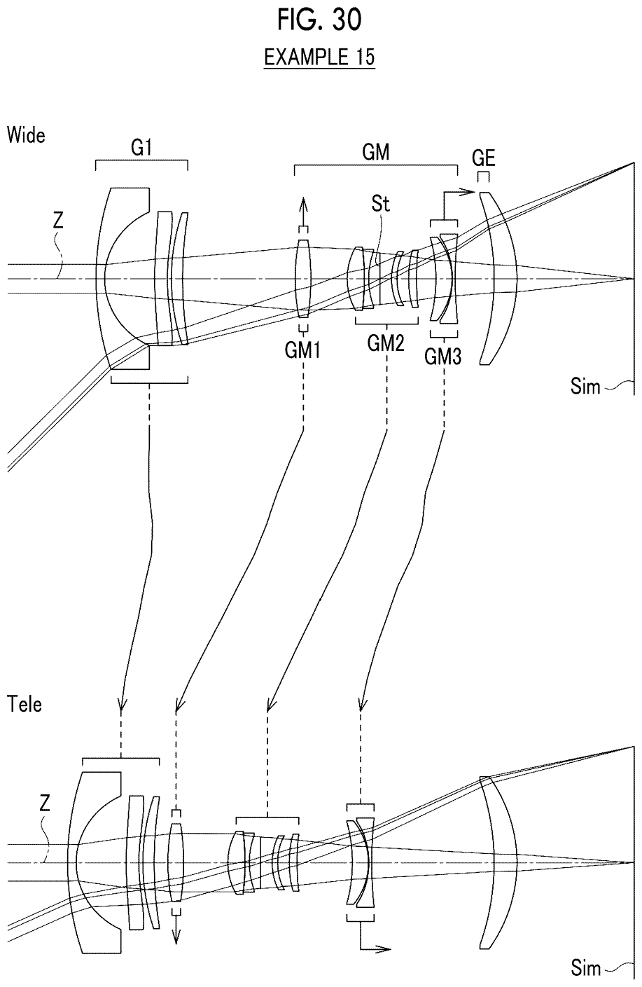

A configuration and a movement locus of a variable magnification optical system according to Example 15 are shown in FIG. 30. The variable magnification optical system according to Example 15 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the first intermediate lens group GM1.

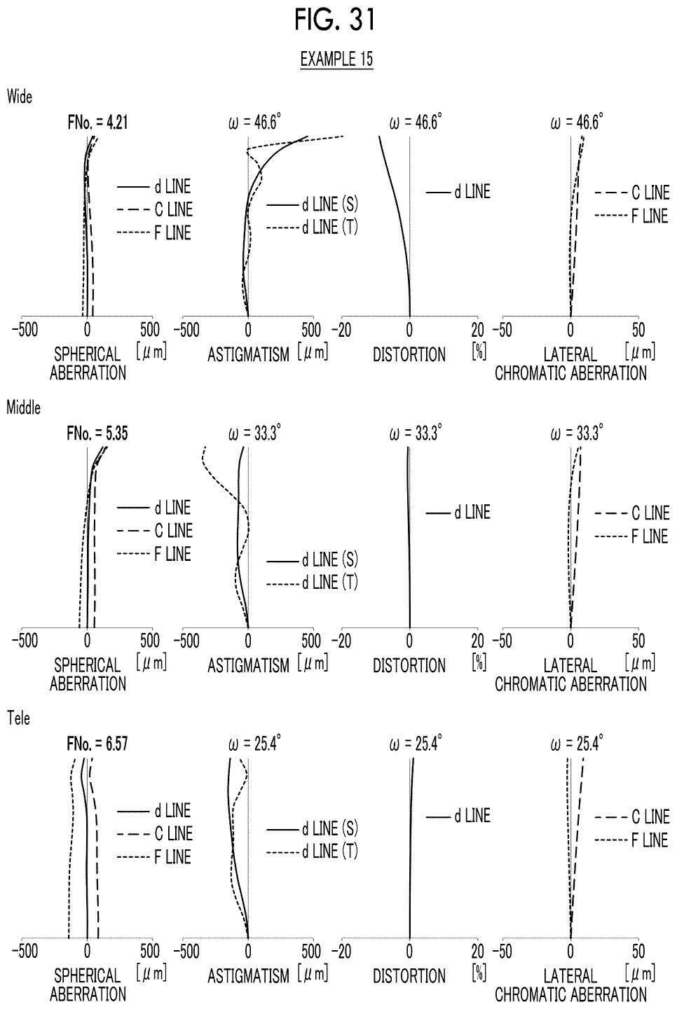

For the variable magnification optical system according to Example 15, basic lens data is shown in Table 43, specifications and variable surface spacings are shown in Table 44, aspherical coefficients are shown in Table 45, and each aberration diagram is shown in FIG. 31.

TABLE 43
Example 15

| | Sn | R | D | Nd | νd | θgF |
|---|---|---|---|---|---|---|
| | 1 | 55.6252 | 1.5002 | 1.77535 | 50.30 | 0.55004 |
| | 2 | 13.7529 | 8.7501 | | | |
| | *3 | 70.6018 | 2.2200 | 1.53409 | 55.87 | 0.55858 |
| | *4 | 37.7960 | 0.7000 | | | |
| | 5 | 40.6751 | 1.9704 | 1.95906 | 17.47 | 0.65993 |
| | 6 | 79.0868 | DD[6] | | | |
| Gois | 7 | 38.2174 | 2.7502 | 1.48749 | 70.24 | 0.53007 |
| | 8 | −48.1674 | DD[8] | | | |
| | 9 | 12.4259 | 3.0098 | 1.53775 | 74.70 | 0.53936 |
| | 10 | −50.4090 | 0.7500 | 1.59270 | 35.31 | 0.59336 |
| | 11 | 15.7647 | 2.0000 | | | |
| | 12(St) | ∞ | 2.0000 | | | |
| | *13 | 12.8916 | 0.9560 | 1.61881 | 63.85 | 0.54182 |
| | *14 | 12.4900 | 2.0276 | | | |
| | *15 | 22.4611 | 1.3862 | 1.53409 | 55.87 | 0.55858 |
| | *16 | 66.1405 | DD[16] | | | |
| Gfoc | 17 | −29.9494 | 2.8155 | 1.43599 | 67.48 | 0.52494 |
| | 18 | −12.8055 | 0.0500 | | | |
| | *19 | −17.1595 | 0.4998 | 1.53409 | 55.87 | 0.55858 |
| | *20 | 70.5485 | DD[20] | | | |
| | 21 | −48.4380 | 4.0002 | 1.80400 | 46.53 | 0.55775 |
| | 22 | −28.6823 | 20.4700 | | | |

TABLE 44
Example 15

| | Wide | Middle | Tele |
|---|---|---|---|
| Zr | 1.0 | 1.5 | 2.0 |
| f | 22.49 | 33.05 | 44.97 |
| Bf | 20.47 | 20.47 | 20.47 |
| FNo. | 4.21 | 5.35 | 6.57 |
| 2ω[°] | 93.2 | 66.6 | 50.8 |
| DD[6] | 19.68 | 9.11 | 2.40 |
| DD[8] | 6.25 | 7.17 | 7.73 |
| DD[16] | 3.40 | 5.83 | 9.55 |
| DD[20] | 6.81 | 14.93 | 21.42 |

TABLE 45
Example 15

| Sn | 3 | 4 | 13 | 14 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −4.2650259E−05 | −7.1654037E−05 | −6.4245861E−06 | 3.2048335E−06 |
| A5 | 3.2905488E−06 | 5.4661843E−06 | 2.0121962E−05 | 1.8831865E−05 |
| A6 | −3.1755879E−07 | −5.3655113E−07 | 7.0254131E−07 | 2.2086201E−06 |
| A7 | 1.4998103E−08 | 8.7646887E−09 | 2.4275769E−07 | 4.7170968E−07 |
| A8 | 1.6172261E−10 | 7.0765866E−10 | 1.2541277E−08 | 6.3442765E−08 |
| A9 | 4.2566616E−11 | 1.6759756E−10 | 7.4485814E−09 | −1.8389379E−08 |
| A10 | 5.3492701E−12 | −1.2829811E−11 | −2.2028206E−09 | 2.7788098E−09 |
| A11 | −1.0228462E−12 | 2.5255014E−13 | 1.6504988E−12 | 9.9081267E−12 |
| A12 | −7.1118813E−14 | −4.2328311E−14 | 4.9116004E−11 | 2.3762395E−11 |
| A13 | 9.3506665E−15 | 4.7321113E−16 | −1.1494529E−12 | −6.7652140E−13 |
| A14 | 1.2222014E−16 | −3.9411813E−16 | 4.2595068E−13 | −1.0775317E−12 |
| A15 | −4.5582035E−18 | 5.3556937E−18 | 1.5529035E−13 | −1.5483313E−13 |
| A16 | −2.6032077E−18 | 3.2591970E−18 | −5.3042037E−14 | 2.3282077E−14 |
| A17 | −8.9689166E−20 | 1.7828397E−19 | −1.5469583E−14 | −4.1371850E−15 |
| A18 | 1.9316477E−20 | −5.7389388E−21 | −5.0693477E−16 | −3.1761866E−15 |
| A19 | 1.4609234E−22 | −2.2886101E−21 | 2.3169842E−16 | 5.1655528E−16 |
| A20 | −4.0739698E−23 | 8.9243750E−23 | 5.8375795E−17 | 4.5418334E−17 |

| Sn | 15 | 16 |
|---|---|---|
| KA | 1.0000000E+00 | 1.0000000E+00 |
| A4 | 1.1630256E−05 | 8.5251851E−05 |
| A6 | −9.6146163E−08 | −4.9513589E−07 |
| A8 | 8.9658023E−08 | −1.8562930E−08 |
| A10 | −5.1996035E−10 | 4.6973889E−09 |
| A12 | −1.4696431E−11 | −1.7925892E−10 |
| A14 | 1.7287003E−12 | 3.5463892E−12 |
| A16 | −1.7673934E−14 | −1.4573647E−14 |
| Sn | 19 | 20 |
| KA | 1.0000000E+00 | 1.0000000E+00 |
| A4 | −9.1717288E−05 | −3.5739354E−05 |
| A6 | 2.3574139E−07 | 7.1148722E−07 |
| A8 | 6.9480397E−09 | −1.0653949E−08 |
| A10 | −1.1994683E−10 | 1.1105522E−10 |
| A12 | −1.5074143E−11 | −4.7756956E−13 |
| A14 | 4.4325729E−13 | −4.1195623E−14 |
| A16 | −2.4867328E−15 | 1.3122604E−15 |
| A18 | −1.2405278E−17 | −1.0180478E−17 |

### Example 16

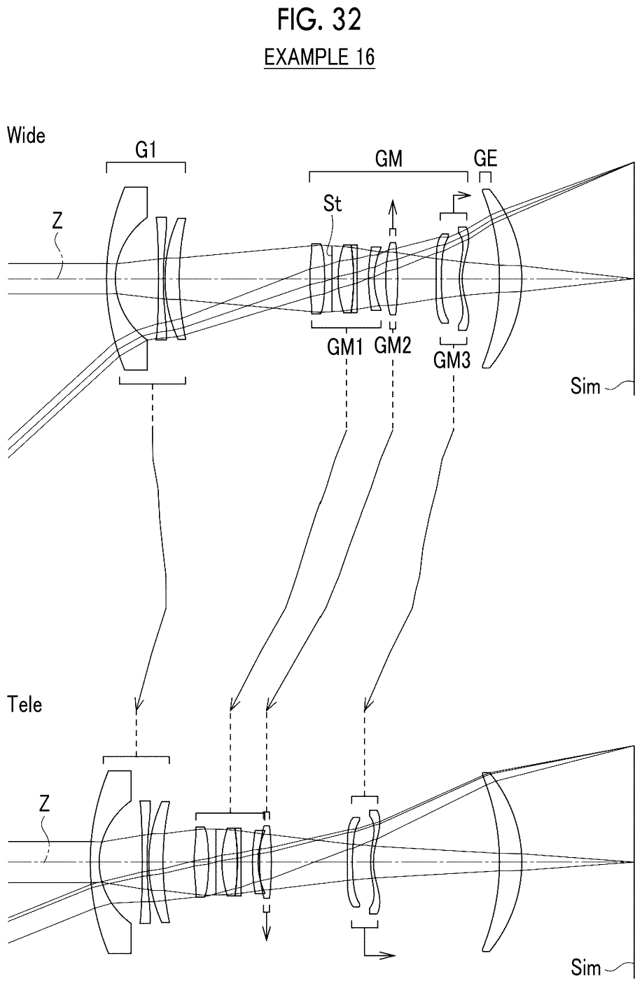

A configuration and a movement locus of a variable magnification optical system according to Example 16 are shown in FIG. 32. The variable magnification optical system according to Example 16 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the second intermediate lens group GM2.

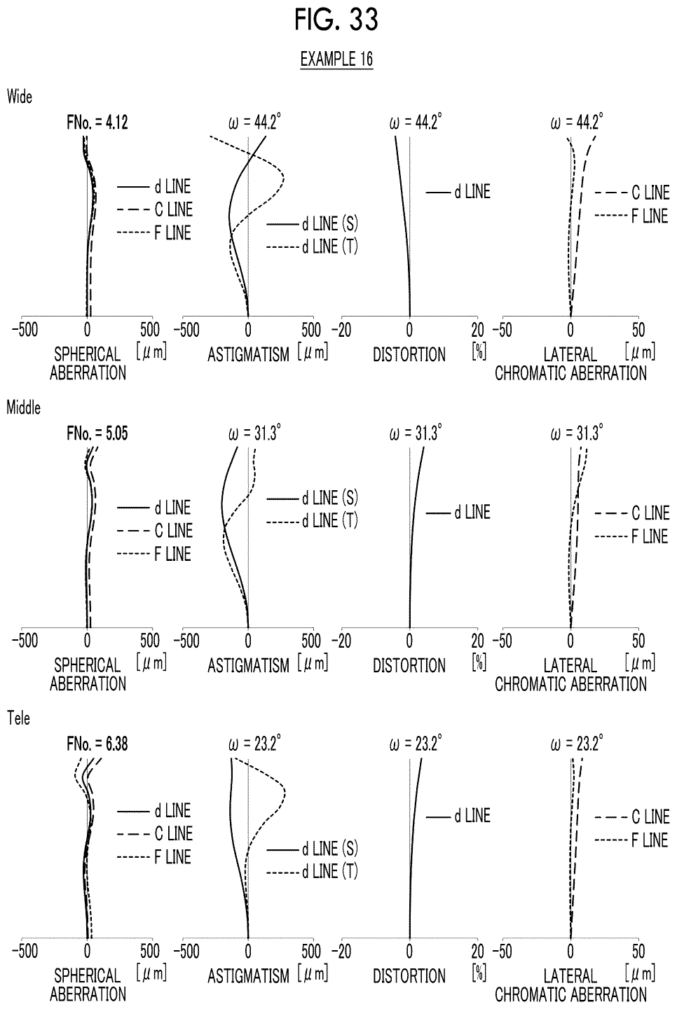

For the variable magnification optical system according to Example 16, basic lens data is shown in Table 46, specifications and variable surface spacings are shown in Table 47, aspherical coefficients are shown in Table 48, and each aberration diagram is shown in FIG. 33.

TABLE 46
Example 16

| | Sn | R | D | Nd | νd | θgF |
|---|---|---|---|---|---|---|
| | 1 | 46.8038 | 1.5500 | 1.89190 | 37.13 | 0.57813 |
| | 2 | 14.4167 | 7.5638 | | | |
| | *3 | −259.8920 | 0.8248 | 1.53409 | 55.87 | 0.55858 |
| | *4 | 61.0035 | 0.3000 | | | |
| | 5 | 28.8756 | 2.5002 | 1.95906 | 17.47 | 0.65993 |
| | 6 | 56.4183 | DD[6] | | | |
| | *7 | 32.5642 | 2.5046 | 1.53409 | 55.87 | 0.55858 |
| | *8 | −54.3611 | 1.2875 | | | |
| | 9(St) | ∞ | 1.0499 | | | |
| | 10 | 21.0101 | 2.7090 | 1.52841 | 76.45 | 0.53954 |
| | 11 | −47.0401 | 0.6250 | 1.80400 | 46.53 | 0.55775 |
| | 12 | 2123.6013 | 2.0002 | | | |
| | 13 | 34.1223 | 0.9998 | 1.84666 | 23.78 | 0.62054 |
| | 14 | 14.5239 | DD[14] | | | |
| Gois | 15 | 29.0666 | 2.1042 | 1.61772 | 49.81 | 0.56035 |
| | 16 | −64.4585 | DD[16] | | | |
| Gfoc | *17 | −4089.0277 | 0.8854 | 1.53409 | 55.87 | 0.55858 |
| | *18 | 48.0982 | 3.1703 | | | |
| | *19 | 15.0554 | 0.5000 | 1.53409 | 55.87 | 0.55858 |
| | *20 | 11.7210 | DD[20] | | | |
| | 21 | −45.4521 | 3.9002 | 1.80400 | 46.53 | 0.55775 |
| | 22 | −27.2217 | 19.6500 | | | |

TABLE 47
Example 16

| | Wide | Middle | Tele |
|---|---|---|---|
| Zr | 1.0 | 1.5 | 2.1 |
| f | 23.25 | 34.17 | 48.82 |
| Bf | 19.65 | 19.65 | 19.65 |
| FNo. | 4.12 | 5.05 | 6.38 |
| 2ω[°] | 88.4 | 62.6 | 46.4 |
| DD[6] | 22.86 | 11.86 | 5.46 |
| DD[14] | 2.00 | 1.23 | 0.24 |
| DD[16] | 6.74 | 10.22 | 13.19 |
| DD[20] | 6.52 | 12.44 | 22.08 |

TABLE 48
Example 16

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −1.1171533E−05 | −2.6708831E−05 | −1.0427944E−04 | −9.8269878E−05 |
| A6 | 8.3215701E−08 | 8.9290311E−08 | −1.0708789E−06 | −1.0081350E−06 |
| A8 | −7.9240545E−10 | −9.0488576E−10 | −1.6666169E−08 | −8.1444875E−09 |
| A10 | 7.5744464E−12 | 1.0775493E−12 | 9.6807715E−11 | −3.3044263E−10 |
| A12 | −4.5746125E−14 | −7.8166788E−15 | −2.0963062E−12 | 3.3412814E−12 |
| A14 | −2.5709368E−16 | 9.3168267E−17 | −1.2201147E−13 | 1.8703398E−13 |
| A16 | 3.9477725E−18 | −1.1968598E−18 | −2.0709740E−16 | −9.8254122E−15 |
| A18 | −1.5327935E−20 | 1.8501319E−21 | 1.8426818E−17 | 1.0637671E−16 |

| Sn | 17 | 20 |
|---|---|---|
| KA | 1.0000000E+00 | 1.0000000E+00 |
| A3 | 0.0000000E+00 | 0.0000000E+00 |
| A4 | −5.0419444E−05 | −4.6240511E−04 |
| A5 | 2.8565952E−05 | −7.2839976E−06 |
| A6 | 4.7692708E−07 | −6.1519765E−07 |
| A7 | 6.9875855E−09 | 4.3793379E−08 |
| A8 | 5.4177633E−09 | 1.3354072E−08 |
| A9 | −1.8484202E−09 | −5.5669451E−12 |
| A10 | −3.5867402E−10 | 1.4468329E−10 |
| A11 | 5.4699148E−12 | −3.0022685E−11 |
| A12 | 3.6163043E−12 | −2.2375791E−12 |
| A13 | 3.0707202E−14 | 6.7200943E−14 |
| A14 | 4.6823142E−14 | 4.6241101E−14 |
| A15 | 1.6468550E−15 | 4.4135865E−15 |
| A16 | 1.5121945E−15 | −7.2239271E−16 |
| A17 | −8.5370068E−17 | −5.1276715E−17 |
| A18 | −1.7409816E−17 | 9.3515831E−19 |
| A19 | −2.5736253E−18 | 1.0568107E−18 |
| A20 | 3.1446338E−19 | −6.0489810E−20 |

| Sn | 18 | 19 |
|---|---|---|
| KA | 1.0000000E+00 | 1.0000000E+00 |
| A3 | 0.0000000E+00 | 0.0000000E+00 |
| A4 | −6.3119281E−05 | −4.6013130E−04 |
| A5 | 3.4894242E−05 | −1.3998022E−06 |
| A6 | 1.0665460E−07 | −8.5252030E−07 |
| A7 | −4.3616230E−08 | 1.6217857E−08 |
| A8 | −1.0432725E−08 | 3.6806166E−09 |
| A9 | −1.6638546E−09 | 7.5187007E−11 |
| A10 | −1.3444945E−10 | −1.7171025E−12 |
| A11 | 7.8150137E−12 | −1.8297044E−12 |
| A12 | 6.6674303E−12 | −5.9815312E−13 |

### Example 17

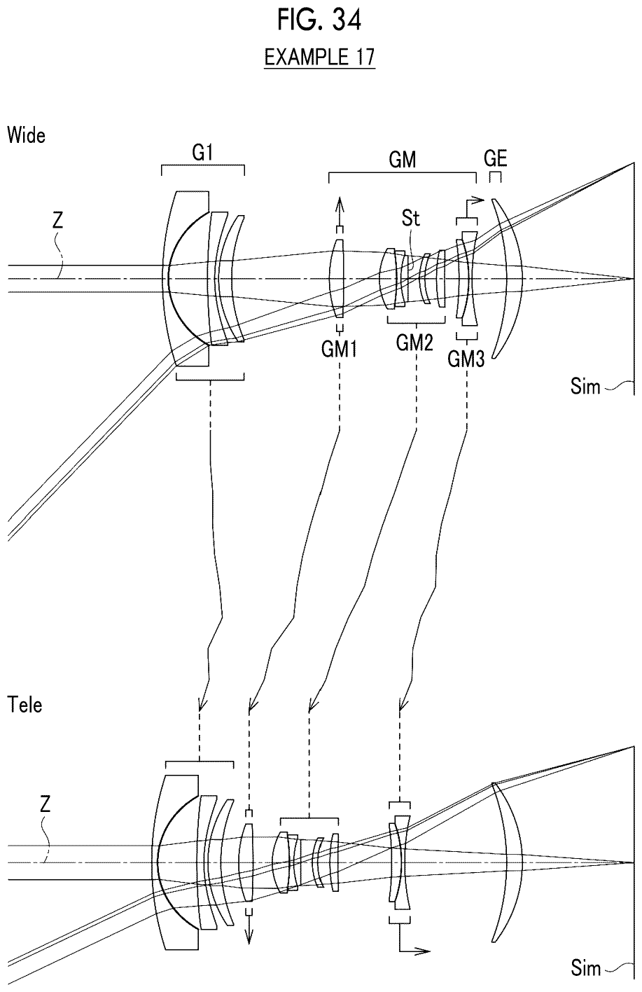

A configuration and a movement locus of a variable magnification optical system according to Example 17 are shown in FIG. 34. The variable magnification optical system according to Example 17 consists of, in order from the object side to the image side, the first lens group G1 having negative refractive power, the intermediate group GM, and the final lens group GE having positive refractive power. The lens closest to the object side of the first lens group G1 is a compound aspherical lens. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the first intermediate lens group GM1.

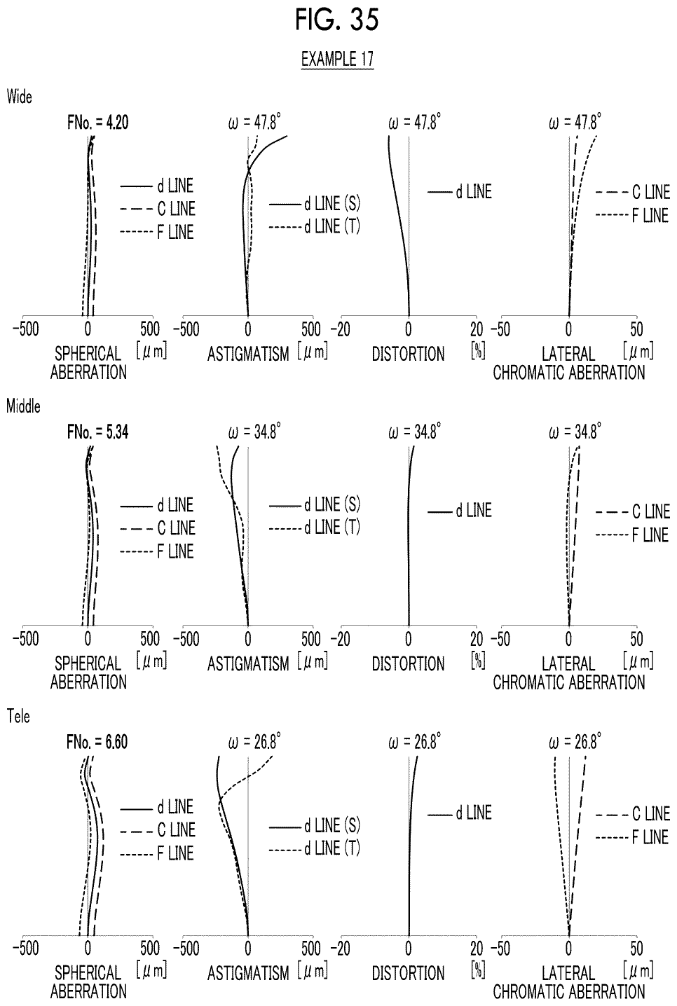

For the variable magnification optical system according to Example 17, basic lens data is shown in Table 49, specifications and variable surface spacings are shown in Table 50, aspherical coefficients are shown in Table 51, and each aberration diagram is shown in FIG. 35.

TABLE 49
Example 17

| | Sn | R | D | Nd | νd | θgF |
|---|---|---|---|---|---|---|
| | 1 | 55.3149 | 0.9998 | 1.77535 | 50.30 | 0.55004 |
| | 2 | 14.3625 | 0.0748 | 1.53409 | 55.87 | 0.55858 |
| | *3 | 14.1175 | 6.8049 | | | |
| | *4 | 87.3028 | 1.2498 | 1.53409 | 55.87 | 0.55858 |
| | *5 | 26.3795 | 0.7000 | | | |
| | 6 | 21.7849 | 2.2652 | 1.95906 | 17.47 | 0.65993 |
| | 7 | 30.4813 | DD[7] | | | |
| Gois | 8 | 21.2595 | 2.5064 | 1.48749 | 70.24 | 0.53007 |
| | 9 | −175.6697 | DD[9] | | | |
| | 10 | 12.0394 | 3.0102 | 1.53775 | 74.70 | 0.53936 |
| | 11 | −37.0480 | 0.7500 | 1.59270 | 35.31 | 0.59336 |
| | 12 | 15.5060 | 1.2498 | | | |
| | 13(St) | ∞ | 2.0000 | | | |
| | *14 | 12.1249 | 0.9358 | 1.61881 | 63.85 | 0.54182 |
| | *15 | 12.7850 | 2.0276 | | | |
| | *16 | 29.2851 | 1.4229 | 1.53409 | 55.87 | 0.55858 |
| | *17 | 3896.3748 | DD[17] | | | |
| Gfoc | 18 | −52.7880 | 1.6660 | 1.43600 | 67.00 | 0.52558 |
| | 19 | −23.6870 | 0.0500 | | | |
| | *20 | −25.2931 | 0.5585 | 1.53409 | 55.87 | 0.55858 |
| | *21 | 44.4420 | DD[21] | | | |
| | 22 | −42.6315 | 2.7498 | 1.80400 | 46.53 | 0.55775 |
| | 23 | −25.3253 | 19.5600 | | | |

TABLE 50
Example 17

| | Wide | Middle | Tele |
|---|---|---|---|
| Zr | 1.0 | 1.5 | 2.0 |
| f | 20.86 | 30.65 | 41.71 |
| Bf | 19.56 | 19.56 | 19.56 |
| FNo. | 4.20 | 5.34 | 6.60 |
| 2ω[°] | 95.6 | 69.6 | 53.6 |
| DD[7] | 16.98 | 7.96 | 3.11 |
| DD[9] | 6.25 | 4.56 | 3.37 |
| DD[17] | 2.54 | 6.16 | 9.40 |
| DD[21] | 6.04 | 11.49 | 17.81 |

TABLE 51
Example 17

| Sn | 3 | 20 | 21 |
|---|---|---|---|
| KA | 1.0000000E+00 | 1.0000000E+00 | 1.0000000E+00 |
| A4 | 1.9608716E−06 | −4.6897867E−05 | 2.1414363E−06 |
| A6 | −2.3212783E−08 | 3.4782409E−07 | 5.6943888E−07 |
| A8 | −1.8526595E−10 | 7.1912334E−09 | −1.0871239E−08 |
| A10 | −1.2288896E−13 | −1.2121941E−10 | 1.0983767E−10 |
| A12 | −3.1958078E−16 | −1.5173987E−11 | −4.9911418E−13 |
| A14 | −2.3957994E−19 | 4.4071283E−13 | −4.1524708E−14 |
| A16 | 4.8661077E−22 | −2.5189368E−15 | 1.3003291E−15 |
| A18 | 1.3281432E−23 | −1.2346979E−17 | −1.0156763E−17 |

| Sn | 4 | 5 | 14 | 15 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −4.3810884E−05 | −6.3229843E−05 | −3.2425558E−05 | 2.0447327E−05 |
| A5 | 5.0735729E−06 | 6.4581846E−06 | 2.0151105E−05 | 1.8201899E−05 |
| A6 | −3.2778244E−07 | −4.6416209E−07 | 7.7576103E−07 | 2.1608042E−06 |
| A7 | 1.1573152E−08 | 9.3222376E−09 | 2.4519217E−07 | 4.7001377E−07 |
| A8 | 2.8263840E−10 | 5.8828934E−10 | 1.2247353E−08 | 6.3349280E−08 |
| A9 | 4.3186873E−11 | 1.6179514E−10 | 7.5070766E−09 | −1.8421356E−08 |
| A10 | 5.3092414E−12 | −1.2879407E−11 | −2.1898498E−09 | 2.8137041E−09 |
| A11 | −1.0240390E−12 | 2.4920707E−13 | 9.7350192E−12 | 1.6962929E−11 |
| A12 | −7.0961692E−14 | −4.2242651E−14 | 4.9480908E−11 | 2.7222500E−11 |
| A13 | 9.3499783E−15 | 4.6546337E−16 | −1.0112410E−12 | −6.0830212E−13 |
| A14 | 1.2173530E−16 | −3.9435598E−16 | 4.4271026E−13 | −1.0378285E−12 |
| A15 | −4.5942930E−18 | 5.4145534E−18 | 1.4308182E−13 | −1.3917313E−13 |
| A16 | −2.6045751E−18 | 3.2555505E−18 | −5.8907158E−14 | 2.4815350E−14 |
| A17 | −8.9852421E−20 | 1.7800443E−19 | −1.6758063E−14 | −4.2895765E−15 |
| A18 | 1.9299297E−20 | −5.7745315E−21 | −5.5753831E−16 | −3.5163643E−15 |
| A19 | 1.4610422E−22 | −2.2903677E−21 | 1.9540154E−16 | 5.2912205E−16 |
| A20 | −4.0757104E−23 | 8.8829239E−23 | 6.1910210E−17 | 8.3230267E−18 |

| Sn | 16 | 17 |
|---|---|---|
| KA | 1.0000000E+00 | 1.0000000E+00 |
| A4 | 3.0238701E−05 | 9.3890018E−05 |
| A6 | −1.4783224E−07 | −3.2732108E−07 |
| A8 | 9.0179503E−08 | −1.8726725E−08 |
| A10 | −5.1876647E−10 | 4.7037375E−09 |
| A12 | −1.5451003E−11 | −1.8079305E−10 |
| A14 | 1.6792289E−12 | 3.5391476E−12 |
| A16 | −1.7790105E−14 | −1.6100321E−14 |

### Example 18

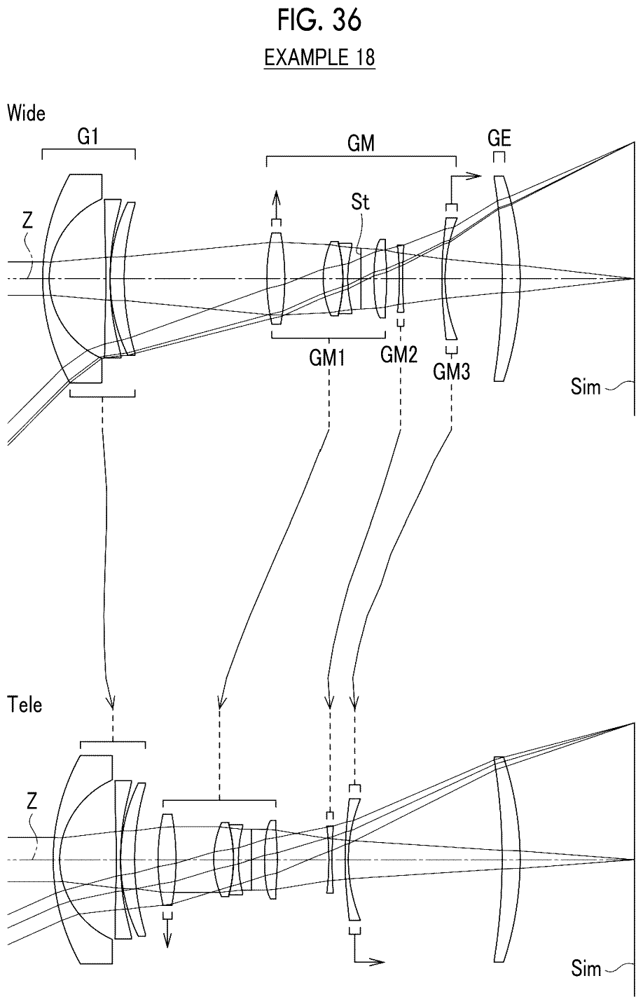

A configuration and a movement locus of a variable magnification optical system according to Example 18 are shown in FIG. 36. The variable magnification optical system according to Example 18 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having negative refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of one lens closest to the object side of the first intermediate lens group GM1.

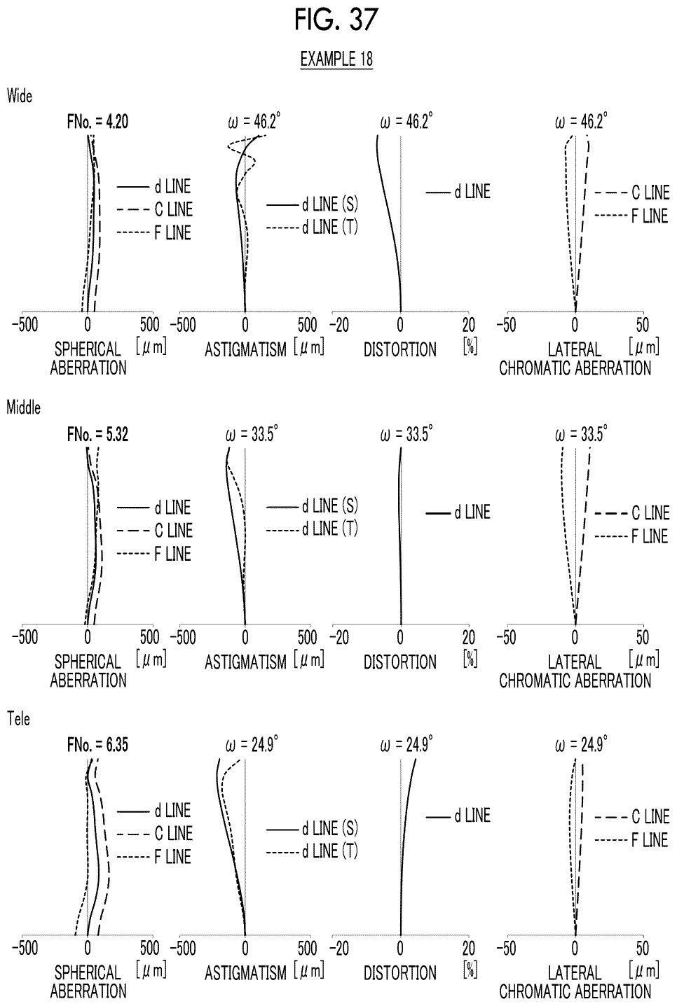

For the variable magnification optical system according to Example 18, basic lens data is shown in Table 52, specifications and variable surface spacings are shown in Table 53, aspherical coefficients are shown in Table 54, and each aberration diagram is shown in FIG. 37.

TABLE 52
Example 18

| | Sn | R | D | Nd | νd | θgF |
|---|---|---|---|---|---|---|
| | 1 | 34.6654 | 0.9998 | 1.77535 | 50.30 | 0.55004 |
| | 2 | 13.8970 | 8.6746 | | | |
| | *3 | −120.0343 | 0.6371 | 1.53409 | 55.87 | 0.55858 |
| | *4 | 50.8196 | 0.0010 | | | |
| | 5 | 28.3442 | 2.1442 | 1.95906 | 17.47 | 0.65993 |
| | 6 | 42.4980 | DD[6] | | | |
| Gois | 7 | 33.8283 | 2.7502 | 1.48749 | 70.24 | 0.53007 |
| | 8 | −41.5040 | 5.7887 | | | |
| | 9 | 14.9742 | 3.0002 | 1.48749 | 70.24 | 0.53007 |
| | 10 | −22.8833 | 0.7600 | 1.60342 | 38.03 | 0.58356 |
| | 11 | 20.8326 | 2.0002 | | | |
| | 12(St) | ∞ | 2.0000 | | | |
| | *13 | 36.0016 | 1.9553 | 1.61881 | 63.85 | 0.54182 |
| | *14 | −38.3271 | DD[14] | | | |
| | *15 | −53.5390 | 0.4970 | 1.53409 | 55.87 | 0.55858 |
| | *16 | 72.5320 | DD[16] | | | |
| Gfoc | *17 | 58.5293 | 0.4998 | 1.53409 | 55.87 | 0.55858 |
| | *18 | 25.0684 | DD[18] | | | |
| | 19 | −104.1737 | 2.7498 | 1.95375 | 32.32 | 0.59056 |
| | 20 | −52.8119 | DD[20] | | | |

TABLE 53
Example 18

| | Wide | Middle | Tele |
|---|---|---|---|
| Zr | 1.0 | 1.5 | 2.0 |
| f | 22.24 | 32.69 | 44.49 |
| Bf | 17.52 | 17.52 | 17.52 |
| FNo. | 4.20 | 5.32 | 6.35 |
| 2ω[°] | 92.4 | 67.0 | 49.8 |
| DD[6] | 21.83 | 11.55 | 3.58 |
| DD[14] | 1.94 | 3.98 | 7.79 |
| DD[16] | 6.00 | 3.11 | 1.99 |
| DD[18] | 8.73 | 19.55 | 23.53 |

TABLE 54
Example 18

| Sn | 3 | 4 | 13 | 14 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 3.3686486E−05 | 3.0374164E−05 | 7.5097839E−05 | 1.1016495E−04 |
| A5 | 3.5082360E−07 | 1.1344486E−06 | 3.7902890E−06 | −4.7853691E−06 |
| A6 | −2.4146901E−07 | −3.6834345E−07 | 9.5221011E−07 | 1.3448290E−06 |
| A7 | 1.8423549E−09 | 5.2651875E−09 | 1.8906537E−07 | 5.2279325E−07 |
| A8 | 7.1391549E−10 | 6.7957839E−10 | 5.4556823E−09 | 4.0122178E−08 |
| A9 | 2.3755152E−11 | 1.3446230E−10 | 8.1524099E−09 | −1.7095596E−08 |
| A10 | 9.4710445E−12 | −1.5563573E−11 | −1.0271477E−09 | 1.1607830E−09 |
| A11 | −1.2769736E−12 | 3.2194417E−13 | 9.5741690E−14 | −1.2956824E−10 |
| A12 | −6.4230286E−14 | −2.1507726E−14 | 4.2298634E−12 | 4.3740791E−11 |
| A13 | 8.3071406E−15 | 1.6892627E−15 | 4.0071014E−12 | 5.6192355E−12 |
| A14 | 6.4222447E−18 | −4.0859365E−16 | 4.5984573E−13 | 2.8711664E−13 |
| A15 | 1.2022741E−17 | 5.4985046E−18 | 5.1915338E−14 | 6.4493458E−14 |
| A16 | −2.8850660E−18 | 3.4797279E−18 | −6.6294762E−15 | −1.7444092E−14 |
| A17 | −6.9898837E−20 | 1.5133944E−19 | −3.4490097E−15 | −4.1288407E−15 |
| A18 | 2.2089700E−20 | −1.0086537E−20 | −5.3071609E−16 | −2.7257448E−16 |
| A19 | −1.4869602E−22 | −2.4475652E−21 | 5.9099931E−17 | 1.4130948E−17 |
| A20 | −4.4665861E−23 | 1.1505699E−22 | 1.0012339E−17 | 1.5527177E−17 |

| Sn | 15 | 16 |
|---|---|---|
| KA | 1.0000000E+00 | 1.0000000E+00 |
| A4 | −7.5222749E−05 | −3.9606351E−05 |
| A6 | −5.6958915E−07 | 1.1904830E−07 |
| A8 | 6.7763175E−08 | −1.8292540E−08 |
| A10 | −9.6921271E−10 | 4.0754261E−09 |
| A12 | −1.2815564E−11 | −1.8877352E−10 |
| A14 | 4.7787312E−13 | 3.7169026E−12 |
| A16 | −3.6992424E−15 | −2.7685405E−14 |

| Sn | 17 | 18 |
|---|---|---|
| KA | 1.0000000E+00 | 1.0000000E+00 |
| A4 | −1.0912581E−05 | −5.1005895E−06 |
| A6 | −2.4618069E−08 | 7.6460657E−08 |
| A8 | −7.8742899E−10 | −2.0935041E−09 |
| A10 | −2.8285628E−11 | 8.0438473E−13 |
| A12 | 3.6122792E−13 | 1.4585998E−13 |
| A14 | 2.7477401E−15 | 8.0933161E−16 |
| A16 | −2.4431857E−17 | −6.8068820E−18 |
| A18 | −8.8229825E−20 | −5.2346064E−20 |

### Example 19

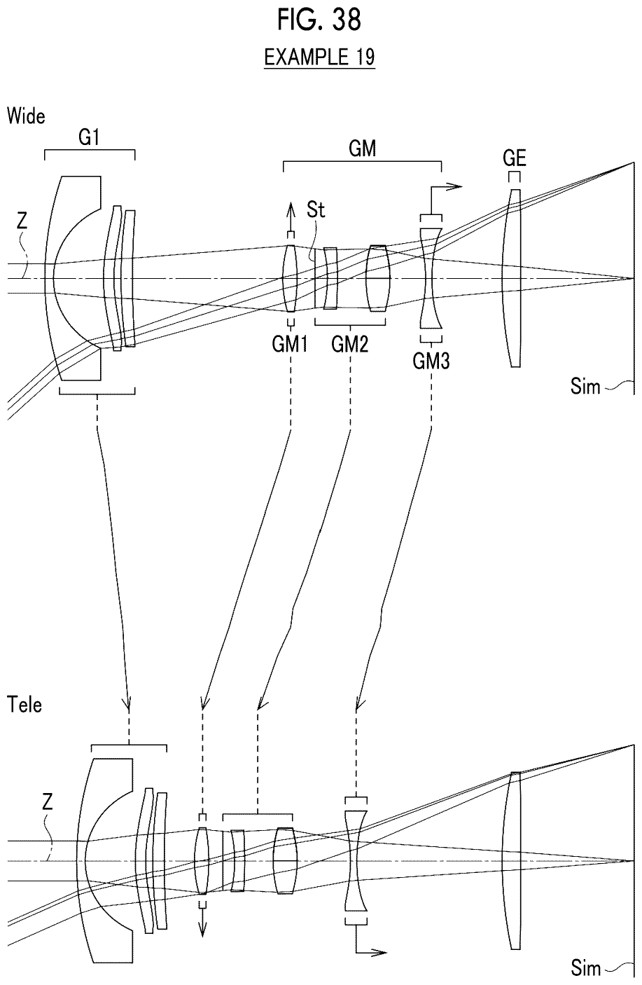

A configuration and a movement locus of a variable magnification optical system according to Example 19 are shown in FIG. 38. The variable magnification optical system according to Example 19 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the first intermediate lens group GM1.

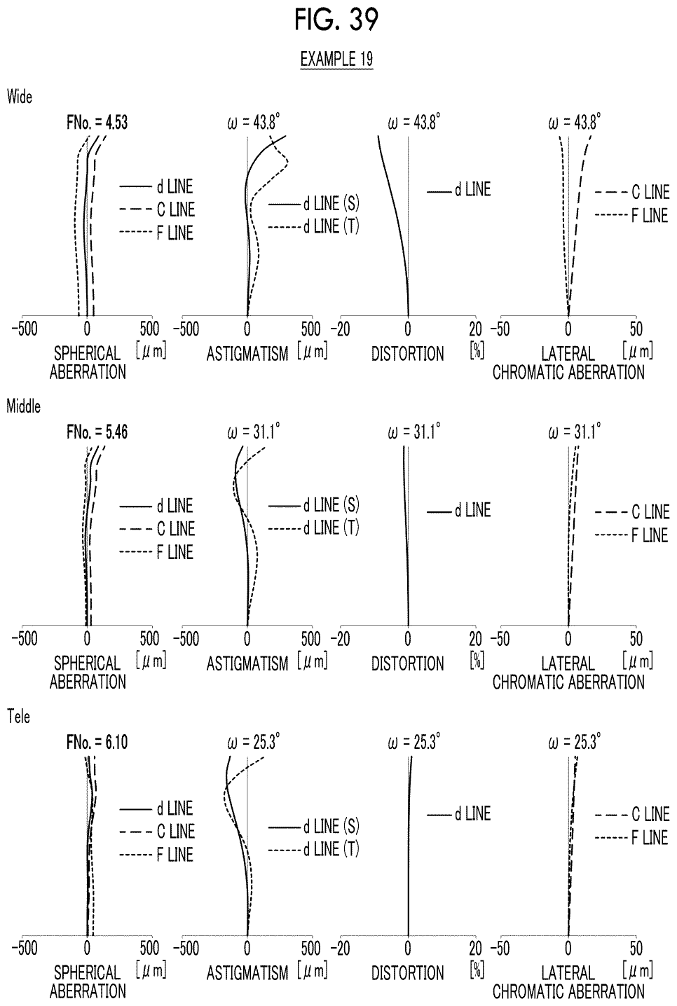

For the variable magnification optical system according to Example 19, basic lens data is shown in Table 55, specifications and variable surface spacings are shown in Table 56, aspherical coefficients are shown in Table 57, and each aberration diagram is shown in FIG. 39.

TABLE 55
Example 19

| | Sn | R | D | Nd | νd | θgF |
|---|---|---|---|---|---|---|
| | 1 | 62.4986 | 1.5023 | 1.64000 | 60.08 | 0.53704 |
| | 2 | 14.3412 | 8.7601 | | | |
| | *3 | 33.6315 | 1.8146 | 1.53409 | 55.87 | 0.55858 |
| | *4 | 29.4671 | 1.2500 | | | |
| | 5 | 94.1509 | 2.0000 | 1.95906 | 17.47 | 0.65993 |
| | 6 | 175.7541 | DD[6] | | | |
| Gois | *7 | 23.2695 | 2.4998 | 1.53409 | 55.87 | 0.55858 |
| | *8 | −37.2687 | DD[8] | | | |
| | 9(St) | ∞ | 2.0623 | | | |
| | 10 | −25.5471 | 1.7499 | 2.00330 | 28.27 | 0.59802 |
| | 11 | −102.2928 | 4.9999 | | | |
| | *12 | 24.9487 | 4.1896 | 1.49700 | 81.54 | 0.53748 |
| | *13 | −20.0452 | DD[13] | | | |
| Gfoc | *14 | −27.7495 | 1.1202 | 1.53409 | 55.87 | 0.55858 |
| | *15 | 38.8299 | DD[15] | | | |
| | 16 | 83.3308 | 3.2501 | 1.48749 | 70.32 | 0.52917 |
| | 17 | −1334.8924 | 19.8200 | | | |

TABLE 56
Example 19

| | Wide | Middle | Tele |
|---|---|---|---|
| Zr | 1.0 | 1.5 | 1.8 |
| f | 24.75 | 36.38 | 45.30 |
| Bf | 19.82 | 19.82 | 19.82 |
| FNo. | 4.52 | 5.46 | 6.09 |
| 2ω[°] | 87.6 | 62.2 | 50.6 |
| DD[6] | 26.29 | 12.37 | 5.29 |
| DD[8] | 3.15 | 3.04 | 2.47 |
| DD[13] | 6.23 | 7.55 | 9.22 |
| DD[15] | 12.28 | 20.93 | 25.41 |

TABLE 57
Example 19

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −4.4118515E−05 | −6.4312093E−05 | −6.6775631E−06 | 5.6767929E−07 |
| A6 | 1.4452603E−07 | 1.1007632E−07 | −6.6855304E−08 | 2.2894946E−08 |
| A8 | −2.5320684E−10 | −4.9505435E−10 | 5.2322066E−10 | 2.5784403E−09 |
| A10 | −1.7752163E−12 | 7.3947275E−13 | 4.9971225E−11 | 8.7314973E−12 |
| A12 | 1.2342417E−14 | −1.3462521E−14 | 1.5380689E−12 | −1.7165810E−12 |
| A14 | 1.0476758E−17 | 1.3870675E−16 | −2.2672384E−14 | 1.2958902E−13 |
| A16 | 1.0371386E−20 | −6.4281435E−19 | −1.0202142E−15 | −3.3781330E−15 |
| A18 | −1.5623150E−21 | −6.7731158E−23 | 2.7673148E−17 | 4.2455658E−17 |

| Sn | 12 | 13 |
|---|---|---|
| KA | 1.0000000E+00 | 1.0000000E+00 |
| A4 | 7.7433322E−06 | 5.7915904E−05 |
| A6 | 4.8123937E−07 | 2.4812174E−07 |
| A8 | 4.6334200E−09 | 2.3712399E−08 |
| A10 | 5.3325035E−10 | −3.3198948E−10 |
| A12 | −1.7875453E−11 | 7.5920742E−12 |
| A14 | 3.6540655E−13 | −4.6575964E−14 |
| A16 | −2.2555701E−15 | 9.3681373E−16 |
| Sn | 14 | 15 |
| KA | 1.0000000E+00 | 1.0000000E+00 |
| A3 | 0.0000000E+00 | 0.0000000E+00 |
| A4 | 1.6301516E−04 | 1.9234559E−04 |
| A5 | −1.6129802E−05 | −1.9386455E−05 |
| A6 | −1.8979641E−06 | −7.4270897E−07 |
| A7 | 2.8289056E−07 | 1.2029148E−07 |
| A8 | 2.5434048E−08 | 1.9492940E−08 |
| A9 | −1.4402541E−09 | −3.2027779E−10 |
| A10 | −4.3645579E−10 | 3.5100988E−11 |
| A11 | 7.6133085E−12 | −3.9276302E−11 |
| A12 | 3.4139930E−12 | −2.4085809E−12 |
| A13 | −2.0800009E−13 | 1.5972904E−13 |
| A14 | 2.1940881E−14 | 6.0263974E−14 |
| A15 | −1.7345327E−15 | 5.6226443E−15 |
| A16 | 1.2765837E−15 | −6.4579090E−16 |
| A17 | −5.5709234E−17 | −6.5688068E−17 |
| A18 | −2.0765188E−17 | −1.6230085E−18 |
| A19 | −1.4494129E−19 | 9.4931921E−19 |
| A20 | 1.8829633E−19 | −3.1518634E−20 |

### Example 20

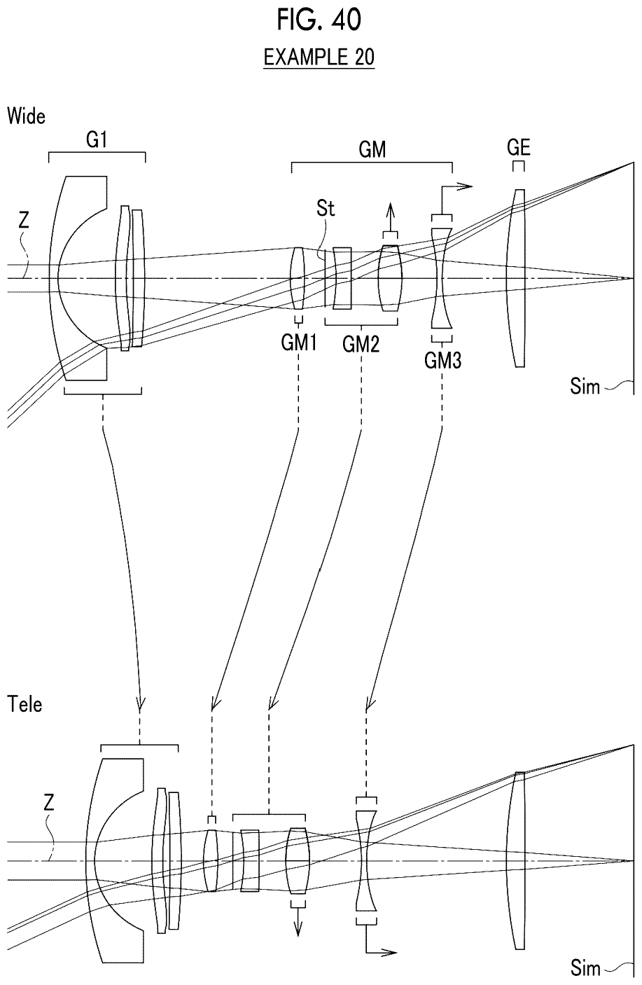

A configuration and a movement locus of a variable magnification optical system according to Example 20 are shown in FIG. 40. The variable magnification optical system according to Example 20 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of one lens closest to the image side of the second intermediate lens group GM2.

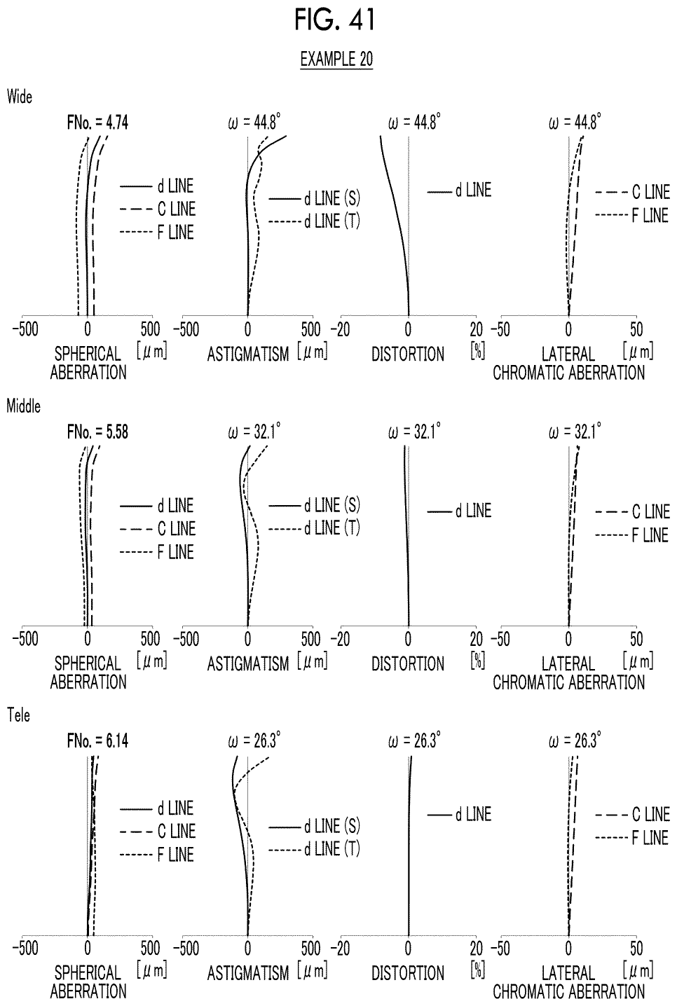

For the variable magnification optical system according to Example 20, basic lens data is shown in Table 58, specifications and variable surface spacings are shown in Table 59, aspherical coefficients are shown in Table 60, and each aberration diagram is shown in FIG. 41.

TABLE 58
Example 20

| | Sn | R | D | Nd | νd | θgF |
|---|---|---|---|---|---|---|
| | 1 | 62.5015 | 1.5502 | 1.64000 | 60.08 | 0.53704 |
| | 2 | 14.1528 | 10.0222 | | | |
| | *3 | 56.1595 | 1.9084 | 1.53409 | 55.87 | 0.55858 |
| | *4 | 47.3119 | 1.2500 | | | |
| | 5 | −509.3540 | 2.0000 | 1.95906 | 17.47 | 0.65993 |
| | 6 | −150.0094 | DD[6] | | | |
| | *7 | 20.6983 | 2.4998 | 1.53409 | 55.87 | 0.55858 |
| | *8 | −43.8539 | DD[8] | | | |
| | 9(St) | ∞ | 1.9298 | | | |
| | 10 | −30.3454 | 2.6633 | 2.00330 | 28.27 | 0.59802 |
| | 11 | −531.1263 | 4.7107 | | | |
| Gois | *12 | 22.8858 | 4.1623 | 1.49700 | 81.54 | 0.53748 |
| | *13 | −20.8860 | DD[13] | | | |
| Gfoc | *14 | −31.1294 | 0.9214 | 1.53409 | 55.87 | 0.55858 |
| | *15 | 33.8795 | DD[15] | | | |
| | 16 | 83.3308 | 3.2498 | 1.48749 | 70.32 | 0.52917 |
| | 17 | −1355.3435 | 19.0900 | | | |

TABLE 59
Example 20

| | Wide | Middle | Tele |
|---|---|---|---|
| Zr | 1.0 | 1.5 | 1.8 |
| f | 23.76 | 34.92 | 43.48 |
| Bf | 19.09 | 19.09 | 19.09 |
| FNo. | 4.73 | 5.58 | 6.14 |
| 2ω[°] | 89.6 | 64.2 | 52.6 |
| DD[6] | 25.50 | 10.87 | 3.90 |
| DD[8] | 3.50 | 3.33 | 2.62 |
| DD[13] | 6.15 | 7.51 | 8.98 |
| DD[15] | 11.24 | 19.33 | 24.48 |

TABLE 60
Example 20

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −2.1278965E−05 | −4.1041372E−05 | −7.5323521E−06 | 2.4949939E−06 |
| A6 | 8.9996488E−08 | 5.9820480E−08 | −6.5495914E−08 | 1.1245882E−09 |
| A8 | −1.6885359E−10 | −5.8293562E−10 | 4.5540800E−10 | 2.5443893E−09 |
| A10 | −2.1236601E−12 | 9.6443458E−13 | 4.6863577E−11 | 7.6680432E−12 |
| A12 | 1.1968584E−14 | −1.3291478E−14 | 1.4411145E−12 | −1.7249099E−12 |
| A14 | 9.8839200E−18 | 1.3893283E−16 | −2.4866504E−14 | 1.2977960E−13 |
| A16 | 1.0471134E−20 | −6.4278348E−19 | −1.0381464E−15 | −3.4240062E−15 |
| A18 | −1.5417147E−21 | −7.5827158E−23 | 2.7747265E−17 | 4.0828455E−17 |

| Sn | 12 | 13 |
|---|---|---|
| KA | 1.0000000E+00 | 1.0000000E+00 |
| A4 | 7.0921358E−06 | 6.4665750E−05 |
| A6 | 4.4660324E−07 | 1.5696766E−07 |
| A8 | 4.1027530E−09 | 2.3330252E−08 |
| A10 | 5.1867799E−10 | −3.3855946E−10 |
| A12 | −1.8231979E−11 | 7.5361847E−12 |
| A14 | 3.6185812E−13 | −4.7248390E−14 |
| A16 | −1.9705864E−15 | 9.4665935E−16 |
| Sn | 14 | 15 |
| KA | 1.0000000E+00 | 1.0000000E+00 |
| A3 | 0.0000000E+00 | 0.0000000E+00 |
| A4 | 1.2074112E−04 | 1.4981529E−04 |
| A5 | −1.5418217E−05 | −1.8190636E−05 |
| A6 | −1.8690280E−06 | −6.7695944E−07 |
| A7 | 2.8341160E−07 | 1.2089620E−07 |
| A8 | 2.5366227E−08 | 1.9457400E−08 |
| A9 | −1.4537914E−09 | −3.2265550E−10 |
| A10 | −4.3820348E−10 | 3.4898762E−11 |
| A11 | 7.4053206E−12 | −3.9305408E−11 |
| A12 | 3.3870903E−12 | −2.4120121E−12 |
| A13 | −2.1238155E−13 | 1.5949479E−13 |
| A14 | 2.1570828E−14 | 6.0130310E−14 |
| A15 | −1.8008403E−15 | 5.6157542E−15 |
| A16 | 1.2838707E−15 | −6.4446219E−16 |
| A17 | −5.4778900E−17 | −6.6381495E−17 |
| A18 | −2.0653483E−17 | −1.6947313E−18 |
| A19 | −1.3690181E−19 | 9.4876458E−19 |
| A20 | 1.8869667E−19 | −3.0509018E−20 |

### Example 21

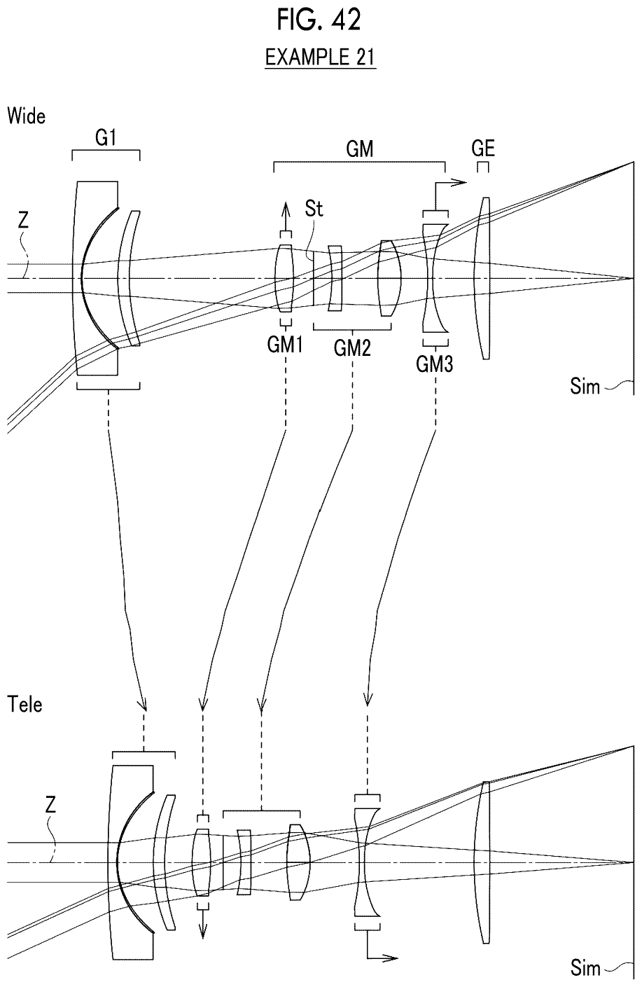

A configuration and a movement locus of a variable magnification optical system according to Example 21 are shown in FIG. 42. The variable magnification optical system according to Example 21 consists of, in order from the object side to the image side, the first lens group G1 having negative refractive power, the intermediate group GM, and the final lens group GE having positive refractive power. The lens closest to the object side of the first lens group G1 is a compound aspherical lens. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the first intermediate lens group GM1.

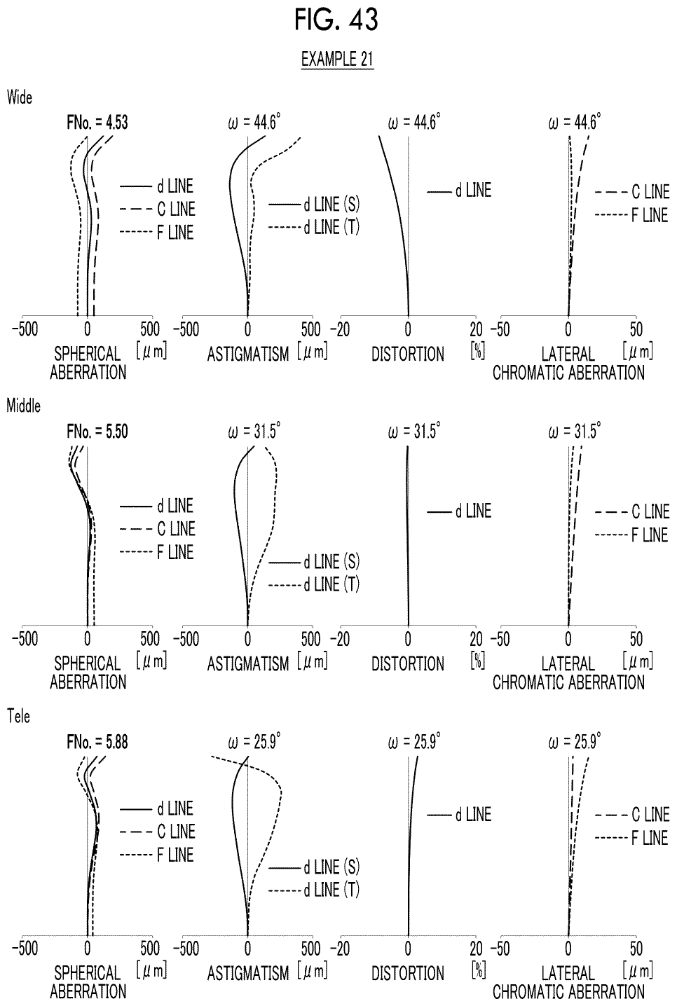

For the variable magnification optical system according to Example 21, basic lens data is shown in Table 61, specifications and variable surface spacings are shown in Table 62, aspherical coefficients are shown in Table 63, and each aberration diagram is shown in FIG. 43.

TABLE 61
Example 21

| | Sn | R | D | Nd | νd | θgF |
|---|---|---|---|---|---|---|
| | 1 | 185.0562 | 1.5500 | 1.64000 | 60.08 | 0.53704 |
| | 2 | 16.7436 | 0.1249 | 1.53409 | 55.87 | 0.55858 |
| | *3 | 15.0454 | 6.2502 | | | |
| | 4 | 33.5916 | 2.0000 | 1.95906 | 17.47 | 0.65993 |
| | 5 | 40.6615 | DD[5] | | | |
| Gois | *6 | 26.8721 | 3.2498 | 1.53409 | 55.87 | 0.55858 |
| | *7 | −30.2216 | DD[7] | | | |
| | 8(St) | ∞ | 3.0898 | | | |
| | 9 | −28.1446 | 1.7710 | 2.00330 | 28.27 | 0.59802 |
| | 10 | −194.0449 | 6.2500 | | | |
| | *11 | 31.1024 | 4.0795 | 1.49700 | 81.54 | 0.53748 |
| | *12 | −15.1705 | DD[12] | | | |
| Gfoc | *13 | −34.2801 | 0.8493 | 1.53409 | 55.87 | 0.55858 |
| | *14 | 31.2441 | DD[14] | | | |
| | 15 | 69.4427 | 2.7500 | 1.48749 | 70.32 | 0.52917 |
| | 16 | −1066.6714 | 25.1300 | | | |

TABLE 62
Example 21

| | Wide | Middle | Tele |
|---|---|---|---|
| Zr | 1.0 | 1.5 | 1.8 |
| f | 24.07 | 35.38 | 43.33 |
| Bf | 25.13 | 25.13 | 25.13 |
| FNo. | 4.52 | 5.50 | 5.88 |
| 2ω[°] | 89.2 | 63.0 | 51.8 |
| DD[5] | 25.46 | 11.90 | 4.78 |
| DD[7] | 3.50 | 2.17 | 2.19 |
| DD[12] | 4.65 | 6.35 | 8.51 |
| DD[14] | 7.26 | 17.47 | 19.19 |

TABLE 63
Example 21

| Sn | 3 | 6 | 7 |
|---|---|---|---|
| KA | 1.0000000E+00 | 1.0000000E+00 | 1.0000000E+00 |
| A4 | −1.3217695E−05 | 5.2889585E−05 | 8.2644412E−05 |
| A6 | −1.0844186E−07 | 1.2868519E−06 | 1.7868379E−06 |
| A8 | 6.4643436E−10 | 6.3995009E−09 | −1.6194921E−08 |
| A10 | −4.5327924E−12 | 1.4729312E−10 | 3.5872218E−10 |
| A12 | −1.4762379E−14 | 3.7978443E−13 | 1.8820156E−11 |
| A14 | 1.6849735E−16 | 9.1760867E−14 | 1.1458092E−13 |
| A16 | −2.9071388E−19 | 1.6782428E−15 | −1.6606464E−14 |
| A18 | −1.1565574E−21 | −2.1675876E−17 | 2.7649083E−16 |

| Sn | 11 | 12 |
|---|---|---|
| KA | 1.0000000E+00 | 1.0000000E+00 |
| A4 | −4.0344311E−05 | 5.0797975E−06 |
| A6 | 3.3279521E−07 | 2.7931771E−07 |
| A8 | −3.2485340E−08 | −1.1456043E−08 |
| A10 | 5.3242718E−10 | −3.6278413E−10 |
| A12 | −1.0277926E−11 | 1.0172397E−11 |
| A14 | 2.0319251E−13 | −5.4438656E−14 |
| A16 | −3.1956130E−15 | −1.3065060E−15 |

| Sn | 13 | 14 |
|---|---|---|
| KA | 1.0000000E+00 | 1.0000000E+00 |
| A3 | 0.0000000E+00 | 0.0000000E+00 |
| A4 | 1.9175072E−04 | 2.3500312E−04 |
| A5 | −2.1793217E−05 | −2.4355166E−05 |
| A6 | −2.0309977E−06 | −9.6265512E−07 |
| A7 | 2.7913600E−07 | 1.1565925E−07 |
| A8 | 2.5281350E−08 | 2.0727665E−08 |
| A9 | −1.5007113E−09 | −1.1434350E−10 |
| A10 | −4.3705714E−10 | 5.9266400E−11 |
| A11 | 9.5478130E−12 | −3.7809418E−11 |
| A12 | 3.6320147E−12 | −2.4493193E−12 |
| A13 | −1.7921201E−13 | 1.3591810E−13 |
| A14 | 2.3521457E−14 | 5.6560144E−14 |
| A15 | −1.9348817E−15 | 5.1002572E−15 |
| A16 | 1.1471274E−15 | −6.8224057E−16 |
| A17 | −7.6756416E−17 | −6.6021035E−17 |
| A18 | −2.3850757E−17 | −1.5248550E−18 |
| A19 | −1.5843298E−19 | 1.0111367E−18 |
| A20 | 2.5771848E−19 | −2.6240186E−20 |

### Example 22

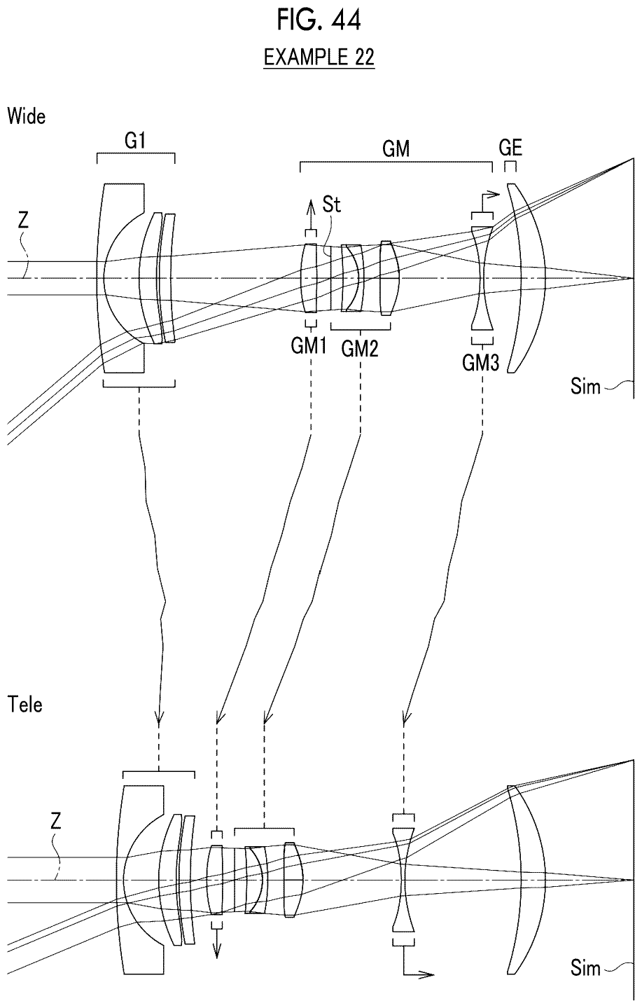

A configuration and a movement locus of a variable magnification optical system according to Example 22 are shown in FIG. 44. The variable magnification optical system according to Example 22 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the first intermediate lens group GM1.

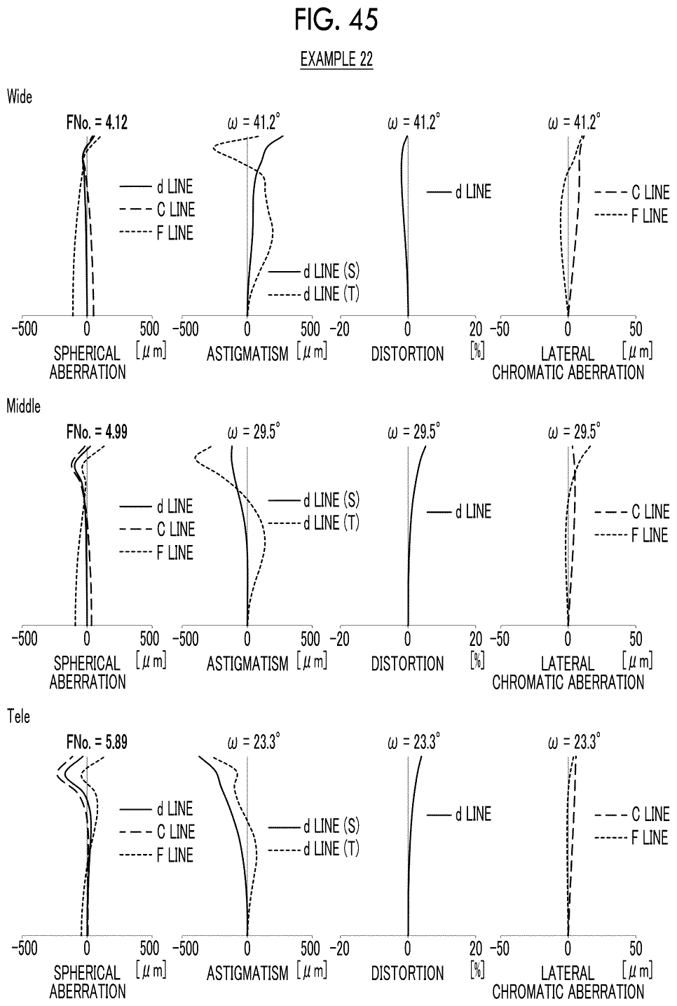

For the variable magnification optical system according to Example 22, basic lens data is shown in Table 64, specifications and variable surface spacings are shown in Table 65, aspherical coefficients are shown in Table 66, and each aberration diagram is shown in FIG. 45.

TABLE 64
Example 22

| | Sn | R | D | Nd | νd | θgF |
|---|---|---|---|---|---|---|
| | 1 | 106.4177 | 1.2498 | 1.64000 | 60.08 | 0.53704 |
| | 2 | 13.4070 | 6.1600 | | | |
| | *3 | 26.9273 | 3.0487 | 1.53409 | 55.87 | 0.55858 |
| | *4 | 38.9835 | 0.5000 | | | |
| | 5 | 61.6758 | 2.0000 | 1.95906 | 17.47 | 0.65993 |
| | 6 | 86.4570 | DD[6] | | | |
| Gois | *7 | 27.3268 | 2.8215 | 1.53409 | 55.87 | 0.55858 |
| | *8 | −76.8062 | DD[8] | | | |
| | 9(St) | ∞ | 2.1416 | | | |
| | 10 | −65.9541 | 2.7638 | 1.52841 | 76.45 | 0.53954 |
| | 11 | −8.5209 | 0.9200 | 1.80400 | 46.53 | 0.55775 |
| | 12 | −32.3609 | 2.8252 | | | |
| | *13 | 1484.2423 | 3.3502 | 1.49700 | 81.54 | 0.53748 |
| | *14 | −12.9882 | DD[14] | | | |
| Gfoc | *15 | −26.2998 | 0.6248 | 1.53409 | 55.87 | 0.55858 |
| | *16 | 28.6085 | DD[16] | | | |
| | 17 | −58.1383 | 4.2502 | 1.80400 | 46.53 | 0.55775 |
| | 18 | −29.4410 | 15.4600 | | | |

TABLE 65
Example 22

| | Wide | Middle | Tele |
|---|---|---|---|
| Zr | 1.0 | 1.5 | 2.0 |
| f | 24.78 | 36.42 | 48.32 |
| Bf | 15.46 | 15.46 | 15.46 |
| FNo. | 4.12 | 4.99 | 5.90 |
| 2ω[°] | 82.4 | 59.0 | 46.6 |
| DD[6] | 22.77 | 9.69 | 2.86 |
| DD[8] | 2.34 | 2.39 | 2.05 |
| DD[14] | 14.17 | 15.81 | 17.12 |
| DD[16] | 6.58 | 13.31 | 20.38 |

TABLE 66
Example 22

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −7.1177616E−06 | −3.2030991E−05 | 4.5351984E−05 | 6.0983752E−05 |
| A6 | 1.5428948E−07 | 1.3158683E−07 | 8.3743667E−07 | 9.3897168E−07 |
| A8 | −3.8341590E−10 | −1.7627687E−09 | 8.4622492E−09 | 4.5640801E−09 |
| A10 | −6.8175060E−12 | −2.9018966E−13 | 7.7091352E−11 | 1.0183844E−10 |
| A12 | 1.2312712E−14 | −1.1203533E−14 | 1.1014349E−12 | 1.0453858E−12 |
| A14 | 1.2851112E−16 | 2.4744986E−16 | −4.5536542E−14 | 1.8248205E−13 |
| A16 | 3.9366559E−19 | 1.0320235E−19 | 1.2253190E−15 | −7.3232516E−15 |
| A18 | −4.2916992E−21 | −6.6268922E−21 | −6.2925647E−18 | 8.9840329E−17 |

| Sn | 13 | 14 |
|---|---|---|
| KA | 1.0000000E+00 | 1.0000000E+00 |
| A4 | 4.1843975E−05 | 6.5688504E−05 |
| A6 | 7.2019276E−07 | 5.0395017E−07 |
| A8 | 1.0998350E−08 | 2.3354607E−08 |
| A10 | 4.9053724E−10 | −2.1683444E−10 |
| A12 | −1.7682072E−11 | 7.8889185E−12 |
| A14 | 4.6385117E−13 | −8.7592406E−14 |
| A16 | −2.9439315E−15 | 2.4642495E−15 |
| Sn | 15 | 16 |
| KA | 1.0000000E+00 | 1.0000000E+00 |
| A3 | 0.0000000E+00 | 0.0000000E+00 |
| A4 | 1.4674716E−04 | 1.8372526E−04 |
| A5 | −2.4934399E−05 | −2.7945157E−05 |
| A6 | −1.5858717E−06 | −6.4750012E−07 |
| A7 | 2.6745986E−07 | 1.4872546E−07 |
| A8 | 2.2900553E−08 | 2.0752702E−08 |
| A9 | −1.2488726E−09 | −3.2211589E−10 |
| A10 | −3.7216122E−10 | 2.3005443E−11 |
| A11 | 1.1379010E−11 | −4.0726239E−11 |
| A12 | 2.8884134E−12 | −2.5518827E−12 |
| A13 | −4.1041772E−13 | 1.4685845E−13 |
| A14 | −1.3486754E−14 | 6.2039339E−14 |
| A15 | −6.4878004E−16 | 5.8256248E−15 |
| A16 | 2.5399409E−15 | 6.0823153E−16 |
| A17 | −2.0037688E−16 | −6.9599845E−17 |
| A18 | −1.9869764E−17 | −1.5739140E−18 |
| A19 | 2.7215063E−18 | 9.3684664E−19 |
| A20 | −8.1952131E−20 | −3.3621206E−20 |

### Example 23

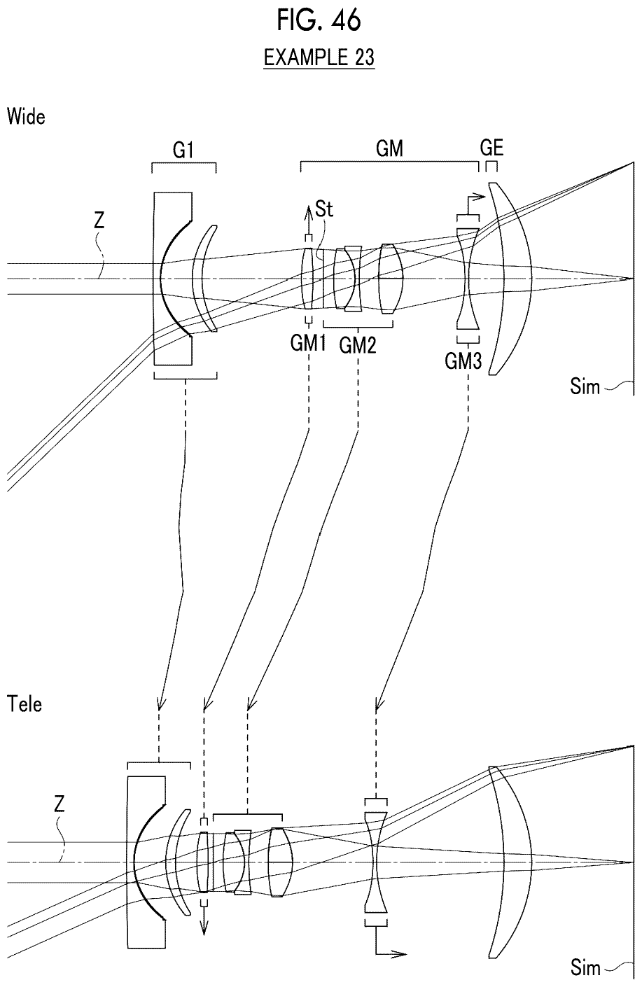

A configuration and a movement locus of a variable magnification optical system according to Example 23 are shown in FIG. 46. The variable magnification optical system according to Example 23 consists of, in order from the object side to the image side, the first lens group G1 having negative refractive power, the intermediate group GM, and the final lens group GE having positive refractive power. The lens closest to the object side of the first lens group G1 is a compound aspherical lens. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the first intermediate lens group GM1.

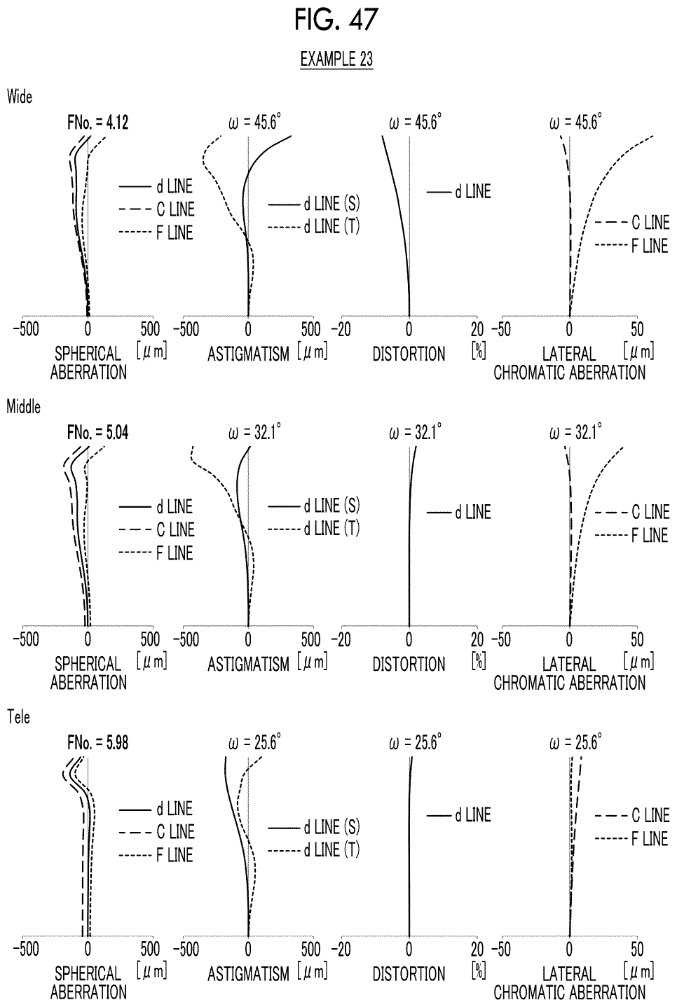

For the variable magnification optical system according to Example 23, basic lens data is shown in Table 67, specifications and variable surface spacings are shown in Table 68, aspherical coefficients are shown in Table 69, and each aberration diagram is shown in FIG. 47.

TABLE 67
Example 23

| | Sn | R | D | Nd | νd | θgF |
|---|---|---|---|---|---|---|
| | 1 | 585.9153 | 1.2499 | 1.64000 | 60.08 | 0.53704 |
| | 2 | 13.1216 | 0.0752 | 1.53409 | 55.87 | 0.55858 |
| | *3 | 11.9967 | 5.5002 | | | |
| | 4 | 15.7652 | 1.7078 | 1.95906 | 17.47 | 0.65993 |
| | 5 | 18.2714 | DD[5] | | | |
| Gois | *6 | 29.9997 | 1.9998 | 1.53409 | 55.87 | 0.55858 |
| | *7 | −48.4776 | DD[7] | | | |
| | 8(St) | ∞ | 1.7498 | | | |
| | 9 | 27.9163 | 3.7525 | 1.52841 | 76.45 | 0.53954 |
| | 10 | −8.8950 | 0.7498 | 1.80400 | 46.53 | 0.55775 |
| | 11 | 45.3290 | 3.3786 | | | |
| | *12 | 34.0795 | 4.2499 | 1.49700 | 81.54 | 0.53748 |
| | *13 | −11.3242 | DD[13] | | | |
| Gfoc | *14 | −26.4377 | 0.6248 | 1.53409 | 55.87 | 0.55858 |
| | *15 | 24.5943 | DD[15] | | | |
| | 16 | −58.1383 | 4.8493 | 1.80400 | 46.53 | 0.55775 |
| | 17 | −28.5507 | 17.8500 | | | |

TABLE 68
Example 23

| | Wide | Middle | Tele |
|---|---|---|---|
| Zr | 1.0 | 1.5 | 2.0 |
| f | 23.00 | 33.80 | 44.85 |
| Bf | 17.85 | 17.85 | 17.85 |
| FNo. | 4.12 | 5.04 | 5.98 |
| 2ω[°] | 91.2 | 64.2 | 51.2 |
| DD[5] | 17.39 | 8.39 | 3.73 |
| DD[7] | 1.75 | 1.50 | 0.84 |
| DD[13] | 10.84 | 12.61 | 13.97 |
| DD[15] | 6.18 | 14.08 | 22.25 |

TABLE 69
Example 23

| Sn | 6 | 7 |
|---|---|---|
| KA | 1.0000000E+00 | 1.0000000E+00 |
| A4 | 6.0722360E−05 | 5.7554286E−05 |
| A6 | 1.6555149E−06 | 1.3548445E−06 |
| A8 | 1.6437878E−08 | 3.8516485E−08 |
| A10 | 5.4501595E−10 | 7.2395965E−10 |
| A12 | 3.1500175E−11 | −9.3784414E−12 |
| A14 | −4.4341890E−13 | 4.4568107E−13 |
| A16 | −1.2207516E−14 | −7.8763710E−15 |
| A18 | 4.4157618E−16 | 3.7087382E−16 |

| Sn | 3 | 12 | 13 |
|---|---|---|---|
| KA | 1.0000000E+00 | 1.0000000E+00 | 1.0000000E+00 |
| A4 | −2.3783657E−05 | −9.9642661E−06 | 6.6362927E−05 |
| A6 | −1.5196122E−07 | −5.8930576E−08 | 2.9155469E−07 |
| A8 | −2.1803104E−09 | 2.0118074E−08 | 4.5850512E−09 |
| A10 | 4.3244224E−11 | 1.8702609E−10 | 1.6786470E−10 |
| A12 | −7.2468890E−13 | −1.8485363E−11 | 7.3633761E−12 |
| A14 | 5.4970500E−15 | 5.1735736E−13 | −3.1298044E−13 |
| A16 | −2.1408044E−17 | −2.7834839E−15 | 5.4977222E−15 |

| Sn | 14 | 15 |
|---|---|---|
| KA | 1.0000000E+00 | 1.0000000E+00 |
| A3 | 0.0000000E+00 | 0.0000000E+00 |
| A4 | 1.2232425E−04 | 1.6419853E−04 |
| A5 | −2.8625625E−05 | −3.0224905E−05 |
| A6 | −1.0046356E−06 | −4.1974339E−07 |
| A7 | 2.7668488E−07 | 1.9022836E−07 |
| A8 | 1.9084063E−08 | 2.1264605E−08 |
| A9 | −1.8853998E−09 | −7.2046961E−10 |
| A10 | −3.6960605E−10 | −1.9724584E−11 |
| A11 | 2.3062200E−11 | −4.0855386E−11 |
| A12 | 3.6030990E−12 | −3.0330109E−12 |
| A13 | −2.8182852E−13 | 3.4289557E−13 |
| A14 | −5.9223706E−16 | 6.6696907E−14 |
| A15 | −8.4760252E−15 | 5.8739690E−15 |
| A16 | 1.9132321E−15 | −8.9798359E−16 |
| A17 | −1.1094864E−16 | −7.8309778E−17 |
| A18 | −1.6063166E−17 | 1.9124231E−19 |
| A19 | 3.8703970E−18 | 1.1036797E−18 |
| A20 | −2.3117426E−19 | −4.5781850E−20 |

### Example 24

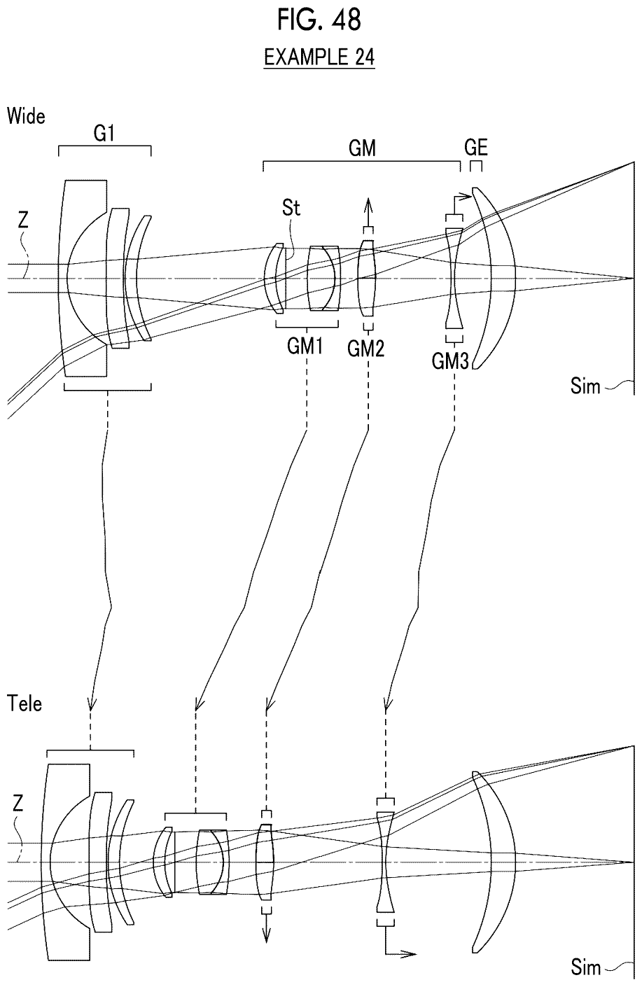

A configuration and a movement locus of a variable magnification optical system according to Example 24 are shown in FIG. 48. The variable magnification optical system according to Example 24 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the second intermediate lens group GM2.

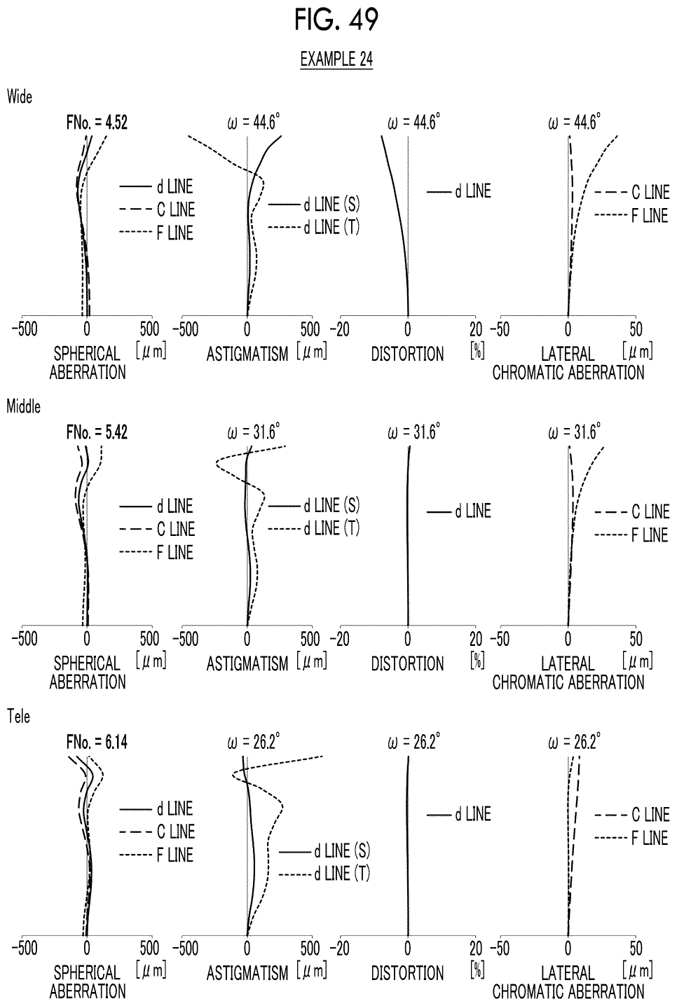

For the variable magnification optical system according to Example 24, basic lens data is shown in Table 70, specifications and variable surface spacings are shown in Table 71, aspherical coefficients are shown in Table 72, and each aberration diagram is shown in FIG. 49.

TABLE 70
Example 24

| | Sn | R | D | Nd | νd | θgF |
|---|---|---|---|---|---|---|
| | 1 | 133.0587 | 1.5502 | 1.64000 | 60.08 | 0.53704 |
| | 2 | 14.3920 | 6.8239 | | | |
| | *3 | −651.5956 | 3.0002 | 1.53409 | 55.87 | 0.55858 |
| | *4 | 111.9509 | 0.3000 | | | |
| | 5 | 21.6933 | 2.0000 | 1.95906 | 17.47 | 0.65993 |
| | 6 | 26.1977 | DD[6] | | | |
| | *7 | 10.9519 | 1.9998 | 1.53409 | 55.87 | 0.55858 |
| | *8 | 14.1830 | 1.7498 | | | |
| | 9(St) | ∞ | 3.7500 | | | |
| | 10 | 30.9190 | 4.7489 | 1.52841 | 76.45 | 0.53954 |
| | 11 | −8.7840 | 1.0002 | 1.80400 | 46.53 | 0.55775 |
| | 12 | −38.8777 | DD[12] | | | |
| Gois | *13 | 48.5243 | 3.1017 | 1.49700 | 81.54 | 0.53748 |
| | *14 | −26.2362 | DD[14] | | | |
| Gfoc | *15 | −62.2809 | 0.6250 | 1.53409 | 55.87 | 0.55858 |
| | *16 | 25.9458 | DD[16] | | | |
| | 17 | −39.6820 | 4.2502 | 1.80400 | 46.53 | 0.55775 |
| | 18 | −24.4892 | 20.7100 | | | |

TABLE 71
Example 24

| | Wide | Middle | Tele |
|---|---|---|---|
| Zr | 1.0 | 1.5 | 1.8 |
| f | 23.82 | 35.02 | 43.84 |
| Bf | 20.71 | 20.71 | 20.71 |
| FNo. | 4.53 | 5.42 | 6.14 |
| 2ω[°] | 89.2 | 63.2 | 52.4 |
| DD[6] | 22.32 | 10.75 | 5.90 |
| DD[12] | 2.99 | 4.02 | 4.69 |
| DD[14] | 13.18 | 16.71 | 18.86 |
| DD[16] | 6.43 | 12.75 | 18.44 |

TABLE 72
Example 24

| Sn | 3 | 4 | 7 | 8 |
|---|---|---|---|---|
| KA | 1.0000000E+00 | 1.0000000E+00 | 1.0000000E+00 | 1.0000000E+00 |
| A4 | 5.3549953E−05 | 4.0119875E−05 | 1.6386140E−05 | 3.4576447E−05 |
| A6 | −8.5977815E−08 | −1.2055973E−07 | 2.0148224E−07 | 1.7919530E−07 |
| A8 | 1.5227920E−10 | −2.6168400E−10 | 4.4341826E−09 | 2.1156681E−10 |
| A10 | −1.5218177E−12 | 8.6410599E−13 | 1.0109752E−11 | −7.8556080E−11 |
| A12 | 9.6447028E−15 | −1.0864556E−14 | −4.2736516E−12 | −2.9057582E−12 |
| A14 | 1.4197182E−17 | 1.3883872E−16 | −8.9553247E−14 | 1.0531738E−13 |
| A16 | 1.0738406E−19 | −7.2481541E−19 | 9.4441021E−15 | 3.7860622E−16 |
| A18 | −1.8367687E−21 | −5.5510250E−22 | −1.2468681E−16 | −1.3036868E−17 |

| Sn | 13 | 14 |
|---|---|---|
| KA | 1.0000000E+00 | 1.0000000E+00 |
| A4 | 1.1232178E−04 | 1.1995714E−04 |
| A6 | 1.0913042E−06 | 8.5033038E−07 |
| A8 | 3.6646386E−09 | 2.5920335E−08 |
| A10 | 4.8400688E−10 | −3.2471580E−10 |
| A12 | −1.8198546E−11 | 7.2883518E−12 |
| A14 | 3.6767963E−13 | −7.7717623E−14 |
| A16 | −2.2065845E−15 | 1.3596287E−15 |
| Sn | 15 | 16 |
| KA | 1.0000000E+00 | 1.0000000E+00 |
| A3 | 0.0000000E+00 | 0.0000000E+00 |
| A4 | 8.0335015E−06 | 5.4888527E−05 |
| A5 | −1.2209337E−05 | −1.8525056E−05 |
| A6 | −1.9414097E−06 | −4.3626526E−07 |
| A7 | 2.5907714E−07 | 1.3228902E−07 |
| A8 | 2.5005940E−08 | 1.9312061E−08 |
| A9 | −1.1491322E−09 | −3.8847599E−10 |
| A10 | −3.9659059E−10 | 2.6698719E−11 |
| A11 | 8.4182172E−12 | −4.0029282E−11 |
| A12 | 2.7956763E−12 | −2.4775245E−12 |
| A13 | −3.4033921E−13 | 1.4885500E−13 |
| A14 | 7.7338414E−15 | 5.9909883E−14 |
| A15 | −2.7736032E−15 | 5.6432832E−15 |
| A16 | 1.5060036E−15 | −6.3989082E−16 |
| A17 | −1.1260004E−17 | −6.4206191E−17 |
| A18 | −2.2727970E−17 | −1.3515936E−18 |
| A19 | 8.5600335E−19 | 9.2410098E−19 |
| A20 | 4.6086224E−20 | −3.4485327E−20 |

### Example 25

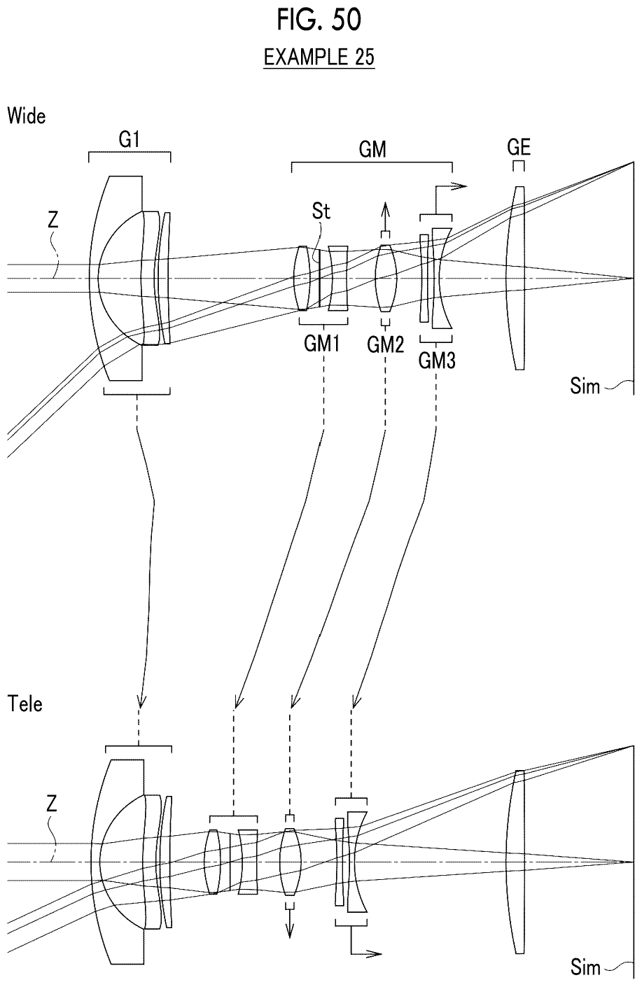

A configuration and a movement locus of a variable magnification optical system according to Example 25 are shown in FIG. 50. The variable magnification optical system according to Example 25 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the second intermediate lens group GM2.

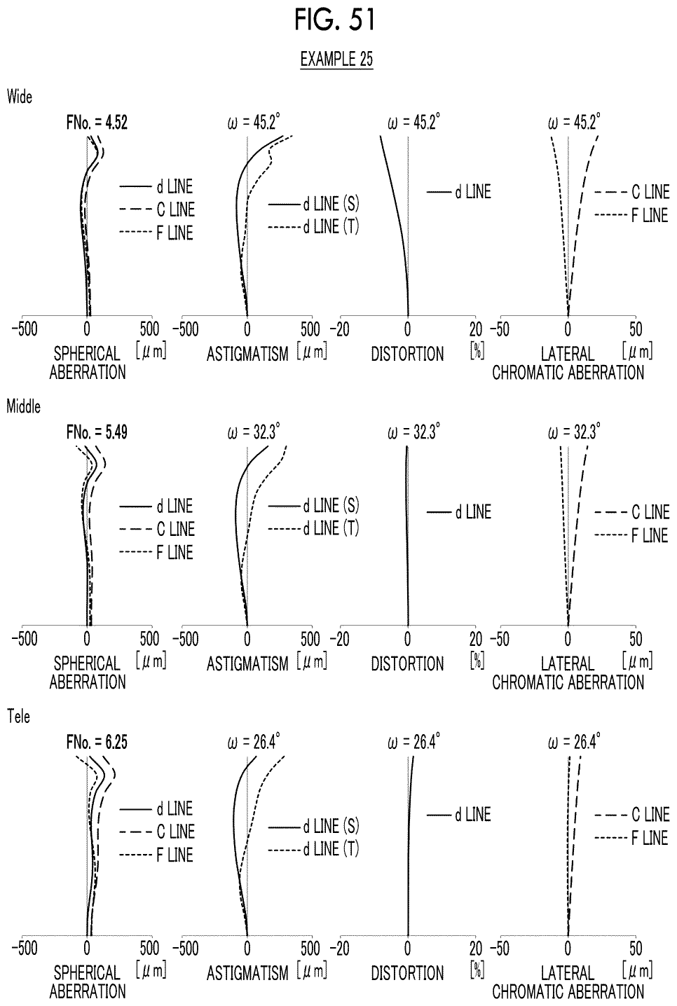

For the variable magnification optical system according to Example 25, basic lens data is shown in Table 73, specifications and variable surface spacings are shown in Table 74, aspherical coefficients are shown in Table 75, and each aberration diagram is shown in FIG. 51.

TABLE 73
Example 25

| | Sn | R | D | Nd | νd | θgF |
|---|---|---|---|---|---|---|
| | 1 | 52.9065 | 1.5502 | 1.77535 | 50.30 | 0.55004 |
| | 2 | 13.9910 | 7.5002 | | | |
| | *3 | 51.0570 | 2.2842 | 1.53409 | 55.87 | 0.55858 |
| | *4 | 29.3441 | 0.7000 | | | |
| | 5 | 62.4996 | 1.7543 | 1.95906 | 17.47 | 0.65993 |
| | 6 | 212.9041 | DD[6] | | | |
| | *7 | 18.0577 | 2.8474 | 1.53409 | 55.87 | 0.55858 |
| | *8 | −29.3686 | 1.6500 | | | |
| | 9(St) | ∞ | 2.1672 | | | |
| | 10 | −25.4035 | 2.5002 | 2.00330 | 28.27 | 0.59802 |
| | 11 | 107.7453 | DD[11] | | | |
| Gois | *12 | 18.3076 | 3.7502 | 1.48749 | 70.32 | 0.52917 |
| | *13 | −14.9016 | DD[13] | | | |
| Gfoc | *14 | −55.7288 | 1.0002 | 1.53409 | 55.87 | 0.55858 |
| | *15 | −424.8731 | 1.1751 | | | |
| | 16 | −82.4242 | 0.8752 | 1.51680 | 64.20 | 0.53430 |
| | 17 | 20.6498 | DD[17] | | | |
| | 18 | 83.3308 | 3.2498 | 1.48749 | 70.32 | 0.52917 |
| | 19 | −1438.6843 | 19.0700 | | | |

TABLE 74
Example 25

| | Wide | Middle | Tele |
|---|---|---|---|
| Zr | 1.0 | 1.5 | 1.8 |
| f | 23.41 | 34.41 | 42.84 |
| Bf | 19.07 | 19.07 | 19.07 |
| FNo. | 4.52 | 5.48 | 6.24 |
| 2ω[°] | 90.4 | 64.6 | 52.8 |
| DD[6] | 21.96 | 10.61 | 6.01 |
| DD[11] | 5.00 | 4.56 | 4.03 |
| DD[13] | 4.38 | 5.44 | 6.17 |
| DD[17] | 11.69 | 20.33 | 26.52 |

TABLE 75
Example 25

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −4.9854560E−05 | −7.9827780E−05 | −2.2963218E−05 | −2.4639246E−07 |
| A6 | 4.5841019E−08 | 5.3321302E−08 | −2.3140071E−07 | −3.9072009E−07 |
| A8 | 3.7810979E−10 | −4.8573865E−10 | −8.4899097E−09 | 9.2272844E−09 |
| A10 | −4.9709119E−12 | 2.2737806E−12 | 3.0716550E−10 | −1.3715985E−10 |
| A12 | 9.3904702E−15 | −2.1081514E−14 | −9.1867881E−12 | −7.9628688E−12 |
| A14 | 3.5723203E−17 | 6.7807851E−17 | 8.3539077E−14 | 1.6078857E−13 |
| A16 | 1.0150626E−19 | −8.6276456E−19 | −2.1401132E−15 | 6.8835419E−16 |
| A18 | −4.0800914E−21 | 2.2644302E−21 | 5.1164045E−18 | −7.8420721E−17 |

| Sn | 12 | 13 |
|---|---|---|
| KA | 1.0000000E+00 | 1.0000000E+00 |
| A4 | −4.7396505E−05 | 8.7853710E−05 |
| A6 | −2.3284850E−07 | −1.1262724E−06 |
| A8 | 2.0997806E−09 | 4.0762855E−08 |
| A10 | 5.4157891E−10 | −7.2083602E−10 |
| A12 | −2.4987342E−11 | 2.3601634E−12 |
| A14 | 4.9660912E−13 | 1.5297966E−13 |
| A16 | −2.6538339E−15 | −7.2932815E−16 |
| Sn | 14 | 15 |
| KA | 1.0000000E+00 | 1.0000000E+00 |
| A3 | 0.0000000E+00 | 0.0000000E+00 |
| A4 | 2.1064220E−04 | 2.0935058E−04 |
| A5 | −2.5706267E−05 | −1.9920044E−05 |
| A6 | −1.1240554E−06 | −7.7591965E−07 |
| A7 | 2.5651640E−07 | 1.2071327E−07 |
| A8 | 2.2130838E−08 | 1.9539455E−08 |
| A9 | −1.6272612E−09 | −3.1895538E−10 |
| A10 | −4.6120869E−10 | 3.5110881E−11 |
| A11 | 1.0201575E−11 | −3.9272734E−11 |
| A12 | 4.3326082E−12 | −2.4074711E−12 |
| A13 | 6.3788014E−15 | 1.5989261E−13 |
| A14 | 4.0880083E−14 | 6.0272298E−14 |
| A15 | −1.8352284E−15 | 5.6224995E−15 |
| A16 | −1.3827733E−16 | −6.4756590E−16 |
| A17 | −2.3506200E−16 | −6.5900234E−17 |
| A18 | 2.0020360E−17 | −1.6472299E−18 |
| A19 | −1.6578470E−18 | 9.5374312E−19 |
| A20 | 2.6688765E−19 | −3.0712043E−20 |

### Example 26

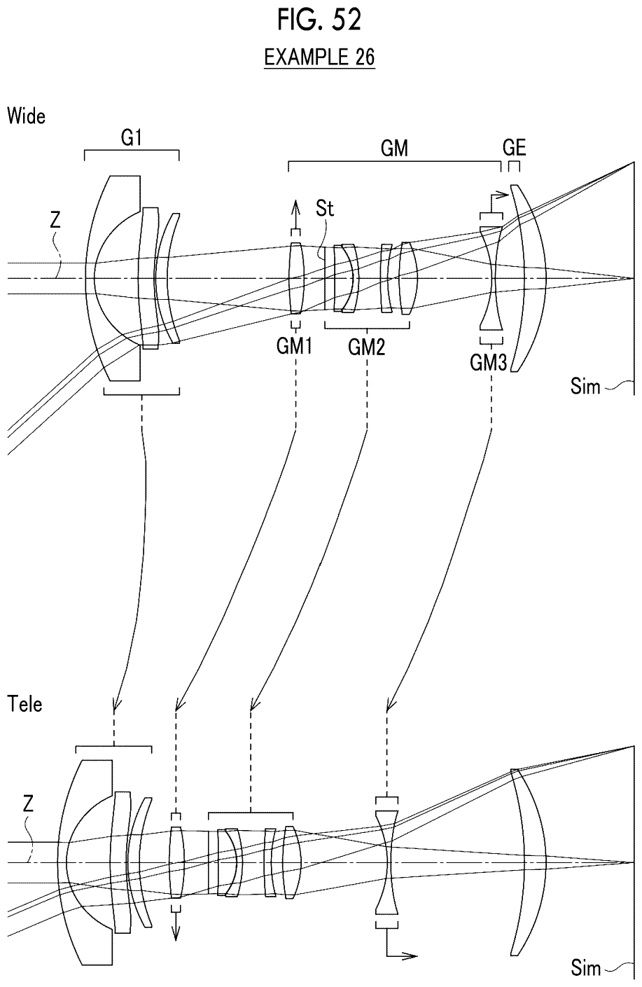

A configuration and a movement locus of a variable magnification optical system according to Example 26 are shown in FIG. 52. The variable magnification optical system according to Example 26 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the first intermediate lens group GM1.

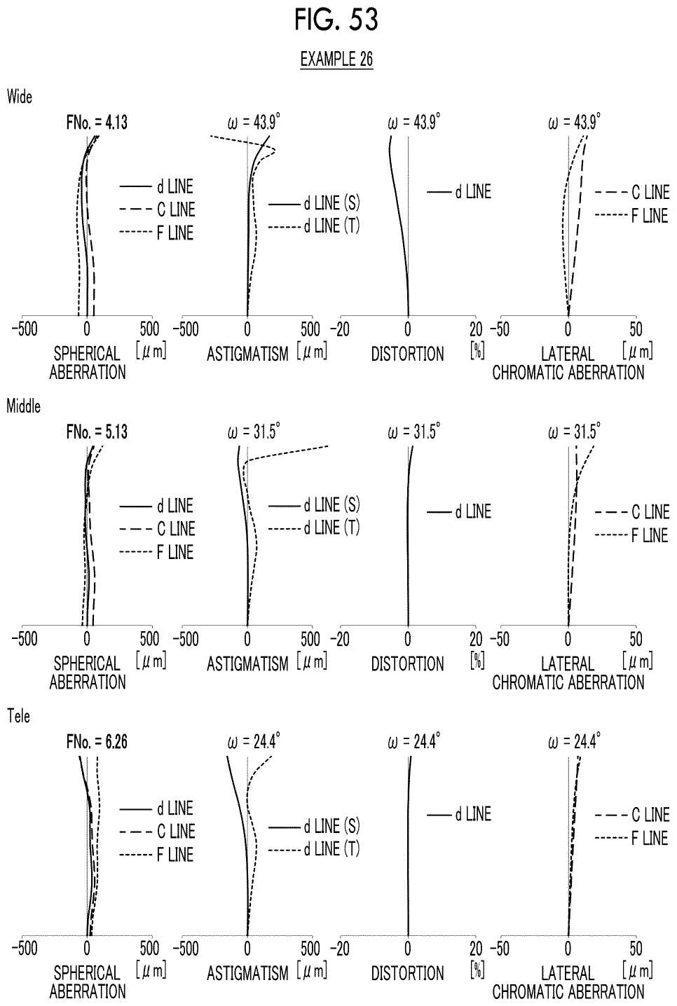

For the variable magnification optical system according to Example 26, basic lens data is shown in Table 76, specifications and variable surface spacings are shown in Table 77, aspherical coefficients are shown in Table 78, and each aberration diagram is shown in FIG. 53.

TABLE 76
Example 26

| | Sn | R | D | Nd | νd | θgF |
|---|---|---|---|---|---|---|
| | 1 | 44.1863 | 1.5502 | 1.77535 | 50.30 | 0.55004 |
| | 2 | 13.6038 | 7.6538 | | | |
| | *3 | 61.4173 | 2.8011 | 1.53409 | 55.87 | 0.55858 |
| | *4 | 42.2803 | 0.3000 | | | |
| | 5 | 25.6599 | 2.0000 | 1.95906 | 17.47 | 0.65993 |
| | 6 | 32.2384 | DD[6] | | | |
| Gois | *7 | 48.3832 | 2.6452 | 1.53409 | 55.87 | 0.55858 |
| | *8 | −35.2912 | DD[8] | | | |
| | 9(St) | ∞ | 1.7498 | | | |
| | 10 | −171.4746 | 3.2062 | 1.52841 | 76.45 | 0.53954 |
| | 11 | −9.7364 | 1.0002 | 1.80400 | 46.53 | 0.55775 |
| | 12 | −22.9229 | 3.7896 | | | |
| | 13 | 80.5165 | 1.2502 | 1.84666 | 23.78 | 0.62054 |
| | 14 | 25.0646 | 2.0090 | | | |
| | 15 | 39.0680 | 3.2028 | 1.54072 | 47.23 | 0.56511 |
| | 16 | −16.6615 | DD[16] | | | |
| Gfoc | *17 | −18.0602 | 0.6248 | 1.53409 | 55.87 | 0.55858 |
| | *18 | 53.1898 | DD[18] | | | |
| | 19 | −60.6651 | 3.7795 | 1.80400 | 46.53 | 0.55775 |
| | 20 | −32.4754 | 15.4100 | | | |

TABLE 77
Example 26

| | Wide | Middle | Tele |
|---|---|---|---|
| Zr | 1.0 | 1.5 | 2.0 |
| f | 23.70 | 34.83 | 47.40 |
| Bf | 15.41 | 15.41 | 15.41 |
| FNo. | 4.13 | 5.13 | 6.26 |
| 2ω[°] | 87.8 | 63.0 | 48.8 |
| DD[6] | 21.31 | 11.19 | 5.24 |
| DD[8] | 3.50 | 4.22 | 4.20 |
| DD[16] | 13.01 | 14.01 | 15.00 |
| DD[18] | 5.08 | 13.73 | 23.36 |

TABLE 78
Example 26

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −1.8079756E−05 | −3.5775889E−05 | −3.2393019E−05 | −1.8228199E−05 |
| A6 | 1.0980709E−07 | 7.5289484E−08 | 7.1250468E−08 | −4.0419566E−07 |
| A8 | −1.2268428E−09 | −1.5746749E−09 | −1.8247950E−08 | 1.1798138E−08 |
| A10 | 5.7247054E−12 | 2.4969273E−12 | 5.0160097E−10 | −5.7362010E−10 |
| A12 | −2.8094995E−14 | 8.7581957E−15 | −4.0540065E−12 | 3.7750482E−12 |
| A14 | −9.8875501E−17 | 1.5524551E−16 | −2.0084485E−13 | 3.3206944E−13 |
| A16 | 3.3285940E−18 | −8.6113830E−19 | 4.1131612E−15 | −1.0464293E−14 |
| A18 | −1.3498324E−20 | −2.2228922E−21 | −2.3292938E−17 | 9.0458554E−17 |

| Sn | 17 | 18 |
|---|---|---|
| KA | 1.0000000E+00 | 1.0000000E+00 |
| A3 | 0.0000000E+00 | 0.0000000E+00 |
| A4 | 1.1802464E−04 | 1.4381854E−04 |
| A5 | −1.0177301E−05 | −1.4904184E−05 |
| A6 | −1.5606385E−06 | −2.7948588E−07 |
| A7 | 2.0855294E−07 | 7.3062021E−08 |
| A8 | 2.2543141E−08 | 1.2299922E−08 |
| A9 | −1.1913830E−09 | −6.9738854E−10 |
| A10 | −4.1047450E−10 | 6.9952783E−11 |
| A11 | 1.3449841E−12 | −3.2828687E−11 |
| A12 | 1.9648343E−12 | −1.8123543E−12 |
| A13 | −2.6116545E−13 | 1.6346048E−13 |
| A14 | 3.2043359E−14 | 5.5918808E−14 |
| A15 | −9.5852059E−17 | 4.9945703E−15 |
| A16 | 1.5612712E−15 | −7.2718655E−16 |
| A17 | −3.6833901E−17 | −6.2375174E−17 |
| A18 | −2.1432033E−17 | −8.6871992E−19 |
| A19 | −7.2342135E−19 | 1.0391671E−18 |
| A20 | 1.7287949E−19 | −4.3317618E−20 |

### Example 27

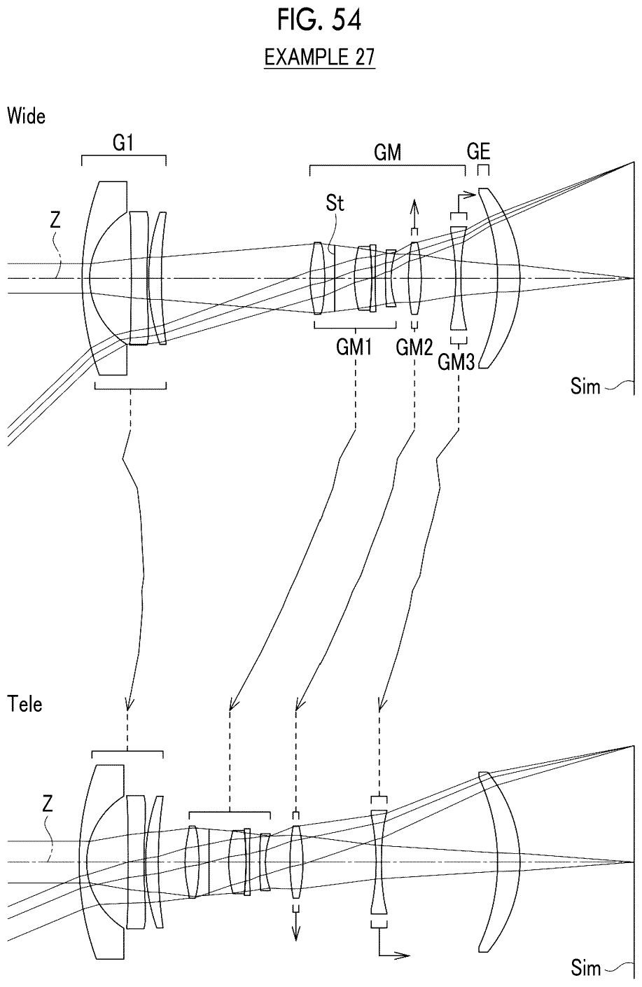

A configuration and a movement locus of a variable magnification optical system according to Example 27 are shown in FIG. 54. The variable magnification optical system according to Example 27 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the second intermediate lens group GM2.

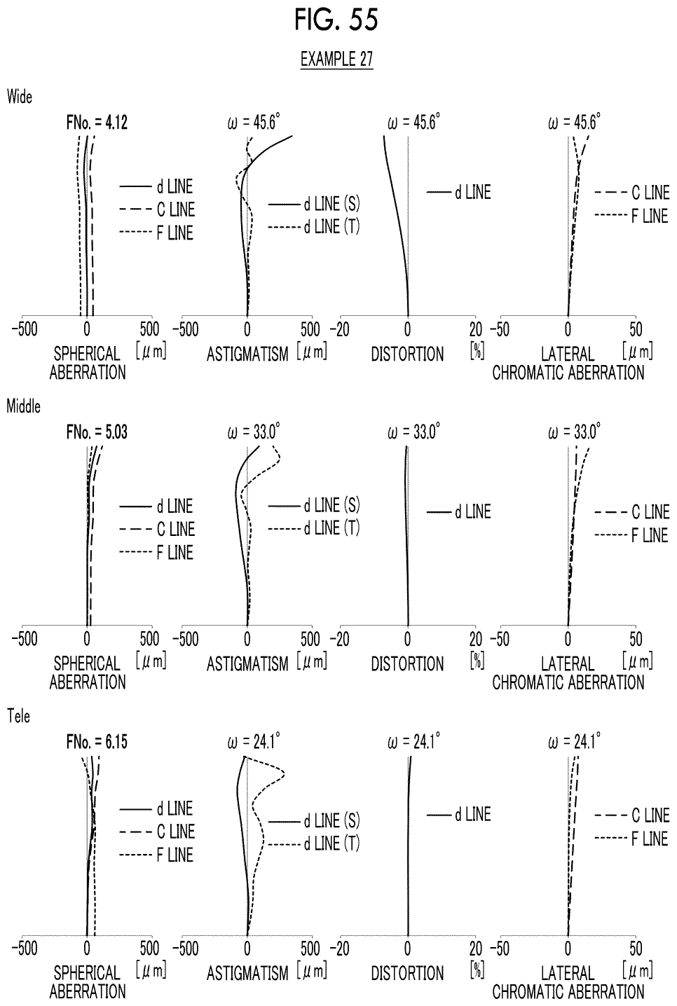

For the variable magnification optical system according to Example 27, basic lens data is shown in Table 79, specifications and variable surface spacings are shown in Table 80, aspherical coefficients are shown in Table 81, and each aberration diagram is shown in FIG. 55.

TABLE 79
Example 27

| | Sn | R | D | Nd | νd | θgF |
|---|---|---|---|---|---|---|
| | 1 | 55.3383 | 1.3100 | 1.89190 | 37.13 | 0.57813 |
| | 2 | 14.8725 | 7.2500 | | | |
| | *3 | −440.8579 | 2.7502 | 1.53409 | 55.87 | 0.55858 |
| | *4 | 108.1556 | 0.3000 | | | |
| | 5 | 39.4491 | 2.2035 | 1.95906 | 17.47 | 0.65993 |
| | 6 | 88.1855 | DD[6] | | | |
| | *7 | 23.0730 | 2.4474 | 1.53409 | 55.87 | 0.55858 |
| | *8 | −46.6044 | 1.7500 | | | |
| | 9(St) | ∞ | 3.4407 | | | |
| | 10 | 23.6314 | 3.0102 | 1.52841 | 76.45 | 0.53954 |
| | 11 | −61.0241 | 0.6248 | 1.80400 | 46.53 | 0.55775 |
| | 12 | 210.2352 | 1.7690 | | | |
| | 13 | 75.9025 | 0.9998 | 1.84666 | 23.78 | 0.62054 |
| | 14 | 16.0896 | DD[14] | | | |
| Gois | 15 | 41.1050 | 2.2500 | 1.61772 | 49.81 | 0.56035 |
| | 16 | −32.6582 | DD[16] | | | |
| Gfoc | *17 | −41.2030 | 0.9116 | 1.53409 | 55.87 | 0.55858 |
| | *18 | 64.3183 | DD[18] | | | |
| | 19 | −39.7031 | 3.9002 | 1.80400 | 46.53 | 0.55775 |
| | 20 | −27.6312 | 19.9100 | | | |

TABLE 80
Example 27

| | Wide | Middle | Tele |
|---|---|---|---|
| Zr | 1.0 | 1.5 | 2.1 |
| f | 22.80 | 33.51 | 47.88 |
| Bf | 19.91 | 19.91 | 19.91 |
| FNo. | 4.12 | 5.03 | 6.15 |
| 2ω[°] | 91.2 | 66.0 | 48.2 |
| DD[6] | 25.97 | 13.45 | 4.66 |
| DD[14] | 3.03 | 3.82 | 4.29 |
| DD[16] | 5.99 | 8.61 | 12.68 |
| DD[18] | 6.41 | 13.18 | 20.29 |

TABLE 81
Example 27

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −3.4238972E−06 | −1.8185031E−05 | −5.0943456E−05 | −3.4331727E−05 |
| A6 | 1.0313962E−07 | 5.5819878E−08 | −4.0891272E−07 | −4.3675475E−07 |
| A8 | −1.2339158E−09 | −1.0019502E−09 | −1.8028548E−08 | −9.6428380E−09 |
| A10 | 8.9335113E−12 | 1.2414650E−12 | 7.6108142E−11 | −3.8136392E−10 |
| A12 | −3.8067599E−14 | 6.7564129E−16 | −6.6746628E−13 | 4.3157176E−12 |
| A14 | −2.7492287E−16 | 1.1975438E−16 | −1.0644892E−13 | 2.5970235E−13 |
| A16 | 3.7961405E−18 | −1.3582469E−18 | 1.1936787E−15 | −1.1184398E−14 |
| A18 | −1.2876365E−20 | 2.7019876E−21 | −3.5541988E−17 | 8.5692858E−17 |

| Sn | 17 | 18 |
|---|---|---|
| KA | 1.0000000E+00 | 1.0000000E+00 |
| A3 | 0.0000000E+00 | 0.0000000E+00 |
| A4 | 1.4274464E−05 | 5.1873907E−05 |
| A5 | 9.6494214E−06 | 2.6602237E−06 |
| A6 | −2.1968778E−06 | −8.2668180E−07 |
| A7 | 2.5499455E−08 | 6.1578913E−10 |
| A8 | 2.5429660E−08 | 8.1049856E−09 |
| A9 | 3.9534072E−10 | −4.3472183E−10 |
| A10 | −2.7511279E−10 | 1.3718707E−10 |
| A11 | −7.1090641E−12 | −2.7260654E−11 |
| A12 | 3.6615810E−13 | −1.7312632E−12 |
| A13 | −4.5199812E−13 | 1.2595387E−13 |
| A14 | 3.0468472E−14 | 4.8790113E−14 |
| A15 | 2.2045236E−15 | 4.3449666E−15 |
| A16 | 1.7538639E−15 | −7.5847614E−16 |
| A17 | −2.3516040E−17 | −5.6704892E−17 |
| A18 | −2.3538062E−17 | 4.2593419E−19 |
| A19 | −9.2005006E−19 | 1.0966225E−18 |
| A20 | 1.8169251E−19 | −5.5641608E−20 |

### Example 28

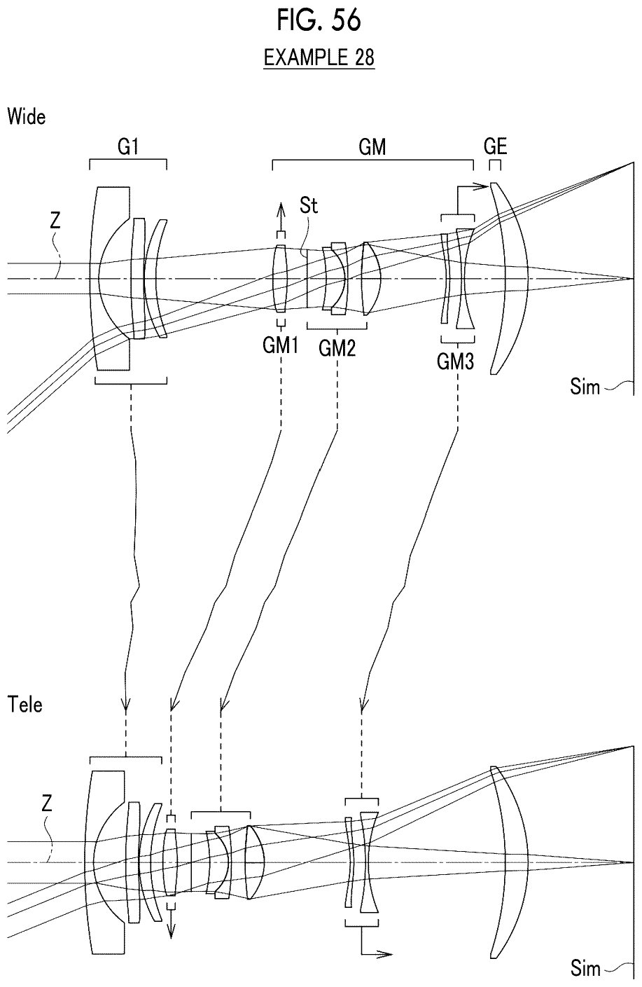

A configuration and a movement locus of a variable magnification optical system according to Example 28 are shown in FIG. 56. The variable magnification optical system according to Example 28 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the first intermediate lens group GM1.

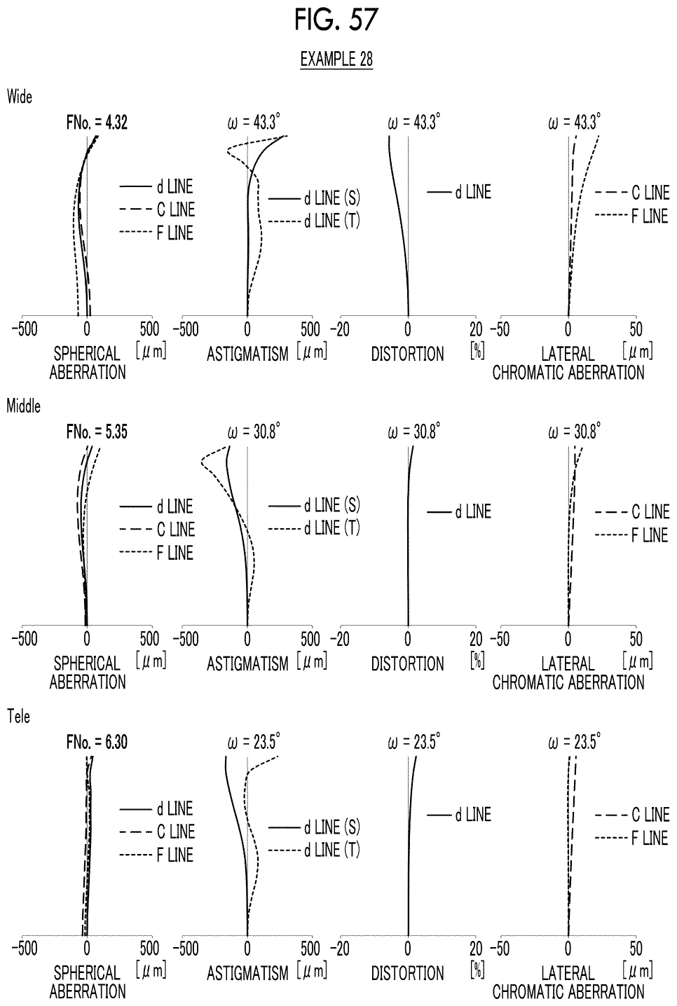

For the variable magnification optical system according to Example 28, basic lens data is shown in Table 82, specifications and variable surface spacings are shown in Table 83, aspherical coefficients are shown in Table 84, and each aberration diagram is shown in FIG. 57.

TABLE 82
Example 28

| | Sn | R | D | Nd | νd | θgF |
|---|---|---|---|---|---|---|
| | 1 | 108.2249 | 1.5501 | 1.77535 | 50.30 | 0.55004 |
| | 2 | 14.3337 | 5.6252 | | | |
| | *3 | 100.8489 | 2.2502 | 1.53409 | 55.87 | 0.55858 |
| | *4 | 122.8323 | 0.1000 | | | |
| | 5 | 23.4885 | 2.0000 | 1.95906 | 17.47 | 0.65993 |
| | 6 | 30.0323 | DD[6] | | | |
| Gois | *7 | 39.6553 | 2.5111 | 1.53409 | 55.87 | 0.55858 |
| | *8 | −32.1939 | DD[8] | | | |
| | 9(St) | ∞ | 3.2076 | | | |
| | 10 | −26.1839 | 3.2872 | 1.52841 | 76.45 | 0.53954 |
| | 11 | −7.4143 | 0.5248 | 1.80400 | 46.53 | 0.55775 |
| | 12 | −47.7657 | 2.3847 | | | |
| | *13 | 46.7240 | 3.3498 | 1.49700 | 81.54 | 0.53748 |
| | *14 | −10.1995 | DD[14] | | | |
| Gfoc | *15 | −19.2754 | 0.6248 | 1.53409 | 55.87 | 0.55858 |
| | *16 | −24.5928 | 2.0315 | | | |
| | 17 | −44.7888 | 0.5000 | 1.51680 | 64.20 | 0.53430 |
| | 18 | 25.6200 | DD[18] | | | |
| | 19 | −58.1382 | 4.0002 | 1.80400 | 46.53 | 0.55775 |
| | 20 | −31.2253 | 18.4600 | | | |

TABLE 83
Example 28

| | Wide | Middle | Tele |
|---|---|---|---|
| Zr | 1.0 | 1.5 | 2.0 |
| f | 24.36 | 35.80 | 48.72 |
| Bf | 18.46 | 18.46 | 18.46 |
| FNo. | 4.32 | 5.35 | 6.30 |
| 2ω[°] | 86.6 | 61.6 | 47.0 |
| DD[6] | 20.48 | 9.35 | 2.16 |
| DD[8] | 3.50 | 2.34 | 2.46 |
| DD[14] | 11.48 | 12.97 | 14.95 |
| DD[18] | 7.15 | 16.47 | 23.96 |

TABLE 84
Example 28

| Sn | 3 | 4 | 7 | 8 |
|---|---|---|---|---|
| KA | 1.0000000E+00 | 1.0000000E+00 | 1.0000000E+00 | 1.0000000E+00 |
| A4 | 7.9828421E−06 | −6.1330500E−06 | 4.7244584E−05 | 6.0106111E−05 |
| A6 | −3.7065049E−08 | −5.6275403E−08 | 1.4144987E−06 | 1.3734267E−06 |
| A8 | −1.2427916E−10 | −1.0825097E−09 | 1.0208964E−08 | 2.1393066E−08 |
| A10 | −7.4264046E−12 | 1.7684825E−12 | 3.0770559E−10 | 1.8807279E−10 |
| A12 | 2.7807074E−14 | 5.2584270E−15 | 4.8875858E−12 | −2.5651100E−14 |
| A14 | 2.8395023E−16 | 2.1599182E−16 | −1.9540815E−14 | 1.9629138E−13 |
| A16 | 6.5112172E−19 | −1.1333274E−18 | 1.3452833E−15 | −2.5654689E−16 |
| A18 | −1.8671058E−20 | −7.2172088E−21 | 7.6383421E−18 | 4.1099766E−17 |

| Sn | 13 | 14 |
|---|---|---|
| KA | 1.0000000E+00 | 1.0000000E+00 |
| A4 | −3.3414192E−05 | 7.2327043E−05 |
| A6 | −5.4303873E−07 | −1.8972407E−07 |
| A8 | 1.1157436E−08 | 1.6661187E−08 |
| A10 | 2.9817237E−10 | −2.7367424E−10 |
| A12 | −2.2379840E−11 | 6.0172932E−12 |
| A14 | 4.1669319E−13 | −1.5723942E−13 |
| A16 | −2.2160864E−15 | 2.0268359E−15 |
| Sn | 15 | 16 |
| KA | 1.0000000E+00 | 1.0000000E+00 |
| A3 | 0.0000000E+00 | 0.0000000E+00 |
| A4 | 4.3461613E−04 | 4.3728144E−04 |
| A5 | −3.2849128E−05 | −3.0628186E−05 |
| A6 | −1.5421679E−06 | −1.2371607E−06 |
| A7 | 2.4895655E−07 | 1.3725037E−07 |
| A8 | 2.0373438E−08 | 2.1883040E−08 |
| A9 | −1.2901365E−09 | −1.7756468E−10 |
| A10 | −3.4904739E−10 | 2.5826238E−11 |
| A11 | 1.5375390E−11 | −4.1835521E−11 |
| A12 | 2.6499764E−12 | −2.7976582E−12 |
| A13 | −2.8876388E−13 | 3.8148922E−14 |
| A14 | −2.9532715E−14 | 5.9032476E−14 |
| A15 | 3.3998345E−15 | 6.3979059E−15 |
| A16 | 1.4039963E−15 | 1.3307491E−16 |
| A17 | −1.1663129E−16 | −5.0698891E−17 |
| A18 | −1.1101343E−17 | −3.4741974E−18 |
| A19 | 2.7342941E−18 | −3.7662241E−19 |
| A20 | −2.0273717E−19 | 2.1391275E−20 |

### Example 29

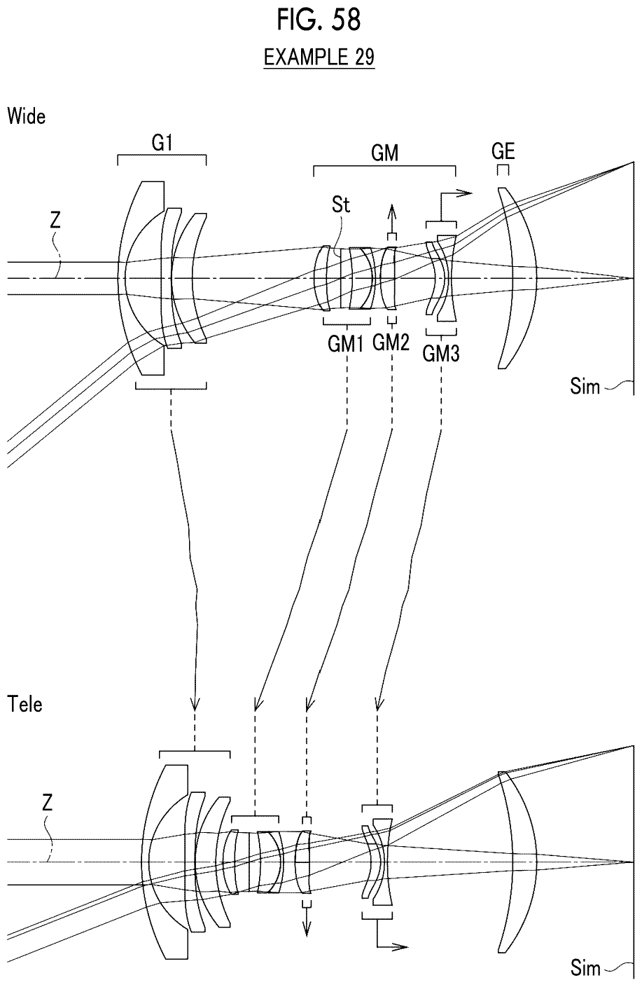

A configuration and a movement locus of a variable magnification optical system according to Example 29 are shown in FIG. 58. The variable magnification optical system according to Example 29 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the second intermediate lens group GM2.

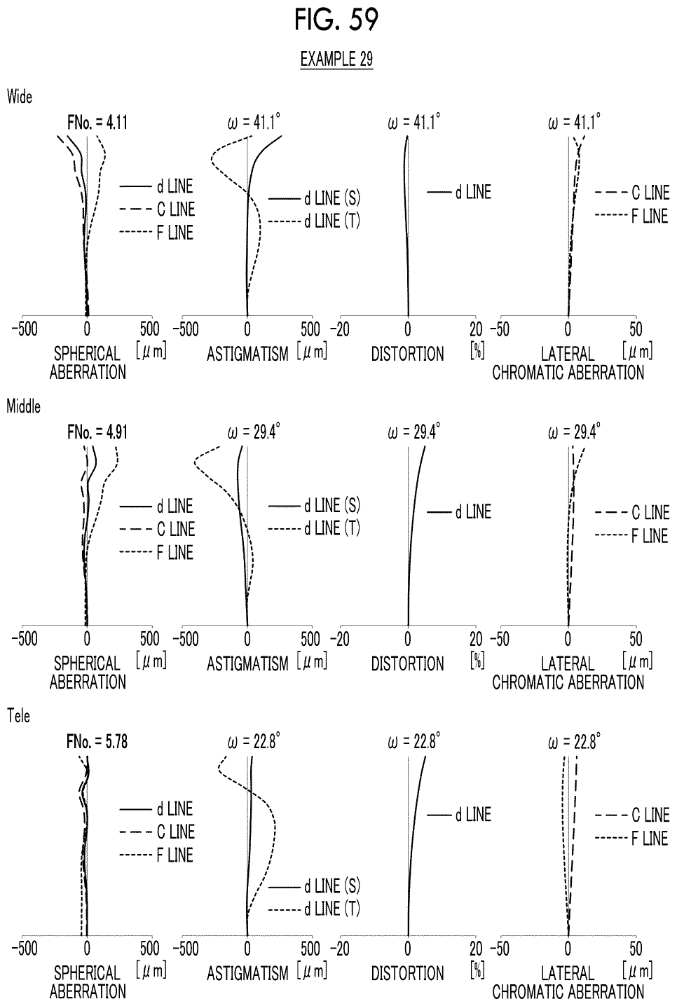

For the variable magnification optical system according to Example 29, basic lens data is shown in Table 85, specifications and variable surface spacings are shown in Table 86, aspherical coefficients are shown in Table 87, and each aberration diagram is shown in FIG. 59.

TABLE 85
Example 29

| | Sn | R | D | Nd | νd | θgF |
|---|---|---|---|---|---|---|
| | 1 | 40.5314 | 1.2498 | 1.90525 | 35.04 | 0.58486 |
| | 2 | 14.8998 | 6.3234 | | | |
| | *3 | −166.7389 | 1.7498 | 1.53409 | 55.87 | 0.55858 |
| | *4 | 104.9321 | 0.0500 | | | |
| | 5 | 19.5886 | 3.6006 | 1.95906 | 17.47 | 0.65993 |
| | 6 | 27.0380 | DD[6] | | | |
| | *7 | 15.1780 | 2.0772 | 1.53409 | 55.87 | 0.55858 |
| | *8 | 50.8837 | 2.5112 | | | |
| | 9(St) | ∞ | 2.0002 | | | |
| | 10 | −30.3632 | 3.5102 | 1.52841 | 76.45 | 0.53954 |
| | 11 | −8.3463 | 0.5248 | 1.67911 | 34.76 | 0.58809 |
| | 12 | −19.4495 | DD[12] | | | |
| Gois | *13 | 20.6587 | 2.5001 | 1.49700 | 81.54 | 0.53748 |
| | *14 | −57.7384 | DD[14] | | | |
| Gfoc | *15 | −9.2722 | 1.6634 | 1.53409 | 55.87 | 0.55858 |
| | *16 | −7.5075 | 0.6803 | | | |
| | 17 | −12.9346 | 0.4998 | 1.51680 | 64.20 | 0.53430 |
| | 18 | 38.2332 | DD[18] | | | |
| | 19 | −53.9775 | 4.2065 | 1.80400 | 46.53 | 0.55775 |
| | 20 | −28.3831 | 16.9300 | | | |

TABLE 86
Example 29

| | Wide | Middle | Tele |
|---|---|---|---|
| Zr | 1.0 | 1.5 | 2.0 |
| f | 24.86 | 36.54 | 48.98 |
| Bf | 16.93 | 16.93 | 16.93 |
| FNo. | 4.11 | 4.92 | 5.78 |
| 2ω[°] | 82.2 | 58.8 | 45.6 |
| DD[6] | 21.30 | 8.54 | 1.23 |
| DD[12] | 0.87 | 1.58 | 2.01 |
| DD[14] | 7.08 | 8.84 | 10.68 |
| DD[18] | 10.71 | 16.47 | 21.92 |

TABLE 87
Example 29

| Sn | 3 | 4 | 7 | 8 |
|---|---|---|---|---|
| KA | 1.0000000E+00 | 1.0000000E+00 | 1.0000000E+00 | 1.0000000E+00 |
| A4 | 9.7394244E−05 | 9.3667626E−05 | 1.3268730E−04 | 1.8624758E−04 |
| A6 | −6.0412763E−07 | −5.9115837E−07 | 9.3326003E−07 | 1.0823704E−06 |
| A8 | 3.1016472E−09 | 2.3547948E−09 | 3.0124625E−08 | 2.4601581E−08 |
| A10 | 7.6576405E−13 | 8.2248095E−12 | 2.4624722E−10 | 3.4243619E−10 |
| A12 | −6.1543009E−14 | −9.8517211E−14 | 2.5252354E−12 | −2.9311450E−12 |
| A14 | −1.0257349E−17 | −9.0207052E−17 | −2.5082568E−13 | 1.1201804E−13 |
| A16 | 1.7369307E−18 | 2.8981345E−18 | 4.1913610E−15 | −3.6268127E−15 |
| A18 | −4.8355132E−21 | −8.3776441E−21 | 5.6041940E−17 | 1.4221210E−16 |

| Sn | 13 | 14 |
|---|---|---|
| KA | 1.0000000E+00 | 1.0000000E+00 |
| A4 | 2.2351609E−04 | 2.4657771E−04 |
| A6 | 2.5933914E−06 | 2.2262925E−06 |
| A8 | 1.2463275E−08 | 1.4077135E−07 |
| A10 | 3.9267324E−09 | −2.2549773E−09 |
| A12 | −9.3026208E−11 | 1.4520230E−10 |
| A14 | 1.8529516E−13 | −5.4215151E−12 |
| A16 | 2.7503388E−14 | 1.0410120E−13 |
| Sn | 15 | 16 |
| KA | 1.0000000E+00 | 1.0000000E+00 |
| A3 | 0.0000000E+00 | 0.0000000E+00 |
| A4 | 2.0419038E−04 | 3.4582730E−04 |
| A5 | −1.2369872E−06 | 1.1905662E−05 |
| A6 | 4.6473736E−06 | 1.4582077E−06 |
| A7 | 4.6959392E−07 | 6.7663558E−07 |
| A8 | 3.0322664E−08 | 6.1448204E−08 |
| A9 | 6.9602618E−10 | 9.6487404E−09 |
| A10 | 7.5809721E−10 | −1.3366457E−10 |
| A11 | 1.8698123E−10 | −8.4444846E−11 |
| A12 | 1.8601950E−11 | 1.1986185E−12 |
| A13 | −2.8446130E−12 | 1.6271759E−12 |
| A14 | −8.2626214E−13 | 4.6355406E−13 |
| A15 | −1.2173199E−13 | 4.7220658E−14 |
| A16 | −1.0071360E−14 | −8.4538291E−16 |
| A17 | −7.6964518E−16 | −1.9360602E−15 |
| A18 | 8.1220851E−16 | −1.1168865E−16 |
| A19 | 7.6232920E−17 | −9.4798036E−17 |
| A20 | −1.3598062E−17 | 1.6534248E−17 |

### Example 30

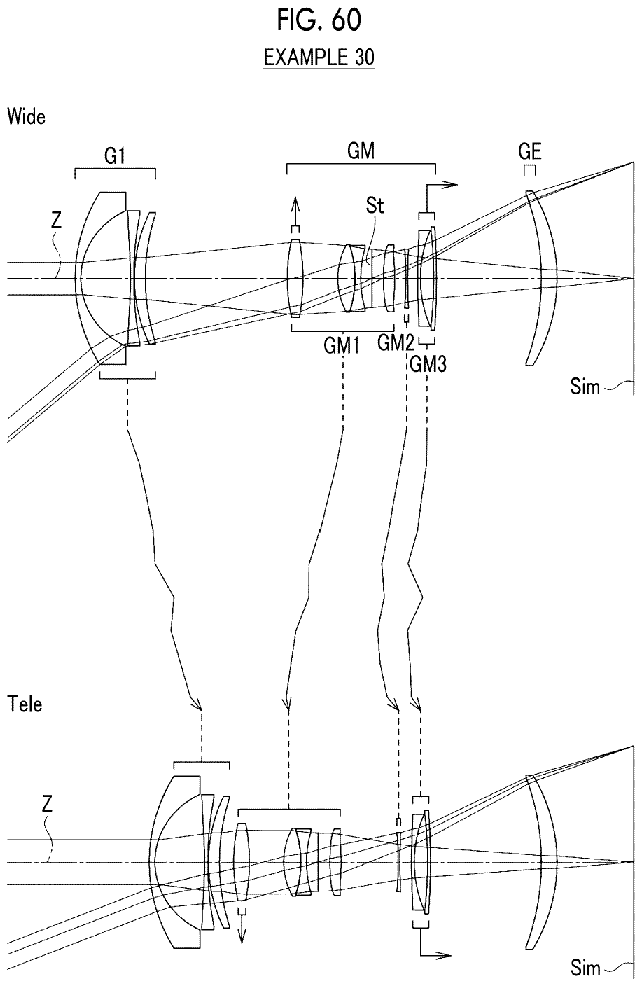

A configuration and a movement locus of a variable magnification optical system according to Example 30 are shown in FIG. 60. The variable magnification optical system according to Example 30 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having negative refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of one lens closest to the object side of the first intermediate lens group GM1.

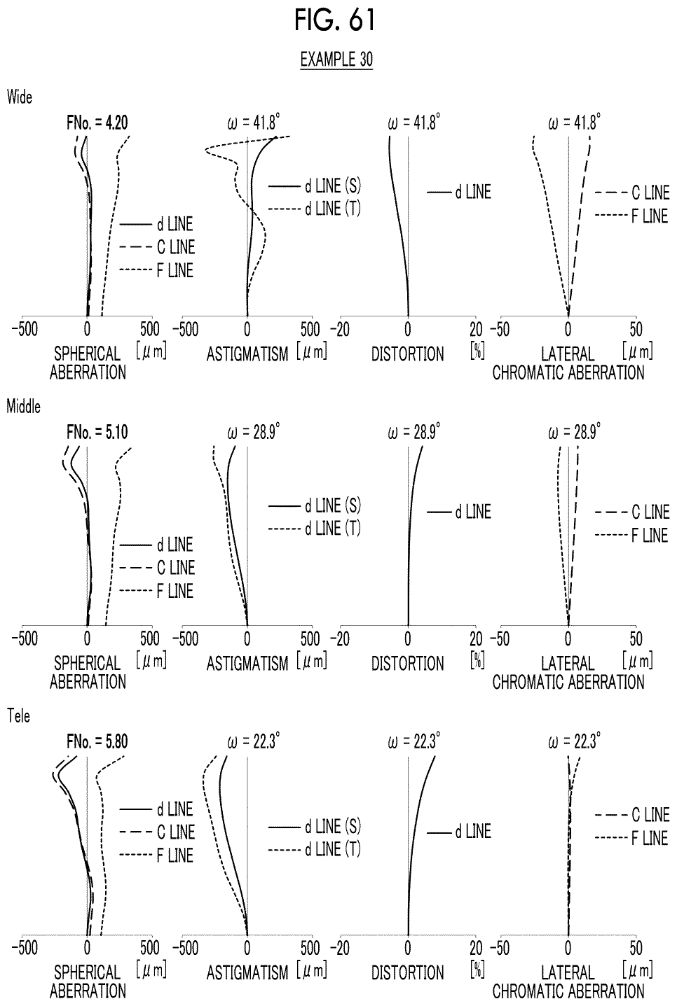

For the variable magnification optical system according to Example 30, basic lens data is shown in Table 88, specifications and variable surface spacings are shown in Table 89, aspherical coefficients are shown in Table 90, and each aberration diagram is shown in FIG. 61.

TABLE 88
Example 30

| | Sn | R | D | Nd | νd | θgF |
|---|---|---|---|---|---|---|
| | 1 | 31.7325 | 0.9998 | 1.77535 | 50.30 | 0.55004 |
| | 2 | 14.0039 | 8.6948 | | | |
| | *3 | −77.9763 | 0.5920 | 1.53409 | 55.87 | 0.55858 |
| | *4 | 89.1355 | 0.1000 | | | |
| | 5 | 29.6411 | 1.9128 | 1.95906 | 17.47 | 0.65993 |
| | 6 | 41.0256 | DD[6] | | | |
| Gois | 7 | 34.9104 | 2.7501 | 1.48749 | 70.24 | 0.53007 |
| | 8 | −39.6430 | 6.0000 | | | |
| | 9 | 13.7830 | 3.0001 | 1.48749 | 70.24 | 0.53007 |
| | 10 | −21.1054 | 1.0100 | 1.60342 | 38.03 | 0.58356 |
| | 11 | 20.9068 | 2.0002 | | | |
| | 12(St) | ∞ | 2.0000 | | | |
| | *13 | 49.6681 | 1.9585 | 1.61881 | 63.85 | 0.54182 |
| | *14 | −37.8577 | DD[14] | | | |
| | *15 | −80.0896 | 0.3018 | 1.53409 | 55.87 | 0.55858 |
| | *16 | 95.1624 | DD[16] | | | |
| Gfoc | *17 | 120.8858 | 0.4840 | 1.53409 | 55.87 | 0.55858 |
| | *18 | 24.6031 | 2.3262 | | | |
| | 19 | −82.3068 | 0.4998 | 1.51680 | 64.20 | 0.53430 |
| | 20 | −135.5207 | DD[20] | | | |
| | 21 | −47.5521 | 2.7498 | 1.95375 | 32.32 | 0.59056 |
| | 22 | −32.9721 | 13.4200 | | | |

TABLE 89
Example 30

| | Wide | Middle | Tele |
|---|---|---|---|
| Zr | 1.0 | 1.5 | 1.9 |
| f | 25.58 | 37.60 | 48.86 |
| Bf | 13.42 | 13.42 | 13.42 |
| FNo. | 4.20 | 5.10 | 5.80 |
| 2ω[°] | 83.6 | 57.8 | 44.6 |
| DD[6] | 24.88 | 10.90 | 2.51 |
| DD[14] | 1.97 | 3.93 | 10.00 |
| DD[16] | 1.76 | 4.95 | 2.04 |
| DD[20] | 18.37 | 19.08 | 19.45 |

TABLE 90
Example 30

| Sn | 3 | 4 | 13 | 14 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 3.6859989E−05 | 3.1262663E−05 | 8.0745282E−05 | 1.1938692E−04 |
| A5 | −4.4220410E−08 | 8.6388842E−07 | 2.6218303E−06 | −3.1985589E−06 |
| A6 | −2.0955117E−07 | −3.5048982E−07 | 1.3738140E−06 | 1.5906812E−06 |
| A7 | −1.0674134E−09 | 6.2631394E−09 | 2.4736142E−07 | 4.5823716E−07 |
| A8 | 1.0058599E−09 | 3.7003032E−10 | −1.5440221E−09 | 6.5229638E−08 |
| A9 | 4.2472958E−11 | 1.4675169E−10 | 7.9175638E−09 | −1.8980228E−08 |
| A10 | 8.8485432E−12 | −1.4088546E−11 | −1.1276311E−09 | 1.1076617E−09 |
| A11 | −1.3909674E−12 | 4.3655834E−13 | 5.6434908E−12 | −1.5955524E−10 |
| A12 | −5.5823986E−14 | −8.9948389E−15 | 6.6236083E−12 | 5.9208547E−11 |
| A13 | 7.7554507E−15 | 8.4268833E−16 | 4.6907595E−12 | 2.8666367E−12 |
| A14 | 7.3904717E−18 | −5.2956573E−16 | 2.2042028E−13 | −1.9888660E−14 |
| A15 | 1.5451975E−17 | 7.0477911E−18 | 3.4557212E−14 | 1.1833403E−13 |
| A16 | −3.0527215E−18 | 3.3158459E−18 | −7.8462749E−15 | −1.5273966E−14 |
| A17 | −6.5544356E−20 | 1.2456156E−19 | −3.3421377E−15 | −3.2357016E−15 |
| A18 | 2.0393002E−20 | −9.8394245E−21 | −3.8107358E−16 | −3.7515625E−16 |
| A19 | −1.8599537E−22 | −2.0773243E−21 | 9.5579888E−17 | −1.5866012E−17 |
| A20 | −3.7602110E−23 | 1.0515033E−22 | 1.0993421E−18 | 1.6946719E−17 |

| Sn | 15 | 16 |
|---|---|---|
| KA | 1.0000000E+00 | 1.0000000E+00 |
| A4 | −4.9921972E−05 | −2.6356920E−05 |
| A6 | −1.0189715E−06 | −8.1999852E−08 |
| A8 | 6.7491515E−08 | −3.5703868E−08 |
| A10 | −1.2731039E−09 | 4.2752132E−09 |
| A12 | −3.3639885E−12 | −1.8550327E−10 |
| A14 | 2.5807935E−13 | 3.6585916E−12 |
| A16 | 7.9830494E−16 | −2.7008336E−14 |
| Sn | 17 | 18 |
| KA | 1.0000000E+00 | 1.0000000E+00 |
| A4 | −1.6499861E−05 | 4.3363181E−06 |
| A6 | −4.3461637E−08 | 1.0200121E−07 |
| A8 | 2.3944373E−09 | −5.6735991E−10 |
| A10 | −4.5621136E−11 | 8.3713970E−14 |
| A12 | 4.0721204E−13 | 1.1464699E−13 |
| A14 | 5.4886776E−15 | −1.4322084E−15 |
| A16 | −6.2546792E−17 | 2.9475479E−17 |
| A18 | −3.2916317E−19 | −3.5632100E−19 |

### Example 31

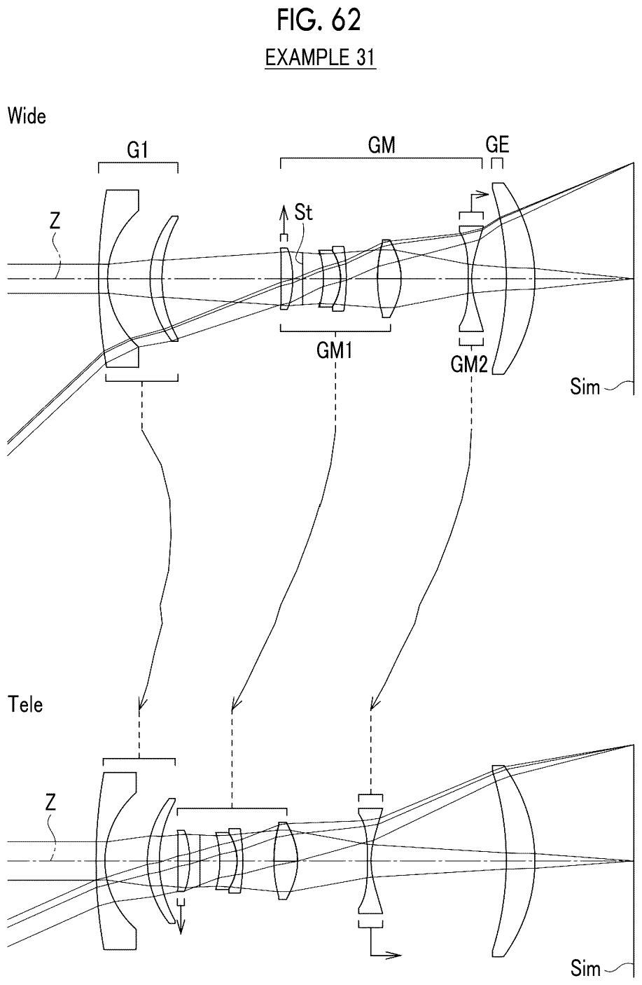

A configuration and a movement locus of a variable magnification optical system according to Example 31 are shown in FIG. 62. The variable magnification optical system according to Example 31 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

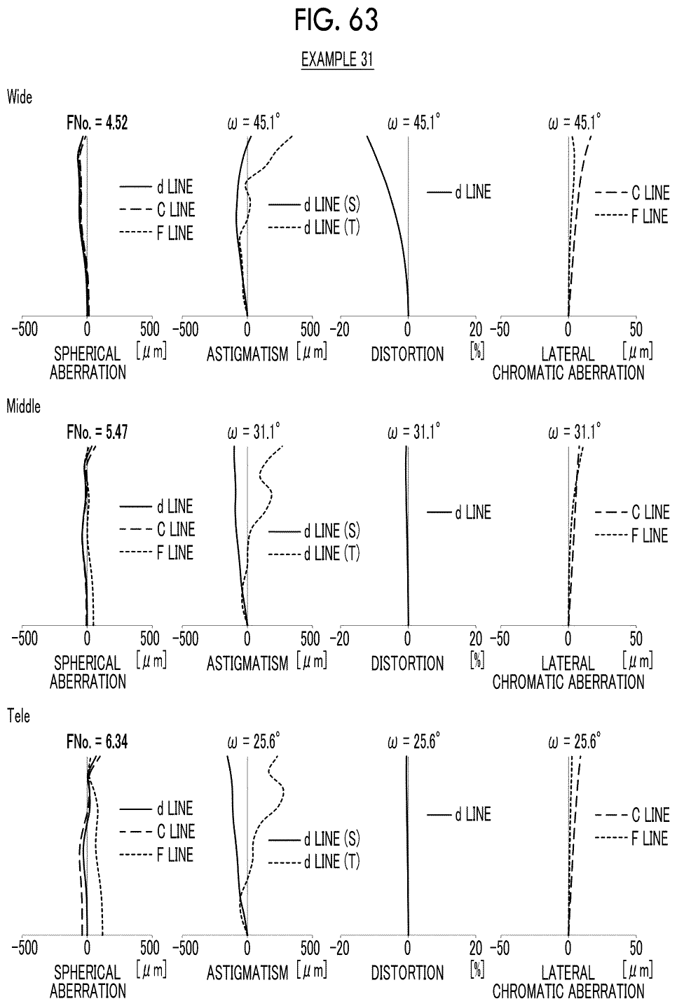

For the variable magnification optical system according to Example 31, basic lens data is shown in Table 91, specifications and variable surface spacings are shown in Table 92, aspherical coefficients are shown in Table 93, and each aberration diagram is shown in FIG. 63.

TABLE 91
Example 31

| | Sn | R | D | Nd | νd | θgF |
|---|---|---|---|---|---|---|
| | 1 | 99.3656 | 1.5502 | 1.83481 | 42.74 | 0.56490 |
| | 2 | 17.5524 | 7.4247 | | | |
| | 3 | 19.5807 | 2.0782 | 1.95906 | 17.47 | 0.65993 |
| | 4 | 23.8572 | DD[4] | | | |
| Gois | *5 | 168.2571 | 2.0582 | 1.53409 | 55.87 | 0.55858 |
| | *6 | −20.5834 | 1.7500 | | | |
| | 7(St) | ∞ | 3.5002 | | | |
| | 8 | −20.1486 | 3.0102 | 1.51680 | 64.20 | 0.53430 |
| | 9 | −10.1901 | 1.0002 | 1.74698 | 38.05 | 0.58038 |
| | 10 | −41.2785 | 5.4426 | | | |
| | *11 | 27.4927 | 4.1337 | 1.43875 | 94.66 | 0.53402 |
| | *12 | −12.0595 | DD[12] | | | |
| Gfoc | *13 | −93.0786 | 0.6250 | 1.53409 | 55.87 | 0.55858 |
| | *14 | 14.8157 | DD[14] | | | |
| | 15 | −59.3310 | 5.0002 | 1.77637 | 50.61 | 0.54811 |
| | 16 | −31.8259 | 17.2600 | | | |

TABLE 92
Example 31

| | Wide | Middle | Tele |
|---|---|---|---|
| Zr | 1.0 | 1.5 | 1.8 |
| f | 24.56 | 36.10 | 45.44 |
| Bf | 17.26 | 17.26 | 17.26 |
| FNo. | 4.51 | 5.47 | 6.33 |
| 2ω[°] | 90.2 | 62.2 | 51.2 |
| DD[4] | 20.80 | 8.08 | 3.26 |
| DD[12] | 11.71 | 12.16 | 12.11 |
| DD[14] | 6.04 | 15.11 | 23.63 |

TABLE 93
Example 31

| Sn | 5 | 6 |
|---|---|---|
| KA | 1.0000000E+00 | 1.0000000E+00 |
| A4 | −9.9476325E−05 | −6.7820564E−05 |
| A6 | −7.4954077E−07 | −1.5271587E−06 |
| A8 | −7.5720928E−08 | 2.7578352E−08 |
| A10 | 2.8856021E−09 | −2.3737413E−09 |
| A12 | −8.9038932E−11 | 5.0709336E−12 |
| A14 | −9.1759947E−13 | 1.4071682E−12 |
| A16 | 8.2436441E−14 | −3.2673230E−14 |
| A18 | −1.1692374E−15 | 1.4446420E−16 |
| Sn | 11 | 12 |
| KA | 1.0000000E+00 | 1.0000000E+00 |
| A4 | 2.3247845E−05 | 1.4689143E−04 |
| A6 | −8.6214568E−08 | −1.2878668E−07 |
| A8 | −4.1878874E−09 | 9.4007435E−09 |
| A10 | 5.3365328E−10 | −3.1439336E−10 |
| A12 | −2.0571329E−11 | 9.7543275E−12 |
| A14 | 3.4729062E−13 | −1.5882257E−13 |
| A16 | −2.1573430E−15 | 1.0610052E−15 |
| Sn | 13 | 14 |
| KA | 1.0000000E+00 | 1.0000000E+00 |
| A3 | 0.0000000E+00 | 0.0000000E+00 |
| A4 | −1.0499493E−04 | −1.9380967E−04 |
| A5 | −2.0114463E−05 | −4.9244095E−06 |
| A6 | 1.5342076E−06 | −7.0931782E−07 |
| A7 | 4.3612243E−08 | 1.2417608E−07 |
| A8 | −7.2806074E−09 | 1.8143308E−08 |
| A9 | −2.0735671E−09 | −5.0693516E−10 |
| A10 | −3.7343662E−11 | 4.5664101E−11 |
| A11 | 7.1798114E−11 | −3.3950842E−11 |
| A12 | 2.9917472E−12 | −3.0424225E−12 |
| A13 | −6.5658775E−13 | 2.8022974E−13 |
| A14 | −5.4700165E−14 | 5.5774954E−14 |
| A15 | −1.2886692E−14 | 5.0315085E−15 |
| A16 | 2.0376504E−15 | −9.4429641E−16 |
| A17 | −5.5398395E−17 | −6.8092492E−17 |
| A18 | −9.4485134E−18 | 2.2209226E−18 |
| A19 | 4.4251186E−18 | 1.2727457E−18 |
| A20 | −3.3436005E−19 | −7.3382659E−20 |

### Example 32

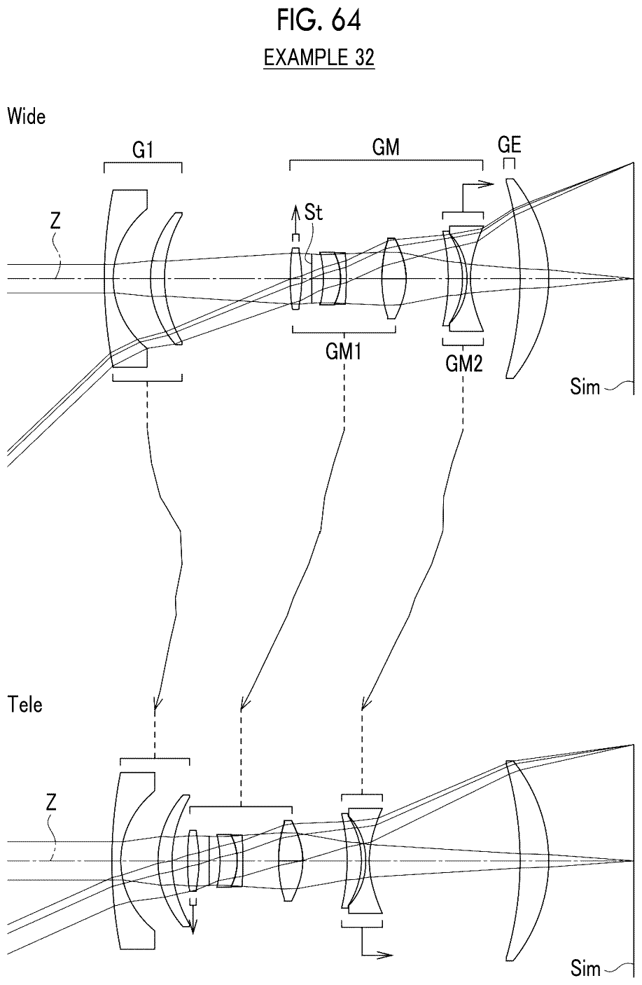

A configuration and a movement locus of a variable magnification optical system according to Example 32 are shown in FIG. 64. The variable magnification optical system according to Example 32 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

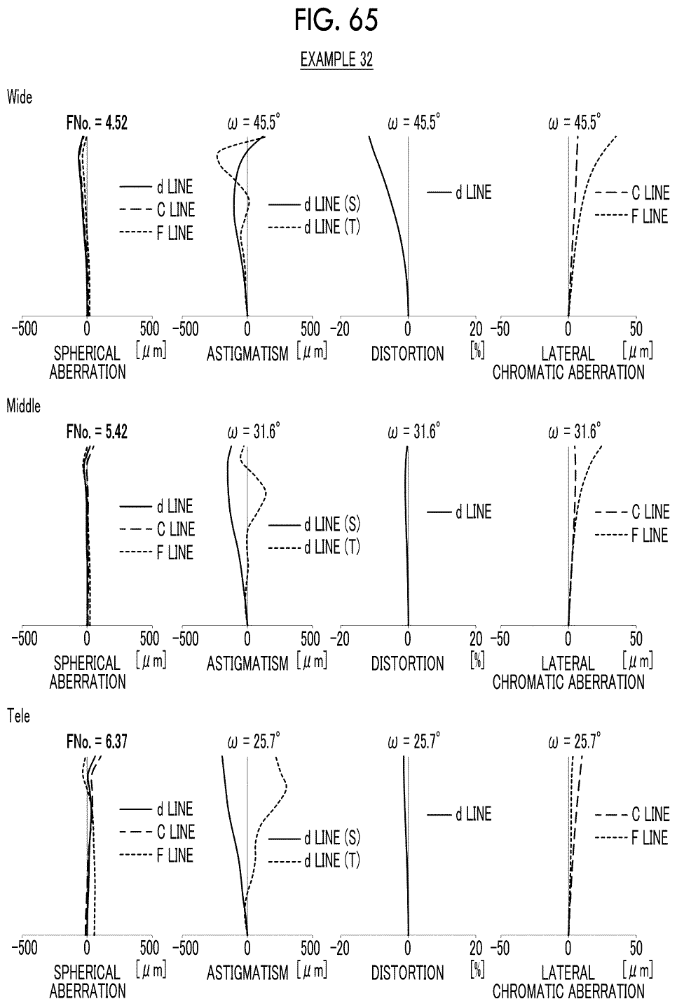

For the variable magnification optical system according to Example 32, basic lens data is shown in Table 94, specifications and variable surface spacings are shown in Table 95, aspherical coefficients are shown in Table 96, and each aberration diagram is shown in FIG. 65.

TABLE 94
Example 32

| | Sn | R | D | Nd | νd | θgF |
|---|---|---|---|---|---|---|
| | 1 | 90.7428 | 1.5502 | 1.83481 | 42.74 | 0.56490 |
| | 2 | 17.2609 | 6.5002 | | | |
| | 3 | 19.4399 | 2.4591 | 1.95906 | 17.47 | 0.65993 |
| | 4 | 24.3867 | DD[4] | | | |
| Gois | *5 | 61.6333 | 1.9998 | 1.53409 | 55.87 | 0.55858 |
| | *6 | −24.3130 | 1.7502 | | | |
| | 7(St) | ∞ | 1.9189 | | | |
| | 8 | −22.0459 | 3.0100 | 1.51680 | 64.20 | 0.53430 |
| | 9 | −11.1323 | 1.0002 | 1.64198 | 35.62 | 0.58584 |
| | 10 | −65.9901 | 6.2259 | | | |
| | *11 | 28.0581 | 4.2283 | 1.43875 | 94.66 | 0.53402 |
| | *12 | −12.6875 | DD[12] | | | |
| Gfoc | 13 | −40.7697 | 2.5002 | 1.69039 | 55.20 | 0.54630 |
| | 14 | −16.2596 | 0.7752 | | | |
| | *15 | −14.3674 | 0.5998 | 1.53409 | 55.87 | 0.55858 |
| | *16 | 17.7475 | DD[16] | | | |
| | 17 | −68.6314 | 5.0002 | 1.71627 | 55.95 | 0.54213 |
| | 18 | −31.0141 | 14.8500 | | | |

TABLE 95
Example 32

| | Wide | Middle | Tele |
|---|---|---|---|
| Zr | 1.0 | 1.5 | 1.9 |
| f | 24.03 | 35.32 | 45.66 |
| Bf | 14.85 | 14.85 | 14.85 |
| FNo. | 4.52 | 5.42 | 6.36 |
| 2ω[°] | 91.0 | 63.2 | 51.4 |
| DD[4] | 21.98 | 8.29 | 2.71 |
| DD[12] | 7.36 | 7.77 | 7.64 |
| DD[16] | 8.68 | 17.06 | 26.36 |

TABLE 96
Example 32

| Sn | 5 | 6 |
|---|---|---|
| KA | 1.0000000E+00 | 1.0000000E+00 |
| A4 | 2.8428150E−05 | 6.4769735E−05 |
| A6 | 2.4344720E−06 | 1.9819184E−06 |
| A8 | −8.4934367E−08 | −1.3831694E−08 |
| A10 | 5.1778154E−09 | 7.0745636E−10 |
| A12 | −7.4542116E−11 | 3.2271484E−11 |
| A14 | −1.3395518E−12 | 4.8008747E−14 |
| A16 | 6.6108250E−14 | −4.2007011E−14 |
| A18 | −5.2817607E−16 | 9.3027754E−16 |
| Sn | 11 | 12 |
| KA | 1.0000000E+00 | 1.0000000E+00 |
| A4 | 2.8869700E−05 | 1.3897248E−04 |
| A6 | 3.9181324E−07 | 6.3757964E−08 |
| A8 | −1.2696159E−08 | 8.6581093E−09 |
| A10 | 6.7142725E−10 | −3.3107938E−10 |
| A12 | −2.0021528E−11 | 9.7558506E−12 |
| A14 | 2.9022465E−13 | −1.5386014E−13 |
| A16 | −1.4966178E−15 | 1.0914821E−15 |
| Sn | 15 | 16 |
| KA | 1.0000000E+00 | 1.0000000E+00 |
| A3 | 0.0000000E+00 | 0.0000000E+00 |
| A4 | 3.9508306E−06 | −5.3478652E−05 |
| A5 | −1.3715057E−05 | −4.3904653E−06 |
| A6 | 5.3449451E−07 | −8.5719785E−07 |
| A7 | 2.2435069E−08 | 8.3415890E−08 |
| A8 | −8.5372542E−10 | 1.5838045E−08 |
| A9 | −1.5566433E−09 | −4.1848243E−10 |
| A10 | −5.7405337E−11 | 7.2586469E−11 |
| A11 | 6.3576194E−11 | −3.1509596E−11 |
| A12 | 2.3036791E−12 | −2.9600936E−12 |
| A13 | −6.3179934E−13 | 2.7231253E−13 |
| A14 | −6.2002339E−14 | 5.4202462E−14 |
| A15 | −1.0379784E−14 | 4.8664985E−15 |
| A16 | 2.2617839E−15 | −9.5693584E−16 |
| A17 | −5.4117784E−17 | −6.4484662E−17 |
| A18 | −1.2201938E−17 | 2.0595961E−18 |
| A19 | 4.0917274E−18 | 1.2854363E−18 |
| A20 | −3.0868288E−19 | −7.4164527E−20 |

### Example 33

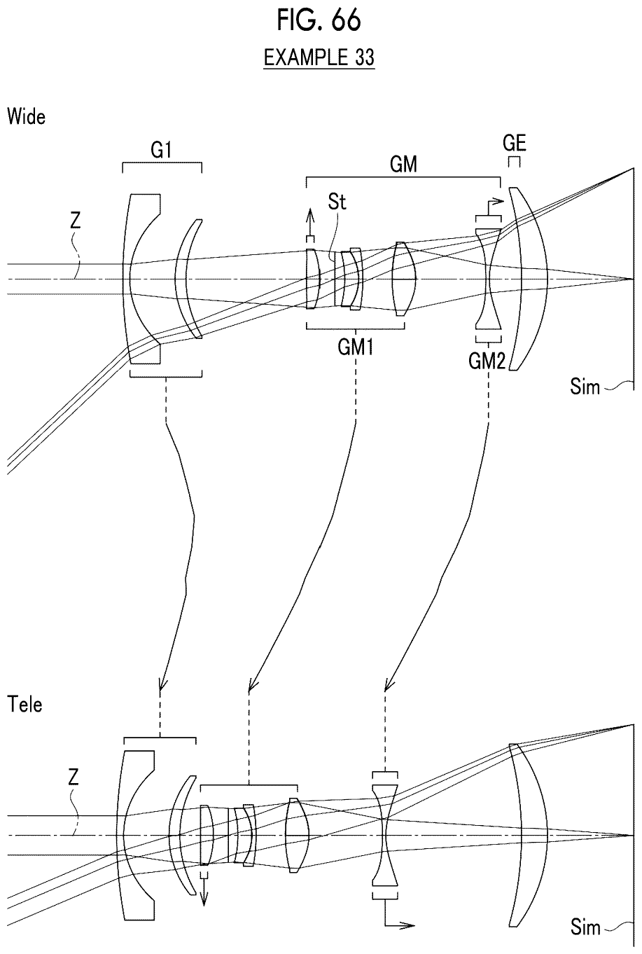

A configuration and a movement locus of a variable magnification optical system according to Example 33 are shown in FIG. 66. The variable magnification optical system according to Example 33 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

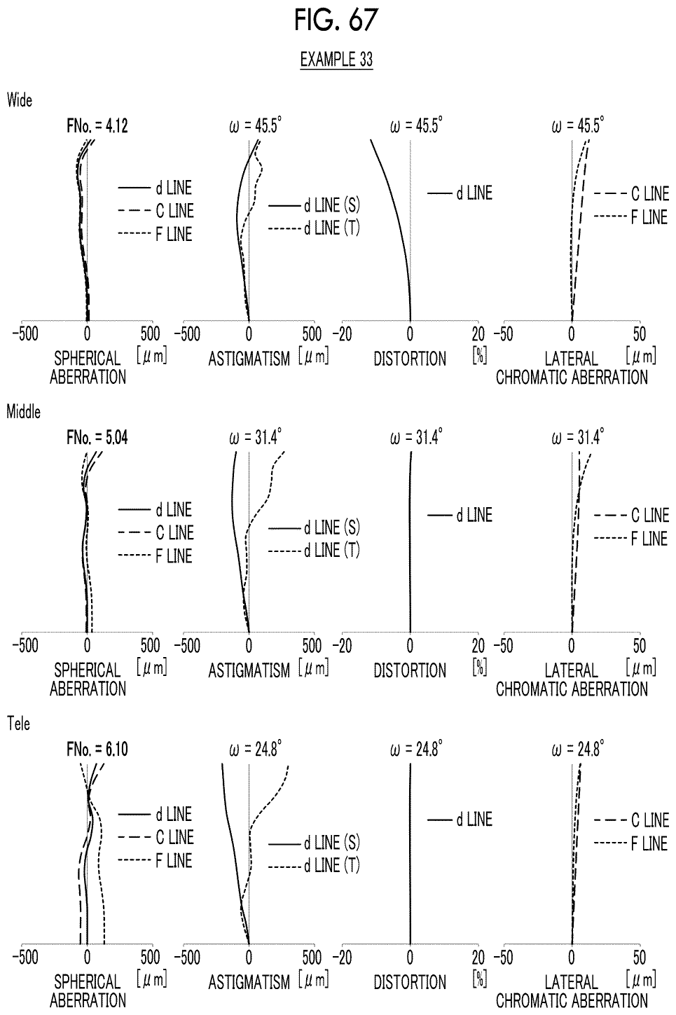

For the variable magnification optical system according to Example 33, basic lens data is shown in Table 97, specifications and variable surface spacings are shown in Table 98, aspherical coefficients are shown in Table 99, and each aberration diagram is shown in FIG. 67.

TABLE 97
Example 33

| | Sn | R | D | Nd | νd | θgF |
|---|---|---|---|---|---|---|
| | 1 | 94.4455 | 1.2498 | 1.83481 | 42.74 | 0.56490 |
| | 2 | 17.4493 | 8.1605 | | | |
| | 3 | 19.4463 | 1.9532 | 1.95906 | 17.47 | 0.65993 |
| | 4 | 23.1248 | DD[4] | | | |
| Gois | *5 | 110.9891 | 2.3330 | 1.53409 | 55.87 | 0.55858 |
| | *6 | −19.5380 | 2.6693 | | | |
| | 7(St) | ∞ | 1.7498 | | | |
| | 8 | −22.0178 | 2.5100 | 1.51680 | 64.20 | 0.53430 |
| | 9 | −10.2183 | 0.7543 | 1.87776 | 39.29 | 0.57068 |
| | 10 | −35.5731 | 5.2862 | | | |
| | *11 | 31.6951 | 4.2343 | 1.43875 | 94.66 | 0.53402 |
| | *12 | −11.0523 | DD[12] | | | |
| Gfoc | *13 | −59.6269 | 0.6250 | 1.53409 | 55.87 | 0.55858 |
| | *14 | 14.1652 | DD[14] | | | |
| | 15 | −69.6802 | 4.6692 | 1.70313 | 56.61 | 0.54212 |
| | 16 | −31.6292 | 15.5100 | | | |

TABLE 98
Example 33

| | Wide | Middle | Tele |
|---|---|---|---|
| Zr | 1.0 | 1.5 | 2.0 |
| f | 24.03 | 35.32 | 46.86 |
| Bf | 15.51 | 15.51 | 15.51 |
| FNo. | 4.12 | 5.04 | 6.09 |
| 2ω[°] | 91.0 | 62.8 | 49.6 |
| DD[4] | 21.70 | 9.22 | 3.70 |
| DD[12] | 12.62 | 13.13 | 13.11 |
| DD[14] | 5.79 | 14.23 | 24.41 |

TABLE 99
Example 33

| Sn | 5 | 6 |
|---|---|---|
| KA | 1.0000000E+00 | 1.0000000E+00 |
| A4 | −8.6990021E−05 | −4.5865859E−05 |
| A6 | −3.5600899E−07 | −1.4543265E−06 |
| A8 | −8.4639191E−08 | 3.6751805E−08 |
| A10 | 3.2190691E−09 | −2.3229980E−09 |
| A12 | −7.9542602E−11 | 4.6223285E−12 |
| A14 | −1.0269620E−12 | 1.4374097E−12 |
| A16 | 7.5660608E−14 | −3.1770520E−14 |
| A18 | −1.0121178E−15 | 1.4337617E−16 |
| Sn | 11 | 12 |
| KA | 1.0000000E+00 | 1.0000000E+00 |
| A4 | 3.2869643E−05 | 1.6469785E−04 |
| A6 | −3.3472205E−07 | 7.6059404E−08 |
| A8 | 7.0685148E−09 | 7.0064738E−09 |
| A10 | 3.9117405E−10 | −1.5727314E−10 |
| A12 | −2.2007172E−11 | 9.2077071E−12 |
| A14 | 4.1133088E−13 | −2.0896159E−13 |
| A16 | −2.4375318E−15 | 1.9354554E−15 |
| Sn | 13 | 14 |
| KA | 1.0000000E+00 | 1.0000000E+00 |
| A3 | 0.0000000E+00 | 0.0000000E+00 |
| A4 | −1.1726844E−04 | −2.2258431E−04 |
| A5 | −1.9768745E−05 | −3.5807503E−06 |
| A6 | 1.8888517E−06 | −6.1832349E−07 |
| A7 | 8.2132043E−09 | 1.3279952E−07 |
| A8 | −1.0811167E−08 | 1.7569405E−08 |
| A9 | −1.8586943E−09 | −6.6129356E−10 |
| A10 | 2.2903827E−11 | 3.4661934E−11 |
| A11 | 7.6064080E−11 | −3.3977887E−11 |
| A12 | 2.7868600E−12 | −2.9524095E−12 |
| A13 | −7.4336538E−13 | 2.9251079E−13 |
| A14 | −6.6215443E−14 | 5.6702461E−14 |
| A15 | −1.3604651E−14 | 5.0327669E−15 |
| A16 | 2.0797748E−15 | −9.5015594E−16 |
| A17 | −3.7002811E−17 | −6.9347791E−17 |
| A18 | −6.7315442E−18 | 2.1194317E−18 |
| A19 | 4.5531472E−18 | 1.2730147E−18 |
| A20 | −3.7992773E−19 | −7.2075556E−20 |

### Example 34

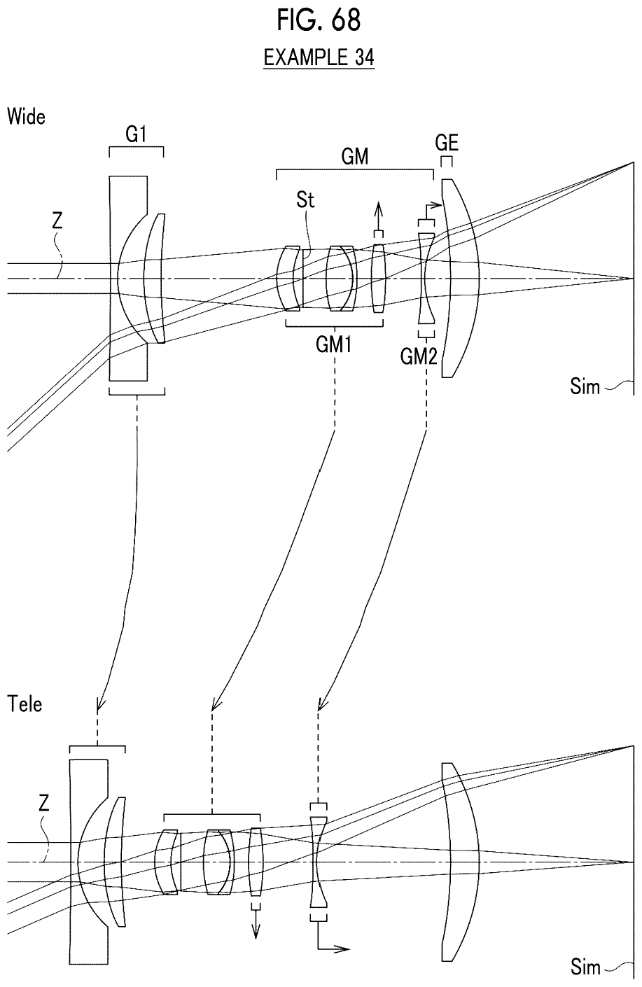

A configuration and a movement locus of a variable magnification optical system according to Example 34 are shown in FIG. 68. The variable magnification optical system according to Example 34 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the image side of the first intermediate lens group GM1.

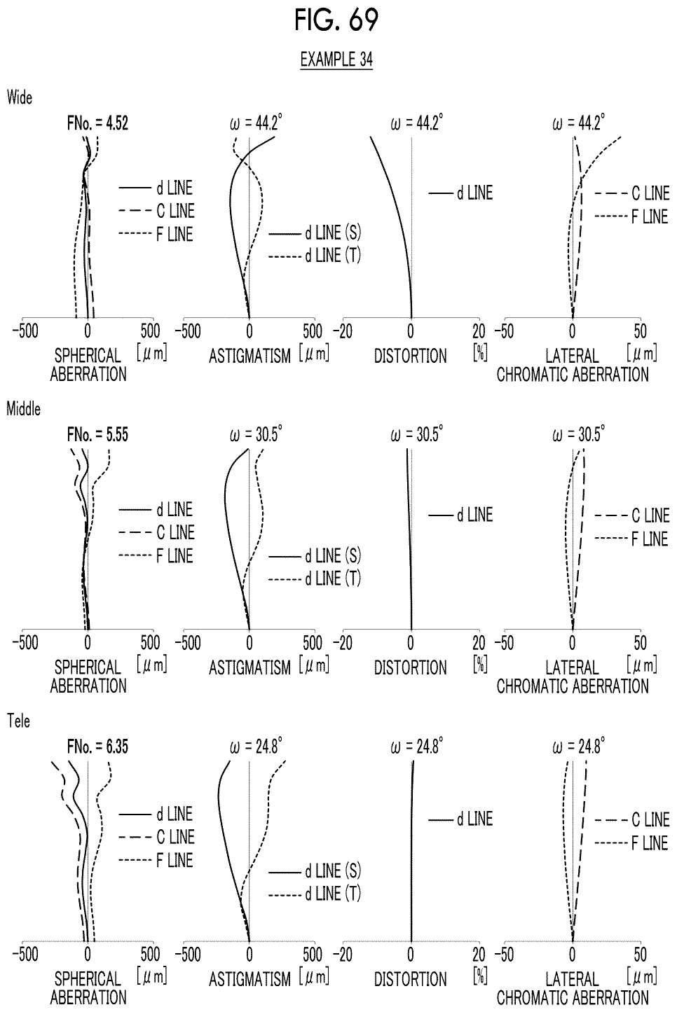

For the variable magnification optical system according to Example 34, basic lens data is shown in Table 100, specifications and variable surface spacings are shown in Table 101, aspherical coefficients are shown in Table 102, and each aberration diagram is shown in FIG. 69.

TABLE 100
Example 34

| | Sn | R | D | Nd | νd | θgF |
|---|---|---|---|---|---|---|
| | 1 | −860.4984 | 1.2500 | 1.77535 | 50.30 | 0.55004 |
| | 2 | 16.4290 | 4.5847 | | | |
| | *3 | 34.7885 | 3.0002 | 1.66121 | 20.35 | 0.66162 |
| | *4 | 90.5944 | DD[4] | | | |
| | *5 | 11.3487 | 2.8611 | 1.53409 | 55.87 | 0.55858 |
| | *6 | 12.8452 | 1.7501 | | | |
| | 7(St) | ∞ | 3.9131 | | | |
| | 8 | 22.7325 | 4.6678 | 1.52841 | 76.45 | 0.53954 |
| | 9 | −9.2105 | 0.7498 | 1.80400 | 46.53 | 0.55775 |
| | 10 | −23.7939 | 2.5000 | | | |
| Gois | 11 | 41.6953 | 2.5000 | 1.43875 | 94.66 | 0.53402 |
| | 12 | −42.5080 | DD[12] | | | |
| Gfoc | *13 | −136.9065 | 0.6251 | 1.53409 | 55.87 | 0.55858 |
| | *14 | 17.6455 | DD[14] | | | |
| | 15 | −79.9750 | 5.0002 | 1.80400 | 46.53 | 0.55775 |
| | 16 | −38.0417 | 27.0000 | | | |

TABLE 101
Example 34

| | Wide | Middle | Tele |
|---|---|---|---|
| Zr | 1.0 | 1.5 | 1.8 |
| f | 25.27 | 37.13 | 46.49 |
| Bf | 27.00 | 27.00 | 27.00 |
| FNo. | 4.52 | 5.55 | 6.35 |
| 2ω[°] | 88.4 | 61.0 | 49.6 |
| DD[4] | 20.20 | 10.17 | 5.82 |
| DD[12] | 6.21 | 7.74 | 8.74 |
| DD[14] | 4.51 | 15.10 | 23.31 |

TABLE 102
Example 34

| Sn | 3 | 4 |
|---|---|---|
| KA | 1.0000000E+00 | 1.0000000E+00 |
| A4 | 1.5093481E−05 | −2.9333618E−06 |
| A6 | −3.5363356E−08 | −6.3878838E−08 |
| A8 | 3.5768810E−10 | 4.1180827E−10 |
| A10 | 4.0703152E−13 | −2.2049269E−13 |
| A12 | 9.6931301E−16 | −9.8133199E−16 |
| Sn | 5 | 6 |
| KA | 1.0000000E+00 | 1.0000000E+00 |
| A4 | −5.0742657E−05 | −5.7728704E−05 |
| A6 | −3.6752719E−07 | −5.0286039E−07 |
| A8 | −7.6273873E−09 | −2.5613172E−08 |
| A10 | −7.4598479E−12 | −4.7016109E−10 |
| A12 | −8.6753626E−12 | 4.7009210E−12 |
| A14 | −3.0958970E−14 | 2.9226278E−13 |
| A16 | 1.6503015E−14 | 2.3879740E−14 |
| A18 | −2.7843657E−16 | −7.4418516E−16 |
| Sn | 13 | 14 |
| KA | 1.0000000E+00 | 1.0000000E+00 |
| A3 | 0.0000000E+00 | 0.0000000E+00 |
| A4 | 5.0596614E−05 | 7.0897091E−05 |
| A5 | −2.3839288E−05 | −1.5482467E−05 |
| A6 | 7.0054933E−07 | −6.6323667E−07 |
| A7 | 1.6930330E−07 | 1.3324638E−07 |
| A8 | 1.3173590E−09 | 1.7645831E−08 |
| A9 | −1.6081821E−09 | −5.8977974E−10 |
| A10 | −1.2932748E−10 | 2.5753807E−11 |
| A11 | 4.0995535E−11 | −3.9641674E−11 |
| A12 | 3.3696260E−12 | −2.2667665E−12 |
| A13 | −8.3987350E−13 | 1.8650643E−13 |
| A14 | −8.7617505E−14 | 6.0082375E−14 |
| A15 | −8.4897508E−15 | 5.8019138E−15 |
| A16 | 3.5347377E−15 | −6.4964628E−16 |
| A17 | 2.5734060E−16 | −6.6655880E−17 |
| A18 | −4.8212259E−17 | −2.0933480E−18 |
| A19 | −1.2706342E−18 | 1.0382406E−18 |
| A20 | 1.9843732E−19 | −4.0435786E−20 |

### Example 35

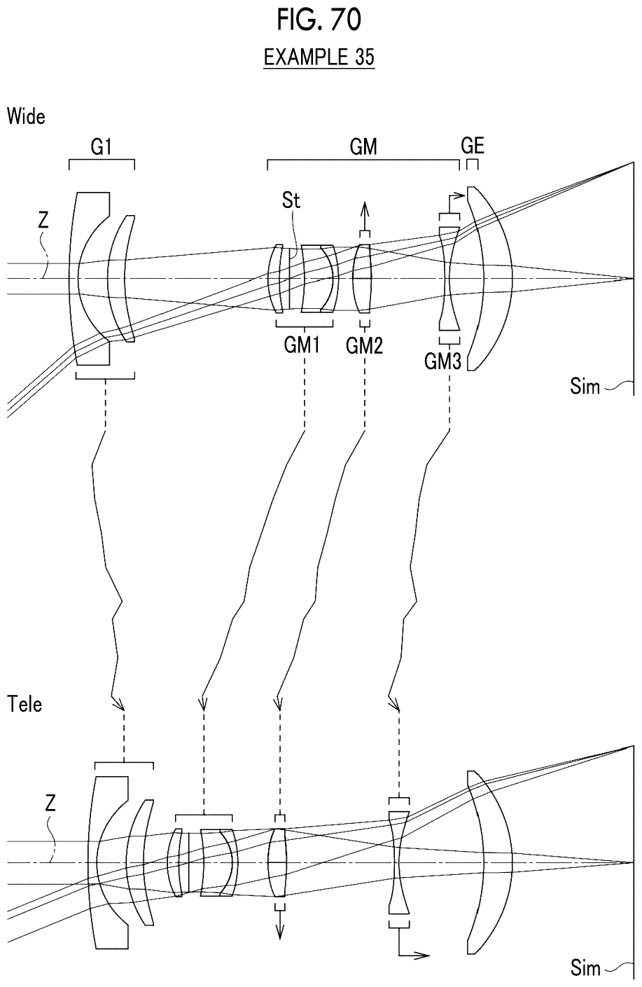

A configuration and a movement locus of a variable magnification optical system according to Example 35 are shown in FIG. 70. The variable magnification optical system according to Example 35 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the second intermediate lens group GM2.

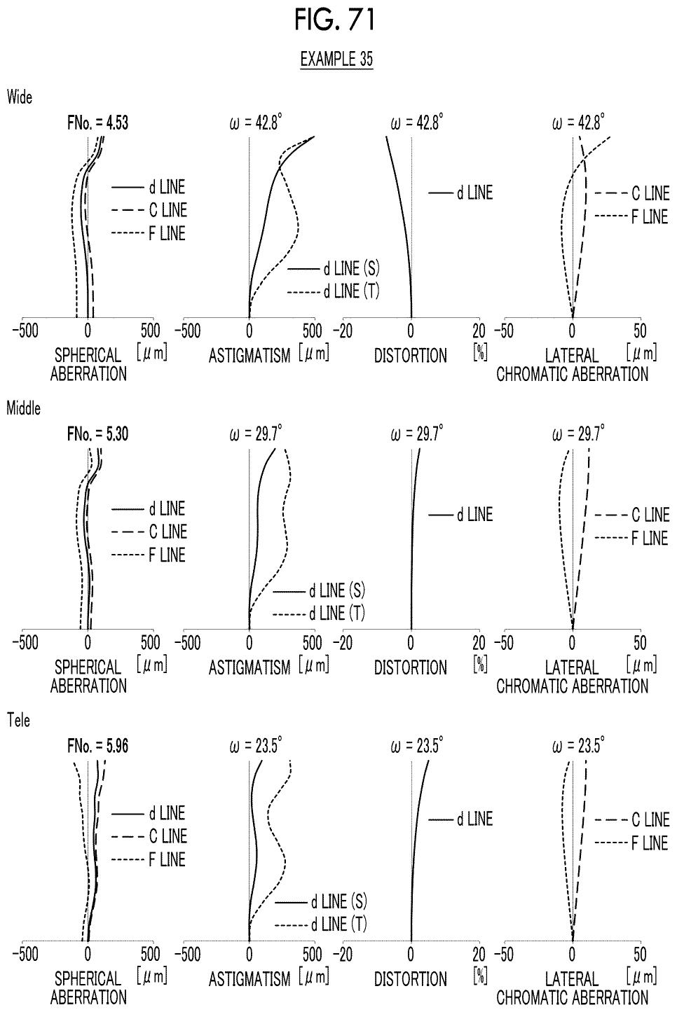

For the variable magnification optical system according to Example 35, basic lens data is shown in Table 103, specifications and variable surface spacings are shown in Table 104, aspherical coefficients are shown in Table 105, and each aberration diagram is shown in FIG. 71.

TABLE 103
Example 35

| | Sn | R | D | Nd | νd | θgF |
|---|---|---|---|---|---|---|
| | 1 | 89.4821 | 1.5502 | 1.77535 | 50.30 | 0.55004 |
| | | 14.9755 | 5.1687 | | | |
| | *3 | 22.7920 | 3.0002 | 1.66121 | 20.35 | 0.66162 |
| | *4 | 33.5487 | DD[4] | | | |
| | *5 | 14.7321 | 1.9998 | 1.53409 | 55.87 | 0.55858 |
| | *6 | 31.8199 | 1.7498 | | | |
| | 7(St) | ∞ | 2.6353 | | | |
| | 8 | −34.0271 | 5.0100 | 1.52841 | 76.45 | 0.53954 |
| | 9 | −8.5852 | 0.9567 | 1.80400 | 46.53 | 0.55775 |
| | 10 | −19.8593 | DD[10] | | | |
| Gois | *11 | 20.0116 | 3.2501 | 1.43875 | 94.66 | 0.53402 |
| | *12 | −34.1736 | DD[12] | | | |
| Gfoc | *13 | −52.2300 | 0.7865 | 1.53409 | 55.87 | 0.55858 |
| | *14 | 22.4139 | DD[14] | | | |
| | 15 | −39.6821 | 5.0002 | 1.80400 | 46.53 | 0.55775 |
| | 16 | −25.3795 | 21.2400 | | | |

TABLE 104
Example 35

| | Wide | Middle | Tele |
|---|---|---|---|
| Zr | 1.0 | 1.5 | 1.9 |
| f | 25.20 | 37.04 | 47.38 |
| Bf | 21.24 | 21.24 | 21.24 |
| FNo. | 4.52 | 5.30 | 5.96 |
| 2ω[°] | 85.6 | 59.4 | 47.0 |
| DD[4] | 24.99 | 11.43 | 4.07 |
| DD[10] | 2.50 | 4.41 | 5.28 |
| DD[12] | 12.87 | 15.82 | 18.89 |
| DD[14] | 5.92 | 11.67 | 14.74 |

TABLE 105
Example 35

| Sn | 3 | 4 |
|---|---|---|
| KA | 1.0000000E+00 | 1.0000000E+00 |
| A4 | 8.2760241E−06 | −1.9328419E−06 |
| A6 | −1.9908935E−08 | −8.9170539E−08 |
| A8 | 1.5779631E−10 | 1.6829817E−10 |
| A10 | −6.3809977E−13 | −5.9049016E−13 |
| A12 | −1.1725130E−15 | −4.3529747E−15 |

| Sn | 5 | 6 | 11 | 12 |
|---|---|---|---|---|
| KA | 1.0000000E+00 | 1.0000000E+00 | 1.0000000E+00 | 1.0000000E+00 |
| A4 | 2.9917524E−05 | 2.1239880E−05 | 7.3650530E−05 | 1.1661138E−04 |
| A6 | 5.1831358E−07 | 4.6145053E−07 | 9.8074335E−07 | 3.4145038E−07 |
| A8 | −6.1031734E−09 | −1.4581029E−08 | −1.4002750E−09 | 4.4102728E−08 |
| A10 | −5.4939662E−11 | −3.3465284E−10 | 6.9879438E−10 | −4.8049204E−10 |
| A12 | −9.5967190E−12 | −5.9070957E−12 | −1.7285612E−11 | −3.5559212E−12 |
| A14 | 3.0312156E−15 | −1.4206174E−13 | 3.0226642E−13 | 3.3917899E−13 |
| A16 | 1.4923717E−14 | 3.1497782E−14 | −5.9082689E−16 | −1.1481124E−15 |
| A18 | −2.6163074E−16 | −5.8772029E−16 | | |

| Sn | 13 | 14 |
|---|---|---|
| KA | 1.0000000E+00 | 1.0000000E+00 |
| A3 | 0.0000000E+00 | 0.0000000E+00 |
| A4 | 2.0120311E−05 | 5.2826783E−05 |
| A5 | −2.2829936E−05 | −1.6288397E−05 |
| A6 | 5.0988660E−07 | −4.9469763E−07 |
| A7 | 1.6327878E−07 | 1.2532713E−07 |
| A8 | 1.0527664E−09 | 1.7474982E−08 |
| A9 | −1.6311075E−09 | −6.0171594E−10 |
| A10 | −1.3199877E−10 | 2.5956269E−11 |
| A11 | 4.0652063E−11 | −3.9529894E−11 |
| A12 | 3.3301282E−12 | −2.2530848E−12 |
| A13 | −8.4162156E−13 | 1.8716275E−13 |
| A14 | −8.7293822E−14 | 6.0035407E−14 |
| A15 | −8.4161875E−15 | 5.7817093E−15 |
| A16 | 3.5411036E−15 | −6.5438423E−16 |
| A17 | 2.5965576E−16 | −6.6927710E−17 |
| A18 | −4.8277498E−17 | −2.1337379E−18 |
| A19 | −1.1722690E−18 | 1.0353711E−18 |
| A20 | 1.8115107E−19 | −3.8641881E−20 |

### Example 36

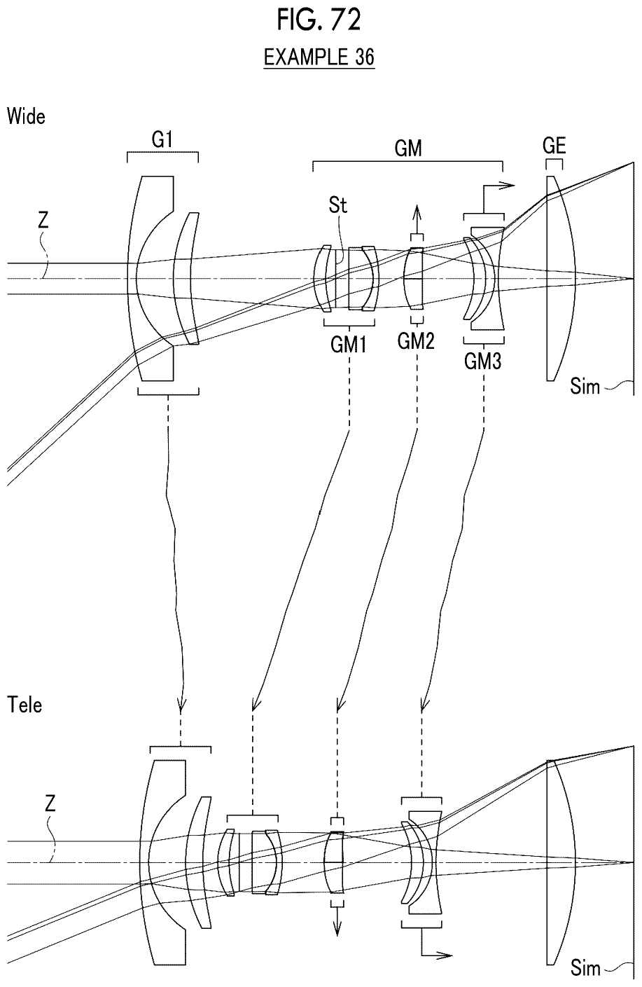

A configuration and a movement locus of a variable magnification optical system according to Example 36 are shown in FIG. 72. The variable magnification optical system according to Example 36 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the third intermediate lens group GM3. The anti-vibration group consists of the second intermediate lens group GM2.

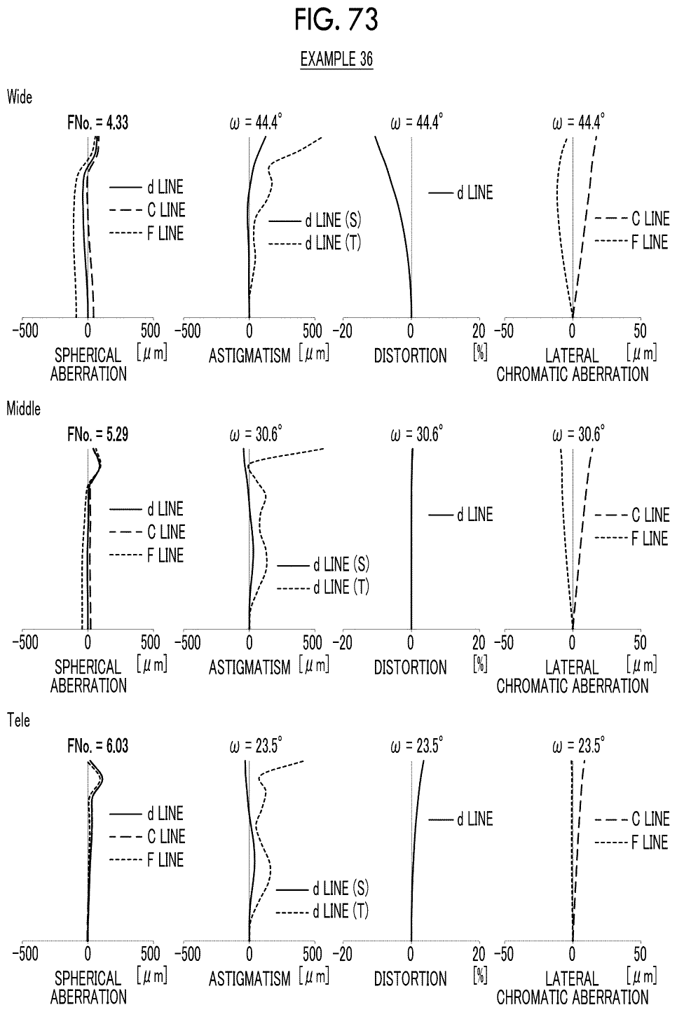

For the variable magnification optical system according to Example 36, basic lens data is shown in Table 106, specifications and variable surface spacings are shown in Table 107, aspherical coefficients are shown in Table 108, and each aberration diagram is shown in FIG. 73.

TABLE 106
Example 36

| | Sn | R | D | Nd | νd | θgF |
|---|---|---|---|---|---|---|
| | 1 | 71.5936 | 1.5502 | 1.77535 | 50.30 | 0.55004 |
| | 2 | 15.3187 | 6.4746 | | | |
| | *3 | 27.1251 | 3.0002 | 1.66121 | 20.35 | 0.66162 |
| | *4 | 40.3917 | DD[4] | | | |
| | *5 | 12.2339 | 1.9998 | 1.53409 | 55.87 | 0.55858 |
| | *6 | 19.0349 | 1.7498 | | | |
| | 7(St) | ∞ | 2.2769 | | | |
| | 8 | 387.4226 | 4.2598 | 1.52841 | 76.45 | 0.53954 |
| | 9 | −8.5893 | 1.0001 | 1.80400 | 46.53 | 0.55775 |
| | 10 | −21.5575 | DD[10] | | | |
| Gois | *11 | 15.8308 | 3.2502 | 1.43875 | 94.66 | 0.53402 |
| | *12 | −88.0943 | DD[12] | | | |
| Gfoc | 13 | −15.7832 | 2.0744 | 1.70529 | 57.03 | 0.54100 |
| | 14 | −11.7234 | 1.5725 | | | |
| | *15 | −10.3956 | 0.6248 | 1.53409 | 55.87 | 0.55858 |
| | *16 | 42.1721 | DD[16] | | | |
| | 17 | ∞ | 5.0002 | 1.80400 | 46.53 | 0.55775 |
| | 18 | −49.5134 | 10.1900 | | | |

TABLE 107
Example 36

| | Wide | Middle | Tele |
|---|---|---|---|
| Zr | 1.0 | 1.5 | 1.9 |
| f | 24.75 | 36.37 | 48.01 |
| Bf | 10.19 | 10.19 | 10.19 |
| FNo. | 4.33 | 5.29 | 6.03 |
| 2ω[°] | 88.8 | 61.2 | 47.0 |
| DD[4] | 21.57 | 10.26 | 2.61 |
| DD[10] | 4.38 | 6.49 | 7.24 |
| DD[12] | 9.00 | 10.12 | 12.04 |
| DD[16] | 8.49 | 15.11 | 19.40 |

TABLE 108
Example 36

| Sn | 3 | 4 |
|---|---|---|
| KA | 1.0000000E+00 | 1.0000000E+00 |
| A4 | −1.1918911E−06 | −1.2382685E−05 |
| A6 | −1.9591197E−08 | −3.8791170E−08 |
| A8 | 7.1359602E−11 | 6.3574168E−11 |
| A10 | −9.4684783E−14 | −2.3976585E−13 |
| A12 | 3.9535332E−16 | −1.3714988E−15 |

| Sn | 5 | 6 | 11 | 12 |
|---|---|---|---|---|
| KA | 1.0000000E+00 | 1.0000000E+00 | 1.0000000E+00 | 1.0000000E+00 |
| A4 | 1.6045932E−05 | 2.4027165E−05 | 1.6463243E−04 | 2.2674898E−04 |
| A6 | −9.2917658E−08 | −3.0774564E−07 | 1.3533551E−06 | 1.1671511E−06 |
| A8 | −6.2837534E−09 | −2.0064379E−08 | 3.6239952E−09 | 4.9674314E−08 |
| A10 | 2.0739360E−11 | −3.4455509E−10 | 7.8539523E−10 | −4.0111078E−10 |
| A12 | −8.8136390E−12 | 2.3060228E−12 | −1.6945137E−11 | −8.3541521E−13 |
| A14 | −6.0957928E−14 | 1.7863880E−14 | 2.7975527E−13 | 4.2155865E−13 |
| A16 | 1.5386720E−14 | 1.9526525E−14 | 6.2293145E−16 | −1.0117040E−15 |
| A18 | −2.6338321E−16 | −4.9887073E−16 | | |

| Sn | 15 | 16 |
|---|---|---|
| KA | 1.0000000E+00 | 1.0000000E+00 |
| A3 | 0.0000000E+00 | 0.0000000E+00 |
| A4 | 6.0108620E−05 | 6.9472597E−05 |
| A5 | −2.2326272E−05 | −1.5367078E−05 |
| A6 | 3.8924087E−07 | −4.9309640E−07 |
| A7 | 1.5843069E−07 | 1.3332478E−07 |
| A8 | 1.3435248E−09 | 1.7408618E−08 |
| A9 | −1.5911444E−09 | −6.0393374E−10 |
| A10 | −1.2953391E−10 | 2.5035285E−11 |
| A11 | 4.0666898E−11 | −3.9732755E−11 |
| A12 | 3.3003821E−12 | −2.2839637E−12 |
| A13 | −8.5030869E−13 | 1.8340367E−13 |
| A14 | −8.9351853E−14 | 5.9611952E−14 |
| A15 | −8.7363808E−15 | 5.7494639E−15 |
| A16 | 3.4734187E−15 | −6.5597100E−16 |
| A17 | 2.5367339E−16 | −6.6890020E−17 |
| A18 | −4.7990634E−17 | −2.1221977E−18 |
| A19 | −1.1911923E−18 | 1.0410002E−18 |
| A20 | 2.1388855E−19 | −3.7849166E−20 |

### Example 37

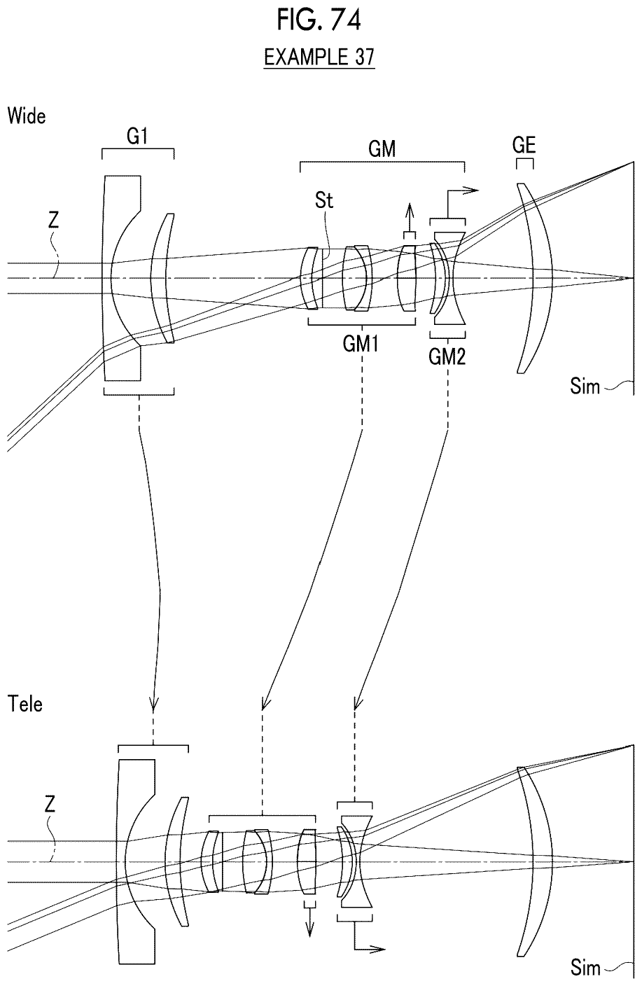

A configuration and a movement locus of a variable magnification optical system according to Example 37 are shown in FIG. 74. The variable magnification optical system according to Example 37 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the image side of the first intermediate lens group GM1.

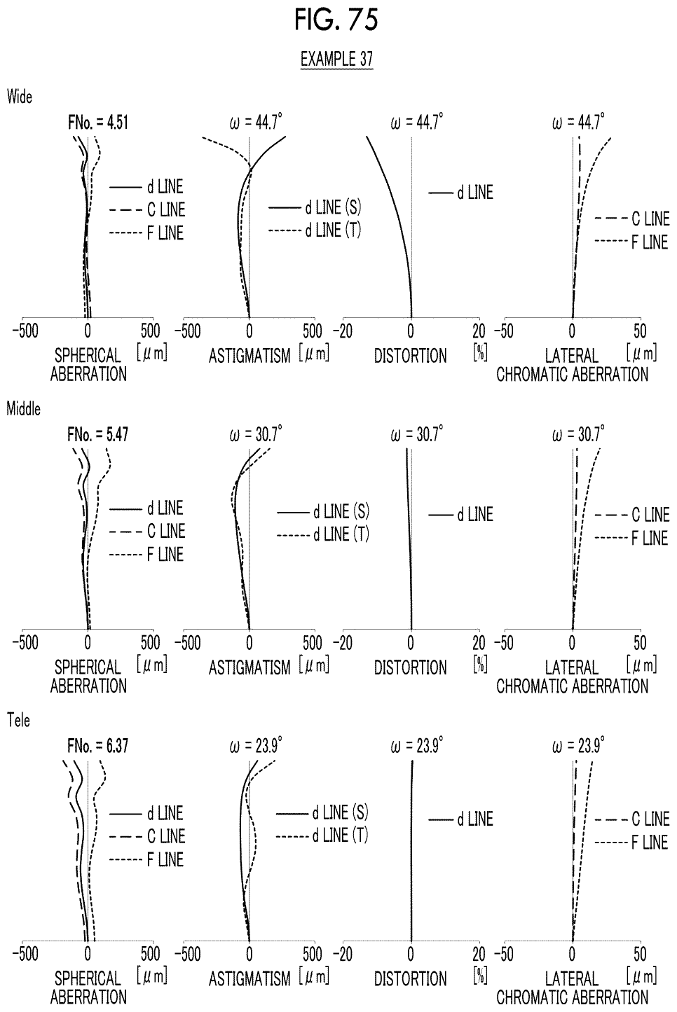

For the variable magnification optical system according to Example 37, basic lens data is shown in Table 109, specifications and variable surface spacings are shown in Table 110, aspherical coefficients are shown in Table 111, and each aberration diagram is shown in FIG. 75.

TABLE 109
Example 37

| | Sn | R | D | Nd | νd | θgF |
|---|---|---|---|---|---|---|
| | 1 | 355.9765 | 1.5508 | 1.77535 | 50.30 | 0.55004 |
| | 2 | 17.6899 | 6.9655 | | | |
| | *3 | 25.9237 | 2.6179 | 1.66121 | 20.35 | 0.66162 |
| | *4 | 43.2113 | DD[4] | | | |
| | *5 | 12.1713 | 2.0000 | 1.53409 | 55.87 | 0.55858 |
| | *6 | 14.6115 | 1.7498 | | | |
| | 7(St) | ∞ | 3.5002 | | | |
| | 8 | 25.6802 | 4.1967 | 1.52841 | 76.45 | 0.53954 |
| | 9 | −8.9772 | 1.0002 | 1.80400 | 46.53 | 0.55775 |
| | 10 | −23.6817 | 4.3752 | | | |
| Gois | *11 | 20.2045 | 3.2502 | 1.43875 | 94.66 | 0.53402 |
| | *12 | −42.9370 | DD[12] | | | |
| Gfoc | 13 | −21.7710 | 1.7062 | 1.72108 | 56.24 | 0.54096 |
| | 14 | −12.0676 | 0.7000 | | | |
| | *15 | −12.3939 | 0.6248 | 1.53409 | 55.87 | 0.55858 |
| | *16 | 16.2952 | DD[16] | | | |
| | 17 | −55.5854 | 3.3971 | 1.80400 | 46.53 | 0.55775 |
| | 18 | −33.6035 | 14.1900 | | | |

TABLE 110
Example 37

| | Wide | Middle | Tele |
|---|---|---|---|
| Zr | 1.0 | 1.5 | 1.9 |
| f | 25.13 | 36.93 | 48.75 |
| Bf | 14.19 | 14.19 | 14.19 |
| FNo. | 4.52 | 5.48 | 6.37 |
| 2ω[°] | 89.4 | 61.4 | 47.8 |
| DD[4] | 23.52 | 10.77 | 3.69 |
| DD[12] | 3.44 | 3.95 | 4.53 |
| DD[16] | 14.00 | 22.54 | 30.26 |

TABLE 111
Example 37

| Sn | 3 | 4 |
|---|---|---|
| KA | 1.0000000E+00 | 1.0000000E+00 |
| A4 | 3.3176430E−06 | −2.8395260E−06 |
| A6 | −5.5681410E−08 | −5.9734046E−08 |
| A8 | 2.4007538E−10 | 1.6864424E−10 |
| A10 | −5.8096939E−13 | −1.4370811E−13 |
| A12 | −1.7272904E−16 | −1.6894996E−15 |

| Sn | 5 | 6 | 11 | 12 |
|---|---|---|---|---|
| KA | 1.0000000E+00 | 1.0000000E+00 | 1.0000000E+00 | 1.0000000E+00 |
| A4 | −2.4900630E−05 | −3.1014867E−05 | 1.1577505E−04 | 1.6151316E−04 |
| A6 | −1.0995156E−07 | −1.5140427E−07 | 1.5130998E−06 | 1.1367038E−06 |
| A8 | −6.8813567E−09 | −2.3068393E−08 | 4.9556796E−09 | 4.9090315E−08 |
| A10 | −1.5145776E−11 | −4.8673469E−10 | 8.0974049E−10 | −4.3503496E−10 |
| A12 | −9.5492731E−12 | 5.4554537E−13 | −1.7195842E−11 | −1.8616918E−12 |
| A14 | −5.3387427E−14 | 1.3577928E−13 | 2.3890713E−13 | 4.0468904E−13 |
| A16 | 1.5395847E−14 | 2.4287910E−14 | 6.2380120E−16 | −1.1028621E−15 |
| A18 | −2.5117060E−16 | −6.2760187E−16 | | |

| Sn | 15 | 16 |
|---|---|---|
| KA | 1.0000000E+00 | 1.0000000E+00 |
| A3 | 0.0000000E+00 | 0.0000000E+00 |
| A4 | −1.8456124E−06 | 3.1591350E−05 |
| A5 | −2.2047015E−05 | −1.2995076E−05 |
| A6 | 5.2454089E−07 | −6.0002810E−07 |
| A7 | 1.6424754E−07 | 1.2459755E−07 |
| A8 | 1.5400021E−09 | 1.6983525E−08 |
| A9 | −1.6126073E−09 | −6.1274192E−10 |
| A10 | −1.3609404E−10 | 2.5407813E−11 |
| A11 | 3.9682932E−11 | −3.9660980E−11 |
| A12 | 3.1959447E−12 | −2.2766009E−12 |
| A13 | −8.5698383E−13 | 1.8416515E−13 |
| A14 | −8.8372877E−14 | 5.9676560E−14 |
| A15 | −8.2227461E−15 | 5.7510906E−15 |
| A16 | 3.6243987E−15 | −6.5608379E−16 |
| A17 | 2.8459986E−16 | −6.7197276E−17 |
| A18 | −5.1188543E−17 | −2.1646174E−18 |
| A19 | −1.0067963E−18 | 1.0355683E−18 |
| A20 | 1.1441180E−19 | −3.7828942E−20 |

### Example 38

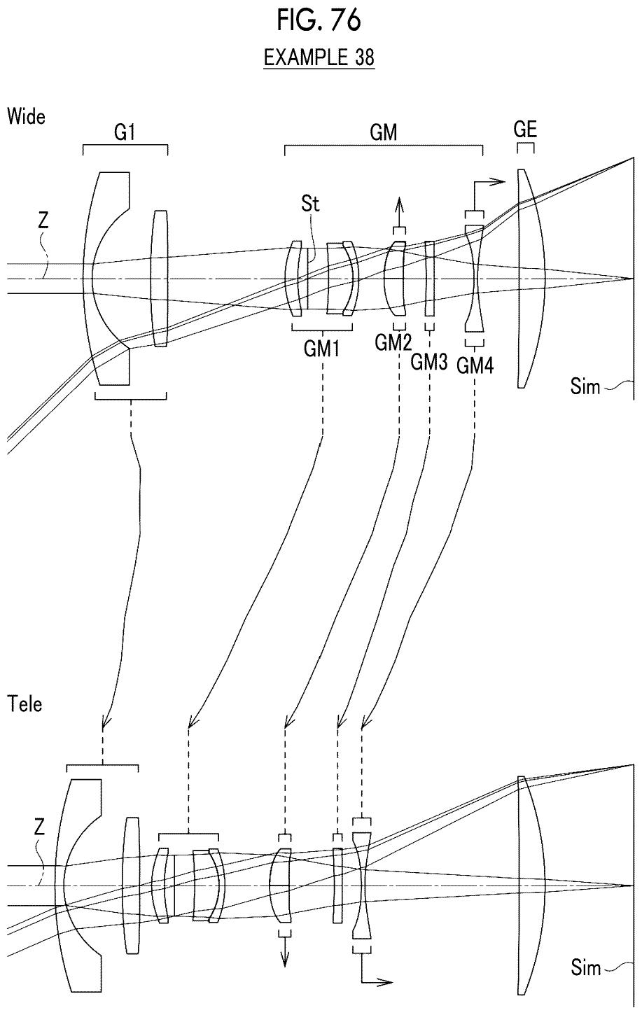

A configuration and a movement locus of a variable magnification optical system according to Example 38 are shown in FIG. 76. The variable magnification optical system according to Example 38 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having positive refractive power, the third intermediate lens group GM3 having negative refractive power, and the fourth intermediate lens group GM4 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the fourth intermediate lens group GM4. The anti-vibration group consists of the second intermediate lens group GM2.

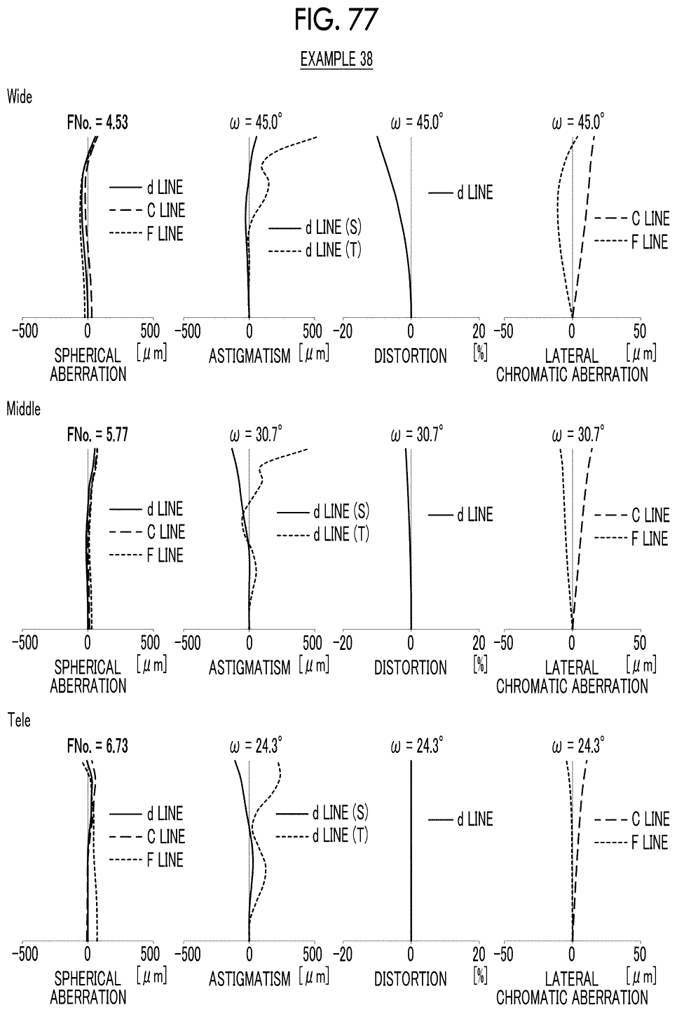

For the variable magnification optical system according to Example 38, basic lens data is shown in Table 112, specifications and variable surface spacings are shown in Table 113, aspherical coefficients are shown in Table 114, and each aberration diagram is shown in FIG. 77.

TABLE 112
Example 38

| | Sn | R | D | Nd | νd | θgF |
|---|---|---|---|---|---|---|
| | 1 | 63.5843 | 1.5498 | 1.77535 | 50.30 | 0.55004 |
| | 2 | 15.2679 | 10.1543 | | | |
| | *3 | 102.9150 | 2.9999 | 1.66121 | 20.35 | 0.66162 |
| | *4 | 835.1278 | DD[4] | | | |
| | *5 | 16.1663 | 2.2197 | 1.53409 | 55.87 | 0.55858 |
| | *6 | 27.4566 | 1.7498 | | | |
| | 7(St) | ∞ | 3.5002 | | | |
| | 8 | −72.1162 | 4.2600 | 1.52841 | 76.45 | 0.53954 |
| | 9 | −10.9053 | 1.0002 | 1.80400 | 46.53 | 0.55775 |
| | 10 | −17.9216 | DD[10] | | | |
| Gois | *11 | 17.0417 | 3.3751 | 1.43875 | 94.66 | 0.53402 |
| | *12 | −318.5779 | DD[12] | | | |
| | 13 | −103.5217 | 1.3892 | 1.92764 | 18.62 | 0.63734 |
| | 14 | −3721.6135 | DD[14] | | | |
| Gfoc | *15 | −30.4959 | 0.6248 | 1.53409 | 55.87 | 0.55858 |
| | *16 | 31.6964 | DD[16] | | | |
| | 17 | −1045.3812 | 4.5005 | 1.80400 | 46.53 | 0.55775 |
| | 18 | −54.2923 | 15.4100 | | | |

TABLE 113
Example 38

| | Wide | Middle | Tele |
|---|---|---|---|
| Zr | 1.0 | 1.5 | 2.0 |
| f | 24.03 | 37.00 | 48.06 |
| Bf | 15.41 | 15.41 | 15.41 |
| FNo. | 4.53 | 5.77 | 6.72 |
| 2ω[°] | 90.0 | 61.4 | 48.6 |
| DD[4] | 20.37 | 8.17 | 2.11 |
| DD[10] | 4.38 | 6.56 | 7.77 |
| DD[12] | 3.96 | 6.00 | 7.75 |
| DD[14] | 6.90 | 4.74 | 3.34 |
| DD[16] | 7.22 | 18.45 | 26.79 |

TABLE 114
Example 38

| Sn | 3 | 4 |
|---|---|---|
| KA | 1.0000000E+00 | 1.0000000E+00 |
| A4 | −5.7127568E−07 | −1.5044546E−05 |
| A6 | −7.0911081E−09 | −1.5027831E−09 |
| A8 | 3.6185763E−10 | 5.2328949E−11 |
| A10 | −3.5014620E−13 | 8.2118599E−13 |
| A12 | −2.3416010E−15 | −7.1576531E−15 |

| Sn | 5 | 6 | 11 | 12 |
|---|---|---|---|---|
| KA | 1.0000000E+00 | 1.0000000E+00 | 1.0000000E+00 | 1.0000000E+00 |
| A4 | 9.5837230E−06 | 4.7375670E−05 | 1.8056016E−04 | 2.4210577E−04 |
| A6 | −4.6598771E−07 | −5.1386618E−07 | 1.5539709E−06 | 1.3459575E−06 |
| A8 | −1.0033603E−08 | −1.6122178E−08 | 3.6099131E−09 | 4.8884126E−08 |
| A10 | 1.9974371E−10 | −2.7789449E−11 | 7.7375414E−10 | −2.8190322E−10 |
| A12 | −9.9809479E−12 | −3.1302353E−12 | −1.6808470E−11 | −7.2779688E−13 |
| A14 | −1.8907975E−13 | −3.0479839E−13 | 2.7145760E−13 | 3.1358868E−13 |
| A16 | 1.2730270E−14 | 1.9154511E−14 | 6.2859617E−17 | 1.2934736E−15 |
| A18 | −1.5194901E−16 | −2.7889120E−16 | | |

| Sn | 15 | 16 |
|---|---|---|
| KA | 1.0000000E+00 | 1.0000000E+00 |
| A3 | 0.0000000E+00 | 0.0000000E+00 |
| A4 | 3.8442213E−05 | 4.5531342E−05 |
| A5 | −2.3246795E−05 | −1.7932530E−05 |
| A6 | 7.2378658E−08 | −5.3266424E−07 |
| A7 | 1.4982445E−07 | 1.3196115E−07 |
| A8 | 2.4998436E−09 | 1.8311929E−08 |
| A9 | −1.4798698E−09 | −5.2207562E−10 |
| A10 | −1.1619220E−10 | 3.0003144E−11 |
| A11 | 4.0546141E−11 | −3.9637376E−11 |
| A12 | 3.3304204E−12 | −2.3075887E−12 |
| A13 | −8.4765376E−13 | 1.7917518E−13 |
| A14 | −8.8270637E−14 | 5.9184274E−14 |
| A15 | −8.5177549E−15 | 5.7213962E−15 |
| A16 | 3.5047931E−15 | −6.5651947E−16 |
| A17 | 2.5341243E−16 | −6.6758780E−17 |
| A18 | −4.8852103E−17 | −2.1064891E−18 |
| A19 | −1.2543034E−18 | 1.0442444E−18 |
| A20 | 2.0888190E−19 | −3.8069231E−20 |

### Example 39

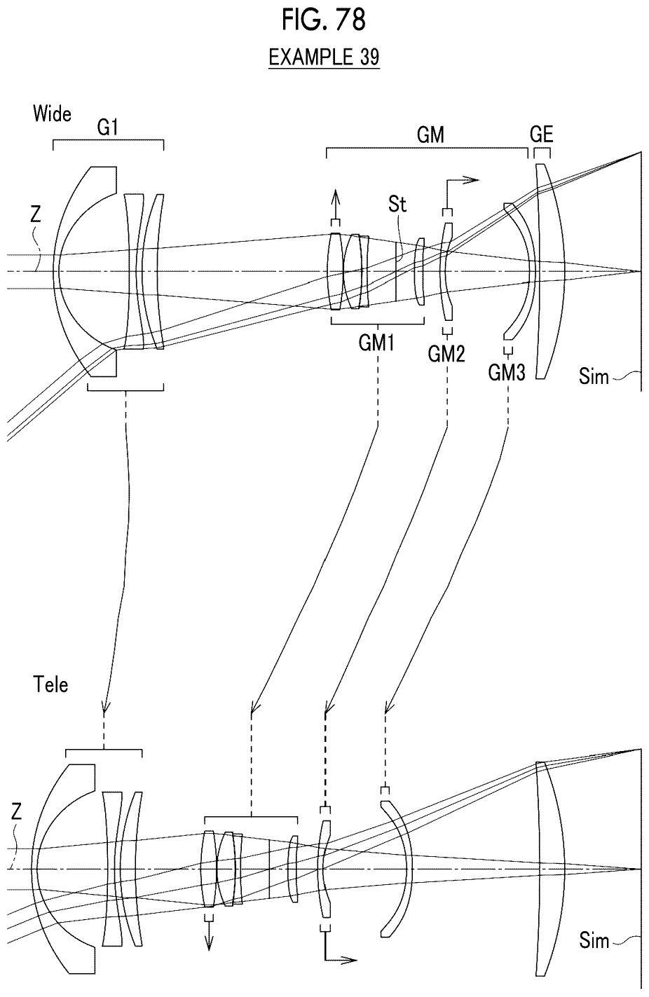

A configuration and a movement locus of a variable magnification optical system according to Example 39 are shown in FIG. 78. The variable magnification optical system according to Example 39 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having negative refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

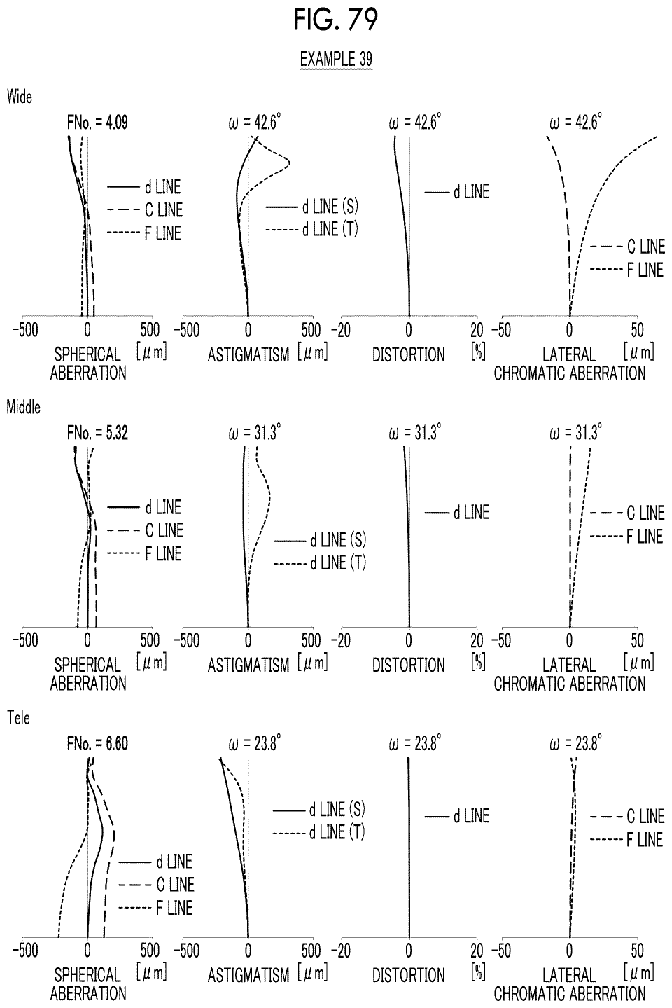

For the variable magnification optical system according to Example 39, basic lens data is shown in Table 115, specifications and variable surface spacings are shown in Table 116, aspherical coefficients are shown in Table 117, and each aberration diagram is shown in FIG. 79.

TABLE 115
Example 39

| | Sn | R | D | Nd | νd | θgF |
|---|---|---|---|---|---|---|
| | 1 | 31.3271 | 0.9498 | 1.77535 | 50.30 | 0.55004 |
| | 2 | 15.1870 | 11.9956 | | | |
| | *3 | −174.8306 | 1.1511 | 1.53409 | 55.87 | 0.55858 |
| | *4 | 42.0638 | 1.0000 | | | |
| | 5 | 39.4150 | 2.5713 | 1.95906 | 17.47 | 0.65993 |
| | 6 | 84.2139 | DD[6] | | | |
| Gois | 7 | 35.3406 | 2.6842 | 1.55030 | 50.26 | 0.55955 |
| | 8 | −42.2116 | 0.0472 | | | |
| | 9 | 16.4245 | 3.1443 | 1.49700 | 81.54 | 0.53748 |
| | 10 | −44.0467 | 0.8750 | 1.98466 | 27.48 | 0.60508 |
| | 11 | 66.9095 | 4.9348 | | | |
| | 12(St) | ∞ | 3.1227 | | | |
| | *13 | 49.1227 | 1.4449 | 1.93318 | 35.43 | 0.58183 |
| | *14 | 400.8140 | DD[14] | | | |
| Gfoc | 15 | 41.9743 | 0.8750 | 1.82966 | 45.38 | 0.55953 |
| | 16 | 16.6726 | DD[16] | | | |
| | *17 | −20.7024 | 0.9886 | 1.53409 | 55.87 | 0.55858 |
| | *18 | −33.2178 | DD[18] | | | |
| | 19 | −302.3009 | 4.2502 | 1.89190 | 37.13 | 0.57813 |
| | 20 | −56.4835 | 13.0000 | | | |

TABLE 116
Example 39

| | Wide | Middle | Tele |
|---|---|---|---|
| Zr | 1.0 | 1.5 | 2.0 |
| f | 24.67 | 36.25 | 49.33 |
| Bf | 13.00 | 13.00 | 13.00 |
| FNo. | 4.09 | 5.32 | 6.60 |
| 2ω[°] | 85.2 | 62.6 | 47.6 |
| DD[6] | 28.85 | 18.29 | 11.13 |
| DD[14] | 2.92 | 2.93 | 3.63 |
| DD[16] | 14.36 | 14.95 | 14.15 |
| DD[18] | 0.73 | 10.95 | 21.64 |

TABLE 117
Example 39

| Sn | 3 | 4 |
|---|---|---|
| KA | 1.0000000E+00 | 1.0000000E+00 |
| A4 | −1.1535256E−05 | −2.5240584E−05 |
| A6 | 6.1081749E−08 | 4.8320418E−08 |
| A8 | −3.2637471E−10 | −5.0830376E−10 |
| A10 | 7.6349431E−13 | 1.5518848E−12 |
| A12 | −1.6152705E−15 | −4.5060646E−15 |

| Sn | 13 | 17 | 18 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | 2.3183301E−04 | −9.7862231E−05 | −9.8771800E−05 |
| A5 | −3.5912145E−06 | −1.9489807E−06 | −9.9134696E−07 |
| A6 | 9.0701121E−08 | 7.7201255E−07 | 6.4367884E−07 |
| A7 | 2.4663749E−06 | 1.4586600E−09 | −3.6663418E−09 |
| A8 | −6.5606076E−07 | −5.3756968E−09 | −2.5150303E−09 |
| A9 | 1.2851532E−08 | 2.2502995E−13 | −9.5730559E−11 |
| A10 | 3.0330337E−08 | 3.0843555E−11 | −3.8657436E−12 |
| A11 | 1.3495501E−09 | −2.3563456E−13 | 1.3615206E−12 |
| A12 | −2.4402958E−09 | −1.3468166E−13 | 1.5853969E−14 |
| A13 | 9.9866230E−11 | −6.9614575E−15 | −4.9004868E−16 |
| A14 | 1.2207694E−11 | −5.5423801E−16 | −5.2658764E−16 |
| A15 | 1.7459601E−11 | 1.5141438E−16 | 3.2386670E−17 |
| A16 | −1.0527348E−12 | 9.5119070E−18 | −4.9084192E−19 |
| A17 | −5.6752159E−13 | 6.4768812E−20 | 1.1342639E−19 |
| A18 | 7.8621141E−15 | −5.2895134E−20 | −2.1505469E−20 |
| A19 | 1.3440005E−14 | −4.0747035E−21 | 2.3117435E−21 |
| A20 | −9.2909255E−16 | 2.0663477E−22 | −9.2693634E−23 |

| Sn | 14 |
|---|---|
| KA | 1.0000000E+00 |
| A3 | 0.0000000E+00 |
| A4 | 2.7615187E−04 |
| A5 | −4.2479789E−06 |
| A6 | −9.7526124E−07 |
| A7 | 2.9307051E−06 |
| A8 | −3.0608469E−07 |
| A9 | −8.4346931E−08 |
| A10 | 1.4152697E−08 |
| A11 | 1.5143929E−09 |
| A12 | −2.5368847E−10 |

### Example 40

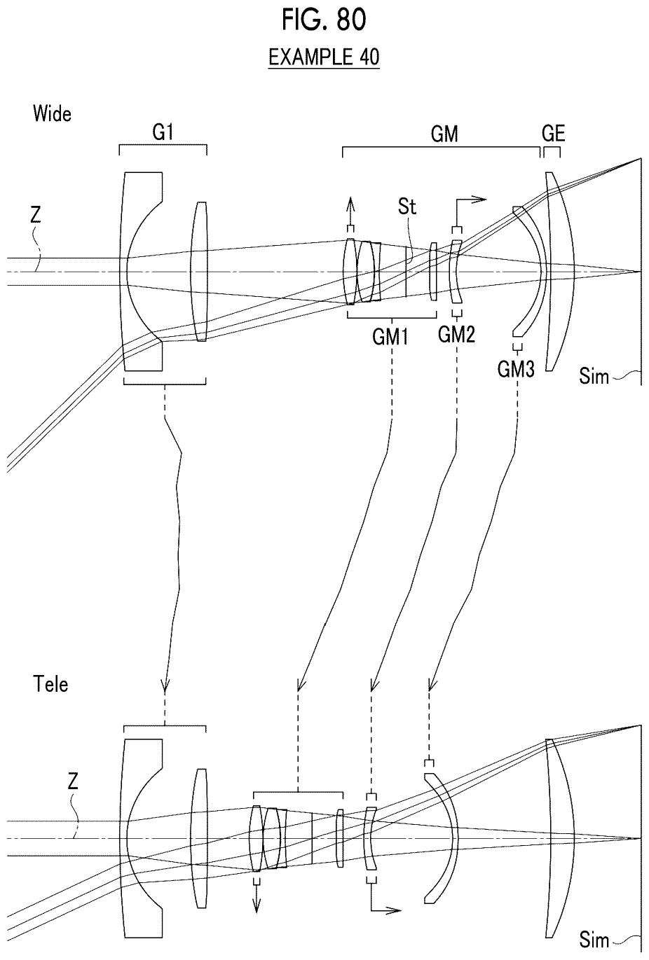

A configuration and a movement locus of a variable magnification optical system according to Example 40 are shown in FIG. 80. The variable magnification optical system according to Example 40 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having negative refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

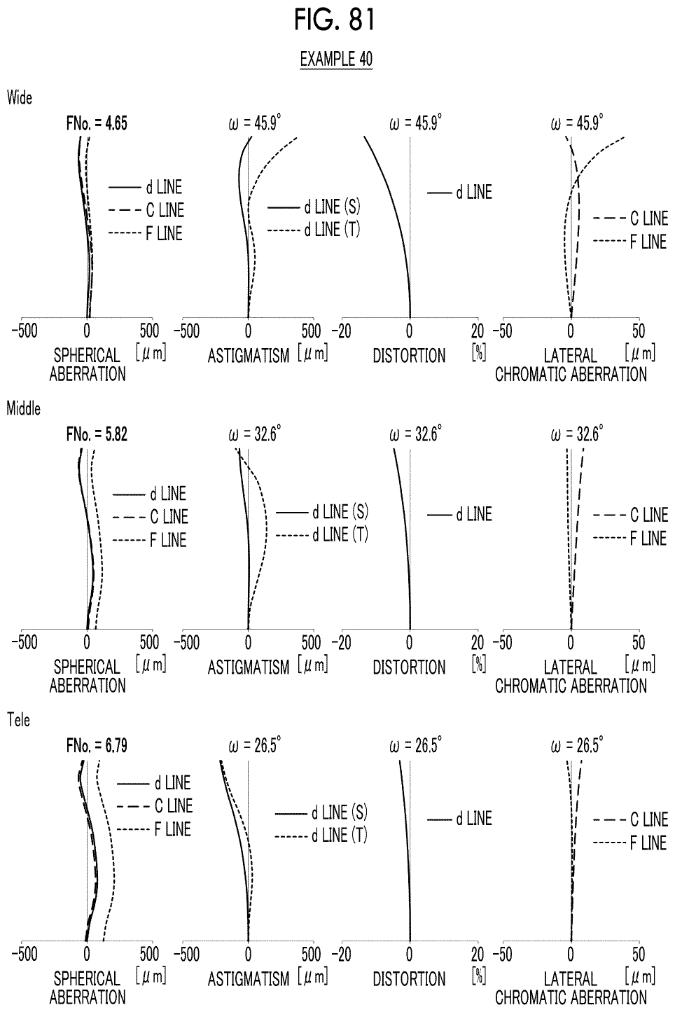

For the variable magnification optical system according to Example 40, basic lens data is shown in Table 118, specifications and variable surface spacings are shown in Table 119, aspherical coefficients are shown in Table 120, and each aberration diagram is shown in FIG. 81.

TABLE 118
Example 40

| | Sn | R | D | Nd | νd | θgF |
|---|---|---|---|---|---|---|
| | 1 | 193.0332 | 1.2500 | 1.80400 | 46.53 | 0.55775 |
| | 2 | 17.2643 | 11.5006 | | | |
| | *3 | 83.8728 | 3.0002 | 1.66121 | 20.35 | 0.66162 |
| | *4 | −3117.6879 | DD[4] | | | |
| Gois | 5 | 26.7876 | 2.4547 | 1.48749 | 70.32 | 0.52917 |
| | 6 | −33.6917 | 0.0473 | | | |
| | 7 | 19.1994 | 3.1107 | 1.49700 | 81.54 | 0.53748 |
| | 8 | −21.9649 | 0.8750 | 1.77231 | 47.91 | 0.55597 |
| | 9 | 58.4447 | 4.8094 | | | |
| | 10(St) | ∞ | 4.2600 | | | |
| | *11 | 594.0291 | 1.2498 | 1.86100 | 37.10 | 0.57857 |
| | *12 | −62.6629 | DD[12] | | | |
| Gfoc | 13 | 30.6491 | 1.2502 | 1.83130 | 23.43 | 0.62266 |
| | 14 | 15.8670 | DD[14] | | | |
| | *15 | −15.5274 | 1.0002 | 1.53409 | 55.87 | 0.55858 |
| | *16 | −24.0975 | DD[16] | | | |
| | 17 | −203.8052 | 4.2500 | 1.77535 | 50.30 | 0.55004 |
| | 18 | −47.0197 | 12.0300 | | | |

TABLE 119
Example 40

| | Wide | Middle | Tele |
|---|---|---|---|
| Zr | 1.0 | 1.5 | 1.8 |
| f | 24.26 | 35.66 | 44.89 |
| Bf | 12.03 | 12.03 | 12.03 |
| FNo. | 4.65 | 5.82 | 6.79 |
| 2ω[°] | 91.8 | 65.2 | 53.0 |
| DD[4] | 24.38 | 12.53 | 7.56 |
| DD[12] | 2.30 | 3.19 | 3.71 |
| DD[14] | 15.25 | 15.32 | 14.75 |
| DD[16] | 0.75 | 9.05 | 16.65 |

TABLE 120
Example 40

| Sn | 3 | 4 |
|---|---|---|
| KA | 1.0000000E+00 | 1.0000000E+00 |
| A4 | 6.9422790E−06 | −3.5247656E−06 |
| A6 | −1.4297990E−09 | −2.9511273E−08 |
| A8 | −5.9418727E−11 | 1.8137819E−11 |
| A10 | 3.1093115E−13 | −6.0175529E−14 |
| A12 | 4.2309967E−16 | 5.4718733E−16 |

| Sn | 11 | 15 | 16 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | 2.2918177E−04 | −4.9803081E−05 | −6.1751449E−05 |
| A5 | 3.1459694E−06 | −2.8482567E−06 | −2.0669460E−06 |
| A6 | 3.8243576E−07 | 8.9266685E−07 | 7.7092943E−07 |
| A7 | 2.4410150E−06 | 7.6025174E−09 | −1.4492575E−08 |
| A8 | −6.6782027E−07 | −6.1865757E−09 | −2.5377274E−09 |
| A9 | 1.2118130E−08 | 2.1430314E−11 | −7.4490295E−11 |
| A10 | 3.0475314E−08 | 2.7867562E−11 | −2.8580042E−12 |
| A11 | 1.4980540E−09 | −1.0072354E−13 | 1.3745159E−12 |
| A12 | −2.4264023E−09 | −1.5328061E−13 | 1.0477118E−14 |
| A13 | 1.0379431E−10 | −4.4806157E−15 | −7.0310083E−16 |
| A14 | 1.2320338E−11 | −2.2011554E−16 | −5.5296038E−16 |
| A15 | 1.7192340E−11 | 1.1757818E−16 | 3.4353955E−17 |
| A16 | −1.1098975E−12 | 8.3045629E−18 | −6.0983163E−19 |
| A17 | −5.6541796E−13 | 3.6240896E−19 | 9.6298063E−20 |
| A18 | 8.7232725E−15 | −5.3068502E−20 | −1.8176342E−20 |
| A19 | 1.3497657E−14 | −4.2660633E−21 | 2.4091923E−21 |
| A20 | −9.2775053E−16 | 1.3093491E−22 | −1.0990976E−22 |

| Sn | 12 |
|---|---|
| KA | 1.0000000E+00 |
| A3 | 0.0000000E+00 |
| A4 | 2.7001628E−04 |
| A5 | −2.2954654E−06 |
| A6 | −7.6680000E−07 |
| A7 | 2.9814816E−06 |
| A8 | −3.0909422E−07 |
| A9 | −8.2423325E−08 |
| A10 | 1.4377566E−08 |
| A11 | 1.4622784E−09 |
| A12 | −2.6086622E−10 |

### Example 41

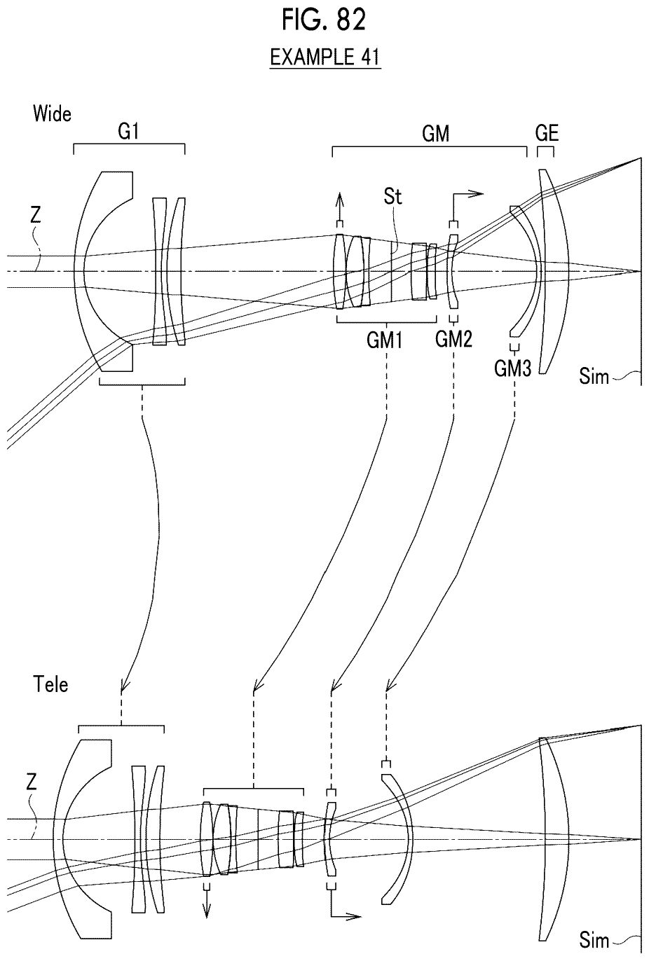

A configuration and a movement locus of a variable magnification optical system according to Example 41 are shown in FIG. 82. The variable magnification optical system according to Example 41 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having negative refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

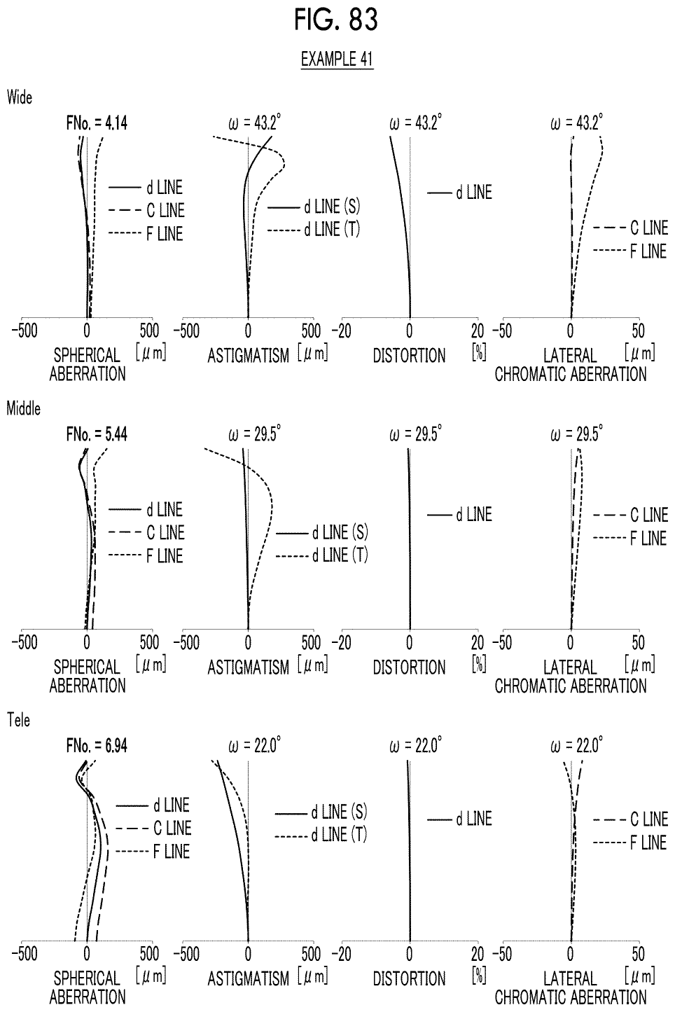

For the variable magnification optical system according to Example 41, basic lens data is shown in Table 121, specifications and variable surface spacings are shown in Table 122, aspherical coefficients are shown in Table 123, and each aberration diagram is shown in FIG. 83.

TABLE 121
Example 41

| | Sn | R | D | Nd | νd | θgF |
|---|---|---|---|---|---|---|
| | 1 | 38.7141 | 1.7500 | 1.81032 | 47.57 | 0.55246 |
| | 2 | 15.4285 | 12.9384 | | | |
| | *3 | −227.2607 | 1.0001 | 1.53409 | 55.87 | 0.55858 |
| | *4 | 54.3358 | 0.9999 | | | |
| | 5 | 47.9740 | 2.5001 | 1.95906 | 17.47 | 0.65993 |
| | 6 | 115.2486 | DD[6] | | | |
| Gois | 7 | 41.5876 | 2.2501 | 1.65038 | 49.17 | 0.55783 |
| | 8 | −45.2670 | 0.0500 | | | |
| | 9 | 17.1243 | 3.2037 | 1.43875 | 94.66 | 0.53402 |
| | 10 | −40.4148 | 0.8750 | 1.93393 | 30.89 | 0.59542 |
| | 11 | 75.8854 | 4.0460 | | | |
| | 12(St) | ∞ | 3.5588 | | | |
| | 13 | 57.0622 | 2.8031 | 1.48749 | 70.24 | 0.53007 |
| | 14 | −164.9742 | 0.1000 | | | |
| | *15 | 47.0122 | 1.4579 | 1.51633 | 64.06 | 0.53345 |
| | *16 | 507.6131 | DD[16] | | | |
| Gfoc | 17 | 40.2077 | 0.8752 | 1.83481 | 42.74 | 0.56490 |
| | 18 | 15.8146 | DD[18] | | | |
| | *19 | −16.2405 | 0.8089 | 1.53409 | 55.87 | 0.55858 |
| | *20 | −25.4557 | DD[20] | | | |
| | 21 | −165.6802 | 4.2498 | 1.87063 | 39.09 | 0.57176 |
| | 22 | −47.0247 | 12.9800 | | | |

TABLE 122
Example 41

| | Wide | Middle | Tele |
|---|---|---|---|
| Zr | 1.0 | 1.6 | 2.2 |
| f | 24.58 | 38.58 | 54.07 |
| Bf | 12.98 | 12.98 | 12.98 |
| FNo. | 4.14 | 5.44 | 6.94 |
| 2ω[°] | 86.4 | 59.0 | 44.0 |
| DD[6] | 27.33 | 13.80 | 7.28 |
| DD[16] | 2.10 | 3.16 | 3.92 |
| DD[18] | 15.25 | 15.06 | 14.16 |
| DD[20] | 0.75 | 11.12 | 23.83 |

TABLE 123
Example 41

| Sn | 3 | 4 |
|---|---|---|
| KA | 1.0000000E+00 | 1.0000000E+00 |
| A4 | −1.0175502E−05 | −2.4309240E−05 |
| A6 | 7.6694948E−08 | 5.6773746E−08 |
| A8 | −3.5784131E−10 | −4.9088514E−10 |
| A10 | 1.0579471E−12 | 1.7615652E−12 |
| A12 | −1.5614948E−15 | −5.0395866E−15 |

| Sn | 15 | 19 | 20 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | 2.1959242E−04 | −5.1889210E−05 | −5.9545992E−05 |
| A5 | −1.2856309E−06 | −1.9428955E−06 | −6.4919352E−07 |
| A6 | 9.2877535E−08 | 8.2386299E−07 | 6.2961529E−07 |
| A7 | 2.4451554E−06 | 4.6010962E−09 | −6.8872305E−09 |
| A8 | −6.6285733E−07 | −5.8214680E−09 | −2.5132163E−09 |
| A9 | 1.3242054E−08 | 3.3791528E−11 | −8.6814657E−11 |
| A10 | 3.0353181E−08 | 3.1148402E−11 | −3.2133511E−12 |
| A11 | 1.3742205E−09 | −2.2860411E−14 | 1.3735243E−12 |
| A12 | −2.4409738E−09 | −1.7747887E−13 | 2.0375770E−14 |
| A13 | 1.0041867E−10 | −5.0616541E−15 | −1.2568968E−16 |
| A14 | 1.2303946E−11 | −3.4277743E−16 | −5.5527688E−16 |
| A15 | 1.7509219E−11 | 1.3827165E−16 | 2.8982818E−17 |
| A16 | −1.0580649E−12 | 9.0140541E−18 | −7.2198525E−19 |
| A17 | −5.7198237E−13 | 2.2575433E−19 | 8.3920820E−20 |
| A18 | 8.2470714E−15 | −6.4890515E−20 | −1.8611312E−20 |
| A19 | 1.3390418E−14 | −5.0100477E−21 | 2.4615082E−21 |
| A20 | −9.1745658E−16 | 2.0655910E−22 | −1.1362307E−22 |

| Sn | 16 |
|---|---|
| KA | 1.0000000E+00 |
| A3 | 0.0000000E+00 |
| A4 | 2.8744667E−04 |
| A5 | −4.4846376E−06 |
| A6 | −7.5342242E−07 |
| A7 | 2.9410184E−06 |
| A8 | −3.1630394E−07 |
| A9 | −8.4416945E−08 |
| A10 | 1.4271752E−08 |
| A11 | 1.4889388E−09 |
| A12 | −2.5286224E−10 |

### Example 42

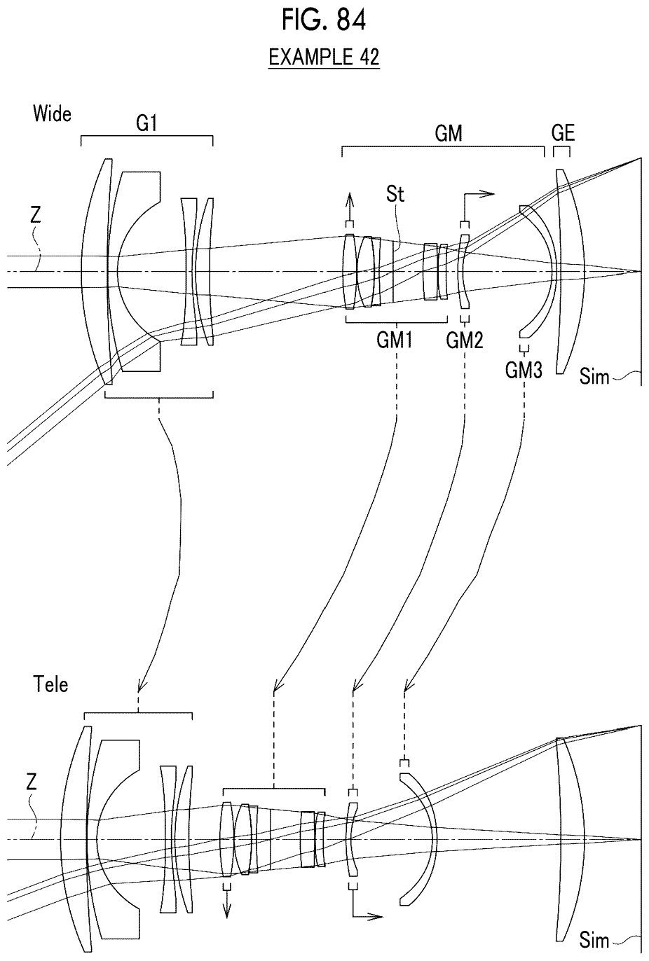

A configuration and a movement locus of a variable magnification optical system according to Example 42 are shown in FIG. 84. The variable magnification optical system according to Example 42 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power, the second intermediate lens group GM2 having negative refractive power, and the third intermediate lens group GM3 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the object side of the first intermediate lens group GM1.

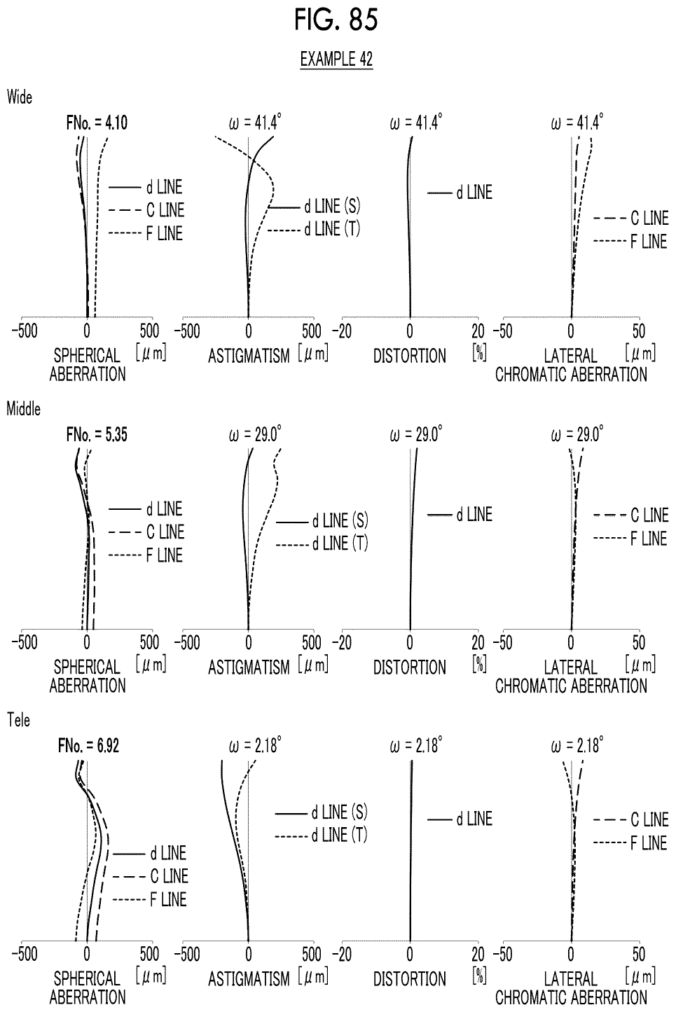

For the variable magnification optical system according to Example 42, basic lens data is shown in Table 124, specifications and variable surface spacings are shown in Table 125, aspherical coefficients are shown in Table 126, and each aberration diagram is shown in FIG. 85.

TABLE 124
Example 42

| | Sn | R | D | Nd | νd | θgF |
|---|---|---|---|---|---|---|
| | 1 | 56.0786 | 4.6510 | 1.54851 | 47.46 | 0.56386 |
| | 2 | 242.7219 | 0.1000 | | | |
| | 3 | 69.0248 | 1.7499 | 1.87291 | 41.60 | 0.56396 |
| | 4 | 15.3482 | 12.3500 | | | |
| | *5 | −181.0624 | 1.0559 | 1.53409 | 55.87 | 0.55858 |
| | *6 | 52.0561 | 0.6568 | | | |
| | 7 | 43.4717 | 2.5000 | 1.95906 | 17.47 | 0.65993 |
| | 8 | 122.2166 | DD[8] | | | |
| Gois | 9 | 42.5924 | 2.5039 | 1.66149 | 47.78 | 0.56040 |
| | 10 | −43.1955 | 0.0500 | | | |
| | 11 | 17.0048 | 3.1386 | 1.43875 | 94.66 | 0.53402 |
| | 12 | −38.7240 | 0.8750 | 1.93700 | 28.90 | 0.60173 |
| | 13 | 79.3358 | 2.4853 | | | |
| | 14(St) | ∞ | 5.4010 | | | |
| | 15 | 54.9887 | 2.5887 | 1.48749 | 70.24 | 0.53007 |
| | 16 | −143.4376 | 0.1000 | | | |
| | *17 | 45.9746 | 1.4749 | 1.51633 | 64.06 | 0.53345 |
| | *18 | 1126.6278 | DD[18] | | | |
| Gfoc | 19 | 38.6495 | 0.8748 | 1.83481 | 42.74 | 0.56490 |
| | 20 | 15.8504 | DD[20] | | | |
| | *21 | −15.2167 | 0.8205 | 1.53409 | 55.87 | 0.55858 |
| | *22 | −24.5771 | DD[22] | | | |
| | 23 | −215.9951 | 4.2502 | 1.80791 | 36.94 | 0.58112 |
| | 24 | −50.9676 | 10.1900 | | | |

TABLE 125
Example 42

| | Wide | Middle | Tele |
|---|---|---|---|
| Zr | 1.0 | 1.6 | 2.2 |
| f | 24.50 | 38.46 | 53.90 |
| Bf | 10.19 | 10.19 | 10.19 |
| FNo. | 4.10 | 5.35 | 6.92 |
| FNo. | 82.8 | 58.0 | 43.6 |
| DD[8] | 23.86 | 10.63 | 5.59 |
| DD[18] | 2.10 | 3.62 | 3.97 |
| DD[20] | 16.07 | 15.62 | 14.66 |
| DD[22] | 0.75 | 9.29 | 22.28 |

TABLE 126
Example 42

| Sn | 5 | 6 |
|---|---|---|
| KA | 1.0000000E+00 | 1.0000000E+00 |
| A4 | −1.6529064E−05 | −2.8595276E−05 |
| A6 | 7.4575576E−08 | 5.7385490E−08 |
| A8 | −3.6205594E−10 | −4.5956043E−10 |
| A10 | 1.2549919E−12 | 1.7116357E−12 |
| A12 | −2.4402738E−15 | −4.9169721E−15 |

| Sn | 17 | 21 | 22 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | 2.1411097E−04 | −7.9274121E−05 | −8.7589624E−05 |
| A5 | −1.7060115E−06 | −2.0582746E−06 | −4.6384509E−07 |
| A6 | 6.6938447E−08 | 8.1922231E−07 | 6.3628051E−07 |
| A7 | 2.4615153E−06 | 3.4046338E−09 | −6.1035651E−09 |
| A8 | −6.5880666E−07 | −5.9264211E−09 | −2.5751003E−09 |
| A9 | 1.3494675E−08 | 2.8419246E−11 | −8.8904149E−11 |
| A10 | 3.0353224E−08 | 3.0361658E−11 | −3.4715601E−12 |
| A11 | 1.3626370E−09 | −3.7196419E−14 | 1.3513861E−12 |
| A12 | −2.4469604E−09 | −1.7403814E−13 | 1.9349485E−14 |
| A13 | 9.8914860E−11 | −5.1763813E−15 | −2.0226313E−16 |
| A14 | 1.2470403E−11 | −3.4259907E−16 | −5.6140907E−16 |
| A15 | 1.7528871E−11 | 1.3790742E−16 | 2.9202625E−17 |
| A16 | −1.0554025E−12 | 8.9835201E−18 | −7.4034795E−19 |
| A17 | −5.7186955E−13 | 2.2280241E−19 | 8.3828095E−20 |
| A18 | 8.2737727E−15 | −6.6651162E−20 | −1.8670881E−20 |
| A19 | 1.3392185E−14 | −5.0800614E−21 | 2.4394489E−21 |
| A20 | −9.1970994E−16 | 1.9768325E−22 | −1.1281105E−22 |

| Sn | 18 |
|---|---|
| KA | 1.0000000E+00 |
| A3 | 0.0000000E+00 |
| A4 | 2.8172067E−04 |
| A5 | −4.2365917E−06 |
| A6 | −7.0179680E−07 |
| A7 | 2.9427471E−06 |
| A8 | −3.1630501E−07 |
| A9 | −8.4480840E−08 |
| A10 | 1.4210099E−08 |
| A11 | 1.4864240E−09 |
| A12 | −2.5317981E−10 |

### Example 43

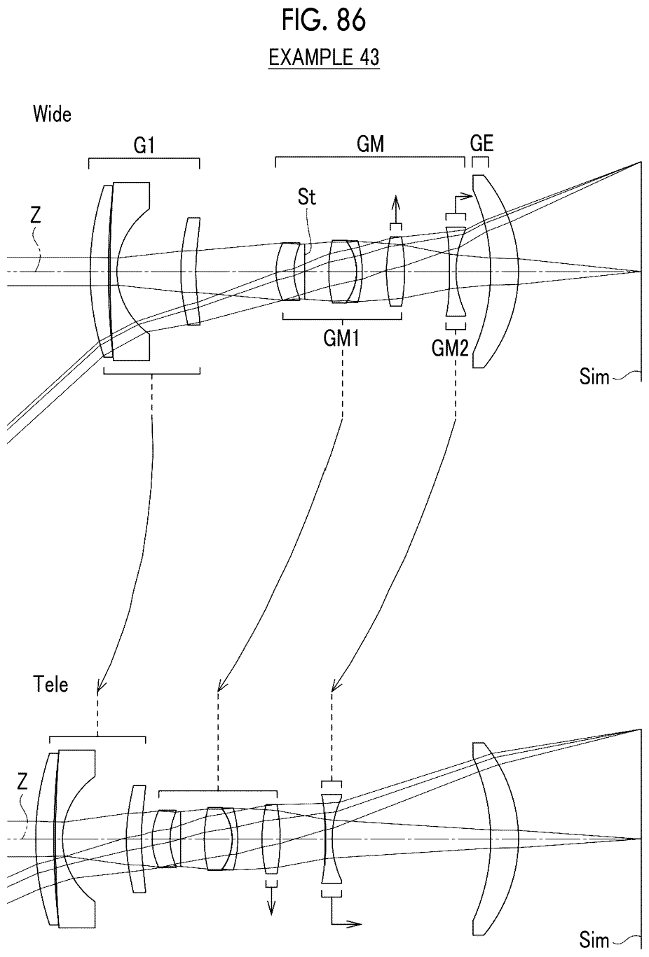

A configuration and a movement locus of a variable magnification optical system according to Example 43 are shown in FIG. 86. The variable magnification optical system according to Example 43 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the image side of the first intermediate lens group GM1.

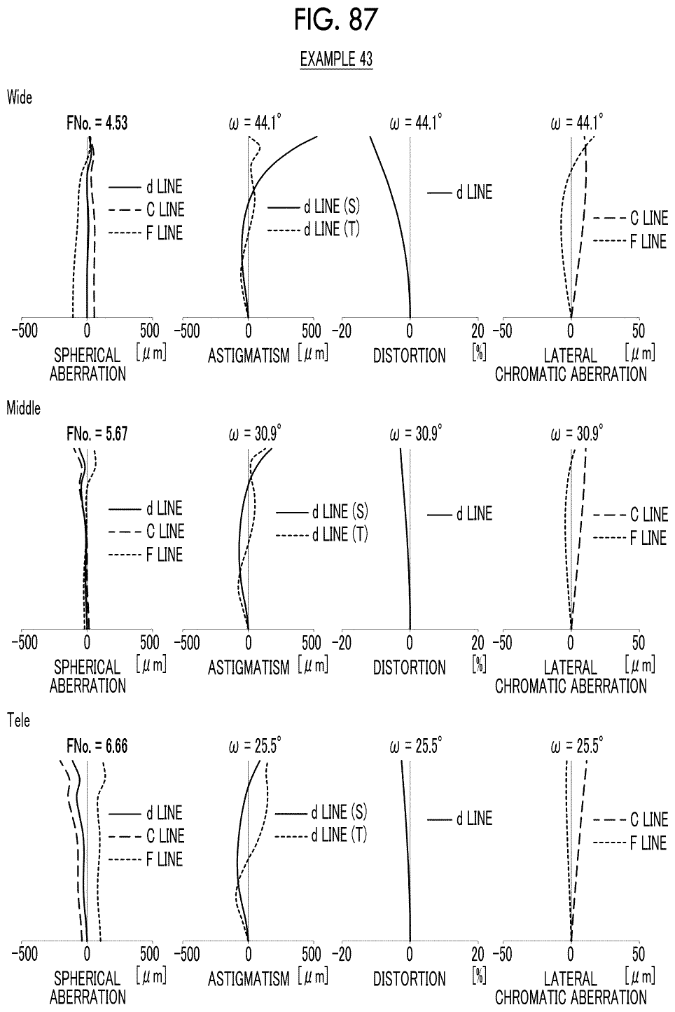

For the variable magnification optical system according to Example 43, basic lens data is shown in Table 127, specifications and variable surface spacings are shown in Table 128, aspherical coefficients are shown in Table 129, and each aberration diagram is shown in FIG. 87.

TABLE 127
Example 43

| | Sn | R | D | Nd | νd | θgF |
|---|---|---|---|---|---|---|
| | 1 | 54.8640 | 3.2699 | 1.95001 | 17.50 | 0.64252 |
| | 2 | 154.4541 | 0.3000 | | | |
| | 3 | 233.3156 | 1.2498 | 1.88724 | 39.84 | 0.56834 |
| | 4 | 15.1944 | 11.4900 | | | |
| | *5 | 34.5330 | 2.7036 | 1.66121 | 20.35 | 0.66162 |
| | *6 | 44.1389 | DD[6] | | | |
| | *7 | 12.5724 | 3.2117 | 1.53409 | 55.87 | 0.55858 |
| | *8 | 12.3443 | 1.9163 | | | |
| | 9(St) | ∞ | 4.2502 | | | |
| | 10 | 27.6702 | 5.0100 | 1.52841 | 76.45 | 0.53954 |
| | 11 | −10.1081 | 1.0002 | 1.80400 | 46.53 | 0.55775 |
| | 12 | −22.0038 | 4.3752 | | | |
| Gois | 13 | 30.8885 | 3.2502 | 1.43875 | 94.66 | 0.53402 |
| | 14 | −39.2558 | DD[14] | | | |
| Gfoc | *15 | −89.2538 | 1.1675 | 1.53409 | 55.87 | 0.55858 |
| | *16 | 19.7211 | DD[16] | | | |
| | 17 | −39.9595 | 5.0002 | 1.80400 | 46.53 | 0.55775 |
| | 18 | −30.2067 | 22.0600 | | | |

TABLE 128
Example 43

| | Wide | Middle | Tele |
|---|---|---|---|
| Zr | 1.0 | 1.5 | 1.8 |
| f | 24.57 | 36.11 | 45.20 |
| Bf | 22.06 | 22.06 | 22.06 |
| FNo. | 4.52 | 5.67 | 6.66 |
| 2ω[°] | 88.2 | 61.8 | 51.0 |
| DD[6] | 14.43 | 5.52 | 1.94 |
| DD[14] | 8.08 | 8.20 | 8.09 |
| DD[16] | 6.24 | 18.37 | 28.52 |

TABLE 129
Example 43

| Sn | 5 | 6 |
|---|---|---|
| KA | 1.0000000E+00 | 1.0000000E+00 |
| A4 | −2.2462641E−05 | −3.9418014E−05 |
| A6 | −2.3833634E−08 | 1.5968558E−09 |
| A8 | −4.7801614E−10 | −9.2839525E−10 |
| A10 | 6.4413426E−12 | 1.1789469E−11 |
| A12 | −1.5148351E−14 | −3.9065583E−14 |
| Sn | 7 | 8 |
| KA | 1.0000000E+00 | 1.0000000E+00 |
| A4 | −6.9251749E−05 | −8.5395364E−05 |
| A6 | −1.2262455E−07 | −5.4908080E−07 |
| A8 | −8.5395043E−09 | −2.2078162E−08 |
| A10 | 6.7618536E−11 | 4.0033373E−10 |
| A12 | −8.7172340E−12 | −1.1774929E−11 |
| A14 | −3.0427155E−14 | 8.2571985E−14 |
| A16 | 1.7728011E−14 | 1.8542151E−14 |
| A18 | −3.1816098E−16 | −4.5125811E−16 |
| Sn | 15 | 16 |
| KA | 1.0000000E+00 | 1.0000000E+00 |
| A3 | 0.0000000E+00 | 0.0000000E+00 |
| A4 | 6.4471086E−05 | 8.9605781E−05 |
| A5 | −2.4000087E−05 | −1.5450652E−05 |
| A6 | 7.2818835E−07 | −6.2174993E−07 |
| A7 | 1.6065173E−07 | 1.3334288E−07 |
| A8 | 8.8686578E−10 | 1.7715579E−08 |
| A9 | −1.5592680E−09 | −6.5145326E−10 |
| A10 | −7.1837829E−11 | 2.2075345E−11 |
| A11 | 4.0869013E−11 | −4.2242049E−11 |
| A12 | 1.8310156E−12 | −2.4877583E−12 |
| A13 | −8.5829065E−13 | 2.1002134E−13 |
| A14 | −1.0170982E−13 | 7.6941155E−14 |
| A15 | −6.6246659E−15 | 4.5971740E−15 |
| A16 | 3.8855236E−15 | −7.6684754E−16 |
| A17 | 2.6718180E−16 | −4.3099781E−17 |
| A18 | −5.2207123E−17 | −4.2442705E−18 |
| A19 | −6.1417058E−19 | 1.0565756E−18 |
| A20 | 1.0773862E−19 | −3.6877286E−20 |

### Example 44

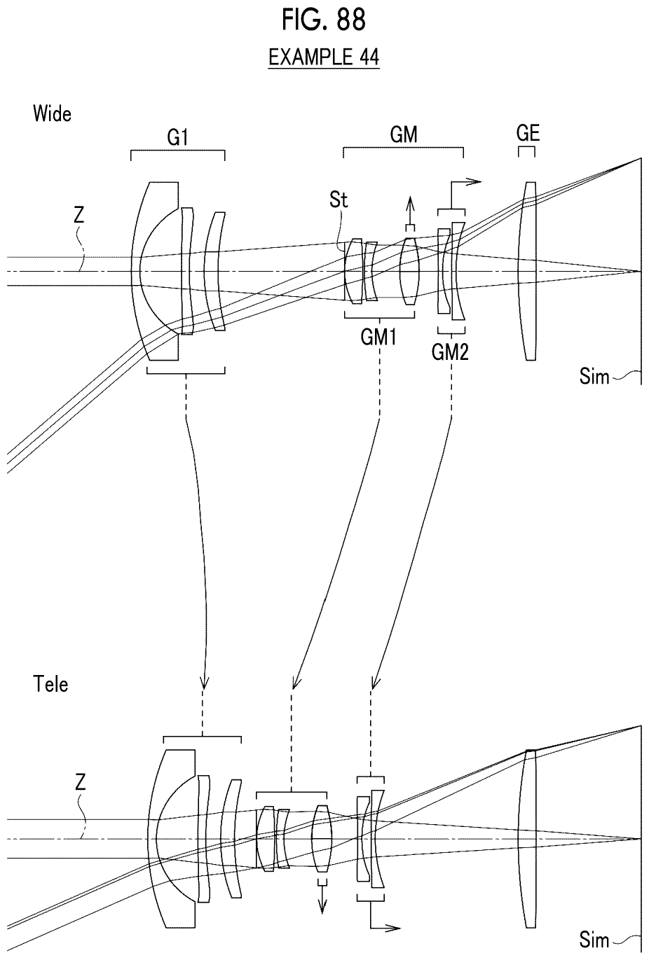

A configuration and a movement locus of a variable magnification optical system according to Example 44 are shown in FIG. 88. The variable magnification optical system according to Example 44 consists of, in order from the object side to the image side, the first lens group G1 having negative refractive power, the intermediate group GM, and the final lens group GE having positive refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, the final lens group GE remains stationary with respect to the image plane Sim, and other lens groups move along the optical axis Z while changing the spacings relative to the adjacent lens groups. The focusing group consists of the second intermediate lens group GM2. The anti-vibration group consists of one lens closest to the image side of the first intermediate lens group GM1.

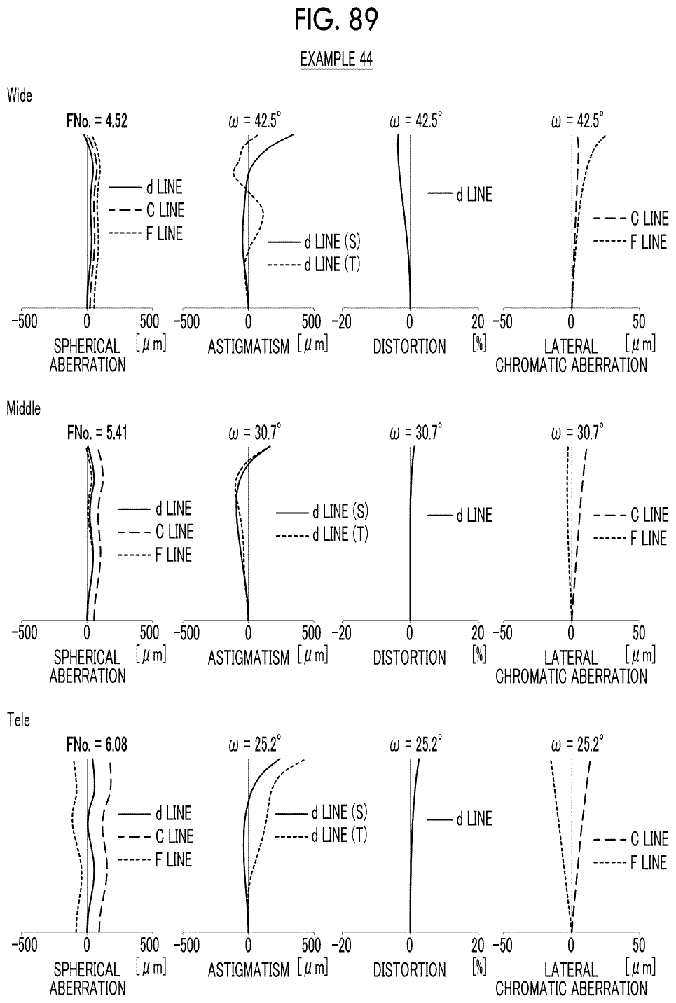

For the variable magnification optical system according to Example 44, basic lens data is shown in Table 130, specifications and variable surface spacings are shown in Table 131, aspherical coefficients are shown in Table 132, and each aberration diagram is shown in FIG. 89.

TABLE 130
Example 44

| | Sn | R | D | Nd | νd | θgF |
|---|---|---|---|---|---|---|
| | 1 | 45.2581 | 1.5500 | 1.64000 | 60.08 | 0.53704 |
| | 2 | 13.8502 | 7.4999 | | | |
| | *3 | 359.2874 | 1.4000 | 1.53409 | 55.87 | 0.55858 |
| | *4 | 55.6802 | 2.6646 | | | |
| | 5 | 32.6948 | 2.4999 | 1.95906 | 17.47 | 0.65993 |
| | 6 | 48.1667 | DD[6] | | | |
| | 7(St) | ∞ | 0.0200 | | | |
| | *8 | 12.8801 | 3.2499 | 1.51633 | 64.06 | 0.53345 |
| | *9 | −84.3654 | 0.3000 | | | |
| | 10 | 38.1859 | 1.3680 | 2.00330 | 28.27 | 0.59802 |
| | 11 | 16.2629 | 4.9999 | | | |
| Gois | *12 | 18.1781 | 3.4995 | 1.49700 | 81.54 | 0.53748 |
| | *13 | −21.2743 | DD[13] | | | |
| Gfoc | *14 | −114.2372 | 0.7501 | 1.51633 | 64.06 | 0.53345 |
| | *15 | 21.7891 | 1.6591 | | | |
| | 16 | 249.4925 | 0.7502 | 1.48749 | 70.32 | 0.52917 |
| | 17 | 27.6430 | DD[17] | | | |
| | 18 | 97.9262 | 3.2500 | 1.77535 | 50.30 | 0.55004 |
| | 19 | −1255.0172 | 18.8600 | | | |

TABLE 131
Example 44

| | Wide | Middle | Tele |
|---|---|---|---|
| Zr | 1.0 | 1.5 | 1.8 |
| f | 24.64 | 36.21 | 45.08 |
| Bf | 18.86 | 18.86 | 18.86 |
| FNo. | 4.52 | 5.43 | 6.07 |
| 2ω[°] | 84.6 | 61.2 | 50.2 |
| DD[6] | 22.64 | 9.77 | 3.95 |
| DD[13] | 3.46 | 4.10 | 4.66 |
| DD[17] | 11.19 | 19.87 | 25.71 |

TABLE 132
Example 44

| Sn | 3 | 4 | 8 | 9 |
|---|---|---|---|---|
| KA | 1.0000000E+00 | 1.0000000E+00 | 1.0000000E+00 | 1.0000000E+00 |
| A4 | 1.1783395E−05 | −6.8328990E−06 | −4.1725393E−05 | 2.0965171E−05 |
| A6 | −1.1020317E−07 | −5.8755887E−08 | −3.8365634E−07 | −8.4496187E−07 |
| A8 | 9.8638708E−10 | −4.6829979E−10 | −1.6055991E−08 | 1.1087743E−08 |
| A10 | −6.4870665E−12 | −3.4972279E−12 | 1.9767989E−10 | −2.1778586E−10 |
| A12 | −4.9060964E−14 | −1.8301722E−14 | −7.1278750E−12 | −1.6785882E−11 |
| A14 | 1.8858957E−16 | 1.8969695E−16 | 2.7990428E−13 | 1.7431097E−13 |
| A16 | 2.4201699E−18 | −3.6344646E−19 | −1.2800217E−14 | 2.5703722E−15 |
| A18 | −1.4103023E−20 | −1.8068518E−21 | 1.4430869E−16 | −3.9414886E−17 |

| Sn | 12 | 13 |
|---|---|---|
| KA | 1.0000000E+00 | 1.0000000E+00 |
| A4 | −2.4243606E−05 | 3.5004400E−05 |
| A6 | −8.7308860E−09 | −5.5610003E−07 |
| A8 | 2.1890620E−09 | 4.2234785E−08 |
| A10 | 5.0753495E−10 | −6.4410071E−10 |
| A12 | −2.5524644E−11 | 2.3008330E−12 |
| A14 | 5.5771444E−13 | 7.8368567E−14 |
| A16 | −2.4459330E−15 | 1.5096213E−15 |
| Sn | 14 | 15 |
| KA | 1.0000000E+00 | 1.0000000E+00 |
| A3 | 0.0000000E+00 | 0.0000000E+00 |
| A4 | 1.6034113E−04 | 2.0935058E−04 |
| A5 | −2.2598713E−05 | −1.9920044E−05 |
| A6 | −8.8766699E−07 | −7.7591965E−07 |
| A7 | 2.5381229E−07 | 1.2071327E−07 |
| A8 | 2.1036159E−08 | 1.9539455E−08 |
| A9 | −1.7230790E−09 | −3.1895538E−10 |
| A10 | −4.4756307E−10 | 3.5110881E−11 |
| A11 | 2.0788517E−11 | −3.9272734E−11 |
| A12 | 5.6812716E−12 | −2.4074711E−12 |
| A13 | −7.4344535E−14 | 1.5989261E−13 |
| A14 | −1.2561812E−14 | 6.0272298E−14 |
| A15 | −6.9646474E−15 | 5.6224995E−15 |
| A16 | −6.8242155E−16 | −6.4756590E−16 |
| A17 | 5.9199533E−18 | −6.5900234E−17 |
| A18 | 5.8796075E−17 | −1.6472299E−18 |
| A19 | −5.8355410E−18 | 9.5374312E−19 |
| A20 | 9.1127821E−20 | −3.0712043E−20 |

### Example 45

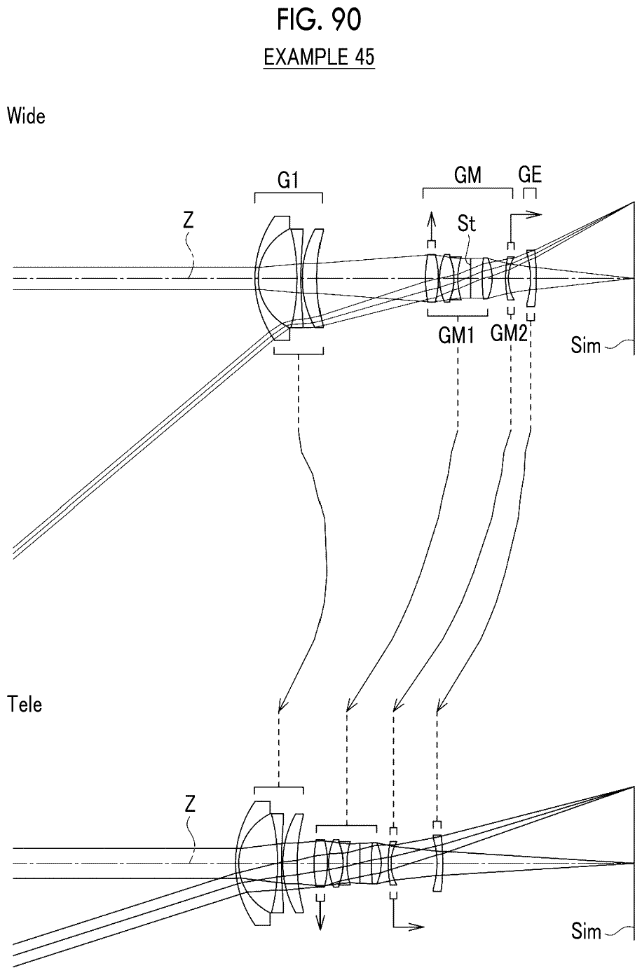

A configuration and a movement locus of a variable magnification optical system according to Example 45 are shown in FIG. 90. The variable magnification optical system according to Example 45 consists of, in order from the object side to the image side, the first lens group G1 having negative refractive power, the intermediate group GM, and the final lens group GE having negative refractive power. The intermediate group GM consists of, in order from the object side to the image side, the first intermediate lens group GM1 having positive refractive power and the second intermediate lens group GM2 having negative refractive power.

During magnification change from the wide angle end to the telephoto end, all the lens groups move along the optical axis Z while changing the spacings between the adjacent lens groups. The focusing group consists of the second intermediate lens group GM2. The anti-vibration group consists of one lens closest to the object side of the first intermediate lens group GM1.

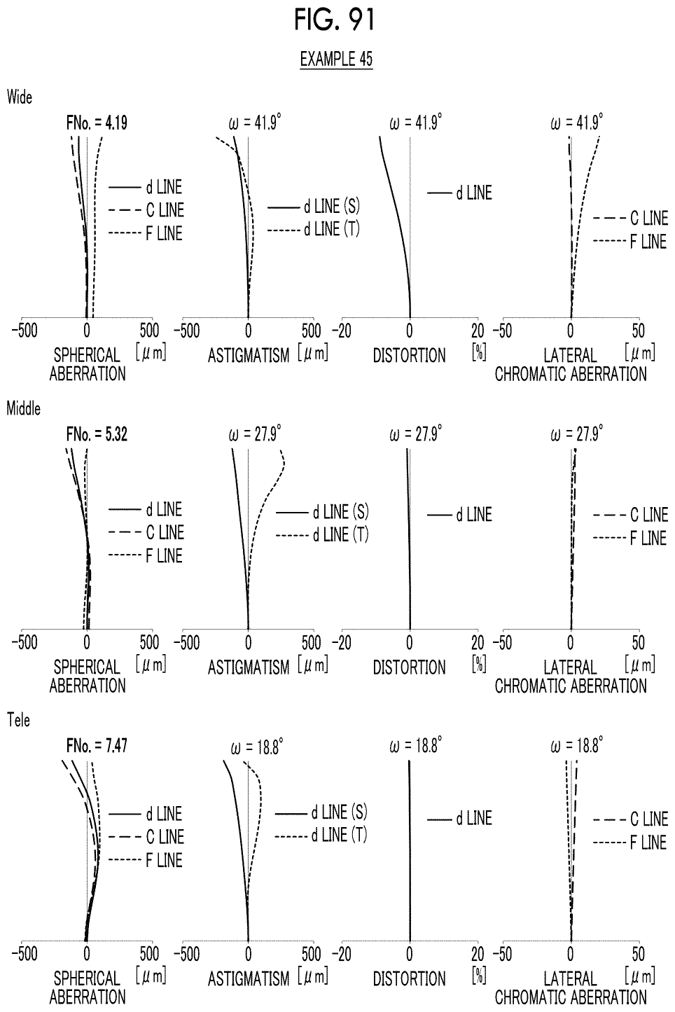

For the variable magnification optical system according to Example 45, basic lens data is shown in Table 133, specifications and variable surface spacings are shown in Table 134, aspherical coefficients are shown in Table 135, and each aberration diagram is shown in FIG. 91.

TABLE 133
Example 45

| | Sn | R | D | Nd | νd | θgF |
|---|---|---|---|---|---|---|
| | 1 | 21.0021 | 0.5628 | 1.92559 | 36.21 | 0.57772 |
| | 2 | 10.4671 | 6.7502 | | | |
| | *3 | −44.7246 | 0.6748 | 1.53409 | 55.87 | 0.55858 |
| | *4 | 71.3622 | 0.2409 | | | |
| | 5 | 19.8722 | 2.5000 | 1.95906 | 17.47 | 0.65993 |
| | 6 | 36.7516 | DD[6] | | | |
| Gois | *7 | 24.0655 | 2.2502 | 1.53409 | 55.87 | 0.55858 |
| | *8 | −17.4047 | 0.2000 | | | |
| | 9 | 11.6802 | 2.5100 | 1.48749 | 70.24 | 0.53007 |
| | 10 | −10.9543 | 0.6750 | 1.78711 | 35.66 | 0.58511 |
| | 11 | 14.0635 | 2.2490 | | | |
| | 12(St) | ∞ | 2.0000 | | | |
| | *13 | 37.4215 | 1.7041 | 1.53409 | 55.87 | 0.55858 |
| | *14 | −9.5776 | DD[14] | | | |
| Gfoc | 15 | 23.0871 | 0.4937 | 1.48749 | 70.24 | 0.53007 |
| | 16 | 8.5144 | DD[16] | | | |
| | *17 | −18.4813 | 1.0000 | 1.51633 | 64.06 | 0.53345 |
| | *18 | −80.5285 | DD[18] | | | |

TABLE 134
Example 45

| | Wide | Middle | Tele |
|---|---|---|---|
| Zr | 1.0 | 1.6 | 2.4 |
| f | 17.39 | 27.09 | 41.74 |
| Bf | 17.01 | 21.44 | 33.27 |
| FNo. | 4.19 | 5.32 | 7.47 |
| 2ω[°] | 83.8 | 55.8 | 37.6 |
| DD[6] | 18.84 | 7.54 | 2.92 |
| DD[14] | 2.36 | 2.26 | 1.22 |
| DD[16] | 3.82 | 5.90 | 7.99 |
| DD[18] | 17.01 | 21.44 | 33.27 |

TABLE 135
Example 45

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −2.7854334E−05 | −3.1445813E−05 | −2.2510559E−05 | 4.6737064E−05 |
| A6 | 1.7285999E−07 | 1.1680925E−07 | −3.0485708E−08 | −1.0585169E−07 |
| A8 | 5.9382194E−10 | 1.1721278E−10 | −1.3465556E−09 | −2.8990715E−09 |
| A10 | −1.0506073E−11 | −1.0755432E−11 | −2.1941063E−10 | −9.5598880E−12 |
| A12 | −3.9424367E−14 | −1.0283276E−13 | 3.7162294E−12 | −2.5291898E−13 |
| Sn | 13 | 14 | 17 | 18 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −4.5403149E−05 | 1.4039733E−04 | −7.3454010E−05 | −1.6326188E−04 |
| A5 | 1.7266292E−06 | −5.3619774E−06 | −3.5787777E−06 | 1.8537563E−06 |
| A6 | −1.7535976E−07 | 1.6546816E−07 | 1.9240651E−06 | 6.8016890E−07 |
| A7 | −5.0161791E−08 | −1.7816736E−08 | −3.0574039E−08 | −2.8641082E−08 |
| A8 | −1.1267858E−08 | 5.9659840E−09 | −1.0894982E−08 | −9.3942532E−09 |
| A9 | −4.2315374E−09 | −6.1689674E−09 | −2.5749502E−09 | 7.4756305E−10 |
| A10 | 6.3086846E−10 | 3.3716859E−09 | −9.8841149E−11 | −1.2789634E−10 |
| A11 | 1.1991068E−10 | 2.2454336E−10 | −2.8899223E−12 | −5.6555456E−11 |
| A12 | 1.5235176E−10 | 8.2730144E−11 | 7.8800322E−12 | −3.3001099E−12 |
| A13 | 5.6773801E−11 | −7.1680827E−12 | −9.2475786E−13 | 7.0545236E−14 |
| A14 | −2.8547344E−11 | −3.2276596E−11 | −3.7426857E−13 | 1.6471374E−13 |
| A15 | 3.1631921E−13 | −2.6291334E−13 | 9.8093844E−15 | 6.1000365E−15 |
| A16 | 2.2779911E−12 | 2.6201137E−12 | 2.4510732E−15 | −1.0255370E−15 |
| A17 | −4.1338127E−13 | −4.5414701E−14 | −2.2295509E−15 | −5.0061520E−17 |
| A18 | −8.6880728E−15 | −5.3741013E−14 | 4.2215624E−17 | 5.1480836E−18 |
| A19 | 1.2571491E−14 | 1.3052087E−14 | 2.9094183E−16 | −2.9477849E−18 |
| A20 | −1.7903572E−15 | −2.6965922E−15 | −4.1415326E−17 | −1.4081252E−18 |

### Example 46

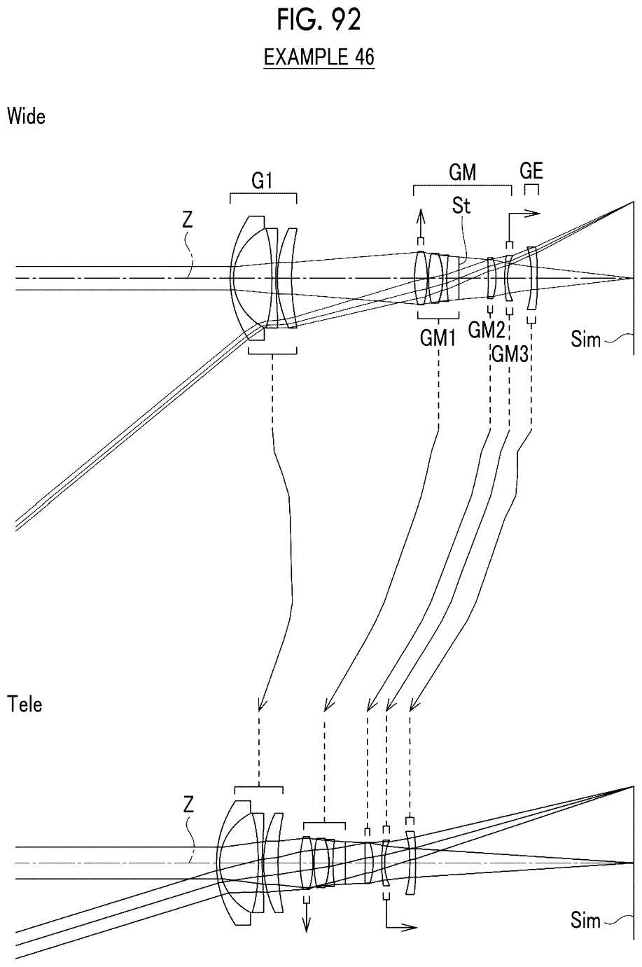

A configuration and a movement locus of a variable magnification optical system according to Example 46 are shown in FIG. 92. The variable magnification optical system according to Example 46 consists of, in order from the object side to the image side, the first lens group G1 having negative refractive power, the intermediate group GM, and the final lens group GE having negative refractive power. The intermediate group GM consists of, in order from the object side to the image side, the first intermediate lens group GM1 having positive refractive power, the second intermediate lens group GM2 having positive refractive power, and the third intermediate lens group GM3 having negative refractive power.

During magnification change from the wide angle end to the telephoto end, all the lens groups move along the optical axis Z while changing the spacings between the adjacent lens groups. The focusing group consists of the third intermediate lens group GM3. The anti-vibration group consists of one lens closest to the object side of the first intermediate lens group GM1.

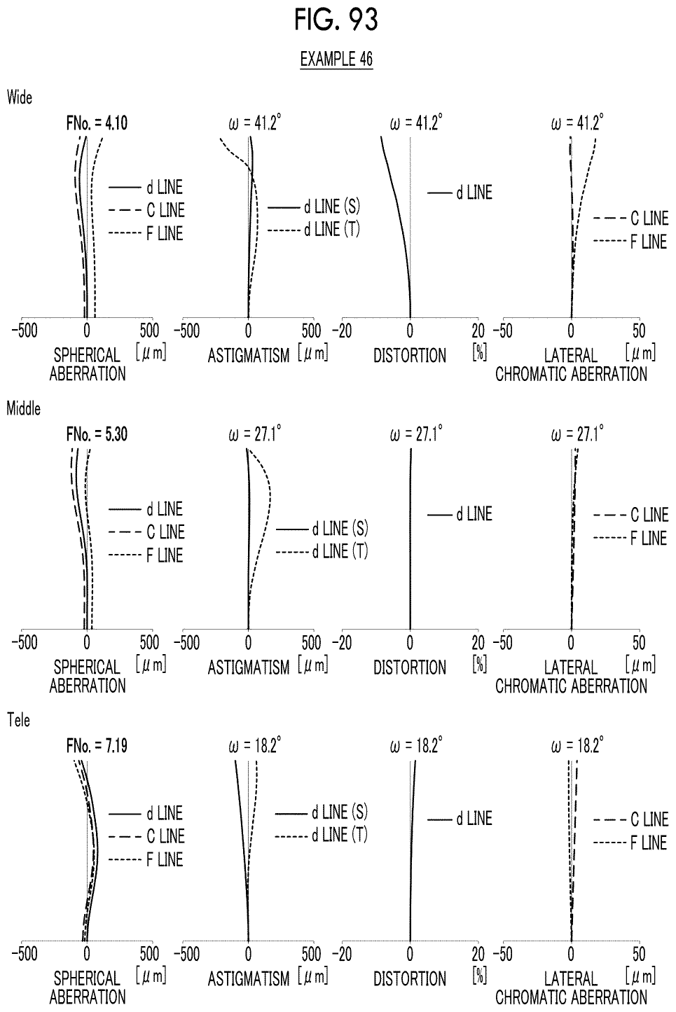

For the variable magnification optical system according to Example 46, basic lens data is shown in Table 136, specifications and variable surface spacings are shown in Table 137, aspherical coefficients are shown in Table 138, and each aberration diagram is shown in FIG. 93.

TABLE 136
Example 46

| | Sn | R | D | Nd | νd | θgF |
|---|---|---|---|---|---|---|
| | 1 | 21.5761 | 0.5586 | 1.93417 | 35.33 | 0.58026 |
| | 2 | 10.5320 | 6.7502 | | | |
| | *3 | −58.2049 | 0.6748 | 1.53409 | 55.87 | 0.55858 |
| | *4 | 59.3700 | 0.2457 | | | |
| | 5 | 22.2118 | 2.5000 | 1.95906 | 17.47 | 0.65993 |
| | 6 | 44.7378 | DD[6] | | | |
| Gois | *7 | 19.7242 | 2.2502 | 1.53409 | 55.87 | 0.55858 |
| | *8 | −19.0081 | 0.2000 | | | |
| | 9 | 22.6011 | 2.5100 | 1.49700 | 81.54 | 0.53748 |
| | 10 | −13.5838 | 0.6750 | 1.73913 | 32.88 | 0.59465 |
| | 11 | 31.6094 | 2.1582 | | | |
| | 12(St) | ∞ | DD[12] | | | |
| | *13 | −302.3421 | 1.3748 | 1.53409 | 55.87 | 0.55858 |
| | *14 | −12.3613 | DD[14] | | | |
| Gfoc | 15 | 32.6048 | 0.4923 | 1.48749 | 70.24 | 0.53007 |
| | 16 | 10.5497 | DD[16] | | | |
| | *17 | −28.1878 | 1.0000 | 1.51633 | 64.06 | 0.53345 |
| | *18 | −156.5858 | DD[18] | | | |

TABLE 137
Example 46

| | Wide | Middle | Tele |
|---|---|---|---|
| Zr | 1.0 | 1.6 | 2.4 |
| f | 17.77 | 27.67 | 42.64 |
| Bf | 16.84 | 24.74 | 38.08 |
| FNo. | 4.10 | 5.30 | 7.19 |
| 2ω[°] | 82.4 | 54.2 | 36.4 |
| DD[6] | 21.37 | 10.41 | 3.87 |
| DD[12] | 5.09 | 4.36 | 3.50 |
| DD[14] | 1.52 | 1.55 | 1.51 |
| DD[16] | 4.18 | 4.64 | 4.44 |
| DD[18] | 16.84 | 24.74 | 38.08 |

TABLE 138
Example 46

| Sn | 3 | 4 | 7 | 8 |
|---|---|---|---|---|
| KA | 1.0000000E+00 | 1.0000000E+00 | 1.0000000E+00 | 1.0000000E+00 |
| A4 | −6.1590185E−05 | −7.1550335E−05 | −2.8679218E−05 | 2.6706684E−05 |
| A6 | 2.4431023E−07 | 1.7422332E−07 | −1.9241366E−07 | −1.3144555E−07 |
| A8 | 2.1251700E−10 | 2.9194729E−10 | −1.1235235E−09 | −3.4028857E−09 |
| A10 | −1.1222958E−11 | −1.2966280E−11 | −2.3642106E−10 | −2.9151235E−11 |
| A12 | −4.4291924E−14 | −9.3502609E−14 | 3.7129017E−12 | 1.2583479E−13 |
| Sn | 13 | 14 | 17 | 18 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.1636109E−04 | 3.2856134E−05 | −1.5630519E−04 | −1.9059859E−04 |
| A5 | 1.4085856E−06 | −3.9886331E−06 | −2.4156816E−06 | 3.1777154E−06 |
| A6 | −1.9868420E−07 | 7.8084159E−08 | 1.9981544E−06 | 7.3326584E−07 |
| A7 | −4.4758403E−08 | −2.1900678E−08 | −3.7507879E−08 | −2.8082075E−08 |
| A8 | −9.4720567E−09 | 5.2819384E−09 | −9.5093327E−09 | −7.9710385E−09 |
| A9 | −4.1190040E−09 | −7.0730487E−09 | −2.6201752E−09 | 6.1282491E−10 |
| A10 | 1.0954530E−09 | 3.6311238E−09 | −1.1838674E−10 | −2.0264331E−10 |
| A11 | 5.9981504E−11 | 2.2912656E−10 | −1.2938350E−11 | −4.7445189E−11 |
| A12 | 1.0956158E−10 | 8.8367117E−11 | 1.3382798E−11 | 2.5627074E−13 |
| A13 | 4.7078072E−11 | −6.4335889E−12 | −6.7171094E−13 | −1.6609103E−13 |
| A14 | −2.8493541E−11 | −3.1950345E−11 | −2.9247402E−13 | 1.6775969E−13 |
| A15 | 5.9301554E−13 | −1.4209544E−13 | 2.4989441E−15 | 1.5892735E−15 |
| A16 | 2.3560350E−12 | 2.2319644E−12 | −2.3094128E−15 | 1.8524723E−15 |
| A17 | −3.7900399E−13 | −3.4129170E−14 | −2.2234775E−15 | −3.3277139E−17 |
| A18 | −1.6806830E−14 | −4.3283409E−14 | 3.0715686E−17 | 3.6593836E−17 |
| A19 | 1.2593830E−14 | 1.3040424E−14 | 3.5030938E−16 | −4.7955856E−18 |
| A20 | −1.8257248E−15 | −2.6192220E−15 | −3.1913430E−17 | 1.1500719E−18 |

Tables 139 to 148 show the corresponding values of Conditional Expressions (1) to (34) of the variable magnification optical systems according to Examples 1 to 46. Preferable ranges of the conditional expressions may be set using the corresponding values of the examples shown in Tables 139 to 148 as the upper limits and the lower limits of the conditional expressions.

TABLE 139

| Expression | | | | | | |
|---|---|---|---|---|---|---|
| number | | Example 1 | Example 2 | Example 3 | Example 4 | Example 5 |
| (1) | TLw/(fw × tanωw) | 3.915 | 4.234 | 3.826 | 4.026 | 4.346 |
| (2) | Bfw/(fw × tanωw) | 0.764 | 0.850 | 0.754 | 0.800 | 0.594 |
| (3) | Dsum/(TLw − Bfw) | 0.449 | 0.500 | 0.381 | 0.472 | 0.412 |
| (4) | FNow/tanωw | 4.340 | 4.616 | 4.504 | 4.188 | 4.396 |
| (5) | (fw × TLw)/ft² | 1.215 | 1.238 | 1.185 | 1.044 | 1.320 |
| (6) | ft/f1 | −1.513 | −1.414 | −1.589 | −1.559 | −1.223 |
| (7) | ft/\|fois\| | 1.597 | 1.960 | 1.519 | 1.218 | 0.723 |
| (8) | fw/f1 | −0.827 | −0.773 | −0.883 | −0.799 | −0.665 |
| (9) | ft/fMw | 1.981 | 1.649 | 1.893 | 1.976 | 1.928 |
| (10) | ft/fme | −1.432 | −1.092 | −1.180 | −1.664 | −1.843 |
| (11) | ft/fE | 0.264 | 0.234 | 0.149 | 0.618 | 0.501 |
| (12) | f1/fm1 | −1.309 | −1.167 | −1.192 | −1.268 | −1.576 |
| (13) | fm1/fme | −0.723 | −0.662 | −0.623 | −0.842 | −0.956 |
| (14) | FNot/(ft/fw) | 3.279 | 3.427 | 3.066 | 3.123 | 3.549 |
| (15) | fw/(ft × tanωt) | 1.091 | 1.111 | 1.154 | 1.125 | 1.067 |
| (16) | fme/fE | −0.184 | −0.215 | −0.126 | −0.371 | −0.272 |
| (17) | (−f1)/fMw | 1.309 | 1.167 | 1.192 | 1.268 | 1.576 |
| (18) | (−f1)/(fw × ft)^{1/2} | 0.894 | 0.957 | 0.844 | 0.896 | 1.109 |
| (19) | fMw/(fw × ft)^{1/2} | 0.683 | 0.820 | 0.709 | 0.707 | 0.704 |
| (20) | (−f1)/(ft/FNot) | 3.966 | 4.435 | 3.474 | 3.907 | 5.339 |
| (21) | TLw/fw | 4.069 | 4.146 | 3.840 | 3.970 | 4.469 |
| (22) | ft/\|ffoc\| | 1.432 | 1.092 | 1.180 | 1.664 | 1.843 |
| (23) | fw/\|ffoc\| | 0.783 | 0.597 | 0.655 | 0.854 | 1.002 |
| (24) | νdfoc | 55.87 | 55.87 | 55.87 | 55.87 | 55.87 |
| (25) | DDL1STw/TLw | 0.424 | 0.481 | 0.409 | 0.423 | 0.378 |
| (26) | \|DDG1Mw − DDG1Mt\|/TLw | 0.187 | 0.196 | 0.211 | 0.178 | 0.150 |
| (27) | (R1nf + R1nr)/(R1nf − R1nr) | 1.582 | 1.990 | 1.229 | 1.089 | 1.403 |
| (28) | d1sum/(ft/FNot) | 0.553 | 0.873 | 0.444 | 0.830 | 0.856 |
| (29) | f1/fL1STw | −1.284 | −2.262 | −0.917 | −0.619 | −0.148 |
| (30) | fw/fL1STw | 1.062 | 1.748 | 0.810 | 0.495 | 0.098 |
| (31) | N1n | 1.64000 | 1.89190 | 1.64000 | 1.64000 | 1.64000 |
| (32) | (Dsum/TLw) × FNow | 1.632 | 1.805 | 1.383 | 1.561 | 1.606 |
| (33) | Dfoc/(fw × tanωw) | 0.026 | 0.028 | 0.030 | 0.026 | 0.027 |
| (34) | d1sum/\|f1\| | 0.140 | 0.197 | 0.128 | 0.212 | 0.160 |

TABLE 140

| Expression | | | | | | Example |
|---|---|---|---|---|---|---|
| number | | Example 6 | Example 7 | Example 8 | Example 9 | 10 |
| (1) | TLw/(fw × tanωw) | 3.559 | 3.751 | 3.865 | 3.958 | 4.064 |
| (2) | Bfw/(fw × tanωw) | 0.771 | 0.632 | 0.538 | 0.781 | 0.763 |
| (3) | Dsum/(TLw − Bfw) | 0.480 | 0.563 | 0.427 | 0.505 | 0.521 |
| (4) | FNow/tanωw | 4.021 | 4.396 | 4.452 | 4.562 | 4.398 |
| (5) | (fw × TLw)/ft² | 0.959 | 1.139 | 1.056 | 1.173 | 0.954 |
| (6) | ft/f1 | −1.759 | −1.309 | −1.652 | −1.568 | −1.752 |
| (7) | ft/\|fois\| | 1.282 | 1.463 | 2.076 | 2.184 | 2.350 |
| (8) | fw/f1 | −0.902 | −0.711 | −0.856 | −0.857 | −0.876 |
| (9) | ft/fMw | 2.177 | 1.883 | 2.292 | 2.008 | 1.903 |
| (10) | ft/fme | −1.843 | −1.960 | −1.695 | −1.640 | −1.338 |
| (11) | ft/fE | 0.717 | 0.559 | 0.243 | 0.443 | 0.538 |
| (12) | f1/fm1 | −1.237 | −1.439 | −1.388 | −1.280 | −1.086 |
| (13) | fm1/fme | −0.847 | −1.041 | −0.740 | −0.817 | −0.703 |
| (14) | FNot/(ft/fw) | 3.072 | 3.647 | 2.959 | 3.327 | 3.140 |
| (15) | fw/(ft × tanωt) | 1.075 | 1.058 | 1.180 | 1.110 | 1.102 |
| (16) | fme/fE | −0.389 | −0.285 | 0.144 | −0.270 | −0.402 |
| (17) | (−f1)/fMw | 1.237 | 1.439 | 1.388 | 1.280 | 1.086 |
| (18) | (−f1)/(fw × ft)^{1/2} | 0.794 | 1.036 | 0.841 | 0.863 | 0.807 |
| (19) | fMw/(fw × ft)^{1/2} | 0.642 | 0.720 | 0.606 | 0.674 | 0.743 |
| (20) | (−f1)/(ft/FNot) | 3.405 | 5.126 | 3.457 | 3.884 | 3.584 |
| (21) | TLw/fw | 3.647 | 3.857 | 3.933 | 3.930 | 3.816 |
| (22) | ft/\|ffoc\| | 1.843 | 1.960 | 1.695 | 1.640 | 1.338 |
| (23) | fw/\|ffoc\| | 0.945 | 1.066 | 0.879 | 0.896 | 0.669 |
| (24) | νdfoc | 55.87 | 55.87 | — | — | 55.87 |
| (25) | DDL1STw/TLw | 0.354 | 0.471 | 0.445 | 0.452 | 0.407 |
| (26) | \|DDG1Mw − DDG1Mt\|/TLw | 0.162 | 0.158 | 0.234 | 0.188 | 0.165 |
| (27) | (R1nf + R1nr)/(R1nf − R1nr) | 1.039 | 1.392 | 1.942 | 2.056 | 1.662 |
| (28) | d1sum/(ft/FNot) | 0.396 | 0.917 | 0.566 | 0.830 | 0.647 |
| (29) | f1/fL1STw | −0.438 | −0.242 | −1.733 | −2.176 | −1.837 |
| (30) | fw/fL1STw | 0.395 | 0.172 | 1.483 | 1.864 | 1.610 |
| (31) | N1n | 1.64000 | 1.64000 | 1.64000 | 1.77535 | 2.77535 |
| (32) | (Dsum/TLw) × FNow | 1.549 | 2.117 | 1.663 | 1.838 | 1.749 |
| (33) | Dfoc/(fw × tanωw) | 0.026 | 0.027 | 0.120 | 0.150 | 0.028 |
| (34) | d1sum/\|f1\| | 0.116 | 0.179 | 0.164 | 0.214 | 0.181 |

TABLE 141

| Expression | | Example | Example | Example | Example | Example |
|---|---|---|---|---|---|---|
| number | | 11 | 12 | 13 | 14 | 15 |
| (1) | TLw/(fw × tanωw) | 3.945 | 3.762 | 3.878 | 3.890 | 3.952 |
| (2) | Bfw/(fw × tanωw) | 0.762 | 0.802 | 0.756 | 0.758 | 0.861 |
| (3) | Dsum/(TLw − Bfw) | 0.519 | 0.485 | 0.514 | 0.521 | 0.508 |
| (4) | FNow/tanωw | 4.413 | 4.510 | 4.301 | 4.346 | 3.981 |
| (5) | (fw × TLw)/ft² | 0.837 | 0.927 | 0.926 | 0.834 | 1.045 |
| (6) | ft/f1 | −2.006 | −1.695 | −1.938 | −1.537 | −1.578 |
| (7) | ft/\|fois\| | 1.810 | 1.688 | 1.627 | 1.803 | 1.018 |
| (8) | fw/f1 | −0.955 | −0.860 | −0.969 | −0.732 | −0.789 |
| (9) | ft/fMw | 2.094 | 2.404 | 2.282 | 1.947 | 1.817 |
| (10) | ft/fme | −0.965 | −1.597 | −2.060 | −0.785 | −0.869 |
| (11) | ft/fE | 0.503 | 0.604 | 0.699 | 0.607 | 0.561 |
| (12) | f1/fm1 | −1.044 | −1.418 | −1.178 | −1.267 | −0.645 |
| (13) | fm1/fme | −0.461 | −0.664 | −0.903 | −0.403 | −0.854 |
| (14) | FNot/(ft/fw) | 3.048 | 3.198 | 3.074 | 3.019 | 3.286 |
| (15) | fw/(ft × tanωt) | 1.127 | 1.157 | 1.102 | 1.111 | 1.053 |
| (16) | fme/fE | −0.522 | −0.379 | −0.339 | −0.774 | −0.645 |
| (17) | (−f1)/fMw | 1.044 | 1.418 | 1.178 | 1.267 | 1.151 |
| (18) | (−f1)/(fw × ft)^{1/2} | 0.722 | 0.828 | 0.730 | 0.943 | 0.896 |
| (19) | fMw/(fw × ft)^{1/2} | 0.692 | 0.584 | 0.620 | 0.744 | 0.778 |
| (20) | (−f1)/(ft/FNot) | 3.190 | 3.717 | 3.174 | 4.126 | 4.164 |
| (21) | TLw/fw | 3.692 | 3.595 | 3.706 | 3.678 | 4.179 |
| (22) | ft/\|ffoc\| | 0.965 | 1.597 | 2.060 | 0.785 | 0.869 |
| (23) | fw/\|ffoc\| | 0.459 | 0.811 | 1.030 | 0.374 | 0.435 |
| (24) | νdfoc | 55.87 | — | — | — | — |
| (25) | DDL1STw/TLw | 0.401 | 0.406 | 0.371 | 0.431 | 0.527 |
| (26) | \|DDG1Mw − DDG1Mt\|/TLw | 0.172 | 0.174 | 0.156 | 0.214 | 0.184 |
| (27) | (R1nf + R1nr)/(R1nf − R1nr) | 2.462 | 2.127 | 1.733 | 1.759 | 1.657 |
| (28) | d1sum/(ft/FNot) | 0.685 | 0.868 | 0.752 | 0.639 | 0.831 |
| (29) | f1/fL1STw | −0.835 | −0.501 | −0.710 | −1.383 | −0.947 |
| (30) | fw/fL1STw | 0.798 | 0.431 | 0.687 | 1.012 | 0.747 |
| (31) | N1n | 1.89190 | 1.90525 | 1.77535 | 1.89290 | 2.77535 |
| (32) | (Dsum/TLw) × FNow | 1.730 | 1.646 | 1.701 | 1.725 | 1.674 |
| (33) | Dfoc/(fw × tanωw) | 0.036 | 0.045 | 0.132 | 0.096 | 0.142 |
| (34) | d1sum/\|f1\| | 0.215 | 0.233 | 0.237 | 0.155 | 0.200 |

TABLE 142

| Expression | | Example | Example | Example | Example | Example |
|---|---|---|---|---|---|---|
| number | | 16 | 17 | 18 | 19 | 20 |
| (1) | TLw/(fw × tanωw) | 4.080 | 3.581 | 3.146 | 4.338 | 4.338 |
| (2) | Bfw/(fw × tanωw) | 0.869 | 0.850 | 0.755 | 0.835 | 0.809 |
| (3) | Dsum/(TLw − Bfw) | 0.475 | 0.494 | 0.621 | 0.423 | 0.443 |
| (4) | FNow/tanωw | 4.237 | 3.808 | 4.028 | 4.713 | 4.763 |
| (5) | (fw × TLw)/ft² | 0.900 | 0.988 | 0.820 | 1.242 | 1.286 |
| (6) | ft/f1 | −1.690 | −1.746 | −1.673 | −1.399 | −1.331 |
| (7) | ft/\|fois\| | 1.492 | 1.068 | 1.150 | 1.665 | 1.916 |
| (8) | fw/f1 | −0.805 | −0.873 | −0.837 | −0.765 | −0.727 |
| (9) | ft/fMw | 2.002 | 1.930 | 1.776 | 1.954 | 1.853 |
| (10) | ft/fme | −1.040 | −0.966 | −0.539 | −1.504 | −1.438 |
| (11) | ft/fE | 0.633 | 0.576 | 0.406 | 0.281 | 0.270 |
| (12) | f1/fm1 | −0.621 | −0.612 | −1.261 | −1.190 | −1.224 |
| (13) | fm1/fme | −0.991 | −0.905 | −0.255 | −0.903 | −0.883 |
| (14) | FNot/(ft/fw) | 3.038 | 3.301 | 3.174 | 3.327 | 3.355 |
| (15) | fw/(ft × tanωt) | 1.111 | 0.990 | 1.077 | 1.156 | 1.106 |
| (16) | fme/fE | −0.609 | −0.596 | −0.754 | −0.187 | −0.188 |
| (17) | (−f1)/fMw | 1.185 | 1.105 | 1.062 | 1.397 | 1.393 |
| (18) | (−f1)/(fw × ft)^{1/2} | 0.858 | 0.810 | 0.845 | 0.967 | 1.017 |
| (19) | fMw/(fw × ft)^{1/2} | 0.724 | 0.733 | 0.796 | 0.692 | 0.730 |
| (20) | (−f1)/(ft/FNot) | 3.776 | 3.780 | 3.795 | 4.352 | 4.614 |
| (21) | TLw/fw | 3.968 | 3.950 | 3.280 | 4.160 | 4.308 |
| (22) | ft/\|ffoc\| | 1.040 | 0.966 | 0.539 | 1.504 | 1.438 |
| (23) | fw/\|ffoc\| | 0.495 | 0.483 | 0.269 | 0.822 | 0.786 |
| (24) | νdfoc | — | — | 55.87 | 55.87 | 55.87 |
| (25) | DDL1STw/TLw | 0.427 | 0.520 | 0.666 | 0.459 | 0.471 |
| (26) | \|DDG1Mw − DDG1Mt\|/TLw | 0.189 | 0.168 | 0.250 | 0.204 | 0.211 |
| (27) | (R1nf + R1nr)/(R1nf − R1nr) | 1.890 | 1.701 | 2.338 | 1.596 | 1.585 |
| (28) | d1sum/(ft/FNot) | 0.637 | 0.726 | 0.540 | 0.715 | 0.771 |
| (29) | f1/fL1STw | −0.627 | −0.712 | −0.577 | −1.625 | −1.752 |
| (30) | fw/fL1STw | 0.505 | 0.622 | 0.483 | 1.242 | 1.274 |
| (31) | N1n | 1.89190 | 1.77535 | 1.77535 | 1.64000 | 1.64000 |
| (32) | (Dsum/TLw) × FNow | 1.540 | 1.581 | 1.983 | 1.545 | 1.704 |
| (33) | Dfoc/(fw × tanωw) | 0.201 | 0.099 | 0.022 | 0.047 | 0.039 |
| (34) | d1sum/\|f1\| | 0.169 | 0.192 | 0.142 | 0.164 | 0.167 |

TABLE 143

| Expression | | Example | Example | Example | Example | Example |
|---|---|---|---|---|---|---|
| number | | 21 | 22 | 23 | 24 | 25 |
| (1) | TLw/(fw × tanωw) | 4.127 | 4.332 | 3.572 | 4.280 | 4.034 |
| (2) | Bfw/(fw × tanωw) | 1.059 | 0.713 | 0.760 | 0.882 | 0.809 |
| (3) | Dsum/(TLw − Bfw) | 0.439 | 0.416 | 0.453 | 0.437 | 0.434 |
| (4) | FNow/tanωw | 4.584 | 4.706 | 4.035 | 4.594 | 4.489 |
| (5) | (fw × TLw)/ft² | 1.256 | 0.997 | 0.959 | 1.246 | 1.213 |
| (6) | ft/f1 | −1.394 | −1.384 | −1.774 | −1.582 | −1.546 |
| (7) | ft/\|fois\| | 1.595 | 1.268 | 1.281 | 1.262 | 2.448 |
| (8) | fw/f1 | −0.774 | −0.710 | −0.910 | −0.860 | −0.845 |
| (9) | ft/fMw | 1.844 | 2.043 | 2.169 | 1.738 | 2.085 |
| (10) | ft/fme | −1.422 | −1.891 | −1.888 | −1.282 | −1.728 |
| (11) | ft/fE | 0.324 | 0.694 | 0.690 | 0.620 | 0.265 |
| (12) | f1/fm1 | −1.144 | −0.916 | −0.722 | −0.552 | −0.264 |
| (13) | fm1/fme | −0.892 | −1.491 | −1.474 | −1.468 | −4.227 |
| (14) | FNot/(ft/fw) | 3.266 | 3.026 | 3.067 | 3.336 | 3.410 |
| (15) | fw/(ft × tanωt) | 1.144 | 1.191 | 1.070 | 1.104 | 1.101 |
| (16) | fme/fE | −0.228 | −0.367 | −0.365 | −0.484 | −0.153 |
| (17) | (−f1)/fMw | 1.323 | 1.476 | 1.223 | 1.098 | 1.348 |
| (18) | (−f1)/(fw × ft)^{1/2} | 0.962 | 1.009 | 0.787 | 0.857 | 0.875 |
| (19) | fMw/(fw × ft)^{1/2} | 0.727 | 0.684 | 0.644 | 0.781 | 0.649 |
| (20) | (−f1)/(ft/FNot) | 4.218 | 4.263 | 3.371 | 3.880 | 4.036 |
| (21) | TLw/fw | 4.070 | 3.792 | 3.648 | 4.220 | 4.063 |
| (22) | ft/\|ffoc\| | 1.422 | 1.891 | 1.888 | 1.282 | 1.728 |
| (23) | fw/\|ffoc\| | 0.790 | 0.970 | 0.968 | 0.696 | 0.944 |
| (24) | νdfoc | 55.87 | 55.87 | 55.87 | 55.87 | — |
| (25) | DDL1STw/TLw | 0.430 | 0.435 | 0.354 | 0.395 | 0.423 |
| (26) | \|DDG1Mw − DDG1Mt\|/TLw | 0.211 | 0.212 | 0.163 | 0.163 | 0.168 |
| (27) | (R1nf + R1nr)/(R1nf − R1nr) | 1.199 | 1.288 | 1.046 | 1.243 | 1.719 |
| (28) | d1sum/(ft/FNot) | 0.499 | 0.769 | 0.404 | 0.917 | 0.814 |
| (29) | f1/fL1STw | −1.392 | −0.816 | −0.421 | 0.245 | −1.861 |
| (30) | fw/fL1STw | 1.078 | 0.579 | 0.383 | −0.210 | 1.572 |
| (31) | N1n | 1.64000 | 1.64000 | 1.64000 | 1.64000 | 2.77535 |
| (32) | (Dsum/TLw) × FNow | 1.475 | 1.432 | 1.468 | 1.573 | 1.569 |
| (33) | Dfoc/(fw × tanωw) | 0.036 | 0.029 | 0.027 | 0.027 | 0.129 |
| (34) | d1sum/\|f1\| | 0.118 | 0.180 | 0.120 | 0.236 | 0.202 |

TABLE 144

| Expression | | Example | Example | Example | Example | Example |
|---|---|---|---|---|---|---|
| number | | 26 | 27 | 28 | 29 | 30 |
| (1) | TLw/(fw × tanωw) | 4.204 | 4.133 | 4.139 | 4.152 | 4.275 |
| (2) | Bfw/(fw × tanωw) | 0.676 | 0.855 | 0.804 | 0.781 | 0.587 |
| (3) | Dsum/(TLw − Bfw) | 0.467 | 0.458 | 0.443 | 0.453 | 0.443 |
| (4) | FNow/tanωw | 4.292 | 4.035 | 4.584 | 4.711 | 4.697 |
| (5) | (fw × TLw)/ft² | 1.011 | 0.957 | 0.975 | 0.933 | 1.048 |
| (6) | ft/f1 | −1.603 | −1.581 | −1.640 | −1.460 | −1.711 |
| (7) | ft/\|fois\| | 1.227 | 1.606 | 1.447 | 1.583 | 1.268 |
| (8) | fw/f1 | −0.802 | −0.753 | −0.820 | −0.741 | −0.896 |
| (9) | ft/fMw | 1.963 | 1.869 | 2.091 | 2.434 | 2.032 |
| (10) | ft/fme | −1.883 | −1.021 | −1.866 | −1.875 | −0.967 |
| (11) | ft/fE | 0.578 | 0.485 | 0.619 | 0.706 | 0.473 |
| (12) | f1/fm1 | −0.765 | −0.707 | −0.882 | −0.818 | −1.330 |
| (13) | fm1/fme | −1.535 | −0.914 | −1.290 | −1.571 | −0.425 |
| (14) | FNot/(ft/fw) | 3.130 | 2.929 | 3.150 | 2.934 | 3.037 |
| (15) | fw/(ft × tanωt) | 1.102 | 1.065 | 1.150 | 1.207 | 1.277 |
| (16) | fme/fE | −0.307 | −0.475 | −0.332 | −0.377 | −0.489 |
| (17) | (−f1)/fMw | 1.225 | 1.182 | 1.276 | 1.667 | 1.187 |
| (18) | (−f1)/(fw × ft)^{1/2} | 0.882 | 0.917 | 0.863 | 0.961 | 0.808 |
| (19) | fMw/(fw × ft)^{1/2} | 0.720 | 0.775 | 0.676 | 0.577 | 0.680 |
| (20) | (−f1)/(ft/FNot) | 3.905 | 3.890 | 3.842 | 3.959 | 3.389 |
| (21) | TLw/fw | 4.045 | 4.221 | 3.901 | 3.622 | 3.823 |
| (22) | ft/\|ffoc\| | 1.883 | 1.021 | 1.866 | 1.875 | 0.967 |
| (23) | fw/\|ffoc\| | 0.942 | 0.486 | 0.933 | 0.952 | 0.506 |
| (24) | νdfoc | 55.87 | 55.87 | — | — | — |
| (25) | DDL1STw/TLw | 0.436 | 0.457 | 0.400 | 0.432 | 0.532 |
| (26) | \|DDG1Mw − DDG1Mt\|/TLw | 0.168 | 0.221 | 0.193 | 0.223 | 0.229 |
| (27) | (R1nf + R1nr)/(R1nf − R1nr) | 1.890 | 1.735 | 1.305 | 2.163 | 2.580 |
| (28) | d1sum/(ft/FNot) | 0.839 | 0.805 | 0.750 | 0.779 | 0.416 |
| (29) | f1/fL1STw | −0.601 | −1.373 | −0.792 | −0.575 | −0.897 |
| (30) | fw/fL1STw | 0.482 | 1.034 | 0.649 | 0.426 | 0.804 |
| (31) | N1n | 1.77535 | 1.89190 | 1.77535 | 1.90525 | 2.77535 |
| (32) | (Dsum/TLw) × FNow | 1.618 | 1.495 | 1.543 | 1.513 | 1.606 |
| (33) | Dfoc/(fw × tanωw) | 0.027 | 0.039 | 0.137 | 0.131 | 0.145 |
| (34) | d1sum/\|f1\| | 0.215 | 0.207 | 0.195 | 0.197 | 0.123 |

TABLE 145

| Expression | | Example | Example | Example | Example | Example |
|---|---|---|---|---|---|---|
| number | | 31 | 32 | 33 | 34 | 35 |
| (1) | TLw/(fw × tanωw) | 3.789 | 3.778 | 3.755 | 3.716 | 4.227 |
| (2) | Bfw/(fw × tanωw) | 0.700 | 0.607 | 0.634 | 1.099 | 0.910 |
| (3) | Dsum/(TLw − Bfw) | 0.494 | 0.510 | 0.409 | 0.519 | 0.402 |
| (4) | FNow/tanωw | 4.494 | 4.442 | 4.049 | 4.648 | 4.881 |
| (5) | (fw × TLw)/ft² | 1.111 | 1.065 | 1.005 | 1.068 | 1.107 |
| (6) | ft/f1 | −1.207 | −1.152 | −1.282 | −1.588 | −1.502 |
| (7) | ft/\|fois\| | 1.318 | 1.387 | 1.497 | 0.960 | 1.617 |
| (8) | fw/f1 | −0.652 | −0.606 | −0.658 | −0.863 | −0.799 |
| (9) | ft/fMw | 2.030 | 2.136 | 2.134 | 2.124 | 1.979 |
| (10) | ft/fme | −1.903 | −1.877 | −2.193 | −1.591 | −1.619 |
| (11) | ft/fE | 0.555 | 0.610 | 0.598 | 0.543 | 0.625 |
| (12) | f1/fm1 | −1.682 | −1.855 | −1.167 | 1.338 | −0.452 |
| (13) | fm1/fme | −0.937 | −0.879 | −1.465 | −0.749 | −2.384 |
| (14) | FNot/(ft/fw) | 3.421 | 3.347 | 3.123 | 3.452 | 3.170 |
| (15) | fw/(ft × tanωt) | 1.128 | 1.094 | 1.110 | 1.176 | 1.223 |
| (16) | fme/fE | −0.292 | −0.325 | −0.273 | −0.341 | −0.386 |
| (17) | (−f1)/fMw | 1.682 | 1.855 | 1.664 | 1.338 | 1.318 |
| (18) | (−f1)/(fw × ft)^{1/2} | 1.127 | 1.197 | 1.089 | 0.854 | 0.913 |
| (19) | fMw/(fw × ft)^{1/2} | 0.670 | 0.645 | 0.654 | 0.639 | 0.693 |
| (20) | (−f1)/(ft/FNot) | 5.246 | 5.523 | 4.749 | 3.999 | 3.968 |
| (21) | TLw/fw | 3.802 | 3.845 | 3.821 | 3.614 | 3.914 |
| (22) | ft/\|ffoc\| | 1.903 | 1.877 | 2.193 | 1.591 | 1.619 |
| (23) | fw/\|ffoc\| | 1.028 | 0.988 | 1.125 | 0.865 | 0.861 |
| (24) | νdfoc | 55.87 | 55.87 | 55.87 | 55.87 | 55.87 |
| (25) | DDL1STw/TLw | 0.382 | 0.392 | 0.415 | 0.368 | 0.390 |
| (26) | \|DDG1Mw − DDG1Mt\|/TLw | 0.188 | 0.209 | 0.196 | 0.157 | 0.212 |
| (27) | (R1nf + R1nr)/(R1nf − R1nr) | 1.429 | 1.470 | 1.453 | 0.963 | 1.402 |
| (28) | d1sum/(ft/FNot) | 0.505 | 0.558 | 0.416 | 0.581 | 0.572 |
| (29) | f1/fL1STw | −1.010 | −1.162 | −1.234 | 0.554 | −0.268 |
| (30) | fw/fL1STw | 0.659 | 0.704 | 0.811 | −0.479 | 0.214 |
| (31) | N1n | 1.83481 | 1.83481 | 1.83481 | 1.77535 | 2.77535 |
| (32) | (Dsum/TLw) × FNow | 1.815 | 1.933 | 1.400 | 1.653 | 1.426 |
| (33) | Dfoc/(fw × tanωw) | 0.025 | 0.158 | 0.026 | 0.025 | 0.034 |
| (34) | d1sum/\|f1\| | 0.096 | 0.101 | 0.088 | 0.145 | 0.144 |

TABLE 146

| Expression | | Example | Example | Example | Example | Example |
|---|---|---|---|---|---|---|
| number | | 36 | 37 | 38 | 39 | 40 |
| (1) | TLw/(fw × tanωw) | 3.650 | 3.731 | 3.977 | 4.404 | 3.746 |
| (2) | Bfw/(fw × tanωw) | 0.420 | 0.571 | 0.641 | 0.573 | 0.481 |
| (3) | Dsum/(TLw − Bfw) | 0.445 | 0.479 | 0.466 | 0.469 | 0.478 |
| (4) | FNow/tanωw | 4.422 | 4.568 | 4.530 | 4.448 | 4.506 |
| (5) | (fw × TLw)/ft² | 0.950 | 0.981 | 0.994 | 1.013 | 1.129 |
| (6) | ft/f1 | −1.421 | −1.396 | −1.458 | −1.423 | −1.358 |
| (7) | ft/\|fois\| | 1.555 | 1.532 | 1.300 | 1.394 | 1.447 |
| (8) | fw/f1 | −0.733 | −0.720 | −0.729 | −0.712 | −0.734 |
| (9) | ft/fMw | 2.215 | 2.494 | 1.985 | 1.735 | 1.587 |
| (10) | ft/fme | −2.260 | −2.362 | −1.657 | −0.466 | −0.527 |
| (11) | ft/fE | 0.780 | 0.493 | 0.676 | 0.639 | 0.576 |
| (12) | f1/fm1 | −0.771 | −1.786 | −0.829 | −1.563 | −1.422 |
| (13) | fm1/fme | −2.061 | −0.947 | −1.371 | −0.210 | −0.273 |
| (14) | FNot/(ft/fw) | 3.109 | 3.284 | 3.360 | 3.301 | 3.670 |
| (15) | fw/(ft × tanωt) | 1.186 | 1.163 | 1.107 | 1.134 | 1.084 |
| (16) | fme/fE | −0.345 | −0.209 | −0.408 | −1.369 | −1.094 |
| (17) | (−f1)/fMw | 1.558 | 1.786 | 1.361 | 1.219 | 1.169 |
| (18) | (−f1)/(fw × ft)^{1/2} | 0.980 | 0.998 | 0.970 | 0.993 | 1.002 |
| (19) | fMw/(fw × ft)^{1/2} | 0.629 | 0.558 | 0.712 | 0.815 | 0.857 |
| (20) | (−f1)/(ft/FNot) | 4.243 | 4.562 | 4.609 | 4.637 | 5.000 |
| (21) | TLw/fw | 3.574 | 3.692 | 3.977 | 4.049 | 3.865 |
| (22) | ft/\|ffoc\| | 2.260 | 2.362 | 1.657 | 1.456 | 1.091 |
| (23) | fw/\|ffoc\| | 1.165 | 1.218 | 0.829 | 0.728 | 0.589 |
| (24) | νdfoc | — | — | 55.87 | 45.38 | 23.43 |
| (25) | DDL1STw/TLw | 0.411 | 0.414 | 0.409 | 0.583 | 0.548 |
| (26) | \|DDG1Mw − DDG1Mt\|/TLw | 0.214 | 0.214 | 0.191 | 0.177 | 0.179 |
| (27) | (R1nf + R1nr)/(R1nf − R1nr) | 1.544 | 1.105 | 1.632 | 2.882 | 1.196 |
| (28) | d1sum/(ft/FNot) | 0.572 | 0.545 | 0.636 | 0.625 | 0.643 |
| (29) | f1/fL1STw | −0.067 | 0.398 | 0.049 | −1.737 | −1.657 |
| (30) | fw/fL1STw | 0.049 | −0.287 | −0.036 | 1.237 | 1.216 |
| (31) | N1n | 1.77535 | 1.77535 | 1.77535 | 1.77535 | 1.80400 |
| (32) | (Dsum/TLw) × FNow | 1.705 | 1.833 | 1.769 | 1.668 | 1.937 |
| (33) | Dfoc/(fw × tanωw) | 0.176 | 0.122 | 0.026 | 0.039 | 0.050 |
| (34) | d1sum/\|f1\| | 0.135 | 0.119 | 0.138 | 0.135 | 0.129 |

TABLE 147

| Expression | | Example | Example | Example | Example |
|---|---|---|---|---|---|
| number | | 41 | 42 | 43 | 44 |
| (1) | TLw/(fw × tanωw) | 4.414 | 4.657 | 4.158 | 4.086 |
| (2) | Bfw/(fw × tanωw) | 0.562 | 0.472 | 0.927 | 0.841 |
| (3) | Dsum/(TLw − Bfw) | 0.489 | 0.527 | 0.626 | 0.487 |
| (4) | FNow/tanωw | 4.409 | 4.651 | 4.664 | 4.967 |
| (5) | (fw × TLw)/ft² | 0.857 | 0.848 | 1.191 | 1.111 |
| (6) | ft/f1 | −1.667 | −1.751 | −1.595 | −1.300 |
| (7) | ft/\|fois\| | 1.606 | 1.643 | 1.131 | 2.218 |
| (8) | fw/f1 | −0.758 | −0.796 | −0.867 | −0.711 |
| (9) | ft/fMw | 1.904 | 2.017 | 2.024 | 2.419 |
| (10) | ft/fme | −0.624 | −0.699 | −1.500 | −2.027 |
| (11) | ft/fE | 0.729 | 0.660 | 0.361 | 0.384 |
| (12) | f1/fm1 | −1.473 | −1.437 | −1.269 | −1.861 |
| (13) | fm1/fme | −0.254 | −0.278 | −0.741 | −0.838 |
| (14) | FNot/(ft/fw) | 3.155 | 3.145 | 3.620 | 3.318 |
| (15) | fw/(ft × tanωt) | 1.125 | 1.136 | 1.140 | 1.167 |
| (16) | fme/fE | −1.168 | −0.945 | −0.240 | −0.190 |
| (17) | (−f1)/fMw | 1.142 | 1.152 | 1.269 | 1.861 |
| (18) | (−f1)/(fw × ft)^{1/2} | 0.890 | 0.847 | 0.851 | 1.040 |
| (19) | fMw/(fw × ft)^{1/2} | 0.779 | 0.735 | 0.670 | 0.559 |
| (20) | (−f1)/(ft/FNot) | 4.163 | 3.952 | 4.177 | 4.668 |
| (21) | TLw/fw | 4.145 | 4.106 | 4.029 | 3.718 |
| (22) | ft/\|ffoc\| | 1.703 | 1.645 | 1.500 | 2.027 |
| (23) | fw/\|ffoc\| | 0.774 | 0.748 | 0.815 | 1.108 |
| (24) | νdfoc | 42.74 | 42.74 | 55.87 | — |
| (25) | DDL1STw/TLw | 0.211 | 0.556 | 0.390 | 0.418 |
| (26) | \|DDG1Mw − DDG1Mt\|/TLw | 0.197 | 0.182 | 0.126 | 0.204 |
| (27) | (R1nf + R1nr)/(R1nf − R1nr) | 2.325 | 1.572 | 1.139 | 1.882 |
| (28) | d1sum/(ft/FNot) | 0.674 | 1.278 | 1.064 | 0.734 |
| (29) | f1/fL1STw | −1.510 | −1.367 | 0.921 | 1.000 |
| (30) | fw/fL1STw | 1.144 | 1.088 | −0.798 | −0.711 |
| (31) | N1n | 1.81032 | 1.87291 | 1.88724 | 1.64000 |
| (32) | (Dsum/TLw) × FNow | 1.766 | 1.941 | 2.200 | 1.750 |
| (33) | Dfoc/(fw × tanωw) | 0.038 | 0.040 | 0.049 | 0.141 |
| (34) | d1sum/\|f1\| | 0.162 | 0.323 | 0.255 | 0.157 |

TABLE 148

| Expression | | Example | Example |
|---|---|---|---|
| number | | 45 | 46 |
| (1) | TLw/(fw × tanωw) | 4.220 | 4.525 |
| (2) | Bfw/(fw × tanωw) | 1.090 | 1.083 |
| (3) | Dsum/(TLw − Bfw) | 0.488 | 0.359 |
| (4) | FNow/tanωw | 4.670 | 4.683 |
| (5) | (fw × TLw)/ft² | 0.657 | 0.688 |
| (6) | ft/f1 | −1.633 | −1.676 |
| (7) | ft/\|fois\| | 2.166 | 2.305 |
| (8) | fw/f1 | −0.680 | −0.699 |
| (9) | ft/fMw | 2.951 | 2.587 |
| (10) | ft/fme | −1.492 | −1.323 |
| (11) | ft/fE | −0.894 | −0.639 |
| (12) | f1/fm1 | −1.807 | −1.056 |
| (13) | fm1/fme | −0.506 | −0.747 |
| (14) | FNot/(ft/fw) | 3.112 | 2.996 |
| (15) | fw/(ft × tanωt) | 1.224 | 1.268 |
| (16) | fme/fE | 0.599 | 0.483 |
| (17) | (−f1)/fMw | 1.807 | 1.543 |
| (18) | (−f1)/(fw × ft)^{1/2} | 0.949 | 0.924 |
| (19) | fMw/(fw × ft)^{1/2} | 0.525 | 0.599 |
| (20) | (−f1)/(ft/FNot) | 4.575 | 4.289 |
| (21) | TLw/fw | 3.786 | 3.961 |
| (22) | ft/\|ffoc\| | 1.492 | 1.323 |
| (23) | fw/\|ffoc\| | 0.621 | 0.551 |
| (24) | νdfoc | 70.24 | 70.24 |
| (25) | DDL1STw/TLw | 0.569 | 0.567 |
| (26) | \|DDG1Mw − DDG1Mt\|/TLw | 0.242 | 0.249 |
| (27) | (R1nf + R1nr)/(R1nf − R1nr) | 2.987 | 2.907 |
| (28) | d1sum/(ft/FNot) | 0.669 | 0.630 |
| (29) | f1/fL1STw | −0.227 | −1.241 |
| (30) | fw/fL1STw | 0.154 | 0.867 |
| (31) | N1n | 1.92559 | 1.93417 |
| (32) | (Dsum/TLw) × FNow | 1.515 | 1.120 |
| (33) | Dfoc/(fw × tanωw) | 0.032 | 0.032 |
| (34) | d1sum/\|f1\| | 0.146 | 0.147 |

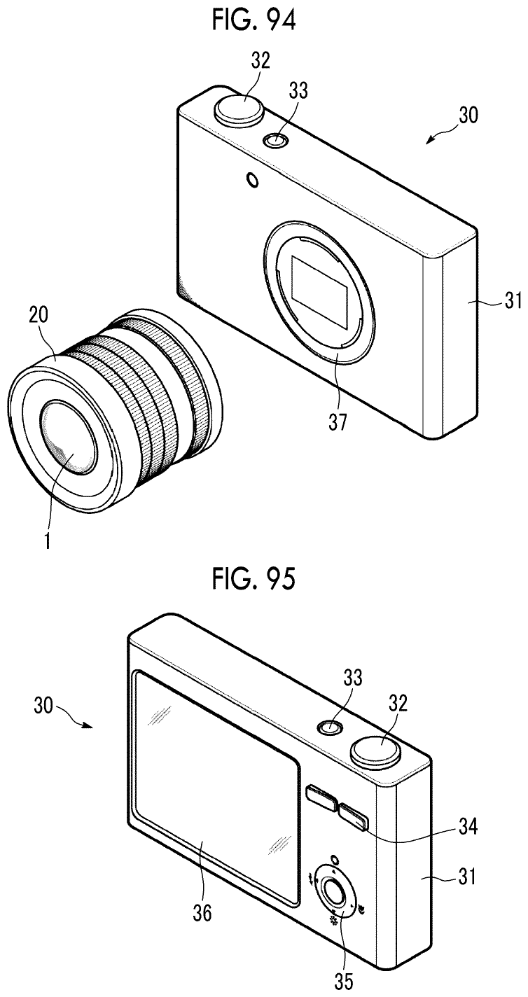

Next, an imaging apparatus according to the embodiment of the present disclosure will be described. FIGS. 94 and 95 are external views of a camera 30 that is the imaging apparatus according to the embodiment of the present disclosure. FIG. 94 is a perspective view of the camera 30, which is seen from the front, and FIG. 95 is a perspective view of the camera 30, which is seen from the rear. The camera 30 is a so-called mirrorless type digital camera in which an interchangeable lens 20 can be attachably and detachably mounted. The interchangeable lens 20 includes the variable magnification optical system 1 according to the embodiment of the present disclosure accommodated in a lens barrel.

The camera 30 comprises a camera body 31, and a shutter button 32 and a power button 33 are provided on an upper surface of the camera body 31. An operation unit 34, an operation unit 35, and a display unit 36 are provided on a rear surface of the camera body 31. The display unit 36 can display a captured image and an image within an angle of view prior to capture.

An imaging aperture on which light from an imaging target is incident is provided at the center of a front surface of the camera body 31, a mount 37 is provided at a position corresponding to the imaging aperture, and the interchangeable lens 20 is mounted on the camera body 31 through the mount 37.

An imaging element, such as a charge-coupled device (CCD) or a complementary metal-oxide-semiconductor (CMOS), that outputs an imaging signal corresponding to a subject image formed by the interchangeable lens 20, a signal processing circuit that processes the imaging signal output from the imaging element to generate an image, a recording medium for recording the generated image, and the like are provided in the camera body 31. In the camera 30, a still image or a moving image can be captured by pressing the shutter button 32, and the image data obtained by the capture is recorded on the recording medium.

Although the technology of the present disclosure has been described above using the embodiment and the examples, the technology of the present disclosure is not limited to the embodiment and the examples, and can be subjected to various modifications. For example, the curvature radius, the surface spacing, the refractive index, the Abbe number, the aspherical coefficient, and the like of each lens are not limited to the values shown in the examples, and may be different values.

Further, the imaging apparatus according to the embodiment of the present disclosure is not limited to the above-described example and can take various forms, for example, a camera of a type other than a mirrorless type, a film camera, a video camera, and a security camera.

The following supplementary notes are further disclosed in regard to the embodiment and the examples described above.

### [Supplementary Note 1]

A variable magnification optical system consisting of, in order from an object side to an image side, a first lens group having negative refractive power, an intermediate group consisting of a plurality of lens groups, and a final lens group having refractive power, in which, during magnification change, a spacing between the first lens group and the intermediate group changes, a spacing between the intermediate group and the final lens group changes, and spacings between all adjacent lens groups in the intermediate group change, a focusing group that moves along an optical axis during focusing is disposed on the image side with respect to the first lens group, and in a case in which a sum of a distance on the optical axis from a lens surface closest to the object side of the first lens group to a lens surface closest to the image side of the final lens group and a back focus in terms of an air-equivalent distance of an entire system in a state in which an infinite distance object is in focus at a wide angle end is denoted by TLw, a focal length of the entire system in a state in which the infinite distance object is in focus at the wide angle end is denoted by fw, a maximum half angle of view in a state in which the infinite distance object is in focus at the wide angle end is denoted by ωw, a back focus in terms of the air-equivalent distance of the entire system in a state in which the infinite distance object is in focus at the wide angle end is denoted by Bfw, and a total sum of thicknesses of all lens groups on the optical axis is denoted by Dsum, Conditional Expressions (1), (2), and (3) represented by 2<TLw/(fw×tan ωw)<6.5 (1), 0.15<Bfw/(fw×tan ωw)<1.5 (2), and 0.1<Dsum/(TLw−Bfw)<0.8 (3) are satisfied.

### [Supplementary Note 2]

The variable magnification optical system according to supplementary note 1, in which Conditional Expression (1-1) represented by 2.6<TLw/(fw×tan ωw)<5.5 (1-1) is satisfied.

### [Supplementary Note 3]

The variable magnification optical system according to supplementary note 2, in which Conditional Expression (1-2) represented by 2.8<TLw/(fw×tan ωw)<5 (1-2) is satisfied.

### [Supplementary Note 4]

The variable magnification optical system according to supplementary note 3, in which Conditional Expression (1-3) represented by 3.1<TLw/(fw×tan ωw)<4.5 (1-3) is satisfied.

### [Supplementary Note 5]

The variable magnification optical system according to supplementary note 4, in which Conditional Expression (1-4) represented by 3.2<TLw/(fw×tan ωw)<4.25 (1-4) is satisfied.

### [Supplementary Note 6]

The variable magnification optical system according to any one of supplementary notes 1 to 5, in which Conditional Expression (2-1) represented by 0.2<Bfw/(fw×tan ωw)<1.25 (2-1) is satisfied.

### [Supplementary Note 7]

The variable magnification optical system according to supplementary note 6, in which Conditional Expression (2-2) represented by 0.25<Bfw/(fw×tan ωw)<1.1 (2-2) is satisfied.

### [Supplementary Note 8]

The variable magnification optical system according to supplementary note 7, in which Conditional Expression (2-3) represented by 0.35<Bfw/(fw×tan ωw)<1 (2-3) is satisfied.

### [Supplementary Note 9]

The variable magnification optical system according to any one of supplementary notes 1 to 8, in which Conditional Expression (3-1) represented by 0.15<Dsum/(TLw−Bfw)<0.6 (3-1) is satisfied.

### [Supplementary Note 10]

The variable magnification optical system according to supplementary note 9, in which Conditional Expression (3-2) represented by 0.21<Dsum/(TLw−Bfw)<0.54 (3-2) is satisfied.

### [Supplementary Note 11]

The variable magnification optical system according to any one of supplementary notes 1 to 10, in which in a case in which an open F-number in a state in which the infinite distance object is in focus at the wide angle end is denoted by FNow, Conditional Expression (4) represented by 2.3<FNow/tan ωw<7 (4) is satisfied.

### [Supplementary Note 12]

The variable magnification optical system according to supplementary note 11, in which Conditional Expression (4-1) represented by 2.9<FNow/tan ωw<6 (4-1) is satisfied.

### [Supplementary Note 13]

The variable magnification optical system according to any one of supplementary notes 1 to 12, in which in a case in which a focal length of the entire system in a state in which the infinite distance object is in focus at a telephoto end is denoted by ft, Conditional Expression (5) represented by 0.45<(fw×TLw)/ft²<3 (5) is satisfied.

### [Supplementary Note 14]

The variable magnification optical system according to supplementary note 13, in which Conditional Expression (5-1) represented by 0.58<(fw×TLw)/ft²<2.2 (5-1) is satisfied.

### [Supplementary Note 15]

The variable magnification optical system according to supplementary note 14, in which Conditional Expression (5-2) represented by 0.73<(fw×TLw)/ft²<1.4 (5-2) is satisfied.

### [Supplementary Note 16]

The variable magnification optical system according to supplementary note 15, in which Conditional Expression (5-3) represented by 0.75<(fw×TLw)/ft²<1.35 (5-3) is satisfied.

### [Supplementary Note 17]

The variable magnification optical system according to any one of supplementary notes 1 to 16, in which in a case in which a focal length of the entire system in a state in which the infinite distance object is in focus at a telephoto end is denoted by ft, and a focal length of the first lens group is denoted by f1, Conditional Expression (6) represented by −10<ft/f1<−0.4 (6) is satisfied.

### [Supplementary Note 18]

The variable magnification optical system according to supplementary note 17, in which Conditional Expression (6-1) represented by −7<ft/f1<−0.9 (6-1) is satisfied.

### [Supplementary Note 19]

The variable magnification optical system according to supplementary note 18, in which Conditional Expression (6-2) represented by −5<ft/f1<−1.1 (6-2) is satisfied.

### [Supplementary Note 20]

The variable magnification optical system according to any one of supplementary notes 1 to 19, in which the intermediate group includes an anti-vibration group that moves in a direction intersecting the optical axis during image shake correction, and in a case in which a focal length of the anti-vibration group is denoted by fois, Conditional Expression (7) represented by 0.3<ft/|fois|<4 (7) is satisfied.

### [Supplementary Note 21]

The variable magnification optical system according to any one of supplementary notes 1 to 20, in which an anti-vibration group that moves in a direction intersecting the optical axis during image shake correction is disposed closest to the object side in a lens group that is located closest to the object side in the intermediate group.

### [Supplementary Note 22]

The variable magnification optical system according to supplementary note 1 or 2, in which the intermediate group includes, in order from the object side to the image side, at least a first intermediate lens group having positive refractive power, a second intermediate lens group having refractive power, and a third intermediate lens group having refractive power.

### [Supplementary Note 23]

The variable magnification optical system according to supplementary note 22, in which Conditional Expression (1-2) represented by 2.8<TLw/(fw×tan ωw)<5 (1-2) is satisfied.

### [Supplementary Note 24]

The variable magnification optical system according to supplementary note 22 or 23, in which Conditional Expression (2-1A) represented by 0.18<Bfw/(fw×tan ωw)<1.25 (2-1A) is satisfied.

### [Supplementary Note 25]

The variable magnification optical system according to any one of supplementary notes 22 to 24, in which in a case in which a focal length of the entire system in a state in which the infinite distance object is in focus at a telephoto end is denoted by ft, Conditional Expression (5-1A) represented by 0.63<(fw×TLw)/ft²<1.85 (5-1A) is satisfied.

### [Supplementary Note 26]

The variable magnification optical system according to any one of supplementary notes 22 to 25, in which in a case in which a focal length of the first lens group is denoted by f1, Conditional Expression (6-1) represented by −7<ft/f1<−0.9 (6-1) is satisfied.

### [Supplementary Note 27]

The variable magnification optical system according to any one of supplementary notes 1 to 26, in which in a case in which a focal length of the first lens group is denoted by f1, Conditional Expression (8) represented by −3.5<fw/f1<−0.2 (8) is satisfied.

### [Supplementary Note 28]

The variable magnification optical system according to any one of supplementary notes 1 to 27, in which in a case in which a focal length of the entire system in a state in which the infinite distance object is in focus at a telephoto end is denoted by ft, and a focal length of the intermediate group in a state in which the infinite distance object is in focus at the wide angle end is denoted by fMw, Conditional Expression (9) represented by 0.2<ft/fMw<7.5 (9) is satisfied.

### [Supplementary Note 29]

The variable magnification optical system according to any one of supplementary notes 1 to 28, in which in a case in which a focal length of the entire system in a state in which the infinite distance object is in focus at a telephoto end is denoted by ft, and a focal length of a lens group located closest to the image side in the intermediate group is denoted by fme, Conditional Expression (10) represented by −16<ft/fme<−0.15 (10) is satisfied.

### [Supplementary Note 30]

The variable magnification optical system according to supplementary note 29, in which Conditional Expression (10-1) represented by −10<ft/fme<−1.5 (10-1) is satisfied.

### [Supplementary Note 31]

The variable magnification optical system according to any one of supplementary notes 1 to 30, in which in a case in which a focal length of the entire system in a state in which the infinite distance object is in focus at a telephoto end is denoted by ft, and a focal length of the final lens group is denoted by fE, Conditional Expression (11) represented by −2<ft/fE<2.5 (11) is satisfied.

### [Supplementary Note 32]

The variable magnification optical system according to supplementary note 31, in which Conditional Expression (11-1) represented by 0.1<ft/fE<0.7 (11-1) is satisfied.

### [Supplementary Note 33]

The variable magnification optical system according to any one of supplementary notes 1 to 32, in which in a case in which a focal length of the first lens group is denoted by f1, and a focal length of a lens group located closest to the object side in the intermediate group is denoted by fm1, Conditional Expression (12) represented by −5<f1/fm1<−0.05 (12) is satisfied.

### [Supplementary Note 34]

The variable magnification optical system according to any one of supplementary notes 1 to 33, in which a lens group located closest to the object side in the intermediate group has positive refractive power, and in a case in which a focal length of the lens group located closest to the object side in the intermediate group is denoted by fm1, and a focal length of a lens group located closest to the image side in the intermediate group is denoted by fme, Conditional Expression (13) represented by −15<fm1/fme<−0.05 (13) is satisfied.

### [Supplementary Note 35]

The variable magnification optical system according to any one of supplementary notes 1 to 34, in which in a case in which an open F-number in a state in which the infinite distance object is in focus at a telephoto end is denoted by FNot, and a focal length of the entire system in a state in which the infinite distance object is in focus at the telephoto end is denoted by ft, Conditional Expression (14) represented by 1.5<FNot/(ft/fw)<7 (14) is satisfied.

### [Supplementary Note 36]

The variable magnification optical system according to any one of supplementary notes 1 to 35, in which in a case in which a focal length of the entire system in a state in which the infinite distance object is in focus at a telephoto end is denoted by ft, and a maximum half angle of view in a state in which the infinite distance object is in focus at the telephoto end is denoted by ωt, Conditional Expression (15) represented by 0.4<fw/(ft×tan ωt)<2.7 (15) is satisfied.

### [Supplementary Note 37]

The variable magnification optical system according to any one of supplementary notes 1 to 36, in which a lens group located closest to the image side in the intermediate group has negative refractive power, and in a case in which a focal length of the lens group located closest to the image side in the intermediate group is denoted by fme, and a focal length of the final lens group is denoted by fE, Conditional Expression (16) represented by −9<fme/fE<−0.05 (16) is satisfied.

### [Supplementary Note 38]

The variable magnification optical system according to supplementary note 37, in which Conditional Expression (16-1) represented by −3<fme/fE<−0.35 (16-1) is satisfied.

### [Supplementary Note 39]

The variable magnification optical system according to any one of supplementary notes 1 to 38, in which in a case in which a focal length of the first lens group is denoted by f1, and a focal length of the intermediate group in a state in which the infinite distance object is in focus at the wide angle end is denoted by fMw, Conditional Expression (17) represented by 0.2<(−f1)/fMw<5 (17) is satisfied.

### [Supplementary Note 40]

The variable magnification optical system according to any one of supplementary notes 1 to 39, in which in a case in which a focal length of the first lens group is denoted by f1, and a focal length of the entire system in a state in which the infinite distance object is in focus at a telephoto end is denoted by ft, Conditional Expression (18) represented by 0.3<(−f1)/(fw×ft)^{1/2}<2 (18) is satisfied.

### [Supplementary Note 41]

The variable magnification optical system according to any one of supplementary notes 1 to 40, in which in a case in which a focal length of the intermediate group in a state in which the infinite distance object is in focus at the wide angle end is denoted by fMw, and a focal length of the entire system in a state in which the infinite distance object is in focus at a telephoto end is denoted by ft, Conditional Expression (19) represented by 0.15<fMw/(fw×ft) 12<2 (19) is satisfied.

### [Supplementary Note 42]

The variable magnification optical system according to any one of supplementary notes 1 to 41, in which in a case in which a focal length of the first lens group is denoted by f1, a focal length of the entire system in a state in which the infinite distance object is in focus at a telephoto end is denoted by ft, and an open F-number in a state in which the infinite distance object is in focus at the telephoto end is denoted by FNot, Conditional Expression (20) represented by 1<(−f1)/(ft/FNot)<12 (20) is satisfied.

### [Supplementary Note 43]

The variable magnification optical system according to any one of supplementary notes 1 to 42, in which Conditional Expression (21) represented by 2.5<TLw/fw<7 (21) is satisfied.

### [Supplementary Note 44]

The variable magnification optical system according to any one of supplementary notes 1 to 43, in which in a case in which a focal length of the entire system in a state in which the infinite distance object is in focus at a telephoto end is denoted by ft, and a focal length of the focusing group is denoted by ffoc, Conditional Expression (22) represented by 0.3<ft/|ffoc|<6 (22) is satisfied.

### [Supplementary Note 45]

The variable magnification optical system according to any one of supplementary notes 1 to 44, in which in a case in which a focal length of the focusing group is denoted by ffoc, Conditional Expression (23) represented by 0.15<fw/|ffoc|<3.2 (23) is satisfied.

### [Supplementary Note 46]

The variable magnification optical system according to any one of supplementary notes 1 to 45, in which the focusing group consists of one lens, and in a case in which an Abbe number, based on a d line, of the lens constituting the focusing group is denoted by vdfoc, Conditional Expression (24) represented by 20<vdfoc<75 (24) is satisfied.

### [Supplementary Note 47]

The variable magnification optical system according to any one of supplementary notes 1 to 46, in which the intermediate group includes an aperture stop, and in a case in which a distance on the optical axis from a surface closest to the object side of the first lens group to the aperture stop in a state in which the infinite distance object is in focus at the wide angle end is denoted by DDLISTw, Conditional Expression (25) represented by 0.18<DDL1STw/TLw<0.8 (25) is satisfied.

### [Supplementary Note 48]

The variable magnification optical system according to any one of supplementary notes 1 to 47, in which in a case in which a spacing on the optical axis between the first lens group and the intermediate group in a state in which the infinite distance object is in focus at the wide angle end is denoted by DDG1Mw, and a spacing on the optical axis between the first lens group and the intermediate group in a state in which the infinite distance object is in focus at a telephoto end is denoted by DDG1Mt, Conditional Expression (26) represented by 0.07<|DDG1Mw−DDG1Mt|/TLw<0.4 (26) is satisfied.

### [Supplementary Note 49]

The variable magnification optical system according to any one of supplementary notes 1 to 48, in which in a case in which a paraxial curvature radius of an object-side surface of a negative lens closest to the object side among negative lenses included in the first lens group is denoted by R1nf, and a paraxial curvature radius of an image-side surface of the negative lens closest to the object side among the negative lenses included in the first lens group is denoted by R1nr, Conditional Expression (27) represented by 0.4<(R1nf+R1nr)/(R1nf−R1nr)<5 (27) is satisfied.

### [Supplementary Note 50]

The variable magnification optical system according to any one of supplementary notes 1 to 49, in which in a case in which a total sum of thicknesses of all lenses included in the first lens group on the optical axis is denoted by d1sum, a focal length of the entire system in a state in which the infinite distance object is in focus at a telephoto end is denoted by ft, and an open F-number in a state in which the infinite distance object is in focus at the telephoto end is denoted by FNot, Conditional Expression (28) represented by 0.15<d1sum/(ft/FNot)<4 (28) is satisfied.

### [Supplementary Note 51]

The variable magnification optical system according to any one of supplementary notes 1 to 50, in which the variable magnification optical system includes an aperture stop, and in a case in which a focal length of the first lens group is denoted by f1, and a composite focal length from a lens closest to the object side of the first lens group to the aperture stop in a state in which the infinite distance object is in focus at the wide angle end is denoted by fL1STw, Conditional Expression (29) represented by −3<f1/fL1STw<−0.1 (29) is satisfied.

### [Supplementary Note 52]

The variable magnification optical system according to any one of supplementary notes 1 to 51, in which the variable magnification optical system includes an aperture stop, and in a case in which a composite focal length from a lens closest to the object side of the first lens group to the aperture stop in a state in which the infinite distance object is in focus at the wide angle end is denoted by fL1STw, Conditional Expression (30) represented by 0.1<fw/fL1STw<3.2 (30) is satisfied.

### [Supplementary Note 53]

The variable magnification optical system according to any one of supplementary notes 1 to 52, in which in a case in which a refractive index, at a d line, of a negative lens closest to the object side among negative lenses included in the first lens group is denoted by N1n, Conditional Expression (31) represented by 1.55<N1n<2 (31) is satisfied.

### [Supplementary Note 54]

The variable magnification optical system according to any one of supplementary notes 1 to 53, in which in a case in which an open F-number in a state in which the infinite distance object is in focus at the wide angle end is denoted by FNow, Conditional Expression (32) represented by 1<(Dsum/TLw)×FNow<2.5 (32) is satisfied.

### [Supplementary Note 55]

The variable magnification optical system according to any one of supplementary notes 1 to 54, in which in a case in which a thickness of the focusing group on the optical axis is denoted by Dfoc, Conditional Expression (33) represented by 0.01<Dfoc/(fw×tan ωw)<0.25 (33) is satisfied.

### [Supplementary Note 56]

The variable magnification optical system according to any one of supplementary notes 1 to 55, in which in a case in which a sum of thicknesses of all lenses included in the first lens group on the optical axis is denoted by d1sum, and a focal length of the first lens group is denoted by f1, Conditional Expression (34) represented by 0.045<d1sum/|f1|<0.5 (34) is satisfied.

### [Supplementary Note 57]

The variable magnification optical system according to any one of supplementary notes 1 to 56, in which the final lens group remains stationary with respect to an image plane during magnification change.

### [Supplementary Note 58]

The variable magnification optical system according to any one of supplementary notes 1 to 57, in which the final lens group consists of one positive lens.

### [Supplementary Note 59]

The variable magnification optical system according to any one of supplementary notes 1 to 58, in which the number of lenses included in the variable magnification optical system is equal to or greater than 7 and equal to or less than 11.

### [Supplementary Note 60]

The variable magnification optical system according to supplementary note 59, in which the number of lenses included in the variable magnification optical system is equal to or greater than 7 and equal to or less than 9.

### [Supplementary Note 61]

The variable magnification optical system according to any one of supplementary notes 1 to 60, in which the first lens group consists of three uncemented single lenses.

### [Supplementary Note 62]

The variable magnification optical system according to any one of supplementary notes 1 to 60, in which the first lens group consists of two lenses.

### [Supplementary Note 63]

The variable magnification optical system according to any one of supplementary notes 1 to 62, in which the focusing group consists of two lenses.

### [Supplementary Note 64]

The variable magnification optical system according to any one of supplementary notes 1 to 62, in which the focusing group consists of one lens.

### [Supplementary Note 65]

An imaging apparatus comprising: the variable magnification optical system according to any one of supplementary notes 1 to 64.

All of the documents, the patent applications, and the technical standards described in the present specification are incorporated herein by reference to the same extent as in a case in which each of the documents, the patent applications, and the technical standards are specifically and individually set forth herein.

What is claimed is:

1. A variable magnification optical system consisting of, in order from an object side to an image side, a first lens group having negative refractive power, an intermediate group consisting of a plurality of lens groups, and a final lens group having refractive power,
wherein, during magnification change, a spacing between the first lens group and the intermediate group changes, a spacing between the intermediate group and the final lens group changes, and spacings between all adjacent lens groups in the intermediate group change,
a focusing group that moves along an optical axis during focusing is disposed on the image side with respect to the first lens group, and
in a case in which
a sum of a distance on the optical axis from a lens surface closest to the object side of the first lens group to a lens surface closest to the image side of the final lens group and a back focus in terms of an air-equivalent distance of the variable magnification optical system in a state in which an infinite distance object is in focus at a wide angle end is denoted by TLw,
a focal length of the variable magnification optical system in a state in which the infinite distance object is in focus at the wide angle end is denoted by fw,
a maximum half angle of view in a state in which the infinite distance object is in focus at the wide angle end is denoted by ωw,
a back focus in terms of the air-equivalent distance of the variable magnification optical system in a state in which the infinite distance object is in focus at the wide angle end is denoted by Bfw, and
a total sum of thicknesses of all lens groups on the optical axis is denoted by Dsum,
Conditional Expressions (1), (2), and (3) represented by
$$2 < TLw / ( fw \times tan ω w ) < 6.5 , \qquad ( 1 )$$
$$0.15 < Bfw / ( fw \times tan ω w ) < 1.5 , and \qquad ( 2 )$$
$$0.1 < D sum / ( TLw - B f w ) < 0.8 \qquad ( 3 )$$
are satisfied.

2. The variable magnification optical system according to claim 1,
wherein Conditional Expression (1-1) represented by
$$2.6 < TLw / ( fw \times tan ω w ) < 5.5 \qquad ( 1 - 1 )$$
is satisfied.

3. The variable magnification optical system according to claim 2,
wherein Conditional Expression (1-2) represented by
$$2.8 < TLw / ( fw \times tan ω w ) < 5 \qquad ( 1 - 2 )$$
is satisfied.

4. The variable magnification optical system according to claim 3,
wherein Conditional Expression (1-3) represented by
$$3.1 < TLw / ( fw \times tan ω w ) < 4.5 \qquad ( 1 - 3 )$$
is satisfied.

5. The variable magnification optical system according to claim 3,
wherein Conditional Expression (2-3) represented by
$$0.35 < Bfw / ( fw \times tan ω w ) < 1 \qquad ( 2 - 3 )$$
is satisfied.

6. The variable magnification optical system according to claim 5,
wherein Conditional Expression (3-2) represented by
$$0. 21 < D sum / ( TLw - Bfw ) < 0 \text{.54} \qquad ( 3 ‐ 2 )$$
is satisfied.

7. The variable magnification optical system according to claim 6,
wherein in a case in which an open F-number in a state in which the infinite distance object is in focus at the wide angle end is denoted by FNow,
Conditional Expression (4-1) represented by
$$2.9 < FNow / tan ω w < 6 \qquad ( 4 ‐ 1 )$$
is satisfied.

8. The variable magnification optical system according to claim 7,
wherein in a case in which a focal length of the variable magnification optical system in a state in which the infinite distance object is in focus at a telephoto end is denoted by ft,
Conditional Expression (5-3) represented by
$$0.75 < ( fw \times TLw ) / {ft}^{2} < 1.35 \qquad ( 5 ‐ 3 )$$
is satisfied.

9. The variable magnification optical system according to claim 8,
wherein in a case in which
the focal length of the variable magnification optical system in a state in which the infinite distance object is in focus at the telephoto end is denoted by ft, and
a focal length of the first lens group is denoted by f1,
Conditional Expression (6-2) represented by
$$- 5 < ft / f 1 < - 1.1 \qquad ( 6 ‐ 2 )$$
is satisfied.

10. The variable magnification optical system according to claim 9,
wherein the intermediate group includes an anti-vibration group that moves in a direction intersecting the optical axis during image shake correction, and
in a case in which a focal length of the anti-vibration group is denoted by fois,
Conditional Expression (7) represented by
$$0.3 < ft / \vert fois \vert < 4 \qquad ( 7 )$$
is satisfied.

11. The variable magnification optical system according to claim 10,
wherein the anti-vibration group is disposed closest to the object side in a lens group that is located closest to the object side in the intermediate group.

12. The variable magnification optical system according to claim 4,
wherein Conditional Expression (2-2) represented by
$$0. 25 < Bfw / ( fw \times tan ω w ) < 1.1 \qquad ( 2 ‐ 2 )$$
is satisfied.

13. The variable magnification optical system according to claim 12,
wherein Conditional Expression (3-2) represented by
$$0. 21 < D sum / ( TLw - Bfw ) < 0 \text{.54} \qquad ( 3 ‐ 2 )$$
is satisfied.

14. The variable magnification optical system according to claim 13,
wherein in a case in which an open F-number in a state in which the infinite distance object is in focus at the wide angle end is denoted by FNow,
Conditional Expression (4-1) represented by
$$2.9 < FNow / tan ω w < 6 \qquad ( 4 ‐ 1 )$$
is satisfied.

15. The variable magnification optical system according to claim 14,
wherein in a case in which a focal length of the variable magnification optical system in a state in which the infinite distance object is in focus at a telephoto end is denoted by ft,
Conditional Expression (5-2) represented by
$$0.73 < ( fw \times TLw ) / {ft}^{2} < 1.4 \qquad ( 5 ‐ 2 )$$
is satisfied.

16. The variable magnification optical system according to claim 15,
wherein in a case in which a focal length of the first lens group is denoted by f1,
Conditional Expression (6-2) represented by
$$- 5 < ft / f 1 < - 1.1 \qquad ( 6 ‐ 2 )$$
is satisfied.

17. The variable magnification optical system according to claim 1,
wherein the intermediate group includes, in order from the object side to the image side, at least a first intermediate lens group having positive refractive power, a second intermediate lens group having refractive power, and a third intermediate lens group having refractive power.

18. The variable magnification optical system according to claim 17,
wherein Conditional Expression (1-2) represented by
$$2.8 < TLw / ( fw \times tan ω w ) < 5 \qquad ( 1 ‐ 2 )$$
is satisfied.

19. The variable magnification optical system according to claim 18,
wherein Conditional Expression (2-1A) represented by
$$0.18 < Bfw / ( fw \times tan ω w ) < 1.25 \qquad ( 2 ‐ 1 A )$$
is satisfied.

20. The variable magnification optical system according to claim 19,
wherein in a case in which a focal length of the variable magnification optical system in a state in which the infinite distance object is in focus at a telephoto end is denoted by ft,
Conditional Expression (5-1A) represented by
$$0.63 < ( fw \times TLw ) / {ft}^{2} < 1.85 \qquad ( 5 ‐ 1 A )$$
is satisfied.

21. The variable magnification optical system according to claim 20,
wherein in a case in which a focal length of the first lens group is denoted by f1,
Conditional Expression (6-1) represented by
$$- 7 < ft / f 1 < - 0.9 \qquad ( 6 ‐ 1 )$$
is satisfied.

22. The variable magnification optical system according to claim 1,
wherein in a case in which a focal length of the first lens group is denoted by f1,
Conditional Expression (8) represented by
$$- 3.5 < fw / f 1 < - 0.2 \qquad ( 8 )$$
is satisfied.

23. The variable magnification optical system according to claim 1,
wherein in a case in which
a focal length of the variable magnification optical system in a state in which the infinite distance object is in focus at a telephoto end is denoted by ft, and
a focal length of the intermediate group in a state in which the infinite distance object is in focus at the wide angle end is denoted by fMw,
Conditional Expression (9) represented by
$$0.2 < ft / fMw < 7.5 \qquad ( 9 )$$
is satisfied.

24. The variable magnification optical system according to claim 1,
wherein in a case in which
a focal length of the variable magnification optical system in a state in which the infinite distance object is in focus at a telephoto end is denoted by ft, and
a focal length of a lens group located closest to the image side in the intermediate group is denoted by fme,
Conditional Expression (10) represented by
$$- 16 < ft / fme < - 0.15 \qquad ( 10 )$$
is satisfied.

25. The variable magnification optical system according to claim 1,
wherein in a case in which
a focal length of the variable magnification optical system in a state in which the infinite distance object is in focus at a telephoto end is denoted by ft, and
a focal length of the final lens group is denoted by fE,
Conditional Expression (11) represented by
$$- 2 < ft / fE < 2.5 \qquad ( 11 )$$
is satisfied.

26. The variable magnification optical system according to claim 1,
wherein in a case in which
a focal length of the first lens group is denoted by f1, and
a focal length of a lens group located closest to the object side in the intermediate group is denoted by fm1,
Conditional Expression (12) represented by
$$- 5 < f 1 / fm 1 < - 0.05 \qquad ( 12 )$$
is satisfied.

27. The variable magnification optical system according to claim 1,
wherein a lens group located closest to the object side in the intermediate group has positive refractive power, and
in a case in which
a focal length of the lens group located closest to the object side in the intermediate group is denoted by fm1, and
a focal length of a lens group located closest to the image side in the intermediate group is denoted by fme,
Conditional Expression (13) represented by
$$- 15 < fm 1 / fme < - 0.05 \qquad ( 13 )$$
is satisfied.

28. The variable magnification optical system according to claim 1,
wherein a lens group located closest to the image side in the intermediate group has negative refractive power, and
in a case in which
a focal length of the lens group located closest to the image side in the intermediate group is denoted by fme, and
a focal length of the final lens group is denoted by fE,
Conditional Expression (16) represented by
$$- 9 < fme / fE < - 0.05 \qquad ( 16 )$$
is satisfied.

29. The variable magnification optical system according to claim 3,
wherein Conditional Expression (2-2) represented by
$$0.25 < Bfw / ( fw \times tan ω w ) < 1.1 \qquad ( 2 - 2 )$$
is satisfied.

30. The variable magnification optical system according to claim 29,
wherein in a case in which a focal length of the variable magnification optical system in a state in which the infinite distance object is in focus at a telephoto end is denoted by ft,
Conditional Expression (5-1) represented by
$$0.58 < ( fw \times TLw ) / {ft}^{2} < 2.2 \qquad ( 5 - 1 )$$
is satisfied.

31. The variable magnification optical system according to claim 30,
wherein in a case in which a focal length of a lens group located closest to the image side in the intermediate group is denoted by fme,
Conditional Expression (10-1) represented by
$$- 10 < ft / fme < - 1.5 \qquad ( 10 - 1 )$$
is satisfied.

32. The variable magnification optical system according to claim 31,
wherein in a case in which a focal length of the final lens group is denoted by fE,
Conditional Expression (11-1) represented by
$$0.1 < ft / fE < 0.7 \qquad ( 11 - 1 )$$
is satisfied.

33. The variable magnification optical system according to claim 32,
wherein Conditional Expression (16-1) represented by
$$- 3 < fme / fE < - 0.35 \qquad ( 16 - 1 )$$
is satisfied.

34. The variable magnification optical system according to claim 1,
wherein in a case in which
a focal length of the first lens group is denoted by f1, and
a focal length of the intermediate group in a state in which the infinite distance object is in focus at the wide angle end is denoted by fMw,
Conditional Expression (17) represented by
$$0.2 < ( - f 1 ) / fMw < 5 \qquad ( 17 )$$
is satisfied.

35. The variable magnification optical system according to claim 1,
wherein in a case in which
a focal length of the first lens group is denoted by f1, and
a focal length of the variable magnification optical system in a state in which the infinite distance object is in focus at a telephoto end is denoted by ft,
Conditional Expression (18) represented by
$$0.3 < ( - f 1 ) / {( fw \times ft )}^{1 / 2} < 2 \qquad ( 18 )$$
is satisfied.

36. The variable magnification optical system according to claim 1,
wherein in a case in which
a focal length of the intermediate group in a state in which the infinite distance object is in focus at the wide angle end is denoted by fMw, and
a focal length of the variable magnification optical system in a state in which the infinite distance object is in focus at a telephoto end is denoted by ft,
Conditional Expression (19) represented by
$$0.15 < fMw / {( fw \times f t )}^{1 / 2} < 2 \qquad ( 19 )$$
is satisfied.

37. The variable magnification optical system according to claim 1,
wherein in a case in which
a spacing on the optical axis between the first lens group and the intermediate group in a state in which the infinite distance object is in focus at the wide angle end is denoted by DDG1Mw, and
a spacing on the optical axis between the first lens group and the intermediate group in a state in which the infinite distance object is in focus at a telephoto end is denoted by DDG1Mt,
Conditional Expression (26) represented by
$$0.07 < \vert DDG 1 Mw - DDG 1 Mt \vert / TLw < 0.4 \qquad ( 26 )$$
is satisfied.

38. An imaging apparatus comprising:
the variable magnification optical system according to claim 1.
